(19) United States
(12) Patent Application Publication
(10) Pub. No.: US 2014/0243375 A1
(43) Pub. Date: Aug. 28, 2014

(54) ISOXAZOLINE DERIVATIVES AS INSECTICIDAL COMPOUNDS

(71) Applicant: Syngenta Participations AG, Basel (CH)

(72) Inventors: Myriem El Qacemi, Stein (CH); Jerome Yves Cassayre, Stein (CH)

(73) Assignee: Syngenta Participations AG, Basel (CH)

(21) Appl. No.: 14/348,931

(22) PCT Filed: Sep. 28, 2012
(86) PCT No.: PCT/EP2012/069173

§ 371 Date: Apr. 1, 2014

(30) Foreign Application Priority Data
Oct. 3, 2011 (EP) 11183691.2

(51) Int. Cl. A01N 43/80

(52) U.S. Cl. CPC A01N 43/80
USPC 514/340; 548/240; 514/380; 546/272.1

(57) ABSTRACT

The present invention provides compounds of formula I wherein G¹ is oxygen; R¹ is hydrogen; R² is group P L is a bond, methylene or ethylene; R³ is hydrogen; R⁴ is independently hydrogen, cyano, cyano-C₁-C₈alkyl, C₁-C₈alkyl, C₁-C₈haloalkyl, C₃-C₈cycloalkyl, C₃-C₈-cycloalkyl where one carbon atom is replaced by O, S, S(O) or SO₂, or C₃-Cgcycloalkyl-C₁-C₈alkyl, C₃-C₈cycloalkyl-C₁-C₈alkyl where one carbon atom in the cycloalkyl group is replaced by O, S, S(O) or SO₂, or C₃-C₈cycloalkyl-C₁-C₈haloalkyl, C₁-C₈hydroxyalkyl, C₁-C₈alkoxy-C₁-C₈alkyl, C₂-C₈alkenyl, C₂-C₈haloalkenyl, C₂-C₈alkynyl, C₂-C₈haloalkynyl, phenyl, phenyl substituted by one to three R⁶, phenyl-C₁-C₄alkyl, phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R6, or C₁-C₄alkyl-(C₁-C₄alkyl-O—N═)C—CH₂—; each R⁶ is independently halogen, cyano, nitro, C₁-C₈alkyl, C₁-C₈haloalkyl, C₁-C₈alkoxy, or C₁-C₈haloalkoxy; Y¹, Y² and Y³ are independently CH or nitrogen; wherein no more than two of Y¹, Y² and Y³ are nitrogen and wherein Y² and Y³ are not both nitrogen; R⁵ is hydrogen, halogen, cyano, nitro, NH₂, C₁-C₂alkyl, C₁-C₂haloalkyl, C₃-C₃cycloalkyl, C₁-C₂halocycloalkyl, C₁-C₂alkoxy, C₁-C₂haloalkoxy; or Y¹ is CR⁷, and R⁵ and R⁷ together form a —CH═CH—CH═CH— bridge or a —N═CH—CH═CH— bridge; X² is C—X⁶ or nitrogen; X¹, X³ and X⁶ are independently hydrogen, halogen or trihalomethyl, wherein at least two of X¹, X³ and X⁶ are not hydrogen; X⁴ is trifluoromethyl, difhioromethyl or chlorodifluoromethyl. or a salt or N-oxide thereof. The invention also provides intermediates useful for the preparation of compounds of formula I, as well as methods of controlling insects, acarines, nematodes or molluscs using the compounds of formula I.

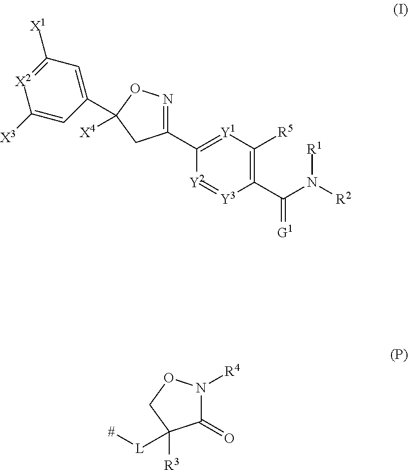

The present invention relates to certain isoxazolines derivatives, to processes and intermediates for preparing these derivatives, to insecticidal, acaricidal, nematicidal and molluscicidal compositions comprising these derivatives and to methods of using these derivatives to control insect, acarine, nematode and mollusc pests. The present invention also relates to use of these compounds in the field of animal health.

Certain isoxazoline derivatives with insecticidal properties are disclosed, for example, in WO2011/067272.

There is an ongoing need to find compounds that exhibit higher levels of activity, broader spectrum of control, higher levels of activity against specific pests, increased safety, reduced impact on the environment. The present invention seeks to address these needs at least in part.

The present invention therefore provides a compound of formula (I):

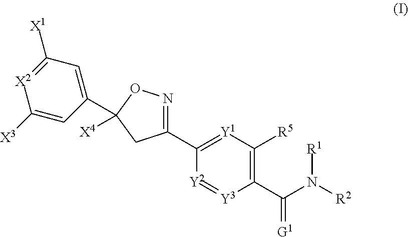

wherein
G¹ is oxygen;
R¹ is hydrogen;
R² is group P

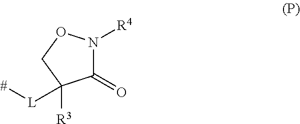

L is a bond, methylene or ethylene;
R³ is hydrogen;
R⁴ is independently hydrogen, cyano, cyano-C₁-C₈alkyl, C₁-C₈alkyl, C₁-C₈haloalkyl, C₃-C₈cycloalkyl, C₃-C₈cycloalkyl where one carbon atom is replaced by O, S, S(O) or SO₂, or C₃-C₈cycloalkyl-C₁-C₈alkyl, C₃-C₈cycloalkyl-C₁-C₈alkyl where one carbon atom in the cycloalkyl group is replaced by O, S, S(O) or SO₂, or C₃-C₈cycloalkyl-C₁-C₈haloalkyl, C₁-C₈hydroxyalkyl, C₁-C₈alkoxy-C₁-C₈alkyl, C₂-C₈alkenyl, C₂-C₈haloalkenyl, C₂-C₈alkynyl, C₂-C₈haloalkynyl, phenyl, phenyl substituted by one to three R⁶, phenyl-C₁-C₄alkyl, phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R⁶, or C₁-C₄alkyl-(C₁-C₄alkyl-O—N═)C—CH₂—;
each R⁶ is independently halogen, cyano, nitro, C₁-C₈alkyl, C₁-C₈haloalkyl, C₁-C₈alkoxy, or C₁-C₈haloalkoxy;
Y¹, Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₂alkyl, C₁-C₂haloalkyl, C₃-C₅cycloalkyl, C₁-C₂halocycloalkyl, C₁-C₂alkoxy, C₁-C₂haloalkoxy;
or Y¹ is CR⁷, and R⁵ and R⁷ together form a —CH═CH—CH═CH— bridge or a —N═CH—CH═CH-bridge;
X² is C—X⁶ or nitrogen;
X¹, X³ and X⁶ are independently hydrogen, halogen or trihalomethyl, wherein at least two of X¹, X³ and X⁶ are not hydrogen;
X⁴ is trifluoromethyl, difluoromethyl or chlorodifluoromethyl.
or a salt or N-oxide thereof.

The compounds of formula (I) may exist in different geometric or optical isomers or tautomeric forms. This invention covers all such isomers and tautomers and mixtures thereof in all proportions as well as isotopic forms such as deuterated compounds. The invention also covers salts and N-oxides of the compounds of the invention.

The compounds of the invention may contain one or more asymmetric carbon atoms, and may exist as enantiomers (or as pairs of diastereoisomers) or as mixtures of such.

Alkyl groups (either alone or as part of a larger group, such as alkoxy-, alkylthio-, alkylsulfinyl-, alkylsulfonyl-, alkylcarbonyl- or alkoxycarbonyl-) can be in the form of a straight or branched chain and are, for example, methyl, ethyl, propyl, prop-2-yl, butyl, but-2-yl, 2-methyl-prop-1-yl or 2-methyl-prop-2-yl. The alkyl groups are preferably C₁-C₆, more preferably C₁-C₄, most preferably C₁-C₃ alkyl groups. Where an alkyl moiety is said to be substituted, the alkyl moiety is preferably substituted by one to four substituents, most preferably by one to three substituents.

Alkylene groups can be in the form of a straight or branched chain and are, for example, —CH₂—, —CH₂—CH₂—, —CH(CH₃)—, —CH₂—CH₂—CH₂—, —CH(CH₃)—CH₂—, or —CH(CH₂CH₃)—. The alkylene groups are preferably C₁-C₃, more preferably C₁-C₂, most preferably C₁ alkylene groups.

Alkenyl groups can be in the form of straight or branched chains, and can be, where appropriate, of either the (E)- or (Z)-configuration. Examples are vinyl and allyl. The alkenyl groups are preferably C₂-C₆, more preferably C₂-C₄, most preferably C₂-C₃ alkenyl groups.

Alkynyl groups can be in the form of straight or branched chains. Examples are ethynyl and propargyl. The alkynyl groups are preferably C₂-C₆, more preferably C₂-C₄, most preferably C₂-C₃ alkynyl groups.

Halogen is fluorine, chlorine, bromine or iodine.

Haloalkyl groups (either alone or as part of a larger group, such as haloalkoxy-, haloalkylthio-, haloalkylsulfinyl- or haloalkylsulfonyl-) are alkyl groups which are substituted by one or more of the same or different halogen atoms and are, for example, difluoromethyl, trifluoromethyl, chlorodifluoromethyl or 2,2,2-trifluoro-ethyl.

Haloalkenyl groups are alkenyl groups which are substituted by one or more of the same or different halogen atoms and are, for example, 2,2-difluoro-vinyl or 1,2-dichloro-2-fluoro-vinyl.

Haloalkynyl groups are alkynyl groups which are substituted by one or more of the same or different halogen atoms and are, for example, 1-chloro-prop-2-ynyl.

Cycloalkyl groups or carbocyclic rings can be in mono- or bi-cyclic form and are, for example, cyclopropyl, cyclobutyl, cyclohexyl and bicyclo[2.2.1]heptan-2-yl. The cycloalkyl groups are preferably C₃-C₈, more preferably C₃-C₆ cycloalkyl groups. Where a cycloalkyl moiety is said to be substituted, the cycloalkyl moiety is preferably substituted by one to four substituents, most preferably by one to three substituents.

Aryl groups (either alone or as part of a larger group, such as aryl-alkylene-) are aromatic ring systems which can be in mono-, bi- or tricyclic form. Examples of such rings include phenyl, naphthyl, anthracenyl, indenyl or phenanthrenyl. Preferred aryl groups are phenyl and naphthyl, phenyl being most preferred. Where an aryl moiety is said to be substituted, the aryl moiety is preferably substituted by one to four substituents, most preferably by one to three substituents.

Heteroaryl groups (either alone or as part of a larger group, such as heteroaryl-alkylene-) are aromatic ring systems containing at least one heteroatom and consisting either of a single ring or of two or more fused rings. Preferably, single rings will contain up to three heteroatoms and bicyclic systems up to four heteroatoms which will preferably be chosen from nitrogen, oxygen and sulfur. Examples of monocyclic groups include pyridyl, pyridazinyl, pyrimidinyl, pyrazinyl, pyrrolyl, pyrazolyl, imidazolyl, triazolyl (e.g. 1.2.4 triazoyl), furanyl, thiophenyl, oxazolyl, isoxazolyl, oxadiazolyl, thiazolyl, isothiazolyl and thiadiazolyl. Examples of bicyclic groups include purinyl, quinolinyl, cinnolinyl, quinoxalinyl, indolyl, indazolyl, benzimidazolyl, benzothiophenyl and benzothiazolyl. Monocyclic heteroaryl groups are preferred, pyridyl being most preferred. Where a heteroaryl moiety is said to be substituted, the heteroaryl moiety is preferably substituted by one to four substituents, most preferably by one to three substituents.

Heterocyclyl groups or heterocyclic rings (either alone or as part of a larger group, such as heterocyclyl-alkylene-) are defined to include heteroaryl groups and in addition their unsaturated or partially unsaturated analogues. Examples of monocyclic groups include isoxazolyl, thietanyl, pyrrolidinyl, tetrahydrofuranyl, [1,3]dioxolanyl, piperidinyl, piperazinyl, [1,4]dioxanyl, and morpholinyl or their oxidised versions such as 1-oxo-thietanyl and 1,1-dioxo-thietanyl. Examples of bicyclic groups include 2,3-dihydro-benzofuranyl, benzo[1,4]dioxolanyl, benzo[1,3]dioxolanyl, chromenyl, and 2,3-dihydro-benzo[1,4]dioxinyl. Where a heterocyclyl moiety is said to be substituted, the heterocyclyl moiety is preferably substituted by one to four substituents, most preferably by one to three substituents.

The term “heterocyclyl” is defined to include heteroaryl and in addition their unsaturated or partially unsaturated analogues.

Preferred values of R⁴, R⁵, R⁶, X¹, X², X³ and X⁴ are, in any combination, as set out below.

Preferably R⁴ is hydrogen, cyano-C₁-C₈alkyl, C₁-C₈alkyl, C₃-C₈cycloalkyl, C₃-C₈cycloalkyl where one carbon atom in the cycloalkyl group is replaced by O, S, S(O) or SO₂, or C₃-C₈cycloalkyl-C₁-C₈alkyl, C₃-C₈cycloalkyl-C₁-C₈alkyl where one carbon atom in the cycloalkyl group is replaced by O, S, S(O) or SO₂, or C₁-C₈haloalkyl, C₁-C₈hydroxyalkyl, C₁-C₈hydroxyalkyl, C₂-C₈alkenyl, C₂-C₈alkynyl, phenyl-C₁-C₄alkyl or phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R⁶; more preferably each R⁴ is independently hydrogen, cyano-C₁-C₈alkyl-, C₁-C₈alkyl, C₃-C₈cycloalkyl, C₃-C₈cycloalkyl where one carbon atom in the cycloalkyl group is replaced by O, S, S(O) or SO₂, or C₁-C₈haloalkyl, C₁-C₈hydroxyalkyl, C₂-C₈alkenyl, C₂-C₈alkynyl, phenyl-C₁-C₄alkyl or phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R⁶; even more preferably each R⁴ is independently hydrogen, cyano-C₁-C₆alkyl, C₁-C₆alkyl, C₃-C₆cycloalkyl, C₃-C₆cycloalkyl where one carbon atom in the cycloalkyl group is replaced by O, S, S(O) or SO₂, or C₁-C₆haloalkyl, C₁-C₆hydroxyalkyl, C₁-C₆alkoxy-C₁-C₆alkyl, C₂-C₆alkenyl, C₂-C₆alkynyl, phenyl-CH₂-alkyl or phenyl-CH₂— wherein the phenyl moiety is substituted by one to three R⁶, furanyl or furanyl substituted by one to three R⁶, triazolyl or triazolyl optionally substituted by one to three R⁶; yet even more preferably each R⁴ is independently hydrogen, C₁-C₄alkyl, C₃-C₆cycloalkyl, C₁-C₄haloalkyl, C₁-C₄hydroxyalkyl, C₁-C₄alkoxy-C₁-C₄alkyl, phenyl-CH₂-alkyl- or phenyl-CH₂— wherein the phenyl moiety is substituted by one to three R⁶, furanyl or furanyl substituted by one to three R¹⁰, thietanyl, oxetanyl, oxo-thietanyl, or dioxo-thietanyl; yet even more preferably each R⁴ is independently methyl, ethyl, cyclopropyl, cyclobutyl, oxetanyl, thietanyl, trifluoroethyl, difluoroethyl, allyl, propargyl, cyanomethyl, 2-cyano-ethyl, benzyl, benzyl substituted by one to three R⁶, or pyridine-methyl- or pyridine-methyl-substituted by one to three R⁶. Ethyl and trifluoroethyl are particularly preferred. Heteroaryl preferably refers to pyridyl, pyridazinyl, pyrimidinyl, pyrazinyl, pyrazolyl, furanyl, thiophenyl, oxazolyl, isoxazolyl or thiazolyl, more preferably pyridyl, pyrazolyl, furanyl, thiophenyl or thiazolyl, most preferably pyridyl.

In one group of compounds R⁴ is hydrogen, methyl, ethyl, 2,2,2-trifluoro-ethyl, 3,3,3-trifluoro-propyl, 2-methoxy-ethyl, 3,3,3-trifluoro-propyl, 2-methoxy-ethyl, 2-hydroxy-ethyl, cyclobutyl, phenyl-methyl, (pyrid-2-yl)-methyl, (pyrid-3-yl)-methyl, thietan-3-yl, 1-oxo-thietan-3-yl, 1,1-dioxo-thietan-3-yl, 3-methyl-thietan-3-yl-, oxetan-3yl, tetrahydropyran-4-yl, cyclopropyl, 2-cyano-ethyl, 2,2-difluoro-ethyl, prop-2-ynyl, cyclopropylmethyl, cyclobutylmethyl, 3-cyano-propyl, 2-([1′,3′]dioxolan-2′-yl)-eth-1-yl, (2-chloro-pyrid-5-yl)-methyl, tetrahydro-pyran-2-ylmethyl, allyl, 3-methyl-but-2-enyl, butyl, but-2-ynyl, 2-methoxyimino-propy, (2,6-difluoro-phenyl)-methyl, (4-fluoro-phenyl)-methyl, 3-phenyl-propyl, 2,5-dimethyl-2H-[1,2,3],2,5-dimethyl-2H-[1,2,3]triazol-4-ylmethyl, cyclohexylmethyl, (tetrahydrofuran-2-yl)-methyl, 5-trifluoromethyl-furan-2-ylmethyl or isopropyl.

In one group of compounds R⁴ is methyl, ethyl, 2,2,2-trifluoro-ethyl, 3,3,3-trifluoro-propyl, 2-prop-2-ynyl, 2,2-difluoro-ethyl, cyclobutyl, 3-cyano-propyl, cyclopropylmethyl, or 2-methoxy-ethyl.

Preferably R⁵ is hydrogen, chloro, bromo, fluoro, trifluoromethyl, methyl, ethyl, methoxy, nitro, trifluoromethoxy, cyano, cyclopropyl, more preferably R⁵ is hydrogen, chloro, bromo, fluoro, trifluoromethyl, methyl, ethyl, nitro, cyano, cyclopropyl, even more preferably R⁵ is chloro, bromo, fluoro, methyl, trifluoromethyl.

Preferably each R⁶ is independently halogen, cyano, C₁-C₈haloalkyl, C₁-C₈alkoxy or C₁-C₈haloalkoxy, most preferably, fluoro, chloro, bromo, trifluoromethyl, trifluoromethoxy, cyano or methoxy.

Preferably X¹ is chloro, X² is CH, X³ is chloro, or X¹ is chloro, X² is C—F, X³ is hydrogen, or X¹ is fluoro, X² is C—Cl, X³ is hydrogen, or X¹ is chloro, X² is C—Cl, X³ is hydrogen, or X¹ is chloro, X² is C—Br, X³ is chloro, or X¹ is chloro, X² is C—F, X³ is chloro, or X¹ is chloro, X² is C—Cl, X³ is chloro, or X¹ is chloro, X² is C—I, X³ is chloro, or X¹ is fluoro, X² is C—F, X³ is fluoro, or X¹ is chloro, X² is CH, X³ is bromo, or X¹ is chloro, X² is CH, X³ is fluoro, or X¹ is chloro, X² is CH, X³ is trifluoromethyl, or X¹ is chloro, X² is C—Cl, X³ is trifluoromethyl, or X¹ is trifluoromethyl, X² is CH, X³ is trifluoromethyl, or X¹ is trifluoromethyl, X² is C—Cl, X³ is trifluoromethyl, or X¹ is trifluoromethyl, X² is CH, X³ is hydrogen, or X¹ is chloro, X² is N, X³ is chloro, or X¹ is trifluoromethyl, X² is N, X³ is trifluoromethyl.

Preferably X⁴ is trifluoromethyl or chlorodifluoromethyl.

The invention also relates to the following intermediates which are useful for the preparation of compounds of formula I:

Compounds of formula X1

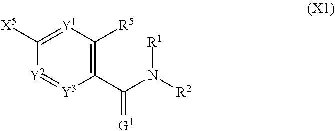

wherein G¹, R¹, R², R⁵, Y¹, Y², and Y³ are as defined for the compound of formula I and X⁵ is chloro, bromo, iodo, amino, CHO, CN, OH, C(═O)OH, C(═NOH)H, C(═NOH)Cl, C(═NOH) NH₂, C(═O)CH₃, C(═NOH)CH₃, C(═O)CH₂Cl, or C(═O)CH₂Br. Preferred definitions of R⁵, Y¹, Y², and Y³ are the same as for the corresponding substituents of compounds of formula I.
Compounds of formula X2

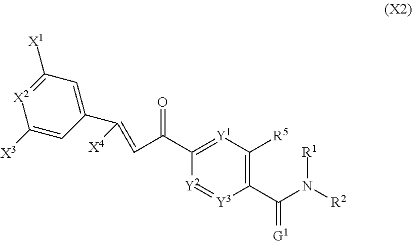

wherein G¹, R¹, R², R⁵, X¹, X², X³, X⁴, Y¹, Y², and Y³ are as defined for the compound of formula I. Preferred definitions of R⁵, X¹, X², X³, X⁴, Y¹, Y², and Y³ are the same as for the corresponding substituents of compounds of formula I.

The following embodiments apply to intermediates X1 and X2 as well as compounds of formula I. Embodiments may be combined where possible.
In embodiment A1 the invention provides compounds of formula I wherein L is a bond.
In embodiment A2 the invention provides compounds of formula I wherein L is a methylene.
In embodiment A3 the invention provides compounds of formula I wherein L is an ethylene.
In embodiment A4 the invention provides compounds of formula I wherein L is a bond and R⁴ is methyl.
In embodiment A5 the invention provides compounds of formula I wherein L is a methylene and R⁴ is methyl.
In embodiment A6 the invention provides compounds of formula I wherein L is an ethylene and R⁴ is methyl.
In embodiment A7 the invention provides compounds of formula I wherein L is a bond and R⁴ is ethyl.
In embodiment A8 the invention provides compounds of formula I wherein L is a methylene and R⁴ is ethyl.
In embodiment A9 the invention provides compounds of formula I wherein L is an ethylene and R⁴ is ethyl.
In embodiment A10 the invention provides compounds of formula I wherein L is a bond and R⁴ is 2,2,2-trifluoro-ethyl.
In embodiment A11 the invention provides compounds of formula I wherein L is a methylene and R⁴ is 2,2,2-trifluoro-ethyl.
In embodiment A12 the invention provides compounds of formula I wherein L is an ethylene and R⁴ is 2,2,2-trifluoro-ethyl.
In embodiment A13 the invention provides compounds of formula I wherein L is a bond and R⁴ is 3,3,3-trifluoro-propyl.
In embodiment A14 the invention provides compounds of formula I wherein L is a methylene and R⁴ is 3,3,3-trifluoro-propyl.
In embodiment A15 the invention provides compounds of formula I wherein L is an ethylene and R⁴ is 3,3,3-trifluoro-propyl.
In embodiment A16 the invention provides compounds of formula I wherein L is a bond and R⁴ is prop-2-ynyl.
In embodiment A17 the invention provides compounds of formula I wherein L is a methylene and R⁴ is prop-2-ynyl.
In embodiment A18 the invention provides compounds of formula I wherein L is an ethylene and R⁴ is prop-2-ynyl.
In embodiment A19 the invention provides compounds of formula I wherein L is a bond and R⁴ is 2-hydroxy-ethyl.
In embodiment A20 the invention provides compounds of formula I wherein L is a methylene and R⁴ is 2-hydroxy-ethyl.
In embodiment A21 the invention provides compounds of formula I wherein L is an ethylene and R⁴ is 2-hydroxy-ethyl.
In embodiment A22 the invention provides compounds of formula I wherein L is a bond and R⁴ is cyclobutyl.
In embodiment A23 the invention provides compounds of formula I wherein L is a methylene and R⁴ is cyclobutyl.
In embodiment A24 the invention provides compounds of formula I wherein L is an ethylene and R⁴ is cyclobutyl.
In embodiment A25 the invention provides compounds of formula I wherein L is a bond and R⁴ is 2-cyano-ethyl.
In embodiment A26 the invention provides compounds of formula I wherein L is a methylene and R⁴ is 2-cyano-ethyl.
In embodiment A27 the invention provides compounds of formula I wherein L is an ethylene and R⁴ is 2-cyano-ethyl.
In embodiment A28 the invention provides compounds of formula I wherein L is a bond and R⁴ is cyclopropylmethyl.
In embodiment A29 the invention provides compounds of formula I wherein L is a methylene and R⁴ is cyclopropylmethyl.
In embodiment A30 the invention provides compounds of formula I wherein L is an ethylene and R⁴ is cyclopropylmethyl.
In embodiment B1 the invention provides compounds of formula I wherein X² is C—X⁶.
In embodiment B2 the invention provides compounds of formula I wherein X² is C—X⁶, Y¹, Y² and Y³ are C—H.
In embodiment C1 the invention provides compounds of formula I wherein R⁵ is hydrogen and G¹, R¹, R², Y¹, Y², Y³, X¹, X², X³ and X⁴ are as defined for the compound of formula I.
In embodiment C2 the invention provides compounds of formula I wherein R⁵ is chloro and G¹, R¹, R², Y¹, Y², Y³, X¹, X², X³ and X⁴ are as defined for the compound of formula I.
In embodiment C3 the invention provides compounds of formula I wherein R⁵ is bromo and G¹, R¹, R², Y¹, Y², Y³, X¹, X², X³ and X⁴ are as defined for the compound of formula I.
In embodiment C4 the invention provides compounds of formula I wherein R⁵ is fluoro and G¹, R¹, R², Y¹, Y², Y³, X¹, X², X³ and X⁴ are as defined for the compound of formula I.
In embodiment C5 the invention provides compounds of formula I wherein R⁵ is trifluoromethyl and G¹, R¹, R², Y¹, Y², Y³, X¹, X², X³ and X⁴ are as defined for the compound of formula I.
In embodiment C6 the invention provides compounds of formula I wherein R⁵ is methyl and G¹, R¹, R², Y¹, Y², Y³, X¹, X², X³ and X⁴ are as defined for the compound of formula I.
In embodiment C7 the invention provides compounds of formula I wherein R⁵ is ethyl and G¹, R¹, R², Y¹, Y², Y³, X¹, X², X³ and X⁴ are as defined for the compound of formula I.
In embodiment C8 the invention provides compounds of formula I wherein R⁵ is methoxy and G¹, R¹, R², Y¹, Y², Y³, X¹, X², X³ and X⁴ are as defined for the compound of formula I.
In embodiment C9 the invention provides compounds of formula I wherein R⁵ is nitro and G¹, R¹, R², Y¹, Y², Y³, X¹, X², X³ and X⁴ are as defined for the compound of formula I.
In embodiment C10 the invention provides compounds of formula I wherein R⁵ is trifluoromethoxy and G¹, R¹, R², Y¹, Y², Y³, X¹, X², X³ and X⁴ are as defined for the compound of formula I.
In embodiment C11 the invention provides compounds of formula I wherein R⁵ is cyano and G¹, R¹, R², Y¹, Y², Y³, X¹, X², X³ and X⁴ are as defined for the compound of formula I.
In embodiment C12 the invention provides compounds of formula I wherein R⁵ is cyclopropyl and G¹, R¹, R², Y¹, Y², Y³, X¹, X², X³ and X⁴ are as defined for the compound of formula I.
In embodiment C13 the invention provides compounds of formula I wherein X¹ is chloro, X² is CH, X³ is chloro and G¹, R¹, R², Y¹, Y², Y³, and X⁴ are as defined for the compound of formula I.
In embodiment C14 the invention provides compounds of formula I wherein X¹ is chloro, X² is C—F, X³ is hydrogen and G¹, R¹, R², R⁵, Y¹, Y², Y³ and X⁴ are as defined for the compound of formula I.
In embodiment C15 the invention provides compounds of formula I wherein X¹ is fluoro, X² is C—Cl, X³ is hydrogen and G¹, R¹, R², R⁵, Y¹, Y², Y³ and X⁴ are as defined for the compound of formula I.
In embodiment C16 the invention provides compounds of formula I wherein X¹ is chloro, X² is C—Cl, X³ is hydrogen and G¹, R¹, R², R⁵, Y¹, Y², Y³ and X⁴ are as defined for the compound of formula I.
In embodiment C17 the invention provides compounds of formula I wherein X¹ is chloro, X² is C—Br, X³ is chloro and G¹, R¹, R², R⁵, Y¹, Y², Y³ and X⁴ are as defined for the compound of formula I.
In embodiment C18 the invention provides compounds of formula I wherein X¹ is chloro, X² is C—F, X³ is chloro and G¹, R¹, R², R⁵, Y¹, Y², Y³ and X⁴ are as defined for the compound of formula I.
In embodiment C19 the invention provides compounds of formula I wherein X¹ is chloro, X² is C—Cl, X³ is chloro and G¹, R¹, R², Y¹, Y², Y³ and X⁴ are as defined for the compound of formula I.
In embodiment C20 the invention provides compounds of formula I wherein X¹ is fluoro, X² is C—F, X³ is fluoro and G¹, R¹, R², Y¹, Y², Y³ and X⁴ are as defined for the compound of formula I.
In embodiment C21 the invention provides compounds of formula I wherein X¹ is chloro, X² is CH, X³ is bromo and G¹, R¹, R², Y¹, Y², Y³ and X⁴ are as defined for the compound of formula I.
In embodiment C22 the invention provides compounds of formula I wherein X¹ is chloro, X² is CH, X³ is fluoro and G¹, R¹, R², Y¹, Y², Y³ and X⁴ are as defined for the compound of formula I.
In embodiment C23 the invention provides compounds of formula I wherein X¹ is chloro, X² is CH, X³ is trifluoromethyl and G¹, R¹, R², Y¹, Y², Y³ and X⁴ are as defined for the compound of formula I.
In embodiment C24 the invention provides compounds of formula I wherein X¹ is chloro, X² is C—Cl, X³ is trifluoromethyl and G¹, R¹, R², Y¹, Y², Y³ and X⁴ are as defined for the compound of formula I.
In embodiment C25 the invention provides compounds of formula I wherein X¹ is trifluoromethyl, X² is CH, X³ is trifluoromethyl and G¹, R¹, R², Y¹, Y², Y³ and X⁴ are as defined for the compound of formula I.
In embodiment C26 the invention provides compounds of formula I wherein X¹ is trifluoromethyl, X² is C—Cl, X³ is trifluoromethyl and G¹, R¹, R², Y¹, Y², Y³ and X⁴ are as defined for the compound of formula I.
In embodiment C27 the invention provides compounds of formula I wherein X¹ is trifluoromethyl, X² is CH, X³ is hydrogen and G¹, R¹, R², Y¹, Y², Y³ and X⁴ are as defined for the compound of formula I.
In embodiment C28 the invention provides compounds of formula I wherein X¹ is chloro, X² is N, X³ is chloro and G¹, R¹, R², R⁵, Y¹, Y², Y³ and X⁴ are as defined for the compound of formula I.
In embodiment C29 the invention provides compounds of formula I wherein X¹ is trifluoromethyl, X² is N, X³ is trifluoromethyl and G¹, R¹, R², R⁵, Y¹, Y², Y³, X¹, X², and X³ are as defined for the compound of formula I.
In embodiment C30 the invention provides compounds of formula I wherein X⁴ is trifluoromethyl and G¹, R¹, R², R⁵, Y¹, Y², Y³, X¹, X², and X³ are as defined for the compound of formula I.
In embodiment C31 the invention provides compounds of formula I wherein X⁴ is difluoromethyl and G¹, R¹, R², R⁵, Y¹, Y², Y³, X¹, X², and X³ are as defined for the compound of formula I.
In embodiment C32 the invention provides compounds of formula I wherein X⁴ is chlorodifluoromethyl and G¹, R¹, R², R⁵, Y¹, Y², Y³, X¹, X², and X³ are as defined for the compound of formula I.
In embodiment C33 the invention provides compounds of formula I wherein R² is 2-methyl-3-oxo-isoxazolidin-4-yl and G¹, R¹, R⁵, Y¹, Y², Y³, X¹, X², X³ and X⁴ are as defined for the compound of formula I.
In embodiment C34 the invention provides compounds of formula I wherein R² is 2-ethyl-3-oxo-isoxadolidin-4-yl and G¹, R¹, R⁵, Y¹, Y², Y³, X¹, X², X³ and X⁴ are as defined for the compound of formula I.
In embodiment C35 the invention provides compounds of formula I wherein R² is 3-oxo-2-(2,2,2-trifluoro-ethyl)-isoxazolidin-4-yl and G¹, R¹, R⁵, Y¹, Y², Y³, X¹, X², X³ and X⁴ are as defined for the compound of formula I.
In embodiment C36 the invention provides compounds of formula I wherein R² is 3-oxo-2-(3,3,3-trifluoro-propyl)-isoxazolidin-4-yl and G¹, R¹, R⁵, Y¹, Y², Y³, X¹, X², X³ and X⁴ are as defined for the compound of formula I.
In embodiment C37 the invention provides compounds of formula I wherein R² is 3-oxo-2-prop-2-ynyl-isoxazolidin-4-yl and G¹, R¹, R⁵, Y¹, Y², Y³, X¹, X², X³ and X⁴ are as defined for the compound of formula I.
In embodiment C38 the invention provides compounds of formula I wherein R² is 2-(2,2-difluoro-ethyl)-3-oxo-isoxazolidin-4-yl and G¹, R¹, R⁵, Y¹, Y², Y³, X¹, X², X³ and X⁴ are as defined for the compound of formula I.
In embodiment C39 the invention provides compounds of formula I wherein R² is 2-cyclobutyl-3-oxo-isoxazolidin-4-yl and G¹, R¹, R⁵, Y¹, Y², Y³, X¹, X², X³ and X⁴ are as defined for the compound of formula I.
In embodiment C40 the invention provides compounds of formula I wherein R² is 2-(3-cyano-propyl)-3-oxo-isoxazolidin-4-yl and G¹, R¹, R⁵, Y¹, Y², Y³, X¹, X², X³ and X⁴ are as defined for the compound of formula I.
In embodiment C41 the invention provides compounds of formula I wherein R² is 2-cyclopropylmethyl-3-oxo-isoxazolidin-4-yl and G¹, R¹, R⁵, Y¹, Y², Y³, X¹, X², X³ and X⁴ are as defined for the compound of formula I.
In embodiment C42 the invention provides compounds of formula I wherein R² is 2-(2-methoxy-ethyl)-3-oxo-isoxazolidin-4-yl and G¹, R¹, R⁵, Y¹, Y², Y³, X¹, X², X³ and X⁴ are as defined for the compound of formula I.
In embodiment C43 the invention provides compounds of formula I wherein Y¹ is CH, Y² is CH, Y³ is CH and G¹, R¹, R², R⁵, X¹, X², X³ and X⁴ are as defined for the compound of formula I.
In embodiment C44 the invention provides compounds of formula I wherein Y¹ is N, Y² is CH, Y³ is CH and G¹, R¹, R², R⁵, X¹, X², X³ and X⁴ are as defined for the compound of formula I.
In embodiment C45 the invention provides compounds of formula I wherein Y¹ is N, Y² is N, Y³ is CH and G¹, R¹, R², R⁵, X¹, X², X³ and X⁴ are as defined for the compound of formula I.
In embodiment C46 the invention provides compounds of formula I wherein Y¹ is CH, Y² is N, Y³ is CH and G¹, R¹, R², R⁵, X¹, X², X³ and X⁴ are as defined for the compound of formula I.
In embodiment C47 the invention provides compounds of formula I wherein Y¹ is CH, Y² is CH, Y³ is N and G¹, R¹, R², R⁵, X¹, X², X³ and X⁴ are as defined for the compound of formula I.
In embodiment C48 the invention provides compounds of formula I wherein Y¹ is C—R⁷, Y² is CH, Y³ is CH and R⁵ and R⁶ together form a —CH═CH—CH═CH— bridge, and G¹, R¹, R², X¹, X², X³ and X⁴ are as defined for the compound of formula I.
In embodiment C49 the invention provides compounds of formula I wherein Y¹ is C—R⁷, Y² is N, Y³ is CH and R⁵ and R⁶ together form a —CH═CH—CH═CH— bridge, and G¹, R¹, R², X¹, X², X³ and X⁴ are as defined for the compound of formula I.
In embodiment C50 the invention provides compounds of formula I wherein Y¹ is C—R⁷, Y² is CH, Y³ is CH and R⁵ and R⁶ together form a —N═CH—CH═CH— bridge, and G¹, R¹, R², X¹, X², X³ and X⁴ are as defined for the compound of formula I.
In embodiment C51 the invention provides compounds of formula I wherein Y¹ is C—R⁷, Y² is N, Y³ is CH and R⁵ and R⁶ together form a —N═CH—CH═CH— bridge, and G¹, R¹, R², X¹, X², X³ and X⁴ are as defined for the compound of formula I.
In embodiment D1 the invention provides compounds of formula I wherein X⁴ is chlorodifluoromethyl, R⁵ is hydrogen and G¹, R¹, R², Y¹, Y², Y³, X¹, X² and X³ are as defined for the compound of formula I.
In embodiment D2 the invention provides compounds of formula I wherein X⁴ is chlorodifluoromethyl, R⁵ is chloro and G¹, R¹, R², Y¹, Y², Y³, X¹, X² and X³ are as defined for the compound of formula I.
In embodiment D3 the invention provides compounds of formula I wherein X⁴ is chlorodifluoromethyl, R⁵ is bromo and G¹, R¹, R², Y¹, Y², Y³, X¹, X² and X³ are as defined for the compound of formula I.
In embodiment D4 the invention provides compounds of formula I wherein X⁴ is chlorodifluoromethyl, R⁵ is fluoro and G¹, R¹, R², Y¹, Y², Y³, X¹, X² and X³ are as defined for the compound of formula I.
In embodiment D5 the invention provides compounds of formula I wherein X⁴ is chlorodifluoromethyl, R⁵ is trifluoromethyl and G¹, R¹, R², Y¹, Y², Y³, X¹, X² and X³ are as defined for the compound of formula I.
In embodiment D6 the invention provides compounds of formula I wherein X⁴ is chlorodifluoromethyl, R⁵ is methyl and G¹, R¹, R², Y¹, Y², Y³, X¹, X² and X³ are as defined for the compound of formula I.
In embodiment D7 the invention provides compounds of formula I wherein X⁴ is chlorodifluoromethyl, R⁵ is ethyl and G¹, R¹, R², Y¹, Y², Y³, X¹, X² and X³ are as defined for the compound of formula I.
In embodiment D8 the invention provides compounds of formula I wherein X⁴ is chlorodifluoromethyl, R⁵ is methoxy and G¹, R¹, R², Y¹, Y², Y³, X¹, X² and X³ are as defined for the compound of formula I.
In embodiment D9 the invention provides compounds of formula I wherein X⁴ is chlorodifluoromethyl, R⁵ is nitro and G¹, R¹, R², Y¹, Y², Y³, X¹, X² and X³ are as defined for the compound of formula I.
In embodiment D10 the invention provides compounds of formula I wherein X⁴ is chlorodifluoromethyl, R⁵ is trifluoromethoxy and G¹, R¹, R², Y¹, Y², Y³, X¹, X² and X³ are as defined for the compound of formula I.
In embodiment D11 the invention provides compounds of formula I wherein X⁴ is chlorodifluoromethyl, R⁵ is cyano and G¹, R¹, R², Y¹, Y², Y³, X¹, X² and X³ are as defined for the compound of formula I.
In embodiment D12 the invention provides compounds of formula I wherein X⁴ is chlorodifluoromethyl, R⁵ is cyclopropyl and G¹, R¹, R², Y¹, Y², Y³, X¹, X² and X³ are as defined for the compound of formula I.
In embodiment D13 the invention provides compounds of formula I wherein X⁴ is chlorodifluoromethyl, X¹ is chloro, X² is CH, X³ is chloro and G¹, R¹, R², Y¹, Y², and Y³ are as defined for the compound of formula I.
In embodiment D14 the invention provides compounds of formula I wherein X⁴ is chlorodifluoromethyl, X¹ is chloro, X² is C—F, X³ is hydrogen and G¹, R¹, R², R⁵, Y¹, Y² and Y³ are as defined for the compound of formula I.
In embodiment D15 the invention provides compounds of formula I wherein X⁴ is chlorodifluoromethyl, X¹ is fluoro, X² is C—Cl, X³ is hydrogen and G¹, R¹, R², R⁵, Y¹, Y² and Y³ are as defined for the compound of formula I.
In embodiment D16 the invention provides compounds of formula I wherein X⁴ is chlorodifluoromethyl, X¹ is chloro, X² is C—Cl, X³ is hydrogen and G¹, R¹, R², R⁵, Y¹, Y² and Y³ are as defined for the compound of formula I.
In embodiment D17 the invention provides compounds of formula I wherein X⁴ is chlorodifluoromethyl, X¹ is chloro, X² is C—Br, X³ is chloro and G¹, R¹, R², R⁵, Y¹, Y² and Y³ are as defined for the compound of formula I.
In embodiment D18 the invention provides compounds of formula I wherein X⁴ is chlorodifluoromethyl, X¹ is chloro, X² is C—F, X³ is chloro and G¹, R¹, R², R⁵, Y¹, Y² and Y³ are as defined for the compound of formula I.
In embodiment D19 the invention provides compounds of formula I wherein X⁴ is chlorodifluoromethyl, X¹ is chloro, X² is C—Cl, X³ is chloro and G¹, R¹, R², R⁵, Y¹, Y² and Y³ are as defined for the compound of formula I.
In embodiment D20 the invention provides compounds of formula I wherein X⁴ is chlorodifluoromethyl, X¹ is fluoro, X² is C—F, X³ is fluoro and G¹, R¹, R², R⁵, Y¹, Y² and Y³ are as defined for the compound of formula I.
In embodiment D21 the invention provides compounds of formula I wherein X⁴ is chlorodifluoromethyl, X¹ is chloro, X² is CH, X³ is bromo and G¹, R¹, R², R⁵, Y¹, Y² and Y³ are as defined for the compound of formula I.
In embodiment D22 the invention provides compounds of formula I wherein X⁴ is chlorodifluoromethyl, X¹ is chloro, X² is CH, X³ is fluoro and G¹, R¹, R², R⁵, Y¹, Y² and Y³ are as defined for the compound of formula I.
In embodiment D23 the invention provides compounds of formula I wherein X⁴ is chlorodifluoromethyl, X¹ is chloro, X² is CH, X³ is trifluoromethyl and G¹, R¹, R², R⁵, Y¹, Y² and Y³ are as defined for the compound of formula I.
In embodiment D24 the invention provides compounds of formula I wherein X⁴ is chlorodifluoromethyl, X¹ is chloro, X² is C—Cl, X³ is trifluoromethyl and G¹, R¹, R², R⁵, Y¹, Y² and and Y³ are as defined for the compound of formula I.
In embodiment D25 the invention provides compounds of formula I wherein X⁴ is chlorodifluoromethyl, X¹ is trifluoromethyl, X² is CH, X³ is trifluoromethyl and G¹, R¹, R², R⁵, Y¹, Y² and Y³ are as defined for the compound of formula I.
In embodiment D26 the invention provides compounds of formula I wherein X⁴ is chlorodifluoromethyl, X¹ is trifluoromethyl, X² is C—Cl, X³ is trifluoromethyl and G¹, R¹, R², R⁵, Y¹, Y² and Y³ are as defined for the compound of formula I.
In embodiment D27 the invention provides compounds of formula I wherein X⁴ is chlorodifluoromethyl, X¹ is trifluoromethyl, X² is CH, X³ is hydrogen and G¹, R¹, R², R⁵, Y¹, Y² and Y³ are as defined for the compound of formula I.
In embodiment D28 the invention provides compounds of formula I wherein X⁴ is chlorodifluoromethyl, X¹ is chloro, X² is N, X³ is chloro and G¹, R¹, R², R⁵, Y¹, Y² and Y³ are as defined for the compound of formula I.
In embodiment D29 the invention provides compounds of formula I wherein X⁴ is chlorodifluoromethyl, X¹ is trifluoromethyl, X² is N, X³ is trifluoromethyl and G¹, R¹, R², R⁵, Y¹, Y², Y³, X¹, X² and X³ are as defined for the compound of formula I.
In embodiment D30 the invention provides compounds of formula I wherein X⁴ is chlorodifluoromethyl, R² is 2-methyl-3-oxo-isoxazolidin-4-yl and G¹, R¹, R⁵, Y¹, Y² and Y³, X¹, X² and X³ are as defined for the compound of formula I.
In embodiment D31 the invention provides compounds of formula I wherein X⁴ is chlorodifluoromethyl, R² is 2-ethyl-3-oxo-isoxazolidin-4-yl and G¹, R¹, R², Y¹, Y², Y³, X¹, X² and X³ are as defined for the compound of formula I.
In embodiment D32 the invention provides compounds of formula I wherein X⁴ is chlorodifluoromethyl, R² is 3-oxo-2-(2,2,2-trifluoro-ethyl)-isoxazolidin-4-yl and G¹, R¹, R⁵, Y¹, Y², Y³, X¹, X² and X³ are as defined for the compound of formula I.
In embodiment D33 the invention provides compounds of formula I wherein X⁴ is chlorodifluoromethyl, R² is 3-oxo-2-(3,3,3-trifluoro-propyl)-isoxazolidin-4-yl and G¹, R¹, R⁵, Y¹, Y², Y³, X¹, X² and X³ are as defined for the compound of formula I.
In embodiment D34 the invention provides compounds of formula I wherein X⁴ is chlorodifluoromethyl, R² is 3-oxo-2-prop-2-ynyl-isoxazolidin-4-yl and G¹, R¹, R⁵, Y¹, Y², Y³, X¹, X² and X³ are as defined for the compound of formula I.
In embodiment D35 the invention provides compounds of formula I wherein X⁴ is chlorodifluoromethyl, R² is 2-(2,2-difluoro-ethyl)-3-oxo-isoxazolidin-4-yl and G¹, R¹, R⁵, Y¹, Y², Y³, X¹, X² and X³ are as defined for the compound of formula I.
In embodiment D36 the invention provides compounds of formula I wherein X⁴ is chlorodifluoromethyl, R² is 2-cyclobutyl-3-oxo-isoxazolidin-4-yl and G¹, R¹, R⁵, Y¹, Y², Y³, X¹, X² and X³ are as defined for the compound of formula I.
In embodiment D37 the invention provides compounds of formula I wherein X⁴ is chlorodifluoromethyl, R² is 2-(3-cyano-propyl)-3-oxo-isoxazolidin-4-yl and G¹, R¹, R⁵, Y¹, Y², Y³, X¹, X² and X³ are as defined for the compound of formula I.
In embodiment D38 the invention provides compounds of formula I wherein X⁴ is chlorodifluoromethyl, R² is 2-cyclopropylmethyl-3-oxo-isoxazolidin-4-yl and G¹, R¹, R⁵, Y¹, Y², Y³, X¹, X² and X³ are as defined for the compound of formula I.
In embodiment D39 the invention provides compounds of formula I wherein X⁴ is chlorodifluoromethyl, R² is 2-(2-methoxy-ethyl)-3-oxo-isoxazolidin-4-yl and G¹, R¹, R⁵, Y¹, Y², Y³, X¹, X² and X³ are as defined for the compound of formula I.
In embodiment D40 the invention provides compounds of formula I wherein X⁴ is chlorodifluoromethyl, Y¹ is CH, Y² is CH, Y³ is CH and G¹, R¹, R², R⁵, X¹, X² and X³ are as defined for the compound of formula I.
In embodiment D41 the invention provides compounds of formula I wherein X⁴ is chlorodifluoromethyl, Y¹ is N, Y² is CH, Y³ is CH and G¹, R¹, R², R⁵, X¹, X² and X³ are as defined for the compound of formula I.
In embodiment D42 the invention provides compounds of formula I wherein X⁴ is chlorodifluoromethyl, Y¹ is N, Y² is N, Y³ is CH and G¹, R¹, R², R⁵, X¹, X² and X³ are as defined for the compound of formula I.
In embodiment D43 the invention provides compounds of formula I wherein X⁴ is chlorodifluoromethyl, Y¹ is CH, Y² is N, Y³ is CH and G¹, R¹, R², R⁵, X¹, X² and X³ are as defined for the compound of formula I.
In embodiment D44 the invention provides compounds of formula I wherein X⁴ is chlorodifluoromethyl, Y¹ is CH, Y² is CH, Y³ is N and G¹, R¹, R², R⁵, X¹, X² and X³ are as defined for the compound of formula I.
In embodiment D45 the invention provides compounds of formula I wherein X⁴ is chlorodifluoromethyl, Y¹ is C—R⁷, Y² is CH, Y³ is CH and R⁵ and R⁶ together form a —CH═CH—CH═CH— bridge, and G¹, R¹, R², X¹, X² and X³ are as defined for the compound of formula I.
In embodiment D46 the invention provides compounds of formula I wherein X⁴ is chlorodifluoromethyl, Y¹ is C—R⁷, Y² is N, Y³ is CH and R⁵ and R⁶ together form a —CH═CH—CH═CH— bridge, and G¹, R¹, R², X¹, X² and X³ are as defined for the compound of formula I.
In embodiment D47 the invention provides compounds of formula I wherein X⁴ is chlorodifluoromethyl, Y¹ is C—R⁷, Y² is CH, Y³ is CH and R⁵ and R⁶ together form a —N═CH—CH═CH— bridge, and G¹, R¹, R², X¹, X² and X³ are as defined for the compound of formula I.
In embodiment D48 the invention provides compounds of formula I wherein X⁴ is chlorodifluoromethyl, Y¹ is C—R⁷, Y² is N, Y³ is CH and R⁵ and R⁶ together form a —N═CH—CH═CH— bridge, and G¹, R¹, R², X¹, X² and X³ are as defined for the compound of formula I.
In embodiment E1 the invention provides compounds of formula I wherein X² is C—X⁶, none of X¹, X³ and X⁶ are hydrogen, R⁵ is hydrogen and G¹, R¹, R², Y¹, Y², and Y³ are as defined for the compound of formula I.
In embodiment E2 the invention provides compounds of formula I wherein X² is C—X⁶, none of X¹, X³ and X⁶ are hydrogen, R⁵ is chloro and G¹, R¹, R², Y¹, Y² and Y³ are as defined for the compound of formula I.
In embodiment E3 the invention provides compounds of formula I wherein X² is C—X⁶, none of X¹, X³ and X⁶ are hydrogen, R⁵ is bromo and G¹, R¹, R², Y¹, Y² and Y³ are as defined for the compound of formula I.
In embodiment E4 the invention provides compounds of formula I wherein X² is C—X⁶, none of X¹, X³ and X⁶ are hydrogen, R⁵ is fluoro and G¹, R¹, R², Y¹, Y² and Y³ are as defined for the compound of formula I.
In embodiment E5 the invention provides compounds of formula I wherein X² is C—X⁶, none of X¹, X³ and X⁶ are hydrogen, R⁵ is trifluoromethyl and G¹, R¹, R², Y¹, Y² and Y³ are as defined for the compound of formula I.
In embodiment E6 the invention provides compounds of formula I wherein X² is C—X⁶, none of X¹, X³ and X⁶ are hydrogen, R⁵ is methyl and G¹, R¹, R², Y¹, Y² and Y³ are as defined for the compound of formula I.
In embodiment E7 the invention provides compounds of formula I wherein X² is C—X⁶, none of X¹, X³ and X⁶ are hydrogen, R⁵ is ethyl and G¹, R¹, R², Y¹, Y² and Y³ are as defined for the compound of formula I.
In embodiment E8 the invention provides compounds of formula I wherein X² is C—X⁶, none of X¹, X³ and X⁶ are hydrogen, R⁵ is methoxy and G¹, R¹, R², Y¹, Y² and Y³ are as defined for the compound of formula I.
In embodiment E9 the invention provides compounds of formula I wherein X² is C—X⁶, none of X¹, X³ and X⁶ are hydrogen, R⁵ is nitro and G¹, R¹, R², Y¹, Y² and Y³ are as defined for the compound of formula I.
In embodiment E10 the invention provides compounds of formula I wherein X² is C—X⁶, none of X¹, X³ and X⁶ are hydrogen, R⁵ is trifluoromethoxy and G¹, R¹, R², Y¹, Y² and Y³ are as defined for the compound of formula I.
In embodiment E11 the invention provides compounds of formula I wherein X² is C—X⁶, none of X¹, X³ and X⁶ are hydrogen, R⁵ is cyano and G¹, R¹, R², Y¹, Y² and Y³ are as defined for the compound of formula I.
In embodiment E12 the invention provides compounds of formula I wherein X² is C—X⁶, none of X¹, X³ and X⁶ are hydrogen, R⁵ is cyclopropyl and G¹, R¹, R², Y¹, Y² and Y³ are as defined for the compound of formula I.
In embodiment E13 the invention provides compounds of formula I wherein X² is C—X⁶, none of X¹, X³ and X⁶ are hydrogen, X⁴ is trifluoromethyl and G¹, R¹, R², R⁵, Y¹, Y² and Y³ are as defined for the compound of formula I.
In embodiment E14 the invention provides compounds of formula I wherein X² is C—X⁶, none of X¹, X³ and X⁶ are hydrogen, X⁴ is difluoromethyl and G¹, R¹, R², R⁵, Y¹, Y² and Y³ are as defined for the compound of formula I.
In embodiment E15 the invention provides compounds of formula I wherein X² is C—X⁶, none of X¹, X³ and X⁶ are hydrogen, X⁴ is chlorodifluoromethyl and G¹, R¹, R², R⁵, Y¹, Y² and Y³ are as defined for the compound of formula I.
In embodiment E16 the invention provides compounds of formula I wherein X² is C—X⁶, none of X¹, X³ and X⁶ are hydrogen, R² is 2-methyl-3-oxo-isoxazolidin-4-yl and G¹, R¹, R⁵, Y¹, Y², Y³, X¹, X², X³ and X⁴ are as defined for the compound of formula I.
In embodiment E17 the invention provides compounds of formula I wherein X² is C—X⁶, none of X¹, X³ and X⁶ are hydrogen, R² is 2-ethyl-3-oxo-isoxazolidin-4-yl and G¹, R¹, R⁵, Y¹, Y², Y³ and X⁴ are as defined for the compound of formula I.
In embodiment E18 the invention provides compounds of formula I wherein X² is C—X⁶, none of X¹, X³ and X⁶ are hydrogen, R² is 3-oxo-2-(2,2,2-trifluoro-ethyl)-isoxazolidin-4-yl and G¹, R¹, R⁵, Y¹, Y², Y³ and X⁴ are as defined for the compound of formula I.
In embodiment E19 the invention provides compounds of formula I wherein X² is C—X⁶, none of X¹, X³ and X⁶ are hydrogen, R² is 3-oxo-2-(3,3,3-trifluoro-propyl)-isoxazolidin-4-yl and G¹, R¹, R⁵, Y¹, Y², Y³ and X⁴ are as defined for the compound of formula I.
In embodiment E20 the invention provides compounds of formula I wherein X² is C—X⁶, none of X¹, X³ and X⁶ are hydrogen, R² is 3-oxo-2-prop-2-ynyl-isoxazolidin-4-yl and G¹, R¹, R⁵, Y¹, Y², Y³ and X⁴ are as defined for the compound of formula I.
In embodiment E21 the invention provides compounds of formula I wherein X² is C—X⁶, none of X¹, X³ and X⁶ are hydrogen, R² is 2-(2,2-difluoro-ethyl)-3-oxo-isoxazolidin-4-yl and G¹, R¹, R⁵, Y¹, Y², Y³ and X⁴ are as defined for the compound of formula I.
In embodiment E22 the invention provides compounds of formula I wherein X² is C—X⁶, none of X¹, X³ and X⁶ are hydrogen, R² is 2-cyclobutyl-3-oxo-isoxazolidin-4-yl and G¹, R¹, R⁵, Y¹, Y², Y³ and X⁴ are as defined for the compound of formula I.
In embodiment E23 the invention provides compounds of formula I wherein X² is C—X⁶, none of X¹, X³ and X⁶ are hydrogen, R² is 2-(3-cyano-propyl)-3-oxo-isoxazolidin-4-yl and G¹, R¹, R⁵, Y¹, Y², Y³ and X⁴ are as defined for the compound of formula I.
In embodiment E24 the invention provides compounds of formula I wherein X² is C—X⁶, none of X¹, X³ and X⁶ are hydrogen, R² is 2-cyclopropylmethyl-3-oxo-isoxazolidin-4-yl and G¹, R¹, R⁵, Y¹, Y², Y³ and X⁴ are as defined for the compound of formula I.
In embodiment E25 the invention provides compounds of formula I wherein X² is C—X⁶, none of X¹, X³ and X⁶ are hydrogen, R² is 2-(2-methoxy-ethyl)-3-oxo-isoxazolidin-4-yl and G¹, R¹, R⁵, Y¹, Y², Y³, and X⁴ are as defined for the compound of formula I.
In embodiment E26 the invention provides compounds of formula I wherein X² is C—X⁶, none of X¹, X³ and X⁶ are hydrogen, Y¹ is CH, Y² is CH, Y³ is CH and G¹, R¹, R², R⁵ and X⁴ are as defined for the compound of formula I.
In embodiment E27 the invention provides compounds of formula I wherein X² is C—X⁶, none of X¹, X³ and X⁶ are hydrogen, Y¹ is N, Y² is CH, Y³ is CH and G¹, R¹, R², R⁵ and X⁴ are as defined for the compound of formula I.
In embodiment E28 the invention provides compounds of formula I wherein X² is C—X⁶, none of X¹, X³ and X⁶ are hydrogen, Y¹ is N, Y² is N, Y³ is CH and G¹, R¹, R², R⁵ and X⁴ are as defined for the compound of formula I.
In embodiment E29 the invention provides compounds of formula I wherein X² is C—X⁶, none of X¹, X³ and X⁶ are hydrogen, Y¹ is CH, Y² is N, Y³ is CH and G¹, R¹, R², R⁵ and X⁴ are as defined for the compound of formula I.
In embodiment E30 the invention provides compounds of formula I wherein X² is C—X⁶, none of X¹, X³ and X⁶ are hydrogen, Y¹ is CH, Y² is CH, Y³ is N and G¹, R¹, R², R⁵ and X⁴ are as defined for the compound of formula I.
In embodiment E31 the invention provides compounds of formula I wherein X² is C—X⁶, none of X¹, X³ and X⁶ are hydrogen, Y¹ is C—R⁷, Y² is CH, Y³ is CH and R⁵ and R⁶ together form a —CH═CH—CH═CH— bridge, and G¹, R¹, R² and X⁴ are as defined for the compound of formula I.
In embodiment E32 the invention provides compounds of formula I wherein X² is C—X⁶, none of X¹, X³ and X⁶ are hydrogen, Y¹ is C—R⁷, Y² is N, Y³ is CH and R⁵ and R⁶ together form a —CH═CH—CH═CH— bridge, and G¹, R¹, R² and X⁴ are as defined for the compound of formula I.
In embodiment E33 the invention provides compounds of formula I wherein X² is C—X⁶, none of X¹, X³ and X⁶ are hydrogen, Y¹ is C—R⁷, Y² is CH, Y³ is CH and R⁵ and R⁶ together form a —N═CH—CH═CH— bridge, and G¹, R¹, R² and X⁴ are as defined for the compound of formula I.
In embodiment E34 the invention provides compounds of formula I wherein X² is C—X⁶, none of X¹, X³ and X⁶ are hydrogen, Y¹ is C—R⁷, Y² is N, Y³ is CH and R⁵ and R⁶ together form a —N═CH—CH═CH— bridge, and G¹, R¹, R² and X⁴ are as defined for the compound of formula I.
In embodiment F1 the invention provides compounds of formula I wherein X¹ is chloro, X² is CH, X³ is trifluoromethyl, R⁵ is hydrogen and G¹, R¹, R², Y¹, Y², and Y³ are as defined for the compound of formula I.
In embodiment F2 the invention provides compounds of formula I wherein X¹ is chloro, X² is CH, X³ is trifluoromethyl, R⁵ is chloro and G¹, R¹, R², Y¹, Y², and Y³ are as defined for the compound of formula I.
In embodiment F3 the invention provides compounds of formula I wherein X¹ is chloro, X² is CH, X³ is trifluoromethyl, R⁵ is bromo and G¹, R¹, R², Y¹, Y² and Y³ are as defined for the compound of formula I.
In embodiment F4 the invention provides compounds of formula I wherein X¹ is chloro, X² is CH, X³ is trifluoromethyl, R⁵ is fluoro and G¹, R¹, R², Y¹, Y² and Y³ are as defined for the compound of formula I.
In embodiment F5 the invention provides compounds of formula I wherein X¹ is chloro, X² is CH, X³ is trifluoromethyl, R⁵ is trifluoromethyl and G¹, R¹, R², Y¹, Y² and Y³ are as defined for the compound of formula I.
In embodiment F6 the invention provides compounds of formula I wherein X¹ is chloro, X² is CH, X³ is trifluoromethyl, R⁵ is methyl and G¹, R¹, R², Y¹, Y² and Y³ are as defined for the compound of formula I.
In embodiment F7 the invention provides compounds of formula I wherein X¹ is chloro, X² is CH, X³ is trifluoromethyl, R⁵ is ethyl and G¹, R¹, R², Y¹, Y² and Y³ are as defined for the compound of formula I.
In embodiment F8 the invention provides compounds of formula I wherein X¹ is chloro, X² is CH, X³ is trifluoromethyl, R⁵ is methoxy and G¹, R¹, R², Y¹, Y² and Y³ are as defined for the compound of formula I.
In embodiment F9 the invention provides compounds of formula I wherein X¹ is chloro, X² is CH, X³ is trifluoromethyl, R⁵ is nitro and G¹, R¹, R², Y¹, Y² and Y³ are as defined for the compound of formula I.
In embodiment F10 the invention provides compounds of formula I wherein X¹ is chloro, X² is CH, X³ is trifluoromethyl, R⁵ is trifluoromethoxy and G¹, R¹, R², Y¹, Y² and are as defined for the compound of formula I.
In embodiment F11 the invention provides compounds of formula I wherein X¹ is chloro, X² is CH, X³ is trifluoromethyl, R⁵ is cyano and G¹, R¹, R², Y¹, Y² and Y³ are as defined for the compound of formula I.
In embodiment F12 the invention provides compounds of formula I wherein X¹ is chloro, X² is CH, X³ is trifluoromethyl, R⁵ is cyclopropyl and G¹, R¹, R², Y¹, Y² and Y³ are as defined for the compound of formula I.
In embodiment F13 the invention provides compounds of formula I wherein X¹ is chloro, X² is CH, X³ is trifluoromethyl, X⁴ is trifluoromethyl and G¹, R¹, R², R⁵, Y¹, Y² and Y³ are as defined for the compound of formula I.
In embodiment F14 the invention provides compounds of formula I wherein X¹ is chloro, X² is CH, X³ is trifluoromethyl, X⁴ is difluoromethyl and G¹, R¹, R², R⁵, Y¹, Y² and Y³ are as defined for the compound of formula I.
In embodiment F15 the invention provides compounds of formula I wherein X¹ is chloro, X² is CH, X³ is trifluoromethyl, X⁴ is chlorodifluoromethyl and G¹, R¹, R², R⁵, Y¹, Y² and Y³ are as defined for the compound of formula I.
In embodiment F16 the invention provides compounds of formula I wherein X¹ is chloro, X² is CH, X³ is trifluoromethyl, R² is 2-methyl-3-oxo-isoxazolidin-4-yl and G¹, R¹, R⁵, Y¹, Y², Y³, X¹, X², X³ and X⁴ are as defined for the compound of formula I.
In embodiment F17 the invention provides compounds of formula I wherein X¹ is chloro, X² is CH, X³ is trifluoromethyl, R² is 2-ethyl-3-oxo-isoxazolidin-4-yl and G¹, R¹, R⁵, Y¹, Y², Y³ and X⁴ are as defined for the compound of formula I.
In embodiment F18 the invention provides compounds of formula I wherein X¹ is chloro, X² is CH, X³ is trifluoromethyl, R² is 3-oxo-2-(2,2,2-trifluoro-ethyl)-isoxazolidin-4-yl and G¹, R¹, R⁵, Y¹, Y², Y³ and X⁴ are as defined for the compound of formula I.
In embodiment F19 the invention provides compounds of formula I wherein X¹ is chloro, X² is CH, X³ is trifluoromethyl, R² is 3-oxo-2-(3,3,3-trifluoro-propyl)-isoxazolidin-4-yl and G¹, R¹, R⁵, Y¹, Y², Y³ and X⁴ are as defined for the compound of formula I.
In embodiment F20 the invention provides compounds of formula I wherein X¹ is chloro, X² is CH, X³ is trifluoromethyl, R² is 3-oxo-2-prop-2-ynyl-isoxazolidin-4-yl and G¹, R¹, R⁵, Y¹, Y², Y³ and X⁴ are as defined for the compound of formula I.
In embodiment F21 the invention provides compounds of formula I wherein X¹ is chloro, X² is CH, X³ is trifluoromethyl, R² is 2-(2,2-difluoro-ethyl)-3-oxo-isoxazolidin-4-yl and G¹, R¹, R⁵, Y¹, Y², Y³ and X⁴ are as defined for the compound of formula I.
In embodiment F22 the invention provides compounds of formula I wherein X¹ is chloro, X² is CH, X³ is trifluoromethyl, R² is 2-cyclobutyl-3-oxo-isoxazolidin-4-yl and G¹, R¹, R⁵, Y¹, Y², Y³ and X⁴ are as defined for the compound of formula I.
In embodiment F23 the invention provides compounds of formula I wherein X¹ is chloro, X² is CH, X³ is trifluoromethyl, R² is 2-(3-cyano-propyl)-3-oxo-isoxazolidin-4-yl and G¹, R¹, R⁵, Y¹, Y², Y³ and X⁴ are as defined for the compound of formula I.
In embodiment F24 the invention provides compounds of formula I wherein X¹ is chloro, X² is CH, X³ is trifluoromethyl, R² is 2-cyclopropylmethyl-3-oxo-isoxazolidin-4-yl and G¹, R¹, R⁵, Y¹, Y², Y³ and X⁴ are as defined for the compound of formula I.
In embodiment F25 the invention provides compounds of formula I wherein X¹ is chloro, X² is CH, X³ is trifluoromethyl, R² is 2-(2-methoxy-ethyl)-3-oxo-isoxazolidin-4-yl and G¹, R¹, R⁵, Y¹, Y², Y³ and X⁴ are as defined for the compound of formula I.
In embodiment F26 the invention provides compounds of formula I wherein X¹ is chloro, X² is CH, X³ is trifluoromethyl, Y¹ is CH, Y² is CH, Y³ is CH and G¹, R¹, R², R⁵ and X⁴ are as defined for the compound of formula I.
In embodiment F27 the invention provides compounds of formula I wherein X¹ is chloro, X² is CH, X³ is trifluoromethyl, Y¹ is N, Y² is CH, Y³ is CH and G¹, R¹, R², R⁵ and X⁴ are as defined for the compound of formula I.
In embodiment F28 the invention provides compounds of formula I wherein X¹ is chloro, X² is CH, X³ is trifluoromethyl, Y¹ is N, Y² is N, Y³ is CH and G¹, R¹, R², R⁵ and X⁴ are as defined for the compound of formula I.
In embodiment F29 the invention provides compounds of formula I wherein X¹ is chloro, X² is CH, X³ is trifluoromethyl, Y¹ is CH, Y² is N, Y³ is CH and G¹, R¹, R², R⁵ and X⁴ are as defined for the compound of formula I.
In embodiment F30 the invention provides compounds of formula I wherein X¹ is chloro, X² is CH, X³ is trifluoromethyl, Y¹ is CH, Y² is CH, Y³ is N and G¹, R¹, R², R⁵ and X⁴ are as defined for the compound of formula I.
In embodiment F31 the invention provides compounds of formula I wherein X¹ is chloro, X² is CH, X³ is trifluoromethyl, Y¹ is C—R⁷, Y² is CH, Y³ is CH and R⁵ and R⁶ together form a —CH═CH—CH═CH— bridge, and G¹, R¹, R² and X⁴ are as defined for the compound of formula I.
In embodiment F32 the invention provides compounds of formula I wherein X¹ is chloro, X² is CH, X³ is trifluoromethyl, Y¹ is C—R⁷, Y² is N, Y³ is CH and R⁵ and R⁶ together form a —CH═CH—CH═CH— bridge, and G¹, R¹, R² and X⁴ are as defined for the compound of formula I.
In embodiment F33 the invention provides compounds of formula I wherein X¹ is chloro, X² is CH, X³ is trifluoromethyl, Y¹ is C—R⁷, Y² is CH, Y³ is CH and R⁵ and R⁶ together form a —N═CH—CH═CH— bridge, and G¹, R¹, R² and X⁴ are as defined for the compound of formula I.
In embodiment F34 the invention provides compounds of formula I wherein X¹ is chloro, X² is CH, X³ is trifluoromethyl, Y¹ is C—R⁷, Y² is N, Y³ is CH and R⁵ and R⁶ together form a —N═CH—CH═CH— bridge, and G¹, R¹, R² and X⁴ are as defined for the compound of formula I.
In embodiment G1 the invention provides compounds of formula I wherein X¹ is chloro, X² is CH, X³ is bromo, R⁵ is hydrogen and G¹, R¹, R², Y¹, Y², and Y³ are as defined for the compound of formula I.
In embodiment G2 the invention provides compounds of formula I wherein X¹ is chloro, X² is CH, X³ is bromo, R⁵ is chloro and G¹, R¹, R², Y¹, Y² and Y³ are as defined for the compound of formula I.
In embodiment G3 the invention provides compounds of formula I wherein X¹ is chloro, X² is CH, X³ is bromo, R⁵ is bromo and G¹, R¹, R², Y¹, Y² and Y³ are as defined for the compound of formula I.
In embodiment G4 the invention provides compounds of formula I wherein X¹ is chloro, X² is CH, X³ is bromo, R⁵ is fluoro and G¹, R¹, R², Y¹, Y² and Y³ are as defined for the compound of formula I.
In embodiment G5 the invention provides compounds of formula I wherein X¹ is chloro, X² is CH, X³ is bromo, R⁵ is trifluoromethyl and G¹, R¹, R², Y¹, Y² and Y³ are as defined for the compound of formula I.
In embodiment G6 the invention provides compounds of formula I wherein X¹ is chloro, X² is CH, X³ is bromo, R⁵ is methyl and G¹, R¹, R², Y¹, Y² and Y³ are as defined for the compound of formula I.
In embodiment G7 the invention provides compounds of formula I wherein X¹ is chloro, X² is CH, X³ is bromo, R⁵ is ethyl and G¹, R¹, R², Y¹, Y² and Y³ are as defined for the compound of formula I.
In embodiment G8 the invention provides compounds of formula I wherein X¹ is chloro, X² is CH, X³ is bromo, R⁵ is methoxy and G¹, R¹, R², Y¹, Y² and Y³ are as defined for the compound of formula I.
In embodiment G9 the invention provides compounds of formula I wherein X¹ is chloro, X² is CH, X³ is bromo, R⁵ is nitro and G¹, R¹, R², Y¹, Y² and Y³ are as defined for the compound of formula I.
In embodiment G10 the invention provides compounds of formula I wherein X¹ is chloro, X² is CH, X³ is bromo, R⁵ is trifluoromethoxy and G¹, R¹, R², Y¹, Y² and Y³ are as defined for the compound of formula I.
In embodiment G11 the invention provides compounds of formula I wherein X¹ is chloro, X² is CH, X³ is bromo, R⁵ is cyano and G¹, R¹, R², Y¹, Y² and Y³ are as defined for the compound of formula I.
In embodiment G12 the invention provides compounds of formula I wherein X¹ is chloro, X² is CH, X³ is bromo, R⁵ is cyclopropyl and G¹, R¹, R², Y¹, Y² and Y³ are as defined for the compound of formula I.
In embodiment G13 the invention provides compounds of formula I wherein X¹ is chloro, X² is CH, X³ is bromo, X⁴ is trifluoromethyl and G¹, R¹, R², R⁵, Y¹, Y² and Y³ are as defined for the compound of formula I.
In embodiment G14 the invention provides compounds of formula I wherein X¹ is chloro, X² is CH, X³ is bromo, X⁴ is difluoromethyl and G¹, R¹, R², R⁵, Y¹, Y² and Y³ are as defined for the compound of formula I.
In embodiment G15 the invention provides compounds of formula I wherein X¹ is chloro, X² is CH, X³ is bromo, X⁴ is chlorodifluoromethyl and G¹, R¹, R², R⁵, Y¹, Y² and Y³ are as defined for the compound of formula I.
In embodiment G16 the invention provides compounds of formula I wherein X¹ is chloro, X² is CH, X³ is bromo, R² is 2-methyl-3-oxo-isoxazolidin-4-yl and G¹, R¹, R⁵, Y¹, Y², Y³, X¹, X², X³ and X⁴ are as defined for the compound of formula I.
In embodiment G17 the invention provides compounds of formula I wherein X¹ is chloro, X² is CH, X³ is bromo, R² is 2-ethyl-3-oxo-isoxazolidin-4-yl and G¹, R¹, R⁵, Y¹, Y², Y³ and X⁴ are as defined for the compound of formula I.
In embodiment G18 the invention provides compounds of formula I wherein X¹ is chloro, X² is CH, X³ is bromo, R² is 3-oxo-2-(2,2,2-trifluoro-ethyl)-isoxazolidin-4-yl and G¹, R¹, R⁵, Y¹, Y², Y³ and X⁴ are as defined for the compound of formula I.
In embodiment G19 the invention provides compounds of formula I wherein X¹ is chloro, X² is CH, X³ is bromo, R² is 3-oxo-2-(3,3,3-trifluoro-propyl)-isoxazolidin-4-yl and G¹, R¹, R⁵, Y¹, Y², Y³ and X⁴ are as defined for the compound of formula I.
In embodiment G20 the invention provides compounds of formula I wherein X¹ is chloro, X² is CH, X³ is bromo, R² is 3-oxo-2-prop-2-ynyl-isoxazolidin-4-yl and G¹, R¹, R⁵, Y¹, Y², Y³ and X⁴ are as defined for the compound of formula I.
In embodiment G21 the invention provides compounds of formula I wherein X¹ is chloro, X² is CH, X³ is bromo, R² is 2-(2,2-difluoro-ethyl)-3-oxo-isoxazolidin-4-yl and G¹, R¹, R⁵, Y¹, Y², Y³ and X⁴ are as defined for the compound of formula I.
In embodiment G22 the invention provides compounds of formula I wherein X¹ is chloro, X² is CH, X³ is bromo, R² is 2-cyclobutyl-3-oxo-isoxazolidin-4-yl and G¹, R¹, R⁵, Y¹, Y², Y³ and X⁴ are as defined for the compound of formula I.
In embodiment G23 the invention provides compounds of formula I wherein X¹ is chloro, X² is CH, X³ is bromo, R² is 2-(3-cyano-propyl)-3-oxo-isoxazolidin-4-yl and G¹, R¹, R⁵, Y¹, Y², Y³ and X⁴ are as defined for the compound of formula I.
In embodiment G24 the invention provides compounds of formula I wherein X¹ is chloro, X² is CH, X³ is bromo, R² is 2-cyclopropylmethyl-3-oxo-isoxazolidin-4-yl and G¹, R¹, R⁵, Y¹, Y², Y³ and X⁴ are as defined for the compound of formula I.
In embodiment G25 the invention provides compounds of formula I wherein X¹ is chloro, X² is CH, X³ is bromo, R² is 2-(2-methoxy-ethyl)-3-oxo-isoxazolidin-4-yl and G¹, R¹, R⁵, Y¹, Y², Y³ and X⁴ are as defined for the compound of formula I.
In embodiment G26 the invention provides compounds of formula I wherein X¹ is chloro, X² is CH, X³ is bromo, Y¹ is CH, Y² is CH, Y³ is CH and G¹, R¹, R², R⁵ and X⁴ are as defined for the compound of formula I.
In embodiment G27 the invention provides compounds of formula I wherein X¹ is chloro, X² is CH, X³ is bromo, Y¹ is N, Y² is CH, Y³ is CH and G¹, R¹, R², R⁵ and X⁴ are as defined for the compound of formula I.
In embodiment G28 the invention provides compounds of formula I wherein X¹ is chloro, X² is CH, X³ is bromo, Y¹ is N, Y² is N, Y³ is CH and G¹, R¹, R², R⁵ and X⁴ are as defined for the compound of formula I.
In embodiment G29 the invention provides compounds of formula I wherein X¹ is chloro, X² is CH, X³ is bromo, Y¹ is CH, Y² is N, Y³ is CH and G¹, R¹, R², R⁵ and X⁴ are as defined for the compound of formula I.
In embodiment G30 the invention provides compounds of formula I wherein X¹ is chloro, X² is CH, X³ is bromo, Y¹ is CH, Y² is CH, Y³ is N and G¹, R¹, R², R⁵ and X⁴ are as defined for the compound of formula I.
In embodiment G31 the invention provides compounds of formula I wherein X¹ is chloro, X² is CH, X³ is bromo, Y¹ is C—R⁷, Y² is CH, Y³ is CH and R⁵ and R⁶ together form a —CH═CH—CH═CH— bridge, and G¹, R¹, R² and X⁴ are as defined for the compound of formula I.
In embodiment G32 the invention provides compounds of formula I wherein X¹ is chloro, X² is CH, X³ is bromo, Y¹ is C—R⁷, Y² is N, Y³ is CH and R⁵ and R⁶ together form a —CH═CH—CH═CH— bridge, and G¹, R¹, R² and X⁴ are as defined for the compound of formula I.
In embodiment G33 the invention provides compounds of formula I wherein X¹ is chloro, X² is CH, X³ is bromo, Y¹ is C—R⁷, Y² is CH, Y³ is CH and R⁵ and R⁶ together form a —N═CH—CH═CH— bridge, and G¹, R¹, R² and X⁴ are as defined for the compound of formula I.
In embodiment G34 the invention provides compounds of formula I wherein X¹ is chloro, X² is CH, X³ is bromo, Y¹ is C—R⁷, Y² is N, Y³ is CH and R⁵ and R⁶ together form a —N═CH—CH═CH— bridge, and G¹, R¹, R² and X⁴ are as defined for the compound of formula I.
In embodiment H1 the invention provides compounds of formula I wherein X¹ is trifluoromethyl, X² is CH, X³ is trifluoromethyl, R⁵ is hydrogen and G¹, R¹, R², Y¹, Y², and Y³ are as defined for the compound of formula I.
In embodiment H2 the invention provides compounds of formula I wherein X¹ is trifluoromethyl, X² is CH, X³ is trifluoromethyl, R⁵ is chloro and G¹, R¹, R², Y¹, Y² and Y³ are as defined for the compound of formula I.
In embodiment H3 the invention provides compounds of formula I wherein X¹ is trifluoromethyl, X² is CH, X³ is trifluoromethyl, R⁵ is bromo and G¹, R¹, R², Y¹, Y² and Y³ are as defined for the compound of formula I.
In embodiment H4 the invention provides compounds of formula I wherein X¹ is trifluoromethyl, X² is CH, X³ is trifluoromethyl, R⁵ is fluoro and G¹, R¹, R², Y¹, Y² and Y³ are as defined for the compound of formula I.
In embodiment H5 the invention provides compounds of formula I wherein X¹ is trifluoromethyl, X² is CH, X³ is trifluoromethyl, R⁵ is trifluoromethyl and G¹, R¹, R², Y¹, Y² and Y³ are as defined for the compound of formula I.
In embodiment H6 the invention provides compounds of formula I wherein X¹ is trifluoromethyl, X² is CH, X³ is trifluoromethyl, R⁵ is methyl and G¹, R¹, R², Y¹, Y² and Y³ are as defined for the compound of formula I.
In embodiment H7 the invention provides compounds of formula I wherein X¹ is trifluoromethyl, X² is CH, X³ is trifluoromethyl, R⁵ is ethyl and G¹, R¹, R², Y¹, Y² and Y³ are as defined for the compound of formula I.
In embodiment H8 the invention provides compounds of formula I wherein X¹ is trifluoromethyl, X² is CH, X³ is trifluoromethyl, R⁵ is methoxy and G¹, R¹, R², Y¹, Y² and Y³ are as defined for the compound of formula I.
In embodiment H9 the invention provides compounds of formula I wherein X¹ is trifluoromethyl, X² is CH, X³ is trifluoromethyl, R⁵ is nitro and G¹, R¹, R², Y¹, Y² and Y³ are as defined for the compound of formula I.
In embodiment H10 the invention provides compounds of formula I wherein X¹ is trifluoromethyl, X² is CH, X³ is trifluoromethyl, R⁵ is trifluoromethoxy and G¹, R¹, R², Y¹, Y² and Y³ are as defined for the compound of formula I.
In embodiment H11 the invention provides compounds of formula I wherein X¹ is trifluoromethyl, X² is CH, X³ is trifluoromethyl, R⁵ is cyano and G¹, R¹, R², Y¹, Y² and Y³ are as defined for the compound of formula I.
In embodiment H12 the invention provides compounds of formula I wherein X¹ is trifluoromethyl, X² is CH, X³ is trifluoromethyl, R⁵ is cyclopropyl and G¹, R¹, R², Y¹, Y² and Y³ are as defined for the compound of formula I.
In embodiment H13 the invention provides compounds of formula I wherein X¹ is trifluoromethyl, X² is CH, X³ is trifluoromethyl, X⁴ is trifluoromethyl and G¹, R¹, R², R⁵, Y¹, Y² and Y3 are as defined for the compound of formula I.
In embodiment H14 the invention provides compounds of formula I wherein X¹ is trifluoromethyl, X² is CH, X³ is trifluoromethyl, X⁴ is difluoromethyl and G¹, R¹, R², R⁵, Y¹, Y² and Y³ are as defined for the compound of formula I.
In embodiment H15 the invention provides compounds of formula I wherein X¹ is trifluoromethyl, X² is CH, X³ is trifluoromethyl, X⁴ is chlorodifluoromethyl and G¹, R¹, R², R⁵, Y¹, Y² and Y³ are as defined for the compound of formula I.
In embodiment H16 the invention provides compounds of formula I wherein X¹ is trifluoromethyl, X² is CH, X³ is trifluoromethyl, R² is 2-methyl-3-oxo-isoxazolidin-4-yl and G¹, R¹, R⁵, Y¹, Y², Y³, X¹, X², X³ and X⁴ are as defined for the compound of formula I.
In embodiment H17 the invention provides compounds of formula I wherein X¹ is trifluoromethyl, X² is CH, X³ is trifluoromethyl, R² is 2-ethyl-3-oxo-isoxazolidin-4-yl and G¹, R¹, R⁵, Y¹, Y², Y³ and X⁴ are as defined for the compound of formula I.
In embodiment H18 the invention provides compounds of formula I wherein X¹ is trifluoromethyl, X² is CH, X³ is trifluoromethyl, R² is 3-oxo-2-(2,2,2-trifluoro-ethyl)-isoxazolidin-4-yl and G¹, R¹, R⁵, Y¹, Y², Y³ and X⁴ are as defined for the compound of formula I.
In embodiment H19 the invention provides compounds of formula I wherein X¹ is trifluoromethyl, X² is CH, X³ is trifluoromethyl, R² is 3-oxo-2-(3,3,3-trifluoro-propyl)-isoxazolidin-4-yl and G¹, R¹, R⁵, Y¹, Y², Y³ and X⁴ are as defined for the compound of formula I.
In embodiment H20 the invention provides compounds of formula I wherein X¹ is trifluoromethyl, X² is CH, X³ is trifluoromethyl, R² is 3-oxo-2-prop-2-ynyl-isoxazolidin-4-yl and G¹, R¹, R⁵, Y¹, Y², Y³ and X⁴ are as defined for the compound of formula I.
In embodiment H21 the invention provides compounds of formula I wherein X¹ is trifluoromethyl, X² is CH, X³ is trifluoromethyl, R² is 2-(2,2-difluoro-ethyl)-3-oxo-isoxazolidin-4-yl and G¹, R¹, R⁵, Y¹, Y², Y³ and X⁴ are as defined for the compound of formula I.
In embodiment H22 the invention provides compounds of formula I wherein X¹ is trifluoromethyl, X² is CH, X³ is trifluoromethyl, R² is 2-cyclobutyl-3-oxo-isoxazolidin-4-yl and G¹, R¹, R⁵, Y¹, Y², Y³ and X⁴ are as defined for the compound of formula I.
In embodiment H23 the invention provides compounds of formula I wherein X¹ is trifluoromethyl, X² is CH, X³ is trifluoromethyl, R² is 2-(3-cyano-propyl)-3-oxo-isoxazolidin-4-yl and G¹, R¹, R⁵, Y¹, Y², Y³ and X⁴ are as defined for the compound of formula I.
In embodiment H24 the invention provides compounds of formula I wherein X¹ is trifluoromethyl, X² is CH, X³ is trifluoromethyl, R² is 2-cyclopropylmethyl-3-oxo-isoxazolidin-4-yl and G¹, R¹, R⁵, Y¹, Y², Y³ and X⁴ are as defined for the compound of formula I.
In embodiment H25 the invention provides compounds of formula I wherein X¹ is trifluoromethyl, X² is CH, X³ is trifluoromethyl, R² is 2-(2-methoxy-ethyl)-3-oxo-isoxazolidin-4-yl and G¹, R¹, R⁵, Y¹, Y², Y³ and X⁴ are as defined for the compound of formula I.
In embodiment H26 the invention provides compounds of formula I wherein X¹ is trifluoromethyl, X² is CH, X³ is trifluoromethyl, Y¹ is CH, Y² is CH, Y³ is CH and G¹, R¹, R², R⁵ and X⁴ are as defined for the compound of formula I.
In embodiment H27 the invention provides compounds of formula I wherein X¹ is trifluoromethyl, X² is CH, X³ is trifluoromethyl, Y¹ is N, Y² is CH, Y³ is CH and G¹, R¹, R², R⁵ and X⁴ are as defined for the compound of formula I.
In embodiment H28 the invention provides compounds of formula I wherein X¹ is trifluoromethyl, X² is CH, X³ is trifluoromethyl, Y¹ is N, Y² is N, Y³ is CH and G¹, R¹, R², R⁵ and X⁴ are as defined for the compound of formula I.
In embodiment H29 the invention provides compounds of formula I wherein X¹ is trifluoromethyl, X² is CH, X³ is trifluoromethyl, Y¹ is CH, Y² is N, Y³ is CH and G¹, R¹, R², R⁵ and X⁴ are as defined for the compound of formula I.
In embodiment H30 the invention provides compounds of formula I wherein X¹ is trifluoromethyl, X² is CH, X³ is trifluoromethyl, Y¹ is CH, Y² is CH, Y³ is N and G¹, R¹, R², R⁵ and X⁴ are as defined for the compound of formula I.
In embodiment H31 the invention provides compounds of formula I wherein X¹ is trifluoromethyl, X² is CH, X³ is trifluoromethyl, Y¹ is C—R⁷, Y² is CH, Y³ is CH and R⁵ and R⁶ together form a —CH═CH—CH═CH— bridge, and G¹, R¹, R² and X⁴ are as defined for the compound of formula I.
In embodiment H32 the invention provides compounds of formula I wherein X¹ is trifluoromethyl, X² is CH, X³ is trifluoromethyl, Y¹ is C—R⁷, Y² is N, Y³ is CH and R⁵ and R⁶ together form a —CH═CH—CH═CH— bridge, and G¹, R¹, R² and X⁴ are as defined for the compound of formula I.
In embodiment H33 the invention provides compounds of formula I wherein X¹ is trifluoromethyl, X² is CH, X³ is trifluoromethyl, Y¹ is C—R⁷, Y² is CH, Y³ is CH and R⁵ and R⁶ together form a —N═CH—CH═CH— bridge, and G¹, R¹, R² and X⁴ are as defined for the compound of formula I.
In embodiment H34 the invention provides compounds of formula I wherein X¹ is trifluoromethyl, X² is CH, X³ is trifluoromethyl, Y¹ is C—R⁷, Y² is N, Y³ is CH and R⁵ and R⁶ together form a —N═CH—CH═CH— bridge, and G¹, R¹, R² and X⁴ are as defined for the compound of formula I.
In embodiment J1 the invention provides compounds of formula I wherein X¹ is chloro, X² is CH, X³ is chloro, Y¹ is CH, Y² is CH, Y³ is CH and G¹, R¹, R², R⁵ and X⁴ are as defined for the compound of formula I.
In embodiment J2 the invention provides compounds of formula I wherein X¹ is chloro, X² is CH, X³ is chloro, Y¹ is N, Y² is CH, Y³ is CH and G¹, R¹, R², R⁵ and X⁴ are as defined for the compound of formula I.
In embodiment J3 the invention provides compounds of formula I wherein X¹ is chloro, X² is CH, X³ is chloro, Y¹ is N, Y² is N, Y³ is CH and G¹, R¹, R², R⁵ and X⁴ are as defined for the compound of formula I.
In embodiment J4 the invention provides compounds of formula I wherein X¹ is chloro, X² is CH, X³ is chloro, Y¹ is CH, Y² is N, Y³ is CH and G¹, R¹, R², R⁵ and X⁴ are as defined for the compound of formula I.
In embodiment J5 the invention provides compounds of formula I wherein X¹ is chloro, X² is CH, X³ is chloro, Y¹ is CH, Y² is CH, Y³ is N and G¹, R¹, R², R⁵ and X⁴ are as defined for the compound of formula I.
In embodiment J6 the invention provides compounds of formula I wherein X¹ is chloro, X² is C—F, X³ is hydrogen, Y¹ is CH, Y² is CH, Y³ is CH and G¹, R¹, R², R⁵ and X⁴ are as defined for the compound of formula I.
In embodiment J7 the invention provides compounds of formula I wherein X¹ is chloro, X² is C—F, X³ is hydrogen, Y¹ is N, Y² is CH, Y³ is CH and G¹, R¹, R², R⁵ and X⁴ are as defined for the compound of formula I.
In embodiment J8 the invention provides compounds of formula I wherein X¹ is chloro, X² is C—F, X³ is hydrogen, Y¹ is N, Y² is N, Y³ is CH and G¹, R¹, R², R⁵ and X⁴ are as defined for the compound of formula I.
In embodiment J9 the invention provides compounds of formula I wherein X¹ is chloro, X² is C—F, X³ is hydrogen, Y¹ is CH, Y² is N, Y³ is CH and G¹, R¹, R², R⁵ and X⁴ are as defined for the compound of formula I.
In embodiment J10 the invention provides compounds of formula I wherein X¹ is chloro, X² is C—F, X³ is hydrogen, Y¹ is CH, Y² is CH, Y³ is N and G¹, R¹, R², R⁵ and X⁴ are as defined for the compound of formula I.
In embodiment J11 the invention provides compounds of formula I wherein X¹ is fluoro, X² is C—Cl, X³ is hydrogen, Y¹ is CH, Y² is CH, Y³ is CH and G¹, R¹, R², R⁵ and X⁴ are as defined for the compound of formula I.
In embodiment J12 the invention provides compounds of formula I wherein X¹ is fluoro, X² is C—Cl, X³ is hydrogen, Y¹ is N, Y² is CH, Y³ is CH and G¹, R¹, R², R⁵ and X⁴ are as defined for the compound of formula I.
In embodiment J13 the invention provides compounds of formula I wherein X¹ is fluoro, X² is C—Cl, X³ is hydrogen, Y¹ is N, Y² is N, Y³ is CH and G¹, R¹, R², R⁵ and X⁴ are as defined for the compound of formula I.
In embodiment J14 the invention provides compounds of formula I wherein X¹ is fluoro, X² is C—Cl, X³ is hydrogen, Y¹ is CH, Y² is N, Y³ is CH and G¹, R¹, R², R⁵ and X⁴ are as defined for the compound of formula I.
In embodiment J15 the invention provides compounds of formula I wherein X¹ is fluoro, X² is C—Cl, X³ is hydrogen, Y¹ is CH, Y² is CH, Y³ is N and G¹, R¹, R², R⁵ and X⁴ are as defined for the compound of formula I.
In embodiment J16 the invention provides compounds of formula I wherein X¹ is chloro, X² is C—Cl, X³ is hydrogen, Y¹ is CH, Y² is CH, Y³ is CH and G¹, R¹, R², R⁵ and X⁴ are as defined for the compound of formula I.
In embodiment J17 the invention provides compounds of formula I wherein X¹ is chloro, X² is C—Cl, X³ is hydrogen, Y¹ is N, Y² is CH, Y³ is CH and G¹, R¹, R², R⁵ and X⁴ are as defined for the compound of formula I.
In embodiment J18 the invention provides compounds of formula I wherein X¹ is chloro, X² is C—Cl, X³ is hydrogen, Y¹ is N, Y² is N, Y³ is CH and G¹, R¹, R², R⁵ and X⁴ are as defined for the compound of formula I.
In embodiment J19 the invention provides compounds of formula I wherein X¹ is chloro, X² is C—Cl, X³ is hydrogen, Y¹ is CH, Y² is N, Y³ is CH and G¹, R¹, R², R⁵ and X⁴ are as defined for the compound of formula I.
In embodiment J20 the invention provides compounds of formula I wherein X¹ is chloro, X² is C—Cl, X³ is hydrogen, Y¹ is CH, Y² is CH, Y³ is N and G¹, R¹, R², R⁵ and X⁴ are as defined for the compound of formula I.
In embodiment J21 the invention provides compounds of formula I wherein X¹ is chloro, X² is C—F, X³ is chloro, Y¹ is CH, Y² is CH, Y³ is CH and G¹, R¹, R², R⁵ and X⁴ are as defined for the compound of formula I.
In embodiment J22 the invention provides compounds of formula I wherein X¹ is chloro, X² is C—F, X³ is chloro, Y¹ is N, Y² is CH, Y³ is CH and G¹, R¹, R², R⁵ and X⁴ are as defined for the compound of formula I.
In embodiment J23 the invention provides compounds of formula I wherein X¹ is chloro, X² is C—F, X³ is chloro, Y¹ is N, Y² is N, Y³ is CH and G¹, R¹, R², R⁵ and X⁴ are as defined for the compound of formula I.
In embodiment J24 the invention provides compounds of formula I wherein X¹ is chloro, X² is C—F, X³ is chloro, Y¹ is CH, Y² is N, Y³ is CH and G¹, R¹, R², R⁵ and X⁴ are as defined for the compound of formula I.
In embodiment J25 the invention provides compounds of formula I wherein X¹ is chloro, X² is C—F, X³ is chloro, Y¹ is CH, Y² is CH, Y³ is N and G¹, R¹, R², R⁵ and X⁴ are as defined for the compound of formula I.
In embodiment J26 the invention provides compounds of formula I wherein X¹ is chloro, X² is C—Cl, X³ is chloro, Y¹ is CH, Y² is CH, Y³ is CH and G¹, R¹, R², R⁵ and X⁴ are as defined for the compound of formula I.
In embodiment J27 the invention provides compounds of formula I wherein X¹ is chloro, X² is C—Cl, X³ is chloro, Y¹ is N, Y² is CH, Y³ is CH and G¹, R¹, R², R⁵ and X⁴ are as defined for the compound of formula I.
In embodiment J28 the invention provides compounds of formula I wherein X¹ is chloro, X² is C—Cl, X³ is chloro, Y¹ is N, Y² is N, Y³ is CH and G¹, R¹, R², R⁵ and X⁴ are as defined for the compound of formula I.
In embodiment J29 the invention provides compounds of formula I wherein X¹ is chloro, X² is C—Cl, X³ is chloro, Y¹ is CH, Y² is N, Y³ is CH and G¹, R¹, R², R⁵ and X⁴ are as defined for the compound of formula I.
In embodiment J30 the invention provides compounds of formula I wherein X¹ is chloro, X² is C—Cl, X³ is chloro, Y¹ is CH, Y² is CH, Y³ is N and G¹, R¹, R², R⁵ and X⁴ are as defined for the compound of formula I.
In embodiment J31 the invention provides compounds of formula I wherein X¹ is chloro, X² is C—Br, X³ is chloro, Y¹ is CH, Y² is CH, Y³ is CH and G¹, R¹, R², R⁵ and X⁴ are as defined for the compound of formula I.
In embodiment J32 the invention provides compounds of formula I wherein X¹ is chloro, X² is C—Br, X³ is chloro, Y¹ is N, Y² is CH, Y³ is CH and G¹, R¹, R², R⁵ and X⁴ are as defined for the compound of formula I.
In embodiment J33 the invention provides compounds of formula I wherein X¹ is chloro, X² is C—Br, X³ is chloro, Y¹ is N, Y² is N, Y³ is CH and G¹, R¹, R², R⁵ and X⁴ are as defined for the compound of formula I.
In embodiment J34 the invention provides compounds of formula I wherein X¹ is chloro, X² is C—Br, X³ is chloro, Y¹ is CH, Y² is N, Y³ is CH and G¹, R¹, R², R⁵ and X⁴ are as defined for the compound of formula I.
In embodiment J35 the invention provides compounds of formula I wherein X¹ is chloro, X² is C—Br, X³ is chloro, Y¹ is CH, Y² is CH, Y³ is N and G¹, R¹, R², R⁵ and X⁴ are as defined for the compound of formula I.
In embodiment J36 the invention provides compounds of formula I wherein X¹ is chloro, X² is C—I, X³ is chloro, Y¹ is CH, Y² is CH, Y³ is CH and G¹, R¹, R², R⁵ and X⁴ are as defined for the compound of formula I.
In embodiment J37 the invention provides compounds of formula I wherein X¹ is chloro, X² is C—I, X³ is chloro, Y¹ is N, Y² is CH, Y³ is CH and G¹, R¹, R², R⁵ and X⁴ are as defined for the compound of formula I.
In embodiment J38 the invention provides compounds of formula I wherein X¹ is chloro, X² is C—I, X³ is chloro, Y¹ is N, Y² is N, Y³ is CH and G¹, R¹, R², R⁵ and X⁴ are as defined for the compound of formula I.
In embodiment J39 the invention provides compounds of formula I wherein X¹ is chloro, X² is C—I, X³ is chloro, Y¹ is CH, Y² is N, Y³ is CH and G¹, R¹, R², R⁵ and X⁴ are as defined for the compound of formula I.
In embodiment J40 the invention provides compounds of formula I wherein X¹ is chloro, X² is C—I, X³ is chloro, Y¹ is CH, Y² is CH, Y³ is N and G¹, R¹, R², R⁵ and X⁴ are as defined for the compound of formula I.
In embodiment J41 the invention provides compounds of formula I wherein X¹ is fluoro, X² is C—F, X³ is fluoro, Y¹ is CH, Y² is CH, Y³ is CH and G¹, R¹, R², R⁵ and X⁴ are as defined for the compound of formula I.
In embodiment J42 the invention provides compounds of formula I wherein X¹ is fluoro, X² is C—F, X³ is fluoro, Y¹ is N, Y² is CH, Y³ is CH and G¹, R¹, R², R⁵ and X⁴ are as defined for the compound of formula I.
In embodiment J43 the invention provides compounds of formula I wherein X¹ is fluoro, X² is C—F, X³ is fluoro, Y¹ is N, Y² is N, Y³ is CH and G¹, R¹, R², R⁵ and X⁴ are as defined for the compound of formula I.
In embodiment J44 the invention provides compounds of formula I wherein X¹ is fluoro, X² is C—F, X³ is fluoro, Y¹ is CH, Y² is N, Y³ is CH and G¹, R¹, R², R⁵ and X⁴ are as defined for the compound of formula I.
In embodiment J45 the invention provides compounds of formula I wherein X¹ is fluoro, X² is C—F, X³ is fluoro, Y¹ is CH, Y² is CH, Y³ is N and G¹, R¹, R², R⁵ and X⁴ are as defined for the compound of formula I.
In embodiment J46 the invention provides compounds of formula I wherein X¹ is chloro, X² is CH, X³ is bromo, Y¹ is CH, Y² is CH, Y³ is CH and G¹, R¹, R², R⁵ and X⁴ are as defined for the compound of formula I.
In embodiment J47 the invention provides compounds of formula I wherein X¹ is chloro, X² is CH, X³ is bromo, Y¹ is N, Y² is CH, Y³ is CH and G¹, R¹, R², R⁵ and X⁴ are as defined for the compound of formula I.
In embodiment J48 the invention provides compounds of formula I wherein X¹ is chloro, X² is CH, X³ is bromo, Y¹ is N, Y² is N, Y³ is CH and G¹, R¹, R², R⁵ and X⁴ are as defined for the compound of formula I.
In embodiment J49 the invention provides compounds of formula I wherein X¹ is chloro, X² is CH, X³ is bromo, Y¹ is CH, Y² is N, Y³ is CH and G¹, R¹, R², R⁵ and X⁴ are as defined for the compound of formula I.
In embodiment J50 the invention provides compounds of formula I wherein X¹ is chloro, X² is CH, X³ is bromo, Y¹ is CH, Y² is CH, Y³ is N and G¹, R¹, R², R⁵ and X⁴ are as defined for the compound of formula I.
In embodiment J51 the invention provides compounds of formula I wherein X¹ is chloro, X² is CH, X³ is fluoro, Y¹ is CH, Y² is CH, Y³ is CH and G¹, R¹, R², R⁵ and X⁴ are as defined for the compound of formula I.
In embodiment J52 the invention provides compounds of formula I wherein X¹ is chloro, X² is CH, X³ is fluoro, Y¹ is N, Y² is CH, Y³ is CH and G¹, R¹, R², R⁵ and X⁴ are as defined for the compound of formula I.
In embodiment J53 the invention provides compounds of formula I wherein X¹ is chloro, X² is CH, X³ is fluoro, Y¹ is N, Y² is N, Y³ is CH and G¹, R¹, R², R⁵ and X⁴ are as defined for the compound of formula I.
In embodiment J54 the invention provides compounds of formula I wherein X¹ is chloro, X² is CH, X³ is fluoro, Y¹ is CH, Y² is N, Y³ is CH and G¹, R¹, R², R⁵ and X⁴ are as defined for the compound of formula I.
In embodiment J55 the invention provides compounds of formula I wherein X¹ is chloro, X² is CH, X³ is fluoro, Y¹ is CH, Y² is CH, Y³ is N and G¹, R¹, R², R⁵ and X⁴ are as defined for the compound of formula I.
In embodiment J56 the invention provides compounds of formula I wherein X¹ is chloro, X² is CH, X³ is trifluoromethyl, Y¹ is CH, Y² is CH, Y³ is CH and G¹, R¹, R², R⁵ and X⁴ are as defined for the compound of formula I.
In embodiment J57 the invention provides compounds of formula I wherein X¹ is chloro, X² is CH, X³ is trifluoromethyl, Y¹ is N, Y² is CH, Y³ is CH and G¹, R¹, R², R⁵ and X⁴ are as defined for the compound of formula I.
In embodiment J58 the invention provides compounds of formula I wherein X¹ is chloro, X² is CH, X³ is trifluoromethyl, Y¹ is N, Y² is N, Y³ is CH and G¹, R¹, R², R⁵ and X⁴ are as defined for the compound of formula I.
In embodiment J59 the invention provides compounds of formula I wherein X¹ is chloro, X² is CH, X³ is trifluoromethyl, Y¹ is CH, Y² is N, Y³ is CH and G¹, R¹, R², R⁵ and X⁴ are as defined for the compound of formula I.
In embodiment J60 the invention provides compounds of formula I wherein X¹ is chloro, X² is CH, X³ is trifluoromethyl, Y¹ is CH, Y² is CH, Y³ is N and G¹, R¹, R², R⁵ and X⁴ are as defined for the compound of formula I.
In embodiment J61 the invention provides compounds of formula I wherein X¹ is chloro, X² is C—Cl, X³ is trifluoromethyl, Y¹ is CH, Y² is CH, Y³ is CH and G¹, R¹, R², R⁵ and X⁴ are as defined for the compound of formula I.
In embodiment J62 the invention provides compounds of formula I wherein X¹ is chloro, X² is C—Cl, X³ is trifluoromethyl, Y¹ is N, Y² is CH, Y³ is CH and G¹, R¹, R², R⁵ and X⁴ are as defined for the compound of formula I.
In embodiment J63 the invention provides compounds of formula I wherein X¹ is chloro, X² is C—Cl, X³ is trifluoromethyl, Y¹ is N, Y² is N, Y³ is CH and G¹, R¹, R², R⁵ and X⁴ are as defined for the compound of formula I.
In embodiment J64 the invention provides compounds of formula I wherein X¹ is chloro, X² is C—Cl, X³ is trifluoromethyl, Y¹ is CH, Y² is N, Y³ is CH and G¹, R¹, R², R⁵ and X⁴ are as defined for the compound of formula I.
In embodiment J65 the invention provides compounds of formula I wherein X¹ is chloro, X² is C—Cl, X³ is trifluoromethyl, Y¹ is CH, Y² is CH, Y³ is N and G¹, R¹, R², R⁵ and X⁴ are as defined for the compound of formula I.
In embodiment J66 the invention provides compounds of formula I wherein X¹ is trifluoromethyl, X² is CH, X³ is trifluoromethyl, Y¹ is CH, Y² is CH, Y³ is CH and G¹, R¹, R², R⁵ and X⁴ are as defined for the compound of formula I.
In embodiment J67 the invention provides compounds of formula I wherein X¹ is trifluoromethyl, X² is CH, X³ is trifluoromethyl, Y¹ is N, Y² is CH, Y³ is CH and G¹, R¹, R², R³ and X⁴ are as defined for the compound of formula I.
In embodiment J68 the invention provides compounds of formula I wherein X¹ is trifluoromethyl, X² is CH, X³ is trifluoromethyl, Y¹ is N, Y² is N, Y³ is CH and G¹, R¹, R², R⁵ and X⁴ are as defined for the compound of formula I.
In embodiment J69 the invention provides compounds of formula I wherein X¹ is trifluoromethyl, X² is CH, X³ is trifluoromethyl, Y¹ is CH, Y² is N, Y³ is CH and G¹, R¹, R², R⁵ and X⁴ are as defined for the compound of formula I.
In embodiment J70 the invention provides compounds of formula I wherein X¹ is trifluoromethyl, X² is CH, X³ is trifluoromethyl, Y¹ is CH, Y² is CH, Y³ is N and G¹, R¹, R², R⁵ and X⁴ are as defined for the compound of formula I.
In embodiment J71 the invention provides compounds of formula I wherein X¹ is trifluoromethyl, X² is C—Cl, X³ is trifluoromethyl, Y¹ is CH, Y² is CH, Y³ is CH and G¹, R¹, R², R⁵ and X⁴ are as defined for the compound of formula I.
In embodiment J72 the invention provides compounds of formula I wherein X¹ is trifluoromethyl, X² is C—Cl, X³ is trifluoromethyl, Y¹ is N, Y² is CH, Y³ is CH and G¹, R¹, R², R⁵ and X⁴ are as defined for the compound of formula I.
In embodiment J73 the invention provides compounds of formula I wherein X¹ is trifluoromethyl, X² is C—Cl, X³ is trifluoromethyl, Y¹ is N, Y² is N, Y³ is CH and G¹, R¹, R², R⁵ and X⁴ are as defined for the compound of formula I.
In embodiment J74 the invention provides compounds of formula I wherein X¹ is trifluoromethyl, X² is C—Cl, X³ is trifluoromethyl, Y¹ is CH, Y² is N, Y³ is CH and G¹, R¹, R², R⁵ and X⁴ are as defined for the compound of formula I.
In embodiment J75 the invention provides compounds of formula I wherein X¹ is trifluoromethyl, X² is C—Cl, X³ is trifluoromethyl, Y¹ is CH, Y² is CH, Y³ is N and G¹, R¹, R², R⁵ and X⁴ are as defined for the compound of formula I.
In embodiment J76 the invention provides compounds of formula I wherein X¹ is trifluoromethyl, X² is CH, X³ is hydrogen, Y¹ is CH, Y² is CH, Y³ is CH and G¹, R¹, R², R⁵ and X⁴ are as defined for the compound of formula I.
In embodiment J77 the invention provides compounds of formula I wherein X¹ is trifluoromethyl, X² is CH, X³ is hydrogen, Y¹ is N, Y² is CH, Y³ is CH and G¹, R¹, R², R⁵ and X⁴ are as defined for the compound of formula I.
In embodiment J78 the invention provides compounds of formula I wherein X¹ is trifluoromethyl, X² is CH, X³ is hydrogen, Y¹ is N, Y² is N, Y³ is CH and G¹, R¹, R², R⁵ and X⁴ are as defined for the compound of formula I.
In embodiment J79 the invention provides compounds of formula I wherein X¹ is trifluoromethyl, X² is CH, X³ is hydrogen, Y¹ is CH, Y² is N, Y³ is CH and G¹, R¹, R², R⁵ and X⁴ are as defined for the compound of formula I.
In embodiment J80 the invention provides compounds of formula I wherein X¹ is trifluoromethyl, X² is CH, X³ is hydrogen, Y¹ is CH, Y² is CH, Y³ is N and G¹, R¹, R², R⁵ and X⁴ are as defined for the compound of formula I.
In embodiment J81 the invention provides compounds of formula I wherein X¹ is chloro, X² is N, X³ is chloro, Y¹ is CH, Y² is CH, Y³ is CH and G¹, R¹, R², R⁵ and X⁴ are as defined for the compound of formula I.
In embodiment J82 the invention provides compounds of formula I wherein X¹ is chloro, X² is N, X³ is chloro, Y¹ is N, Y² is CH, Y³ is CH and G¹, R¹, R², R⁵ and X⁴ are as defined for the compound of formula I.
In embodiment J83 the invention provides compounds of formula I wherein X¹ is chloro, X² is N, X³ is chloro, Y¹ is N, Y² is N, Y³ is CH and G¹, R¹, R², R⁵ and X⁴ are as defined for the compound of formula I.
In embodiment J84 the invention provides compounds of formula I wherein X¹ is chloro, X² is N, X³ is chloro, Y¹ is CH, Y² is N, Y³ is CH and G¹, R¹, R², R⁵ and X⁴ are as defined for the compound of formula I.
In embodiment J85 the invention provides compounds of formula I wherein X¹ is chloro, X² is N, X³ is chloro, Y¹ is CH, Y² is CH, Y³ is N and G¹, R¹, R², R⁵ and X⁴ are as defined for the compound of formula I.
In embodiment J86 the invention provides compounds of formula I wherein X¹ is trifluoromethyl, X² is N, X³ is trifluoromethyl, Y¹ is CH, Y² is CH, Y³ is CH and G¹, R¹, R², R⁵ and X⁴ are as defined for the compound of formula I.
In embodiment J87 the invention provides compounds of formula I wherein X¹ is trifluoromethyl, X² is N, X³ is trifluoromethyl, Y¹ is N, Y² is CH, Y³ is CH and G¹, R¹, R², R⁵ and X⁴ are as defined for the compound of formula I.
In embodiment J88 the invention provides compounds of formula I wherein X¹ is trifluoromethyl, X² is N, X³ is trifluoromethyl, Y¹ is N, Y² is N, Y³ is CH and G¹, R¹, R², R⁵ and X⁴ are as defined for the compound of formula I.
In embodiment J89 the invention provides compounds of formula I wherein X¹ is trifluoromethyl, X² is N, X³ is trifluoromethyl, Y¹ is CH, Y² is N, Y³ is CH and G¹, R¹, R², R⁵ and X⁴ are as defined for the compound of formula I.
In embodiment J90 the invention provides compounds of formula I wherein X¹ is trifluoromethyl, X² is N, X³ is trifluoromethyl, Y¹ is CH, Y² is CH, Y³ is N and G¹, R¹, R², R⁵ and X⁴ are as defined for the compound of formula I.

In a further aspect the invention provides a method of controlling insects, acarines, nematodes or molluscs, preferably in a crop of useful plants, which comprises applying to a pest, to a locus of a pest, or to a plant susceptible to attack by a pest an insecticidally, acaricidally, nematicidally or molluscicidally effective amount of a compound of formula I as defined above, including preferences thereof.

In a further aspect the invention provides a method of protecting useful plants from insects, acarines, nematodes or molluscs, comprising applying to said plants, to the locus thereof, or to plant propagation material thereof, an insecticidally, acaricidally, nematicidally or molluscicidally effective amount of a compound of formula I as defined above, including preferences thereof.

In a further aspect the invention provides a method of controlling insects, acarines, nematodes or molluscs, preferably those described below, and preferably in a crop of useful plants, which comprises applying to a pest, to a locus of a pest, or to a plant susceptible to attack by a pest an insecticidally, acaricidally, nematicidally or molluscicidally effective amount of a compound of formula IA

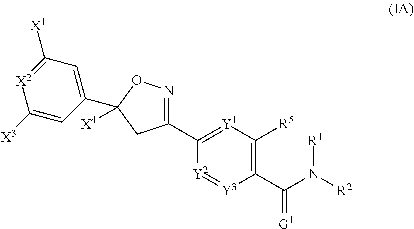

wherein
G¹ is oxygen;
R¹ is hydrogen;
R² is group P

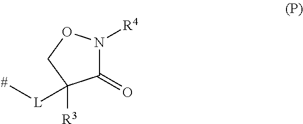

L is a bond, methylene or ethylene;
R³ is hydrogen;
R⁴ is independently hydrogen, cyano, cyano-C₁-C₈alkyl, C₁-C₈alkyl, C₁-C₈haloalkyl, C₃-C₈cycloalkyl, C₃-C₈cycloalkyl where one carbon atom is replaced by O, S, S(O) or SO₂, or C₃-C₈cycloalkyl-C₁-C₈alkyl, C₃-C₈cycloalkyl-C₁-C₈alkyl where one carbon atom in the cycloalkyl group is replaced by O, S, S(O) or SO₂, or C₃-C₈cycloalkyl-C₁-C₈haloalkyl, C₁-C₈hydroxyalkyl, C₁-C₈alkoxy-C₁-C₈alkyl, C₂-C₈alkenyl, C₂-C₈haloalkenyl, C₂-C₈alkynyl, C₂-C₈haloalkynyl, phenyl, phenyl substituted by one to three R⁶, phenyl-C₁-C₄alkyl, phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R⁶, or C₁-C₄alkyl-(C₁-C₄alkyl-O—N═)C—CH₂—;
each R⁶ is independently halogen, cyano, nitro, C₁-C₈alkyl, C₁-C₈haloalkyl, C₁-C₈alkoxy, or C₁-C₈haloalkoxy;
Y¹, Y² and Y³ are independently CH or nitrogen;
wherein no more than two of Y¹, Y² and Y³ are nitrogen and wherein Y² and Y³ are not both nitrogen;
R⁵ is bromo, chloro, fluoro;
X² is C—X⁶ or nitrogen;
X¹, X³ and X⁶ are independently hydrogen, halogen or trihalomethyl, wherein at least two of X¹, X³ and X⁶ are not hydrogen;
X⁴ is trifluoromethyl, difluoromethyl or chlorodifluoromethyl.

In a further aspect the invention provides a method of protecting useful plants from insects, acarines, nematodes or molluscs, preferably as described below, comprising applying to said plants, to the locus thereof, or to plant propagation material thereof, an insecticidally, acaricidally, nematicidally or molluscicidally effective amount of a compound of formula IA as defined above, including preferences thereof.

Preferred values of R⁴, R⁵, R⁶, Y¹, Y², Y³, X¹, X², X³, X⁴ and X⁶ for compounds of formula IA are, in any combination, as set out below.

The preferred values of R⁴ are as set out for compounds of formula I.

The preferred values of R⁶ are as set out for compounds of formula I.

Preferably Y¹ is CH, Y² is CH, Y³ is CH, or Y¹ is N, Y² is CH, Y³ is CH, or Y¹ is N, Y² is N, Y³ is CH, or Y¹ is CH, Y² is N, Y³ is CH, or Y¹ is CH, Y² is CH, Y³ is N. More preferably Y¹ is CH, Y² is CH, Y³ is CH.

Preferably X¹ is chloro, X² is CH, X³ is chloro, or X¹ is chloro, X² is C—F, X³ is hydrogen, or X¹ is fluoro, X² is C—Cl, X³ is hydrogen, or X¹ is chloro, X² is C—Cl, X³ is hydrogen, or X¹ is chloro, X² is C—Br, X³ is chloro, or X¹ is chloro, X² is C—F, X³ is chloro, or X¹ is chloro, X² is C—Cl, X³ is chloro, or X¹ is chloro, X² is C—I, X³ is chloro, or X¹ is fluoro, X² is C—F, X³ is fluoro, or X¹ is chloro, X² is CH, X³ is bromo, or X¹ is chloro, X² is CH, X³ is fluoro, or X¹ is chloro, X² is CH, X³ is trifluoromethyl, or X¹ is chloro, X² is C—Cl, X³ is trifluoromethyl, or X¹ is trifluoromethyl, X² is CH, X³ is trifluoromethyl, or X¹ is trifluoromethyl, X² is C—Cl, X³ is trifluoromethyl, or X¹ is trifluoromethyl, X² is CH, X³ is hydrogen, or X¹ is chloro, X² is N, X³ is chloro, or X¹ is trifluoromethyl, X² is N, X³ is trifluoromethyl. Preferably X¹ is chloro, X² is CH, X³ is chloro, or X¹ is chloro, X² is C—Cl, X³ is chloro, or X¹ is chloro, X² is C—F, X³ is chloro, or X¹ is trifluoromethyl, X² is CH, X³ is trifluoromethyl. Most preferably X¹ is chloro, X² is CH, X³ is chloro.

Preferably X⁴ is trifluoromethyl.In one embodiment the invention provides compounds of formula IA wherein R⁵ is chloro and G¹, R¹, R², Y¹, Y², Y³, X¹, X², X³ and X⁴ are as defined for the compound of formula IA.

In one embodiment the invention provides compounds of formula IA wherein R⁵ is bromo and G¹, R¹, R², Y¹, Y², Y³, X¹, X², X³ and X⁴ are as defined for the compound of formula IA.

In one embodiment the invention provides compounds of formula IA wherein R⁵ is fluoro and G¹, R¹, R², Y¹, Y², Y³, X¹, X², X³ and X⁴ are as defined for the compound of formula IA.

In one embodiment the invention provides compounds of formula IA wherein

G¹ is oxygen;

R¹ is hydrogen;

R² is group P as defined above;

Y¹ is CH, Y² is CH, Y³ is CH;

R⁵ is bromo, chloro, fluoro;

X¹ is chloro, X² is CH, X³ is chloro, or X¹ is chloro, X² is C—Cl, X³ is chloro, or X¹ is chloro, X² is C—F, X³ is chloro, or X¹ is trifluoromethyl, X² is CH, X³ is trifluoromethyl; and

X⁴ is trifluoromethyl.

In one embodiment the invention provides compounds of formula IA wherein

G¹ is oxygen;

R¹ is hydrogen;

R² is group P as defined above;

Y¹ is CH, Y² is CH, Y³ is CH;

R⁵ is chloro;

X¹ is chloro, X² is CH, X³ is chloro, X¹ is chloro, X² is C—Cl, X³ is chloro, X¹ is chloro, X² is C—F, X³ is chloro, or X¹ is trifluoromethyl, X² is CH, X³ is trifluoromethyl; and

X⁴ is trifluoromethyl.

In one embodiment the invention provides a compound of formula IA for use in controlling and/or preventing insects of the family Curculionidae, preferably in for use in controlling and/or preventing Anthonomus grandis.

Additional examples of insects from the family of Curculionidae are Anthonomus corvulus, Anthonomus elutus, Anthonomus elongatus, Anthonomus eugenii, Anthonomus consors, Anthonomus haematopus, Anthonomus lecontei, Anthonomus molochinus, Anthonomus morticinus, Anthonomus musculus, Anthonomus nigrinus, Anthonomus phyllocola, Anthonomus pictus, Anthonomus pomorum, Anthonomus quadrigibbus, Anthonomus rectirostris, Anthonomus rubi, Anthonomus santacruzi, Anthonomus signatus, Anthonomus subfasciatus, and Anthonomus tenebrosus.

In one embodiment the invention provides a compound of formula IA for use against Anthonomus grandis in cotton.

In one embodiment the invention provides a compound of formula IA for use in controlling and/or preventing soil pests.

In one embodiment the invention provides a compound of formula IA for use in controlling and/or preventing corn rootworm, in particular for use against corn root worm from the genus Diabrotica.

In one embodiment the invention provides a compound of formula IA for use in controlling and/or preventing Diabrotica virgifera.

In one embodiment the invention provides a compound of formula IA for use in controlling and/or preventing Diabrotica barberi.

In one embodiment the invention provides a compound of formula IA for use in controlling and/or preventing Diabrotica undecimpunctata howardi.

In one embodiment the invention provides a compound of formula IA for use in controlling and/or preventing wireworms, in particular Agriotes spp.

In one embodiment the invention provides a compound of formula IA for use in controlling and/or preventing Agriotes spp. in cereals, potato or corn.

Additional examples of Agriotes spp. include Agriotes lineatus, Agriotes obscurus, Agriotes brevis, Agriotes gurgistanus, Agriotes sputator, Agriotes ustulatus, Ctenicera destructor, and Limonius californicus.

In one embodiment the invention provides a compound of formula IA for use in controlling and/or preventing grubs, in particular white grubs.

In one embodiment the invention provides a compound of formula IA for use in controlling and/or preventing Phyllophaga spp., particularly on corn, soybean or cotton.

In one embodiment the invention provides a compound of formula IA for use in controlling and/or preventing Diloboderus spp. particularly on corn, soybean or cotton.

In one embodiment the invention provides a compound of formula IA for use in controlling and/or preventing Popillia japonica, particularly on corn, soybean or cotton.

Additional examples of white grubs include Phyllophaga anxia, Phyllophaga crinite, Phyllophaga subnitida, Diloboderus abderus.

In one embodiment the invention provides a compound of formula IA for use in controlling and/or preventing termites, e.g. on sugarcane.

Examples of termites include Reticulitermes, Coptotermes, Macrotermes, Microtermes, Globitermes. Specific of subterranean termites include Reticulitermes flavipes, Reticulitermes hesperus, Reticulitermes verginicus, Reticulitermes hageni, Reticulitermes speratus, Reticulitermes lucifugus, Heterotermes aureus, Coptotermes formosanus, Coptotermes acinaciformis, Coptotermes curvignathus, Nasutitermes exitiosus, Nasutitermes walkeri, Mastotermes darwiniensis, Schedorhinotermes spp, Macrotermes bellicosus, Macrotermes spp., Globitermes sulphureus, Odontotermes spp. Specific examples of dry wood termites include Incisitermes minor, Marginitermes hubbardi, Cryptotermes brevis, Kalotermes flavicollis. Additional examples of termites include procornitermes spp. and procornitermes araujoi

In one embodiment the invention provides a compound of formula IA for use in controlling and/or preventing subterraneous stinkbugs, e.g. Scaptocoris spp.

In one embodiment the invention provides a compound of formula IA for use in controlling and/or preventing Scaptocoris castaneus, in particular on cereals, soybean or corn.

In one embodiment the invention provides a compound of formula IA for use in controlling and/or preventing cutworms, e.g. agrotis spp.

In one embodiment the invention provides a compound of formula IA for use in controlling and/or preventing Agrotis ipsilon, particularly on cereals, canola, soybean or corn.

In one embodiment the invention provides a compound of formula IA for use in controlling and/or preventing millipedes, e.g. Julus spp.

In one embodiment the invention provides a compound of formula IA for use in controlling and/or preventing Julus spp., particularly on cereals, canola, soybean & corn.

In one embodiment the invention provides a compound of formula IA for use in controlling and/or preventing broca gigante, e.g. Telchin licus, particularly on sugarcane.

In one embodiment the invention provides a compound of formula IA for use in controlling and/or preventing whitefly.

In one embodiment the invention provides a compound of formula IA for use in controlling and/or preventing Bemisia tabaci, particularly on vegetables, cotton, soybean, or potatoes.

In one embodiment the invention provides a compound of formula IA for use in controlling and/or preventing Trialeurodes vaporariorum, particularly on vegetables, cotton, soybean, or potatoes.

In one embodiment the invention provides a compound of formula IA for use in controlling and/or preventing stinkbugs, in particular Euschistus spp.

In one embodiment the invention provides a compound of formula IA for use in controlling and/or preventing Euschistus spp., particularly in soybean.

Examples of stinkbugs include Nezara spp. (e.g. Nezara viridula, Nezara antennata, Nezara hilare), Piezodorus spp. (e.g. Piezodorus guildinii), Acrosternum spp. Euchistus spp. (e.g. Euchistus heros, Euschistus servus), Halyomorpha halys, Plautia crossota, Riptortus clavatus, Rhopalus msculatus, Antestiopsis orbitalus, Dichelops spp. (e.g. Dichelops furcatus, Dichelops melacanthus), Eurygaster spp. (e.g. Eurygaster intergriceps, Eurygaster maura), Oebalus spp. (e.g. Oebalus mexicana, Oebalus poecilus, Oebalus pugnase, Scotinophara spp. (e.g. Scotinophara lurida, Scotinophara coarctata). Preferred targets include Antestiopsis orbitalus, Dichelops furcatus, Dichelops melacanthus, Euchistus heros, Euschistus servus, Nezara viridula, Nezara hilare, Piezodorus guildinii, Halyomorpha halys. In one embodiment the stinkbug target is Nezara viridula, Piezodorus spp., Acrosternum spp, Euchistus heros.

In one embodiment the invention provides a compound of formula IA for use against rice pests.

In one embodiment the invention provides a compound of formula IA for use against stemborer, particularly in rice.

Examples of stemborers include Chilo sp, Chilo suppressalis, Chilo polychrysus, Chilo auricilius, Scirpophaga spp., Scirpophaga incertulas, Scirpophaga innotata, Scirpophaga nivella Sesamia sp, Sesamia inferens.

In one embodiment the invention provides a compound of formula IA for use against leaffolder, particularly in rice.

Examples of leaffolders include Cnaphalocrocis spp., Cnaphalocrocis medinalis, Marasmia spp., Marasmia patnalis, Marasmia exigua.

In one embodiment the invention provides a compound of formula IA for use against hoppers, particularly in rice.

Examples of Hoppers include Nephotettix spp., Nephotettix virescens, Nephotettix nigropictus, Nephotettix malayanus, Nephotettix cincticeps, Nilaparvata lugens, Sogatella furcifera.

In one embodiment the invention provides a compound of formula IA for use against gallmidge, particularly in rice.

Examples of Gall midge include Orseolia sp, Orseolia oryzae.

In one embodiment the invention provides a compound of formula IA for use against whorl maggot, particularly in rice.

Examples of whorl maggots include Hydrellia sp, Hydrellia philippina.

In one embodiment the invention provides a compound of formula IA for use against Rice bugs, particularly in rice.

Examples of rice bugs include Leptocorisa sp, Leptocorisa oratorius, Leptocorisa chinensis, Leptocorisa acuta.

In one embodiment the invention provides a compound of formula IA for use against Black bugs, particularly in rice.

Examples of Black bugs include Scotinophara sp, Scotinophara coarctata, Scotinophara lurida, Scotinophara latiuscula.

In one embodiment the invention provides a compound of formula IA for use against plutella spp.

In one embodiment the invention provides a compound of formula IA for use against Plutella xylostella, particularly in brassica crops.

In a further aspect the invention provides a method of controlling insects, acarines, nematodes or molluscs, preferably those described below, and preferably in a crop of useful plants, which comprises applying to a pest, to a locus of a pest, or to a plant susceptible to attack by a pest an insecticidally, acaricidally, nematicidally or molluscicidally effective amount of a compound of formula IB

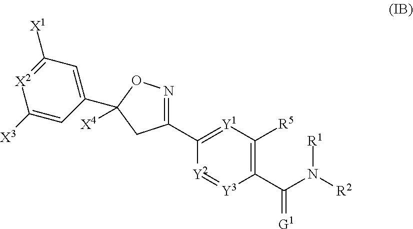

wherein
G¹ is oxygen;
R¹ is hydrogen;
R² is group P

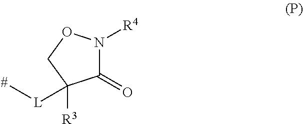

L is a bond, methylene or ethylene;
R³ is hydrogen;
R⁴ is independently hydrogen, cyano, cyano-C₁-C₈alkyl, C₁-C₈alkyl, C₁-C₈haloalkyl, C₃-C₈cycloalkyl, C₃-C₈cycloalkyl where one carbon atom is replaced by O, S, S(O) or SO₂, or C₃-C₈cycloalkyl-C₁-C₈alkyl, C₃-C₈cycloalkyl-C₁-C₈alkyl where one carbon atom in the cycloalkyl group is replaced by O, S, S(O) or SO₂, or C₃-C₈cycloalkyl-C₁-C₈haloalkyl, C₁-C₈hydroxyalkyl, C₁-C₈alkoxy-C₁-C₈alkyl, C₂-C₈alkenyl, C₂-C₈haloalkenyl, C₂-C₈alkynyl, C₂-C₈haloalkynyl, phenyl, phenyl substituted by one to three R⁶, phenyl-C₁-C₄alkyl, phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R⁶, or C₁-C₄alkyl-(C₁-C₄alkyl-O—N═)C—CH₂—;
each R⁶ is independently halogen, cyano, nitro, C₁-C₈alkyl, C₁-C₈haloalkyl, C₁-C₈alkoxy, or C₁-C₈haloalkoxy;
Y¹, Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₂alkyl, C₁-C₂haloalkyl, C₃-C₅cycloalkyl, C₁-C₂halocycloalkyl, C₁-C₂alkoxy, C₁-C₂haloalkoxy;

### X² is C—X⁶;

X¹, X³ and X⁶ are independently halogen or trihalomethyl;
X⁴ is trifluoromethyl, difluoromethyl or chlorodifluoromethyl.

In a further aspect the invention provides a method of protecting useful plants from insects, acarines, nematodes or molluscs, preferably those described below, comprising applying to said plant, to the locus thereof, or to plant propagation material thereof, an insecticidally, acaricidally, nematicidally or molluscicidally effective amount of a compound of formula IB as defined above, including preferences thereof.

In one embodiment the invention provides compounds of formula IB wherein X¹ is chloro, X² is C—Br, X³ is chloro and G¹, R¹, R², R⁵, Y¹, Y², Y³ and X⁴ are as defined for the compound of formula IB.

In one embodiment the invention provides compounds of formula IB wherein X¹ is chloro, X² is C—F, X³ is chloro and G¹, R¹, R², R⁵, Y¹, Y², Y³ and X⁴ are as defined for the compound of formula IB.

In one embodiment the invention provides compounds of formula IB wherein X¹ is chloro, X² is C—Cl, X³ is chloro and G¹, R¹, R², R⁵, Y¹, Y², Y³ and X⁴ are as defined for the compound of formula IB.

In oneembodiment the invention provides compounds of formula IB wherein X¹ is chloro, X² is C—I, X³ is chloro and G¹, R¹, R², R⁵, Y¹, Y², Y³ and X⁴ are as defined for the compound of formula IB.

In one embodiment the invention provides compounds of formula IB wherein X¹ is fluoro, X² is C—F, X³ is fluoro and G¹, R¹, R², R⁵, Y¹, Y², Y³ and X⁴ are as defined for the compound of formula IB.

In embodiment the invention provides compounds of formula IB wherein X¹ is chloro, X² is C—Cl, X³ is trifluoromethyl and G¹, R¹, R², R⁵, Y¹, Y², Y³ and X⁴ are as defined for the compound of formula IB.

In embodiment the invention provides compounds of formula IB wherein X¹ is trifluoromethyl, X² is C—Cl, X³ is trifluoromethyl and G¹, R¹, R², R⁵, Y¹, Y², Y³ and X⁴ are as defined for the compound of formula IB.

In one embodiment the invention provides a compound of formula IB for use in controlling and/or preventing insects of the family Curculionidae, preferably in for use in controlling and/or preventing Anthonomus grandis.

Additional examples of insects from the family of Curculionidae are Anthonomus corvulus, Anthonomus elutus, Anthonomus elongatus, Anthonomus eugenii, Anthonomus consors, Anthonomus haematopus, Anthonomus lecontei, Anthonomus molochinus, Anthonomus morticinus, Anthonomus musculus, Anthonomus nigrinus, Anthonomus phyllocola, Anthonomus pictus, Anthonomus pomorum, Anthonomus quadrigibbus, Anthonomus rectirostris, Anthonomus rubi, Anthonomus santacruzi, Anthonomus signatus, Anthonomus subfascIBtus, and Anthonomus tenebrosus.

In one embodiment the invention provides a compound of formula IB for use against Anthonomus grandis in cotton.

In one embodiment the invention provides a compound of formula IB for use in controlling and/or preventing soil pests.

In one embodiment the invention provides a compound of formula IB for use in controlling and/or preventing corn rootworm, in particular for use against corn root worm from the genus Diabrotica.

In one embodiment the invention provides a compound of formula IB for use in controlling and/or preventing Diabrotica virgifera.

In one embodiment the invention provides a compound of formula IB for use in controlling and/or preventing Diabrotica barberi.

In one embodiment the invention provides a compound of formula IB for use in controlling and/or preventing Diabrotica undecimpunctata howardi.

In one embodiment the invention provides a compound of formula IB for use in controlling and/or preventing wireworms, in particular Agriotes spp.

In one embodiment the invention provides a compound of formula IB for use in controlling and/or preventing Agriotes spp. in cereals, potato or corn.

Additional examples of Agriotes spp. include Agriotes lineatus, Agriotes obscurus, Agriotes brevis, Agriotes gurgistanus, Agriotes sputator, Agriotes ustulatus, Ctenicera destructor, and Limonius californicus.

In one embodiment the invention provides a compound of formula IB for use in controlling and/or preventing grubs, in particular white grubs.

In one embodiment the invention provides a compound of formula IB for use in controlling and/or preventing Phyllophaga spp., particularly on corn, soybean or cotton.

In one embodiment the invention provides a compound of formula IB for use in controlling and/or preventing Diloboderus spp. particularly on corn, soybean or cotton.

In one embodiment the invention provides a compound of formula IB for use in controlling and/or preventing Popillia japonica, particularly on corn, soybean or cotton.

Additional examples of white grubs include Phyllophaga anxia, Phyllophaga crinite, Phyllophaga subnitida, Diloboderus abderus.

In one embodiment the invention provides a compound of formula IB for use in controlling and/or preventing termites, e.g. on sugarcane.

Examples of termites include Reticulitermes, Coptotermes, Macrotermes, Microtermes, Globitermes. Specific of subterranean termites include Reticulitermes flavipes, Reticulitermes hesperus, Reticulitermes verginicus, Reticulitermes hageni, Reticulitermes speratus, Reticulitermes lucifugus, Heterotermes aureus, Coptotermes formosanus, Coptotermes acinaciformis, Coptotermes curvignathus, Nasutitermes exitiosus, Nasutitermes walkeri, Mastotermes darwiniensis, Schedorhinotermes spp, Macrotermes bellicosus, Macrotermes spp., Globitermes sulphureus, Odontotermes spp. Specific examples of dry wood termites include Incisitermes minor, Marginitermes hubbardi, Cryptotermes brevis, Kalotermes flavicollis. Additional examples of termites include procornitermes spp. and procornitermes araujoi

In one embodiment the invention provides a compound of formula IB for use in controlling and/or preventing subterraneous stinkbugs, e.g. Scaptocoris spp.

In one embodiment the invention provides a compound of formula IB for use in controlling and/or preventing Scaptocoris castaneus, in particular on cereals, soybean or corn.

In one embodiment the invention provides a compound of formula IB for use in controlling and/or preventing cutworms, e.g. agrotis spp.

In one embodiment the invention provides a compound of formula IB for use in controlling and/or preventing Agrotis ipsilon, particularly on cereals, canola, soybean or corn.

In one embodiment the invention provides a compound of formula IB for use in controlling and/or preventing millipedes, e.g. Julus spp.

In one embodiment the invention provides a compound of formula IB for use in controlling and/or preventing Julus spp., particularly on cereals, canola, soybean & corn.

In one embodiment the invention provides a compound of formula IB for use in controlling and/or preventing broca gigante, e.g. Telchin licus, particularly on sugarcane.

In one embodiment the invention provides a compound of formula IB for use in controlling and/or preventing whitefly.

In one embodiment the invention provides a compound of formula IB for use in controlling and/or preventing Bemisia tabaci, particularly on vegetables, cotton, soybean, or potatoes.

In one embodiment the invention provides a compound of formula IB for use in controlling and/or preventing Trialeurodes vaporariorum, particularly on vegetables, cotton, soybean, or potatoes.

In one embodiment the invention provides a compound of formula IB for use in controlling and/or preventing stinkbugs, in particular Euschistus spp.

In one embodiment the invention provides a compound of formula IB for use in controlling and/or preventing Euschistus spp., particularly in soybean.

Examples of stinkbugs include Nezara spp. (e.g. Nezara viridula, Nezara antennata, Nezara hilare), Piezodorus spp. (e.g. Piezodorus guildinii), Acrosternum spp. Euchistus spp. (e.g. Euchistus heros, Euschistus servus), Halyomorpha halys, Plautia crossota, Riptortus clavatus, Rhopalus msculatus, Antestiopsis orbitalus, Dichelops spp. (e.g. Dichelops furcatus, Dichelops melacanthus), Eurygaster spp. (e.g. Eurygaster intergriceps, Eurygaster maura), Oebalus spp. (e.g. Oebalus mexicana, Oebalus poecilus, Oebalus pugnase, Scotinophara spp. (e.g. Scotinophara lurida, Scotinophara coarctata). Preferred targets include Antestiopsis orbitalus, Dichelops furcatus, Dichelops melacanthus, Euchistus heros, Euschistus servus, Nezara viridula, Nezara hilare, Piezodorus guildinii, Halyomorpha halys. In one embodiment the stinkbug target is Nezara viridula, Piezodorus spp., Acrosternum spp, Euchistus heros.

In one embodiment the invention provides a compound of formula IB for use against rice pests.

In one embodiment the invention provides a compound of formula IB for use against stemborer, particularly in rice.

Examples of stemborers include Chilo sp, Chilo suppressalis, Chilo polychrysus, Chilo auricilius, Scirpophaga spp., Scirpophaga incertulas, Scirpophaga innotata, Scirpophaga nivella Sesamia sp, Sesamia inferens.

In one embodiment the invention provides a compound of formula IB for use against leaffolder, particularly in rice.

Examples of leaffolders include Cnaphalocrocis spp., Cnaphalocrocis medinalis, Marasmia spp., Marasmia patnalis, Marasmia exigua.

In one embodiment the invention provides a compound of formula IB for use against hoppers, particularly in rice.

Examples of Hoppers include Nephotettix spp., Nephotettix virescens, Nephotettix nigropictus, Nephotettix malayanus, Nephotettix cincticeps, Nilaparvata lugens, Sogatella furcifera.

In one embodiment the invention provides a compound of formula IB for use against gallmidge, particularly in rice.

Examples of Gall midge include Orseolia sp, Orseolia oryzae.

In one embodiment the invention provides a compound of formula IB for use against whorl maggot, particularly in rice.

Examples of whorl maggots include Hydrellia sp, Hydrellia philippina.

In one embodiment the invention provides a compound of formula IB for use against Rice bugs, particularly in rice.

Examples of rice bugs include Leptocorisa sp, Leptocorisa oratorius, Leptocorisa chinensis, Leptocorisa acuta.

In one embodiment the invention provides a compound of formula IB for use against Black bugs, particularly in rice.

Examples of Black bugs include Scotinophara sp, Scotinophara coarctata, Scotinophara lurida, Scotinophara latiuscula.

In one embodiment the invention provides a compound of formula IB for use against plutella spp.

In one embodiment the invention provides a compound of formula IB for use against Plutella xylostella, particularly in brassica crops.

The compounds in the Tables below illustrate the compounds of the invention.

(I-A)

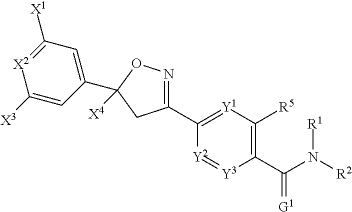

| | | | 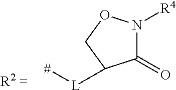 | |
|---|---|---|---|---|
| | X⁴ | R⁵ | L | R⁴ |
| P.001 | chlorodifluoromethyl | bromo | bond | hydrogen |
| P.002 | chlorodifluoromethyl | bromo | bond | methyl- |
| P.003 | chlorodifluoromethyl | bromo | bond | ethyl- |
| P.004 | chlorodifluoromethyl | bromo | bond | 2,2,2-trifluoro-ethyl- |
| P.005 | chlorodifluoromethyl | bromo | bond | 3,3,3-trifluoro-propyl- |
| P.006 | chlorodifluoromethyl | bromo | bond | 2-methoxy-ethyl- |
| P.007 | chlorodifluoromethyl | bromo | bond | 2-hydroxy-ethyl- |
| P.008 | chlorodifluoromethyl | bromo | bond | cyclobutyl- |
| P.009 | chlorodifluoromethyl | bromo | bond | phenyl-methyl- |
| P.010 | chlorodifluoromethyl | bromo | bond | (pyrid-2-yl)-methyl- |
| P.011 | chlorodifluoromethyl | bromo | bond | (pyrid-3-yl)-methyl- |
| P.012 | chlorodifluoromethyl | bromo | bond | thietan-3-yl- |
| P.013 | chlorodifluoromethyl | bromo | bond | 1-oxo-thietan-3-yl- |
| P.014 | chlorodifluoromethyl | bromo | bond | 1,1-dioxo-thietan-3-yl- |
| P.015 | chlorodifluoromethyl | bromo | bond | 3-methyl-thietan-3-yl- |
| P.016 | chlorodifluoromethyl | bromo | bond | oxetan-3yl- |
| P.017 | chlorodifluoromethyl | bromo | bond | tetrahydropyran-4-yl- |
| P.018 | chlorodifluoromethyl | bromo | bond | cyclopropyl- |
| P.019 | chlorodifluoromethyl | bromo | bond | 2-cyano-ethyl- |
| P.020 | chlorodifluoromethyl | bromo | bond | 2,2-difluoro-ethyl- |
| P.021 | chlorodifluoromethyl | bromo | bond | prop-2-ynyl- |
| P.022 | chlorodifluoromethyl | bromo | bond | cyclopropylmethyl- |
| P.023 | chlorodifluoromethyl | bromo | bond | cyclobutylmethyl- |
| P.024 | chlorodifluoromethyl | bromo | bond | 3-cyano-propyl- |
| P.025 | chlorodifluoromethyl | bromo | bond | 2-([1′,3′]dioxolan-2′-yl)- |
| | | | | eth-1-yl- |
| P.026 | chlorodifluoromethyl | bromo | bond | (2-chloro-pyrid-5-yl)- |
| | | | | methyl- |
| P.027 | chlorodifluoromethyl | bromo | bond | tetrahydro-pyran-2-ylmethyl- |
| P.028 | chlorodifluoromethyl | bromo | bond | allyl- |
| P.029 | chlorodifluoromethyl | bromo | bond | 3-methyl-but-2-enyl- |
| P.030 | chlorodifluoromethyl | bromo | bond | butyl- |
| P.031 | chlorodifluoromethyl | bromo | bond | but-2-ynyl- |
| P.032 | chlorodifluoromethyl | bromo | bond | 2-methoxyimino-propyl |
| P.033 | chlorodifluoromethyl | bromo | bond | (2,6-difluoro-phenyl)- |
| | | | | methyl- |
| P.034 | chlorodifluoromethyl | bromo | bond | (4-fluoro-phenyl)-methyl- |
| P.035 | chlorodifluoromethyl | bromo | bond | 3-phenyl-propyl- |
| P.036 | chlorodifluoromethyl | bromo | bond | 2,5-dimethyl-2H- |
| | | | | [1,2,3]triazol- |
| | | | | 4-ylmethyl- |
| P.037 | chlorodifluoromethyl | bromo | bond | cyclohexylmethyl- |
| P.038 | chlorodifluoromethyl | bromo | bond | (tetrahydrofuran-2-yl)- |
| | | | | methyl- |
| P.039 | chlorodifluoromethyl | bromo | bond | 5-trifluoromethyl-furan- |
| | | | | 2-ylmethyl- |
| P.040 | chlorodifluoromethyl | bromo | bond | isopropyl- |
| P.041 | chlorodifluoromethyl | chloro | bond | hydrogen |
| P.042 | chlorodifluoromethyl | chloro | bond | methyl- |
| P.043 | chlorodifluoromethyl | chloro | bond | ethyl- |
| P.044 | chlorodifluoromethyl | chloro | bond | 2,2,2-trifluoro-ethyl- |
| P.045 | chlorodifluoromethyl | chloro | bond | 3,3,3-trifluoro-propyl- |
| P.046 | chlorodifluoromethyl | chloro | bond | 2-methoxy-ethyl- |
| P.047 | chlorodifluoromethyl | chloro | bond | 2-hydroxy-ethyl- |
| P.048 | chlorodifluoromethyl | chloro | bond | cyclobutyl- |
| P.049 | chlorodifluoromethyl | chloro | bond | phenyl-methyl- |
| P.050 | chlorodifluoromethyl | chloro | bond | (pyrid-2-yl)-methyl- |
| P.051 | chlorodifluoromethyl | chloro | bond | (pyrid-3-yl)-methyl- |
| P.052 | chlorodifluoromethyl | chloro | bond | thietan-3-yl- |
| P.053 | chlorodifluoromethyl | chloro | bond | 1-oxo-thietan-3-yl- |
| P.054 | chlorodifluoromethyl | chloro | bond | 1,1-dioxo-thietan-3-yl- |
| P.055 | chlorodifluoromethyl | chloro | bond | 3-methyl-thietan-3-yl- |
| P.056 | chlorodifluoromethyl | chloro | bond | oxetan-3yl- |
| P.057 | chlorodifluoromethyl | chloro | bond | tetrahydropyran-4-yl- |
| P.058 | chlorodifluoromethyl | chloro | bond | cyclopropyl- |
| P.059 | chlorodifluoromethyl | chloro | bond | 2-cyano-ethyl- |
| P.060 | chlorodifluoromethyl | chloro | bond | 2,2-difluoro-ethyl- |
| P.061 | chlorodifluoromethyl | chloro | bond | prop-2-ynyl- |
| P.062 | chlorodifluoromethyl | chloro | bond | cyclopropylmethyl- |
| P.063 | chlorodifluoromethyl | chloro | bond | cyclobutylmethyl- |
| P.064 | chlorodifluoromethyl | chloro | bond | 3-cyano-propyl- |
| P.065 | chlorodifluoromethyl | chloro | bond | 2-([1′,3′]dioxolan-2′-yl)- |
| | | | | eth-1-yl- |
| P.066 | chlorodifluoromethyl | chloro | bond | (2-chloro-pyrid-5-yl)- |
| | | | | methyl- |
| P.067 | chlorodifluoromethyl | chloro | bond | tetrahydro-pyran-2-ylmethyl- |
| P.068 | chlorodifluoromethyl | chloro | bond | allyl- |
| P.069 | chlorodifluoromethyl | chloro | bond | 3-methyl-but-2-enyl- |
| P.070 | chlorodifluoromethyl | chloro | bond | butyl- |
| P.071 | chlorodifluoromethyl | chloro | bond | but-2-ynyl- |
| P.072 | chlorodifluoromethyl | chloro | bond | 2-methoxyimino-propyl |
| P.073 | chlorodifluoromethyl | chloro | bond | (2,6-difluoro-phenyl)- |
| | | | | methyl- |
| P.074 | chlorodifluoromethyl | chloro | bond | (4-fluoro-phenyl)-methyl- |
| P.075 | chlorodifluoromethyl | chloro | bond | 3-phenyl-propyl- |
| P.076 | chlorodifluoromethyl | chloro | bond | 2,5-dimethyl-2H- |
| | | | | [1,2,3]triazol- |
| | | | | 4-ylmethyl- |
| P.077 | chlorodifluoromethyl | chloro | bond | cyclohexylmethyl- |
| P.078 | chlorodifluoromethyl | chloro | bond | (tetrahydrofuran-2-yl)- |
| | | | | methyl- |
| P.079 | chlorodifluoromethyl | chloro | bond | 5-trifluoromethyl-furan- |
| | | | | 2-ylmethyl- |
| P.080 | chlorodifluoromethyl | chloro | bond | isopropyl- |
| P.081 | chlorodifluoromethyl | cyano | bond | hydrogen |
| P.082 | chlorodifluoromethyl | cyano | bond | methyl- |
| P.083 | chlorodifluoromethyl | cyano | bond | ethyl- |
| P.084 | chlorodifluoromethyl | cyano | bond | 2,2,2-trifluoro-ethyl- |
| P.085 | chlorodifluoromethyl | cyano | bond | 3,3,3-trifluoro-propyl- |
| P.086 | chlorodifluoromethyl | cyano | bond | 2-methoxy-ethyl- |
| P.087 | chlorodifluoromethyl | cyano | bond | 2-hydroxy-ethyl- |
| P.088 | chlorodifluoromethyl | cyano | bond | cyclobutyl- |
| P.089 | chlorodifluoromethyl | cyano | bond | phenyl-methyl- |
| P.090 | chlorodifluoromethyl | cyano | bond | (pyrid-2-yl)-methyl- |
| P.091 | chlorodifluoromethyl | cyano | bond | (pyrid-3-yl)-methyl- |
| P.092 | chlorodifluoromethyl | cyano | bond | thietan-3-yl- |
| P.093 | chlorodifluoromethyl | cyano | bond | 1-oxo-thietan-3-yl- |
| P.094 | chlorodifluoromethyl | cyano | bond | 1,1-dioxo-thietan-3-yl- |
| P.095 | chlorodifluoromethyl | cyano | bond | 3-methyl-thietan-3-yl- |
| P.096 | chlorodifluoromethyl | cyano | bond | oxetan-3yl- |
| P.097 | chlorodifluoromethyl | cyano | bond | tetrahydropyran-4-yl- |
| P.098 | chlorodifluoromethyl | cyano | bond | cyclopropyl- |
| P.099 | chlorodifluoromethyl | cyano | bond | 2-cyano-ethyl- |
| P.100 | chlorodifluoromethyl | cyano | bond | 2,2-difluoro-ethyl- |
| P.101 | chlorodifluoromethyl | cyano | bond | prop-2-ynyl- |
| P.102 | chlorodifluoromethyl | cyano | bond | cyclopropylmethyl- |
| P.103 | chlorodifluoromethyl | cyano | bond | cyclobutylmethyl- |
| P.104 | chlorodifluoromethyl | cyano | bond | 3-cyano-propyl- |
| P.105 | chlorodifluoromethyl | cyano | bond | 2-([1′,3′]dioxolan-2′-yl)- |
| | | | | eth-1-yl- |
| P.106 | chlorodifluoromethyl | cyano | bond | (2-chloro-pyrid-5-yl)- |
| | | | | methyl- |
| P.107 | chlorodifluoromethyl | cyano | bond | tetrahydro-pyran-2-ylmethyl- |
| P.108 | chlorodifluoromethyl | cyano | bond | allyl- |
| P.109 | chlorodifluoromethyl | cyano | bond | 3-methyl-but-2-enyl- |
| P.110 | chlorodifluoromethyl | cyano | bond | butyl- |
| P.111 | chlorodifluoromethyl | cyano | bond | but-2-ynyl- |
| P.112 | chlorodifluoromethyl | cyano | bond | 2-methoxyimino-propyl |
| P.113 | chlorodifluoromethyl | cyano | bond | (2,6-difluoro-phenyl)- |
| | | | | methyl- |
| P.114 | chlorodifluoromethyl | cyano | bond | (4-fluoro-phenyl)-methyl- |
| P.115 | chlorodifluoromethyl | cyano | bond | 3-phenyl-propyl- |
| P.116 | chlorodifluoromethyl | cyano | bond | 2,5-dimethyl-2H- |
| | | | | [1,2,3]triazol- |
| | | | | 4-ylmethyl- |
| P.117 | chlorodifluoromethyl | cyano | bond | cyclohexylmethyl- |
| P.118 | chlorodifluoromethyl | cyano | bond | (tetrahydrofuran-2-yl)- |
| | | | | methyl- |
| P.119 | chlorodifluoromethyl | cyano | bond | 5-trifluoromethyl-furan- |
| | | | | 2-ylmethyl- |
| P.120 | chlorodifluoromethyl | cyano | bond | isopropyl- |
| P.121 | chlorodifluoromethyl | cyclopropyl | bond | hydrogen |
| P.122 | chlorodifluoromethyl | cyclopropyl | bond | methyl- |
| P.123 | chlorodifluoromethyl | cyclopropyl | bond | ethyl- |
| P.124 | chlorodifluoromethyl | cyclopropyl | bond | 2,2,2-trifluoro-ethyl- |
| P.125 | chlorodifluoromethyl | cyclopropyl | bond | 3,3,3-trifluoro-propyl- |
| P.126 | chlorodifluoromethyl | cyclopropyl | bond | 2-methoxy-ethyl- |
| P.127 | chlorodifluoromethyl | cyclopropyl | bond | 2-hydroxy-ethyl- |
| P.128 | chlorodifluoromethyl | cyclopropyl | bond | cyclobutyl- |
| P.129 | chlorodifluoromethyl | cyclopropyl | bond | phenyl-methyl- |
| P.130 | chlorodifluoromethyl | cyclopropyl | bond | (pyrid-2-yl)-methyl- |
| P.131 | chlorodifluoromethyl | cyclopropyl | bond | (pyrid-3-yl)-methyl- |
| P.132 | chlorodifluoromethyl | cyclopropyl | bond | thietan-3-yl- |
| P.133 | chlorodifluoromethyl | cyclopropyl | bond | 1-oxo-thietan-3-yl- |
| P.134 | chlorodifluoromethyl | cyclopropyl | bond | 1,1-dioxo-thietan-3-yl- |
| P.135 | chlorodifluoromethyl | cyclopropyl | bond | 3-methyl-thietan-3-yl- |
| P.136 | chlorodifluoromethyl | cyclopropyl | bond | oxetan-3yl- |
| p.137 | chlorodifluoromethyl | cyclopropyl | bond | tetrahydropyran-4-yl- |
| P.138 | chlorodifluoromethyl | cyclopropyl | bond | cyclopropyl- |
| P.139 | chlorodifluoromethyl | cyclopropyl | bond | 2-cyano-ethyl- |
| P.140 | chlorodifluoromethyl | cyclopropyl | bond | 2,2-difluoro-ethyl- |
| P.141 | chlorodifluoromethyl | cyclopropyl | bond | prop-2-ynyl- |
| P.142 | chlorodifluoromethyl | cyclopropyl | bond | cyclopropylmethyl- |
| P.143 | chlorodifluoromethyl | cyclopropyl | bond | cyclobutylmethyl- |
| P.144 | chlorodifluoromethyl | cyclopropyl | bond | 3-cyano-propyl- |
| P.145 | chlorodifluoromethyl | cyclopropyl | bond | 2-([1′,3′]dioxolan-2′-yl)- |
| | | | | eth-1-yl- |
| P.146 | chlorodifluoromethyl | cyclopropyl | bond | (2-chloro-pyrid-5-yl)- |
| | | | | methyl- |
| P.147 | chlorodifluoromethyl | cyclopropyl | bond | tetrahydro-pyran-2-ylmethyl- |
| P.148 | chlorodifluoromethyl | cyclopropyl | bond | allyl- |
| P.149 | chlorodifluoromethyl | cyclopropyl | bond | 3-methyl-but-2-enyl- |
| P.150 | chlorodifluoromethyl | cyclopropyl | bond | butyl- |
| P.151 | chlorodifluoromethyl | cyclopropyl | bond | but-2-ynyl- |
| P.152 | chlorodifluoromethyl | cyclopropyl | bond | 2-methoxyimino-propyl |
| P.153 | chlorodifluoromethyl | cyclopropyl | bond | (2,6-difluoro-phenyl)- |
| | | | | methyl- |
| P.154 | chlorodifluoromethyl | cyclopropyl | bond | (4-fluoro-phenyl)-methyl- |
| P.155 | chlorodifluoromethyl | cyclopropyl | bond | 3-phenyl-propyl- |
| P.156 | chlorodifluoromethyl | cyclopropyl | bond | 2,5-dimethyl-2H- |
| | | | | [1,2,3]triazol- |
| | | | | 4-ylmethyl- |
| P.157 | chlorodifluoromethyl | cyclopropyl | bond | cyclohexylmethyl- |
| P.158 | chlorodifluoromethyl | cyclopropyl | bond | (tetrahydrofuran-2-yl)- |
| | | | | methyl- |
| P.159 | chlorodifluoromethyl | cyclopropyl | bond | 5-trifluoromethyl-furan- |
| | | | | 2-ylmethyl- |
| P.160 | chlorodifluoromethyl | cyclopropyl | bond | isopropyl- |
| P.161 | chlorodifluoromethyl | ethyl | bond | hydrogen |
| P.162 | chlorodifluoromethyl | ethyl | bond | methyl- |
| P.163 | chlorodifluoromethyl | ethyl | bond | ethyl- |
| P.164 | chlorodifluoromethyl | ethyl | bond | 2,2,2-trifluoro-ethyl- |
| P.165 | chlorodifluoromethyl | ethyl | bond | 3,3,3-trifluoro-propyl- |
| P.166 | chlorodifluoromethyl | ethyl | bond | 2-methoxy-ethyl- |
| P.167 | chlorodifluoromethyl | ethyl | bond | 2-hydroxy-ethyl- |
| P.168 | chlorodifluoromethyl | ethyl | bond | cyclobutyl- |
| P.169 | chlorodifluoromethyl | ethyl | bond | phenyl-methyl- |
| P.170 | chlorodifluoromethyl | ethyl | bond | (pyrid-2-yl)-methyl- |
| P.171 | chlorodifluoromethyl | ethyl | bond | (pyrid-3-yl)-methyl- |
| P.172 | chlorodifluoromethyl | ethyl | bond | thietan-3-yl- |
| P.173 | chlorodifluoromethyl | ethyl | bond | 1-oxo-thietan-3-yl- |
| P.174 | chlorodifluoromethyl | ethyl | bond | 1,1-dioxo-thietan-3-yl- |
| P.175 | chlorodifluoromethyl | ethyl | bond | 3-methyl-thietan-3-yl- |
| P.176 | chlorodifluoromethyl | ethyl | bond | oxetan-3yl- |
| P.177 | chlorodifluoromethyl | ethyl | bond | tetrahydropyran-4-yl- |
| P.178 | chlorodifluoromethyl | ethyl | bond | cyclopropyl- |
| P.179 | chlorodifluoromethyl | ethyl | bond | 2-cyano-ethyl- |
| P.180 | chlorodifluoromethyl | ethyl | bond | 2,2-difluoro-ethyl- |
| P.181 | chlorodifluoromethyl | ethyl | bond | prop-2-ynyl- |
| P.182 | chlorodifluoromethyl | ethyl | bond | cyclopropylmethyl- |
| P.183 | chlorodifluoromethyl | ethyl | bond | cyclobutylmethyl- |
| P.184 | chlorodifluoromethyl | ethyl | bond | 3-cyano-propyl- |
| P.185 | chlorodifluoromethyl | ethyl | bond | 2-([1′,3′]dioxolan-2′-yl)- |
| | | | | eth-1-yl- |
| P.186 | chlorodifluoromethyl | ethyl | bond | (2-chloro-pyrid-5-yl)- |
| | | | | methyl- |
| P.187 | chlorodifluoromethyl | ethyl | bond | tetrahydro-pyran-2-ylmethyl- |
| P.188 | chlorodifluoromethyl | ethyl | bond | allyl- |
| P.189 | chlorodifluoromethyl | ethyl | bond | 3-methyl-but-2-enyl- |
| P.190 | chlorodifluoromethyl | ethyl | bond | butyl- |
| P.191 | chlorodifluoromethyl | ethyl | bond | but-2-ynyl- |
| P.192 | chlorodifluoromethyl | ethyl | bond | 2-methoxyimino-propyl |
| P.193 | chlorodifluoromethyl | ethyl | bond | (2,6-difluoro-phenyl)- |
| | | | | methyl- |
| P.194 | chlorodifluoromethyl | ethyl | bond | (4-fluoro-phenyl)-methyl- |
| P.195 | chlorodifluoromethyl | ethyl | bond | 3-phenyl-propyl- |
| P.196 | chlorodifluoromethyl | ethyl | bond | 2,5-dimethyl-2H- |
| | | | | [1,2,3]triazol- |
| | | | | 4-ylmethyl- |
| P.197 | chlorodifluoromethyl | ethyl | bond | cyclohexylmethyl- |
| P.198 | chlorodifluoromethyl | ethyl | bond | (tetrahydrofuran-2-yl)- |
| | | | | methyl- |
| P.199 | chlorodifluoromethyl | ethyl | bond | 5-trifluoromethyl-furan- |
| | | | | 2-ylmethyl- |
| P.200 | chlorodifluoromethyl | fluoro | bond | isopropyl- |
| P.201 | chlorodifluoromethyl | fluoro | bond | hydrogen |
| P.202 | chlorodifluoromethyl | fluoro | bond | methyl- |
| P.203 | chlorodifluoromethyl | fluoro | bond | ethyl- |
| P.204 | chlorodifluoromethyl | fluoro | bond | 2,2,2-trifluoro-ethyl- |
| P.205 | chlorodifluoromethyl | fluoro | bond | 3,3,3-trifluoro-propyl- |
| P.206 | chlorodifluoromethyl | fluoro | bond | 2-methoxy-ethyl- |
| P.207 | chlorodifluoromethyl | fluoro | bond | 2-hydroxy-ethyl- |
| P.208 | chlorodifluoromethyl | fluoro | bond | cyclobutyl- |
| P.209 | chlorodifluoromethyl | fluoro | bond | phenyl-methyl- |
| P.210 | chlorodifluoromethyl | fluoro | bond | (pyrid-2-yl)-methyl- |
| P.211 | chlorodifluoromethyl | fluoro | bond | (pyrid-3-yl)-methyl- |
| P.212 | chlorodifluoromethyl | fluoro | bond | thietan-3-yl- |
| P.213 | chlorodifluoromethyl | fluoro | bond | 1-oxo-thietan-3-yl- |
| P.214 | chlorodifluoromethyl | fluoro | bond | 1,1-dioxo-thietan-3-yl- |
| P.215 | chlorodifluoromethyl | fluoro | bond | 3-methyl-thietan-3-yl- |
| P.216 | chlorodifluoromethyl | fluoro | bond | oxetan-3yl- |
| P.217 | chlorodifluoromethyl | fluoro | bond | tetrahydropyran-4-yl- |
| P.218 | chlorodifluoromethyl | fluoro | bond | cyclopropyl- |
| P.219 | chlorodifluoromethyl | fluoro | bond | 2-cyano-ethyl- |
| P.220 | chlorodifluoromethyl | fluoro | bond | 2,2-difluoro-ethyl- |
| P.221 | chlorodifluoromethyl | fluoro | bond | prop-2-ynyl- |
| P.222 | chlorodifluoromethyl | fluoro | bond | cyclopropylmethyl- |
| P.223 | chlorodifluoromethyl | fluoro | bond | cyclobutylmethyl- |
| P.224 | chlorodifluoromethyl | fluoro | bond | 3-cyano-propyl- |
| P.225 | chlorodifluoromethyl | fluoro | bond | 2-([1′,3′]dioxolan-2′-yl)- |
| | | | | eth-1-yl- |
| P.226 | chlorodifluoromethyl | fluoro | bond | (2-chloro-pyrid-5-yl)- |
| | | | | methyl- |
| P.227 | chlorodifluoromethyl | fluoro | bond | tetrahydro-pyran-2-ylmethyl- |
| P.228 | chlorodifluoromethyl | fluoro | bond | allyl- |
| P.229 | chlorodifluoromethyl | fluoro | bond | 3-methyl-but-2-enyl- |
| P.230 | chlorodifluoromethyl | fluoro | bond | butyl- |
| P.231 | chlorodifluoromethyl | fluoro | bond | but-2-ynyl- |
| P.232 | chlorodifluoromethyl | fluoro | bond | 2-methoxyimino-propyl |
| P.233 | chlorodifluoromethyl | fluoro | bond | (2,6-difluoro-phenyl)- |
| | | | | methyl- |
| P.234 | chlorodifluoromethyl | fluoro | bond | (4-fluoro-phenyl)-methyl- |
| P.235 | chlorodifluoromethyl | fluoro | bond | 3-phenyl-propyl- |
| P.236 | chlorodifluoromethyl | fluoro | bond | 2,5-dimethyl-2H- |
| | | | | [1,2,3]triazol- |
| | | | | 4-ylmethyl- |
| P.237 | chlorodifluoromethyl | fluoro | bond | cyclohexylmethyl- |
| P.238 | chlorodifluoromethyl | fluoro | bond | (tetrahydrofuran-2-yl)- |
| | | | | methyl- |
| P.239 | chlorodifluoromethyl | fluoro | bond | 5-trifluoromethyl-furan- |
| | | | | 2-ylmethyl- |
| P.576 | chlorodifluoromethyl | fluoro | bond | isopropyl- |
| P.241 | chlorodifluoromethyl | hydrogen | bond | hydrogen |
| P.242 | chlorodifluoromethyl | hydrogen | bond | methyl- |
| P.243 | chlorodifluoromethyl | hydrogen | bond | ethyl- |
| P.244 | chlorodifluoromethyl | hydrogen | bond | 2,2,2-trifluoro-ethyl- |
| P.245 | chlorodifluoromethyl | hydrogen | bond | 3,3,3-trifluoro-propyl- |
| P.246 | chlorodifluoromethyl | hydrogen | bond | 2-methoxy-ethyl- |
| P.247 | chlorodifluoromethyl | hydrogen | bond | 2-hydroxy-ethyl- |
| P.248 | chlorodifluoromethyl | hydrogen | bond | cyclobutyl- |
| P.249 | chlorodifluoromethyl | hydrogen | bond | phenyl-methyl- |
| P.250 | chlorodifluoromethyl | hydrogen | bond | (pyrid-2-yl)-methyl- |
| P.251 | chlorodifluoromethyl | hydrogen | bond | (pyrid-3-yl)-methyl- |
| P.252 | chlorodifluoromethyl | hydrogen | bond | thietan-3-yl- |
| P.253 | chlorodifluoromethyl | hydrogen | bond | 1-oxo-thietan-3-yl- |
| P.254 | chlorodifluoromethyl | hydrogen | bond | 1,1-dioxo-thietan-3-yl- |
| P.255 | chlorodifluoromethyl | hydrogen | bond | 3-methyl-thietan-3-yl- |
| P.256 | chlorodifluoromethyl | hydrogen | bond | oxetan-3yl- |
| P.257 | chlorodifluoromethyl | hydrogen | bond | tetrahydropyran-4-yl- |
| P.258 | chlorodifluoromethyl | hydrogen | bond | cyclopropyl- |
| P.259 | chlorodifluoromethyl | hydrogen | bond | 2-cyano-ethyl- |
| P.260 | chlorodifluoromethyl | hydrogen | bond | 2,2-difluoro-ethyl- |
| P.261 | chlorodifluoromethyl | hydrogen | bond | prop-2-ynyl- |
| P.262 | chlorodifluoromethyl | hydrogen | bond | cyclopropylmethyl- |
| P.263 | chlorodifluoromethyl | hydrogen | bond | cyclobutylmethyl- |
| P.264 | chlorodifluoromethyl | hydrogen | bond | 3-cyano-propyl- |
| P.265 | chlorodifluoromethyl | hydrogen | bond | 2-([1′,3′]dioxolan-2′-yl)- |
| | | | | eth-1-yl- |
| P.266 | chlorodifluoromethyl | hydrogen | bond | (2-chloro-pyrid-5-yl)- |
| | | | | methyl- |
| P.267 | chlorodifluoromethyl | hydrogen | bond | tetrahydro-pyran-2-ylmethyl- |
| P.268 | chlorodifluoromethyl | hydrogen | bond | allyl- |
| P.269 | chlorodifluoromethyl | hydrogen | bond | 3-methyl-but-2-enyl- |
| P.270 | chlorodifluoromethyl | hydrogen | bond | butyl- |
| P.271 | chlorodifluoromethyl | hydrogen | bond | but-2-ynyl- |
| P.272 | chlorodifluoromethyl | hydrogen | bond | 2-methoxyimino-propyl |
| P.273 | chlorodifluoromethyl | hydrogen | bond | (2,6-difluoro-phenyl)- |
| | | | | methyl- |
| P.274 | chlorodifluoromethyl | hydrogen | bond | (4-fluoro-phenyl)-methyl- |
| P.275 | chlorodifluoromethyl | hydrogen | bond | 3-phenyl-propyl- |
| P.276 | chlorodifluoromethyl | hydrogen | bond | 2,5-dimethyl-2H- |
| | | | | [1,2,3]triazol- |
| | | | | 4-ylmethyl- |
| P.277 | chlorodifluoromethyl | hydrogen | bond | cyclohexylmethyl- |
| P.278 | chlorodifluoromethyl | hydrogen | bond | (tetrahydrofuran-2-yl)- |
| | | | | methyl- |
| P.279 | chlorodifluoromethyl | hydrogen | bond | 5-trifluoromethyl-furan- |
| | | | | 2-ylmethyl- |
| P.280 | chlorodifluoromethyl | hydrogen | bond | isopropyl- |
| P.281 | chlorodifluoromethyl | methoxy | bond | hydrogen |
| P.282 | chlorodifluoromethyl | methoxy | bond | methyl- |
| P.283 | chlorodifluoromethyl | methoxy | bond | ethyl- |
| P.284 | chlorodifluoromethyl | methoxy | bond | 2,2,2-trifluoro-ethyl- |
| P.285 | chlorodifluoromethyl | methoxy | bond | 3,3,3-trifluoro-propyl- |
| P.286 | chlorodifluoromethyl | methoxy | bond | 2-methoxy-ethyl- |
| P.287 | chlorodifluoromethyl | methoxy | bond | 2-hydroxy-ethyl- |
| P.288 | chlorodifluoromethyl | methoxy | bond | cyclobutyl- |
| P.289 | chlorodifluoromethyl | methoxy | bond | phenyl-methyl- |
| P.290 | chlorodifluoromethyl | methoxy | bond | (pyrid-2-yl)-methyl- |
| P.291 | chlorodifluoromethyl | methoxy | bond | (pyrid-3-yl)-methyl- |
| P.292 | chlorodifluoromethyl | methoxy | bond | thietan-3-yl- |
| P.293 | chlorodifluoromethyl | methoxy | bond | 1-oxo-thietan-3-yl- |
| P.294 | chlorodifluoromethyl | methoxy | bond | 1,1-dioxo-thietan-3-yl- |
| P.295 | chlorodifluoromethyl | methoxy | bond | 3-methyl-thietan-3-yl- |
| P.296 | chlorodifluoromethyl | methoxy | bond | oxetan-3yl- |
| P.297 | chlorodifluoromethyl | methoxy | bond | tetrahydropyran-4-yl- |
| P.298 | chlorodifluoromethyl | methoxy | bond | cyclopropyl- |
| P.299 | chlorodifluoromethyl | methoxy | bond | 2-cyano-ethyl- |
| P.300 | chlorodifluoromethyl | methoxy | bond | 2,2-difluoro-ethyl- |
| P.301 | chlorodifluoromethyl | methoxy | bond | prop-2-ynyl- |
| P.302 | chlorodifluoromethyl | methoxy | bond | cyclopropylmethyl- |
| P.303 | chlorodifluoromethyl | methoxy | bond | cyclobutylmethyl- |
| P.304 | chlorodifluoromethyl | methoxy | bond | 3-cyano-propyl- |
| P.305 | chlorodifluoromethyl | methoxy | bond | 2-([1′,3′]dioxolan-2′-yl)- |
| | | | | eth-1-yl- |
| P.306 | chlorodifluoromethyl | methoxy | bond | (2-chloro-pyrid-5-yl)- |
| | | | | methyl- |
| P.307 | chlorodifluoromethyl | methoxy | bond | tetrahydro-pyran-2-ylmethyl- |
| P.308 | chlorodifluoromethyl | methoxy | bond | allyl- |
| P.309 | chlorodifluoromethyl | methoxy | bond | 3-methyl-but-2-enyl- |
| P.310 | chlorodifluoromethyl | methoxy | bond | butyl- |
| P.311 | chlorodifluoromethyl | methoxy | bond | but-2-ynyl- |
| P.312 | chlorodifluoromethyl | methoxy | bond | 2-methoxyimino-propyl |
| P.313 | chlorodifluoromethyl | methoxy | bond | (2,6-difluoro-phenyl)- |
| | | | | methyl- |
| P.314 | chlorodifluoromethyl | methoxy | bond | (4-fluoro-phenyl)-methyl- |
| P.315 | chlorodifluoromethyl | methoxy | bond | 3-phenyl-propyl- |
| P.316 | chlorodifluoromethyl | methoxy | bond | 2,5-dimethyl-2H- |
| | | | | [1,2,3]triazol- |
| | | | | 4-ylmethyl- |
| P.317 | chlorodifluoromethyl | methoxy | bond | cyclohexylmethyl- |
| P.318 | chlorodifluoromethyl | methoxy | bond | (tetrahydrofuran-2-yl)- |
| | | | | methyl- |
| P.319 | chlorodifluoromethyl | methoxy | bond | 5-trifluoromethyl-furan- |
| | | | | 2-ylmethyl- |
| P.320 | chlorodifluoromethyl | methoxy | bond | isopropyl- |
| P.321 | chlorodifluoromethyl | methyl | bond | hydrogen |
| P.322 | chlorodifluoromethyl | methyl | bond | methyl- |
| P.323 | chlorodifluoromethyl | methyl | bond | ethyl- |
| P.324 | chlorodifluoromethyl | methyl | bond | 2,2,2-trifluoro-ethyl- |
| P.325 | chlorodifluoromethyl | methyl | bond | 3,3,3-trifluoro-propyl- |
| P.326 | chlorodifluoromethyl | methyl | bond | 2-methoxy-ethyl- |
| P.327 | chlorodifluoromethyl | methyl | bond | 2-hydroxy-ethyl- |
| P.328 | chlorodifluoromethyl | methyl | bond | cyclobutyl- |
| P.329 | chlorodifluoromethyl | methyl | bond | phenyl-methyl- |
| P.330 | chlorodifluoromethyl | methyl | bond | (pyrid-2-yl)-methyl- |
| P.331 | chlorodifluoromethyl | methyl | bond | (pyrid-3-yl)-methyl- |
| P.332 | chlorodifluoromethyl | methyl | bond | thietan-3-yl- |
| P.333 | chlorodifluoromethyl | methyl | bond | 1-oxo-thietan-3-yl- |
| P.334 | chlorodifluoromethyl | methyl | bond | 1,1-dioxo-thietan-3-yl- |
| P.335 | chlorodifluoromethyl | methyl | bond | 3-methyl-thietan-3-yl- |
| P.336 | chlorodifluoromethyl | methyl | bond | oxetan-3yl- |
| p.337 | chlorodifluoromethyl | methyl | bond | tetrahydropyran-4-yl- |
| P.338 | chlorodifluoromethyl | methyl | bond | cyclopropyl- |
| P.339 | chlorodifluoromethyl | methyl | bond | 2-cyano-ethyl- |
| P.340 | chlorodifluoromethyl | methyl | bond | 2,2-difluoro-ethyl- |
| P.341 | chlorodifluoromethyl | methyl | bond | prop-2-ynyl- |
| P.342 | chlorodifluoromethyl | methyl | bond | cyclopropylmethyl- |
| P.343 | chlorodifluoromethyl | methyl | bond | cyclobutylmethyl- |
| P.344 | chlorodifluoromethyl | methyl | bond | 3-cyano-propyl- |
| P.345 | chlorodifluoromethyl | methyl | bond | 2-([1′,3′]dioxolan-2′-yl)- |
| | | | | eth-1-yl- |
| P.346 | chlorodifluoromethyl | methyl | bond | (2-chloro-pyrid-5-yl)- |
| | | | | methyl- |
| P.347 | chlorodifluoromethyl | methyl | bond | tetrahydro-pyran-2-ylmethyl- |
| P.348 | chlorodifluoromethyl | methyl | bond | allyl- |
| P.349 | chlorodifluoromethyl | methyl | bond | 3-methyl-but-2-enyl- |
| P.350 | chlorodifluoromethyl | methyl | bond | butyl- |
| P.351 | chlorodifluoromethyl | methyl | bond | but-2-ynyl- |
| P.352 | chlorodifluoromethyl | methyl | bond | 2-methoxyimino-propyl |
| P.353 | chlorodifluoromethyl | methyl | bond | (2,6-difluoro-phenyl)- |
| | | | | methyl- |
| P.354 | chlorodifluoromethyl | methyl | bond | (4-fluoro-phenyl)-methyl- |
| P.355 | chlorodifluoromethyl | methyl | bond | 3-phenyl-propyl- |
| P.356 | chlorodifluoromethyl | methyl | bond | 2,5-dimethyl-2H- |
| | | | | [1,2,3]triazol- |
| | | | | 4-ylmethyl- |
| P.357 | chlorodifluoromethyl | methyl | bond | cyclohexylmethyl- |
| P.358 | chlorodifluoromethyl | methyl | bond | (tetrahydrofuran-2-yl)- |
| | | | | methyl- |
| P.359 | chlorodifluoromethyl | methyl | bond | 5-trifluoromethyl-furan- |
| | | | | 2-ylmethyl- |
| P.360 | chlorodifluoromethyl | methyl | bond | isopropyl- |
| P.361 | chlorodifluoromethyl | nitro | bond | hydrogen |
| P.362 | chlorodifluoromethyl | nitro | bond | methyl- |
| P.363 | chlorodifluoromethyl | nitro | bond | ethyl- |
| P.364 | chlorodifluoromethyl | nitro | bond | 2,2,2-trifluoro-ethyl- |
| P.365 | chlorodifluoromethyl | nitro | bond | 3,3,3-trifluoro-propyl- |
| P.366 | chlorodifluoromethyl | nitro | bond | 2-methoxy-ethyl- |
| P.367 | chlorodifluoromethyl | nitro | bond | 2-hydroxy-ethyl- |
| P.368 | chlorodifluoromethyl | nitro | bond | cyclobutyl- |
| P.369 | chlorodifluoromethyl | nitro | bond | phenyl-methyl- |
| P.370 | chlorodifluoromethyl | nitro | bond | (pyrid-2-yl)-methyl- |
| P.371 | chlorodifluoromethyl | nitro | bond | (pyrid-3-yl)-methyl- |
| P.372 | chlorodifluoromethyl | nitro | bond | thietan-3-yl- |
| P.373 | chlorodifluoromethyl | nitro | bond | 1-oxo-thietan-3-yl- |
| P.374 | chlorodifluoromethyl | nitro | bond | 1,1-dioxo-thietan-3-yl- |
| P.375 | chlorodifluoromethyl | nitro | bond | 3-methyl-thietan-3-yl- |
| P.376 | chlorodifluoromethyl | nitro | bond | oxetan-3yl- |
| P.377 | chlorodifluoromethyl | nitro | bond | tetrahydropyran-4-yl- |
| P.378 | chlorodifluoromethyl | nitro | bond | cyclopropyl- |
| P.379 | chlorodifluoromethyl | nitro | bond | 2-cyano-ethyl- |
| P.380 | chlorodifluoromethyl | nitro | bond | 2,2-difluoro-ethyl- |
| P.381 | chlorodifluoromethyl | nitro | bond | prop-2-ynyl- |
| P.382 | chlorodifluoromethyl | nitro | bond | cyclopropylmethyl- |
| P.383 | chlorodifluoromethyl | nitro | bond | cyclobutylmethyl- |
| P.384 | chlorodifluoromethyl | nitro | bond | 3-cyano-propyl- |
| P.385 | chlorodifluoromethyl | nitro | bond | 2-([1′,3′]dioxolan-2′-yl)- |
| | | | | eth-1-yl- |
| P.386 | chlorodifluoromethyl | nitro | bond | (2-chloro-pyrid-5-yl)- |
| | | | | methyl- |
| P.387 | chlorodifluoromethyl | nitro | bond | tetrahydro-pyran-2-ylmethyl- |
| P.388 | chlorodifluoromethyl | nitro | bond | allyl- |
| P.389 | chlorodifluoromethyl | nitro | bond | 3-methyl-but-2-enyl- |
| P.390 | chlorodifluoromethyl | nitro | bond | butyl- |
| P.391 | chlorodifluoromethyl | nitro | bond | but-2-ynyl- |
| P.392 | chlorodifluoromethyl | nitro | bond | 2-methoxyimino-propyl |
| P.393 | chlorodifluoromethyl | nitro | bond | (2,6-difluoro-phenyl)- |
| | | | | methyl- |
| P.394 | chlorodifluoromethyl | nitro | bond | (4-fluoro-phenyl)-methyl- |
| P.395 | chlorodifluoromethyl | nitro | bond | 3-phenyl-propyl- |
| P.396 | chlorodifluoromethyl | nitro | bond | 2,5-dimethyl-2H- |
| | | | | [1,2,3]triazol- |
| | | | | 4-ylmethyl- |
| P.397 | chlorodifluoromethyl | nitro | bond | cyclohexylmethyl- |
| P.398 | chlorodifluoromethyl | nitro | bond | (tetrahydrofuran-2-yl)- |
| | | | | methyl- |
| P.399 | chlorodifluoromethyl | nitro | bond | 5-trifluoromethyl-furan- |
| | | | | 2-ylmethyl- |
| P.400 | chlorodifluoromethyl | nitro | bond | isopropyl- |
| P.401 | chlorodifluoromethyl | trifluoromethoxy | bond | hydrogen |
| P.402 | chlorodifluoromethyl | trifluoromethoxy | bond | methyl- |
| P.403 | chlorodifluoromethyl | trifluoromethoxy | bond | ethyl- |
| P.404 | chlorodifluoromethyl | trifluoromethoxy | bond | 2,2,2-trifluoro-ethyl- |
| P.405 | chlorodifluoromethyl | trifluoromethoxy | bond | 3,3,3-trifluoro-propyl- |
| P.406 | chlorodifluoromethyl | trifluoromethoxy | bond | 2-methoxy-ethyl- |
| P.407 | chlorodifluoromethyl | trifluoromethoxy | bond | 2-hydroxy-ethyl- |
| P.408 | chlorodifluoromethyl | trifluoromethoxy | bond | cyclobutyl- |
| P.409 | chlorodifluoromethyl | trifluoromethoxy | bond | phenyl-methyl- |
| P.410 | chlorodifluoromethyl | trifluoromethoxy | bond | (pyrid-2-yl)-methyl- |
| P.411 | chlorodifluoromethyl | trifluoromethoxy | bond | (pyrid-3-yl)-methyl- |
| P.412 | chlorodifluoromethyl | trifluoromethoxy | bond | thietan-3-yl- |
| P.413 | chlorodifluoromethyl | trifluoromethoxy | bond | 1-oxo-thietan-3-yl- |
| P.414 | chlorodifluoromethyl | trifluoromethoxy | bond | 1,1-dioxo-thietan-3-yl- |
| P.415 | chlorodifluoromethyl | trifluoromethoxy | bond | 3-methyl-thietan-3-yl- |
| P.416 | chlorodifluoromethyl | trifluoromethoxy | bond | oxetan-3yl- |
| P.417 | chlorodifluoromethyl | trifluoromethoxy | bond | tetrahydropyran-4-yl- |
| P.418 | chlorodifluoromethyl | trifluoromethoxy | bond | cyclopropyl- |
| P.419 | chlorodifluoromethyl | trifluoromethoxy | bond | 2-cyano-ethyl- |
| P.420 | chlorodifluoromethyl | trifluoromethoxy | bond | 2,2-difluoro-ethyl- |
| P.421 | chlorodifluoromethyl | trifluoromethoxy | bond | prop-2-ynyl- |
| P.422 | chlorodifluoromethyl | trifluoromethoxy | bond | cyclopropylmethyl- |
| P.423 | chlorodifluoromethyl | trifluoromethoxy | bond | cyclobutylmethyl- |
| P.424 | chlorodifluoromethyl | trifluoromethoxy | bond | 3-cyano-propyl- |
| P.425 | chlorodifluoromethyl | trifluoromethoxy | bond | 2-([1′,3′]dioxolan-2′-yl)- |
| | | | | eth-1-yl- |
| P.426 | chlorodifluoromethyl | trifluoromethoxy | bond | (2-chloro-pyrid-5-yl)- |
| | | | | methyl- |
| P.427 | chlorodifluoromethyl | trifluoromethoxy | bond | tetrahydro-pyran-2-ylmethyl- |
| P.428 | chlorodifluoromethyl | trifluoromethoxy | bond | allyl- |
| P.429 | chlorodifluoromethyl | trifluoromethoxy | bond | 3-methyl-but-2-enyl- |
| P.430 | chlorodifluoromethyl | trifluoromethoxy | bond | butyl- |
| P.431 | chlorodifluoromethyl | trifluoromethoxy | bond | but-2-ynyl- |
| P.432 | chlorodifluoromethyl | trifluoromethoxy | bond | 2-methoxyimino-propyl |
| P.433 | chlorodifluoromethyl | trifluoromethoxy | bond | (2,6-difluoro-phenyl)- |
| | | | | methyl- |
| P.434 | chlorodifluoromethyl | trifluoromethoxy | bond | (4-fluoro-phenyl)-methyl- |
| P.435 | chlorodifluoromethyl | trifluoromethoxy | bond | 3-phenyl-propyl- |
| P.436 | chlorodifluoromethyl | trifluoromethoxy | bond | 2,5-dimethyl-2H- |
| | | | | [1,2,3]triazol- |
| | | | | 4-ylmethyl- |
| P.437 | chlorodifluoromethyl | trifluoromethoxy | bond | cyclohexylmethyl- |
| P.438 | chlorodifluoromethyl | trifluoromethoxy | bond | (tetrahydrofuran-2-yl)- |
| | | | | methyl- |
| P.439 | chlorodifluoromethyl | trifluoromethoxy | bond | 5-trifluoromethyl-furan- |
| | | | | 2-ylmethyl- |
| P.440 | chlorodifluoromethyl | trifluoromethoxy | bond | isopropyl- |
| P.441 | chlorodifluoromethyl | trifluoromethyl | bond | hydrogen |
| P.442 | chlorodifluoromethyl | trifluoromethyl | bond | methyl- |
| P.443 | chlorodifluoromethyl | trifluoromethyl | bond | ethyl- |
| P.444 | chlorodifluoromethyl | trifluoromethyl | bond | 2,2,2-trifluoro-ethyl- |
| P.445 | chlorodifluoromethyl | trifluoromethyl | bond | 3,3,3-trifluoro-propyl- |
| P.446 | chlorodifluoromethyl | trifluoromethyl | bond | 2-methoxy-ethyl- |
| P.447 | chlorodifluoromethyl | trifluoromethyl | bond | 2-hydroxy-ethyl- |
| P.448 | chlorodifluoromethyl | trifluoromethyl | bond | cyclobutyl- |
| P.449 | chlorodifluoromethyl | trifluoromethyl | bond | phenyl-methyl- |
| P.450 | chlorodifluoromethyl | trifluoromethyl | bond | (pyrid-2-yl)-methyl- |
| P.451 | chlorodifluoromethyl | trifluoromethyl | bond | (pyrid-3-yl)-methyl- |
| P.452 | chlorodifluoromethyl | trifluoromethyl | bond | thietan-3-yl- |
| P.453 | chlorodifluoromethyl | trifluoromethyl | bond | 1-oxo-thietan-3-yl- |
| P.454 | chlorodifluoromethyl | trifluoromethyl | bond | 1,1-dioxo-thietan-3-yl- |
| P.455 | chlorodifluoromethyl | trifluoromethyl | bond | 3-methyl-thietan-3-yl- |
| P.456 | chlorodifluoromethyl | trifluoromethyl | bond | oxetan-3yl- |
| P.457 | chlorodifluoromethyl | trifluoromethyl | bond | tetrahydropyran-4-yl- |
| P.458 | chlorodifluoromethyl | trifluoromethyl | bond | cyclopropyl- |
| P.459 | chlorodifluoromethyl | trifluoromethyl | bond | 2-cyano-ethyl- |
| P.460 | chlorodifluoromethyl | trifluoromethyl | bond | 2,2-difluoro-ethyl- |
| P.461 | chlorodifluoromethyl | trifluoromethyl | bond | prop-2-ynyl- |
| P.462 | chlorodifluoromethyl | trifluoromethyl | bond | cyclopropylmethyl- |
| P.463 | chlorodifluoromethyl | trifluoromethyl | bond | cyclobutylmethyl- |
| P.464 | chlorodifluoromethyl | trifluoromethyl | bond | 3-cyano-propyl- |
| P.465 | chlorodifluoromethyl | trifluoromethyl | bond | 2-([1′,3′]dioxolan-2′-yl)- |
| | | | | eth-1-yl- |
| P.466 | chlorodifluoromethyl | trifluoromethyl | bond | (2-chloro-pyrid-5-yl)- |
| | | | | methyl- |
| P.467 | chlorodifluoromethyl | trifluoromethyl | bond | tetrahydro-pyran-2-ylmethyl- |
| P.468 | chlorodifluoromethyl | trifluoromethyl | bond | allyl- |
| P.469 | chlorodifluoromethyl | trifluoromethyl | bond | 3-methyl-but-2-enyl- |
| P.470 | chlorodifluoromethyl | trifluoromethyl | bond | butyl- |
| P.471 | chlorodifluoromethyl | trifluoromethyl | bond | but-2-ynyl- |
| P.472 | chlorodifluoromethyl | trifluoromethyl | bond | 2-methoxyimino-propyl |
| P.473 | chlorodifluoromethyl | trifluoromethyl | bond | (2,6-difluoro-phenyl)- |
| | | | | methyl- |
| P.474 | chlorodifluoromethyl | trifluoromethyl | bond | (4-fluoro-phenyl)-methyl- |
| P.475 | chlorodifluoromethyl | trifluoromethyl | bond | 3-phenyl-propyl- |
| P.476 | chlorodifluoromethyl | trifluoromethyl | bond | 2,5-dimethyl-2H- |
| | | | | [1,2,3]triazol- |
| | | | | 4-ylmethyl- |
| P.477 | chlorodifluoromethyl | trifluoromethyl | bond | cyclohexylmethyl- |
| P.478 | chlorodifluoromethyl | trifluoromethyl | bond | (tetrahydrofuran-2-yl)- |
| | | | | methyl- |
| P.479 | chlorodifluoromethyl | trifluoromethyl | bond | 5-trifluoromethyll-furan- |
| | | | | 2-ylmethyl- |
| P.480 | chlorodifluoromethyl | trifluoromethyl | bond | isopropyl- |
| P.481 | difluoromethyl | bromo | bond | hydrogen |
| P.482 | difluoromethyl | bromo | bond | methyl- |
| P.483 | difluoromethyl | bromo | bond | ethyl- |
| P.484 | difluoromethyl | bromo | bond | 2,2,2-trifluoro-ethyl- |
| P.485 | difluoromethyl | bromo | bond | 3,3,3-trifluoro-propyl- |
| P.486 | difluoromethyl | bromo | bond | 2-methoxy-ethyl- |
| P.487 | difluoromethyl | bromo | bond | 2-hydroxy-ethyl- |
| P.488 | difluoromethyl | bromo | bond | cyclobutyl- |
| P.489 | difluoromethyl | bromo | bond | phenyl-methyl- |
| P.490 | difluoromethyl | bromo | bond | (pyrid-2-yl)-methyl- |
| P.491 | difluoromethyl | bromo | bond | (pyrid-3-yl)-methyl- |
| P.492 | difluoromethyl | bromo | bond | thietan-3-yl- |
| P.493 | difluoromethyl | bromo | bond | 1-oxo-thietan-3-yl- |
| P.494 | difluoromethyl | bromo | bond | 1,1-dioxo-thietan-3-yl- |
| P.495 | difluoromethyl | bromo | bond | 3-methyl-thietan-3-yl- |
| P.496 | difluoromethyl | bromo | bond | oxetan-3yl- |
| P.497 | difluoromethyl | bromo | bond | tetrahydropyran-4-yl- |
| P.498 | difluoromethyl | bromo | bond | cyclopropyl- |
| P.499 | difluoromethyl | bromo | bond | 2-cyano-ethyl- |
| P.500 | difluoromethyl | bromo | bond | 2,2-difluoro-ethyl- |
| P.501 | difluoromethyl | bromo | bond | prop-2-ynyl- |
| P.502 | difluoromethyl | bromo | bond | cyclopropylmethyl- |
| P.503 | difluoromethyl | bromo | bond | cyclobutylmethyl- |
| P.504 | difluoromethyl | bromo | bond | 3-cyano-propyl- |
| P.505 | difluoromethyl | bromo | bond | 2-([1′,3′]dioxolan-2′-yl)- |
| | | | | eth-1-yl- |
| P.506 | difluoromethyl | bromo | bond | (2-chloro-pyrid-5-yl)- |
| | | | | methyl- |
| P.507 | difluoromethyl | bromo | bond | tetrahydro-pyran-2-ylmethyl- |
| P.508 | difluoromethyl | bromo | bond | allyl- |
| P.509 | difluoromethyl | bromo | bond | 3-methyl-but-2-enyl- |
| P.510 | difluoromethyl | bromo | bond | butyl- |
| P.511 | difluoromethyl | bromo | bond | but-2-ynyl- |
| P.512 | difluoromethyl | bromo | bond | 2-methoxyimino-propyl |
| P.513 | difluoromethyl | bromo | bond | (2,6-difluoro-phenyl)- |
| | | | | methyl- |
| P.514 | difluoromethyl | bromo | bond | (4-fluoro-phenyl)-methyl- |
| P.515 | difluoromethyl | bromo | bond | 3-phenyl-propyl- |
| P.516 | difluoromethyl | bromo | bond | 2,5-dimethyl-2H- |
| | | | | [1,2,3]triazol- |
| | | | | 4-ylmethyl- |
| P.517 | difluoromethyl | bromo | bond | cyclohexylmethyl- |
| P.518 | difluoromethyl | bromo | bond | (tetrahydrofuran-2-yl)- |
| | | | | methyl- |
| P.519 | difluoromethyl | bromo | bond | 5-trifluoromethyl-furan- |
| | | | | 2-ylmethyl- |
| P.520 | difluoromethyl | bromo | bond | isopropyl- |
| P.521 | difluoromethyl | chloro | bond | hydrogen |
| P.522 | difluoromethyl | chloro | bond | methyl- |
| P.523 | difluoromethyl | chloro | bond | ethyl- |
| P.524 | difluoromethyl | chloro | bond | 2,2,2-trifluoro-ethyl- |
| P.525 | difluoromethyl | chloro | bond | 3,3,3-trifluoro-propyl- |
| P.526 | difluoromethyl | chloro | bond | 2-methoxy-ethyl- |
| P.527 | difluoromethyl | chloro | bond | 2-hydroxy-ethyl- |
| P.528 | difluoromethyl | chloro | bond | cyclobutyl- |
| P.529 | difluoromethyl | chloro | bond | phenyl-methyl- |
| P.530 | difluoromethyl | chloro | bond | (pyrid-2-yl)-methyl- |
| P.531 | difluoromethyl | chloro | bond | (pyrid-3-yl)-methyl- |
| P.532 | difluoromethyl | chloro | bond | thietan-3-yl- |
| P.533 | difluoromethyl | chloro | bond | 1-oxo-thietan-3-yl- |
| P.534 | difluoromethyl | chloro | bond | 1,1-dioxo-thietan-3-yl- |
| P.535 | difluoromethyl | chloro | bond | 3-methyl-thietan-3-yl- |
| P.536 | difluoromethyl | chloro | bond | oxetan-3yl- |
| P.537 | difluoromethyl | chloro | bond | tetrahydropyran-4-yl- |
| P.538 | difluoromethyl | chloro | bond | cyclopropyl- |
| P.539 | difluoromethyl | chloro | bond | 2-cyano-ethyl- |
| P.540 | difluoromethyl | chloro | bond | 2,2-difluoro-ethyl- |
| P.541 | difluoromethyl | chloro | bond | prop-2-ynyl- |
| P.542 | difluoromethyl | chloro | bond | cyclopropylmethyl- |
| P.543 | difluoromethyl | chloro | bond | cyclobutylmethyl- |
| P.544 | difluoromethyl | chloro | bond | 3-cyano-propyl- |
| P.545 | difluoromethyl | chloro | bond | 2-([1′,3′]dioxolan-2′-yl)- |
| | | | | eth-1-yl- |
| P.546 | difluoromethyl | chloro | bond | (2-chloro-pyrid-5-yl)- |
| | | | | methyl- |
| P.547 | difluoromethyl | chloro | bond | tetrahydro-pyran-2-ylmethyl- |
| P.548 | difluoromethyl | chloro | bond | allyl- |
| P.549 | difluoromethyl | chloro | bond | 3-methyl-but-2-enyl- |
| P.550 | difluoromethyl | chloro | bond | butyl- |
| P.551 | difluoromethyl | chloro | bond | but-2-ynyl- |
| P.552 | difluoromethyl | chloro | bond | 2-methoxyimino-propyl |
| P.553 | difluoromethyl | chloro | bond | (2,6-difluoro-phenyl)- |
| | | | | methyl- |
| P.554 | difluoromethyl | chloro | bond | (4-fluoro-phenyl)-methyl- |
| P.555 | difluoromethyl | chloro | bond | 3-phenyl-propyl- |
| P.556 | difluoromethyl | chloro | bond | 2,5-dimethyl-2H- |
| | | | | [1,2,3]triazol- |
| | | | | 4-ylmethyl- |
| P.557 | difluoromethyl | chloro | bond | cyclohexylmethyl- |
| P.558 | difluoromethyl | chloro | bond | (tetrahydrofuran-2-yl)- |
| | | | | methyl- |
| P.559 | difluoromethyl | chloro | bond | 5-trifluoromethyl-furan- |
| | | | | 2-ylmethyl |
| P.560 | difluoromethyl | chloro | bond | isopropyl- |
| P.561 | difluoromethyl | cyano | bond | hydrogen |
| P.562 | difluoromethyl | cyano | bond | methyl- |
| P.563 | difluoromethyl | cyano | bond | ethyl- |
| P.564 | difluoromethyl | cyano | bond | 2,2,2-trifluoro-ethyl- |
| P.565 | difluoromethyl | cyano | bond | 3,3,3-trifluoro-propyl- |
| P.566 | difluoromethyl | cyano | bond | 2-methoxy-ethyl- |
| P.567 | difluoromethyl | cyano | bond | 2-hydroxy-ethyl- |
| P.568 | difluoromethyl | cyano | bond | cyclobutyl- |
| P.569 | difluoromethyl | cyano | bond | phenyl-methyl- |
| P.570 | difluoromethyl | cyano | bond | (pyrid-2-yl)-methyl- |
| P.571 | difluoromethyl | cyano | bond | (pyrid-3-yl)-methyl- |
| P.572 | difluoromethyl | cyano | bond | thietan-3-yl- |
| P.573 | difluoromethyl | cyano | bond | 1-oxo-thietan-3-yl- |
| P.574 | difluoromethyl | cyano | bond | 1,1-dioxo-thietan-3-yl- |
| R575 | difluoromethyl | cyano | bond | 3-methyl-thietan-3-yl- |
| P.576 | difluoromethyl | cyano | bond | oxetan-3yl- |
| P.577 | difluoromethyl | cyano | bond | tetrahydropyran-4-yl- |
| P.578 | difluoromethyl | cyano | bond | cyclopropyl- |
| P.579 | difluoromethyl | cyano | bond | 2-cyano-ethyl- |
| P.580 | difluoromethyl | cyano | bond | 2,2-difluoro-ethyl- |
| P.581 | difluoromethyl | cyano | bond | prop-2-ynyl- |
| P.582 | difluoromethyl | cyano | bond | cyclopropylmethyl- |
| P.583 | difluoromethyl | cyano | bond | cyclobutylmethyl- |
| P.584 | difluoromethyl | cyano | bond | 3-cyano-propyl- |
| P.585 | difluoromethyl | cyano | bond | 2-([1′,3′]dioxolan-2′-yl)- |
| | | | | eth-1-yl- |
| P.586 | difluoromethyl | cyano | bond | (2-chloro-pyrid-5-yl)- |
| | | | | methyl- |
| P.587 | difluoromethyl | cyano | bond | tetrahydro-pyran-2-ylmethyl- |
| P.588 | difluoromethyl | cyano | bond | allyl- |
| P.589 | difluoromethyl | cyano | bond | 3-methyl-but-2-enyl- |
| P.590 | difluoromethyl | cyano | bond | butyl- |
| P.591 | difluoromethyl | cyano | bond | but-2-ynyl- |
| P.592 | difluoromethyl | cyano | bond | 2-methoxyimino-propyl |
| P.593 | difluoromethyl | cyano | bond | (2,6-difluoro-phenyl)- |
| | | | | methyl- |
| P.594 | difluoromethyl | cyano | bond | (4-fluoro-phenyl)-methyl- |
| P.595 | difluoromethyl | cyano | bond | 3-phenyl-propyl- |
| P.596 | difluoromethyl | cyano | bond | 2,5-dimethyl-2H- |
| | | | | [1,2,3]triazol- |
| | | | | 4-ylmethyl- |
| P.597 | difluoromethyl | cyano | bond | cyclohexylmethyl- |
| P.598 | difluoromethyl | cyano | bond | (tetrahydrofuran-2-yl)- |
| | | | | methyl- |
| P.599 | difluoromethyl | cyano | bond | 5-trifluoromethyl-furan- |
| | | | | 2-ylmethyl- |
| P.600 | difluoromethyl | cyano | bond | isopropyl- |
| P.601 | difluoromethyl | cyclopropyl | bond | hydrogen |
| P.602 | difluoromethyl | cyclopropyl | bond | methyl- |
| P.603 | difluoromethyl | cyclopropyl | bond | ethyl- |
| P.604 | difluoromethyl | cyclopropyl | bond | 2,2,2-trifluoro-ethyl- |
| P.605 | difluoromethyl | cyclopropyl | bond | 3,3,3-trifluoro-propyl- |
| P.606 | difluoromethyl | cyclopropyl | bond | 2-methoxy-ethyl- |
| P.607 | difluoromethyl | cyclopropyl | bond | 2-hydroxy-ethyl- |
| P.608 | difluoromethyl | cyclopropyl | bond | cyclobutyl- |
| P.609 | difluoromethyl | cyclopropyl | bond | phenyl-methyl- |
| P.610 | difluoromethyl | cyclopropyl | bond | (pyrid-2-yl)-methyl- |
| P.611 | difluoromethyl | cyclopropyl | bond | (pyrid-3-yl)-methyl- |
| P.612 | difluoromethyl | cyclopropyl | bond | thietan-3-yl- |
| P.613 | difluoromethyl | cyclopropyl | bond | 1-oxo-thietan-3-yl- |
| P.614 | difluoromethyl | cyclopropyl | bond | 1,1-dioxo-thietan-3-yl- |
| P.615 | difluoromethyl | cyclopropyl | bond | 3-methyl-thietan-3-yl- |
| P.616 | difluoromethyl | cyclopropyl | bond | oxetan-3yl- |
| P.617 | difluoromethyl | cyclopropyl | bond | tetrahydropyran-4-yl- |
| P.618 | difluoromethyl | cyclopropyl | bond | cyclopropyl- |
| P.619 | difluoromethyl | cyclopropyl | bond | 2-cyano-ethyl- |
| P.620 | difluoromethyl | cyclopropyl | bond | 2,2-difluoro-ethyl- |
| P.621 | difluoromethyl | cyclopropyl | bond | prop-2-ynyl- |
| P.622 | difluoromethyl | cyclopropyl | bond | cyclopropylmethyl- |
| P.623 | difluoromethyl | cyclopropyl | bond | cyclobutylmethyl- |
| P.624 | difluoromethyl | cyclopropyl | bond | 3-cyano-propyl- |
| P.625 | difluoromethyl | cyclopropyl | bond | 2-([1′,3′]dioxolan-2′-yl)- |
| | | | | eth-1-yl- |
| P.626 | difluoromethyl | cyclopropyl | bond | (2-chloro-pyrid-5-yl)- |
| | | | | methyl- |
| P.627 | difluoromethyl | cyclopropyl | bond | tetrahydro-pyran-2-ylmethyl- |
| P.628 | difluoromethyl | cyclopropyl | bond | allyl- |
| P.629 | difluoromethyl | cyclopropyl | bond | 3-methyl-but-2-enyl- |
| P.630 | difluoromethyl | cyclopropyl | bond | butyl- |
| P.631 | difluoromethyl | cyclopropyl | bond | but-2-ynyl- |
| P.632 | difluoromethyl | cyclopropyl | bond | 2-methoxyimino-propyl |
| P.633 | difluoromethyl | cyclopropyl | bond | (2,6-difluoro-phenyl)- |
| | | | | methyl- |
| P.634 | difluoromethyl | cyclopropyl | bond | (4-fluoro-phenyl)-methyl- |
| P.635 | difluoromethyl | cyclopropyl | bond | 3-phenyl-propyl- |
| P.636 | difluoromethyl | cyclopropyl | bond | 2,5-dimethyl-2H- |
| | | | | [1,2,3]triazol- |
| | | | | 4-ylmethyl- |
| P.637 | difluoromethyl | cyclopropyl | bond | cyclohexylmethyl- |
| P.638 | difluoromethyl | cyclopropyl | bond | (tetrahydrofuran-2-yl)- |
| | | | | methyl- |
| P.639 | difluoromethyl | cyclopropyl | bond | 5-trifluoromethyl-furan- |
| | | | | 2-ylmethyl- |
| P.640 | difluoromethyl | cyclopropyl | bond | isopropyl- |
| P.641 | difluoromethyl | ethyl | bond | hydrogen |
| P.642 | difluoromethyl | ethyl | bond | methyl- |
| P.643 | difluoromethyl | ethyl | bond | ethyl- |
| P.644 | difluoromethyl | ethyl | bond | 2,2,2-trifluoro-ethyl- |
| P.645 | difluoromethyl | ethyl | bond | 3,3,3-trifluoro-propyl- |
| P.646 | difluoromethyl | ethyl | bond | 2-methoxy-ethyl- |
| P.647 | difluoromethyl | ethyl | bond | 2-hydroxy-ethyl- |
| P.648 | difluoromethyl | ethyl | bond | cyclobutyl- |
| P.649 | difluoromethyl | ethyl | bond | phenyl-methyl- |
| P.650 | difluoromethyl | ethyl | bond | (pyrid-2-yl)-methyl- |
| P.651 | difluoromethyl | ethyl | bond | (pyrid-3-yl)-methyl- |
| P.652 | difluoromethyl | ethyl | bond | thietan-3-yl- |
| P.653 | difluoromethyl | ethyl | bond | 1-oxo-thietan-3-yl- |
| P.654 | difluoromethyl | ethyl | bond | 1,1-dioxo-thietan-3-yl- |
| P.655 | difluoromethyl | ethyl | bond | 3-methyl-thietan-3-yl- |
| P.656 | difluoromethyl | ethyl | bond | oxetan-3yl- |
| P.657 | difluoromethyl | ethyl | bond | tetrahydropyran-4-yl- |
| P.658 | difluoromethyl | ethyl | bond | cyclopropyl- |
| P.659 | difluoromethyl | ethyl | bond | 2-cyano-ethyl- |
| P.660 | difluoromethyl | ethyl | bond | 2,2-difluoro-ethyl- |
| P.661 | difluoromethyl | ethyl | bond | prop-2-ynyl- |
| P.662 | difluoromethyl | ethyl | bond | cyclopropylmethyl- |
| P.663 | difluoromethyl | ethyl | bond | cyclobutylmethyl- |
| P.664 | difluoromethyl | ethyl | bond | 3-cyano-propyl- |
| P.665 | difluoromethyl | ethyl | bond | 2-([1′,3′]dioxolan-2′-yl)- |
| | | | | eth-1-yl- |
| P.666 | difluoromethyl | ethyl | bond | (2-chloro-pyrid-5-yl)- |
| | | | | methyl- |
| P.667 | difluoromethyl | ethyl | bond | tetrahydro-pyran-2-ylmethyl- |
| P.668 | difluoromethyl | ethyl | bond | allyl- |
| P.669 | difluoromethyl | ethyl | bond | 3-methyl-but-2-enyl- |
| P.670 | difluoromethyl | ethyl | bond | butyl- |
| P.671 | difluoromethyl | ethyl | bond | but-2-ynyl- |
| P.672 | difluoromethyl | ethyl | bond | 2-methoxyimino-propyl |
| P.673 | difluoromethyl | ethyl | bond | (2,6-difluoro-phenyl)- |
| | | | | methyl- |
| P.674 | difluoromethyl | ethyl | bond | (4-fluoro-phenyl)-methyl- |
| P.675 | difluoromethyl | ethyl | bond | 3-phenyl-propyl- |
| P.676 | difluoromethyl | ethyl | bond | 2,5-dimethyl-2H- |
| | | | | [1,2,3]triazol- |
| | | | | 4-ylmethyl- |
| P.677 | difluoromethyl | ethyl | bond | cyclohexylmethyl- |
| P.678 | difluoromethyl | ethyl | bond | (tetrahydrofuran-2-yl)- |
| | | | | methyl- |
| P.679 | difluoromethyl | ethyl | bond | 5-trifluoromethyl-furan- |
| | | | | 2-ylmethyl- |
| P.680 | difluoromethyl | fluoro | bond | isopropyl- |
| P.681 | difluoromethyl | fluoro | bond | hydrogen |
| P.682 | difluoromethyl | fluoro | bond | methyl- |
| P.683 | difluoromethyl | fluoro | bond | ethyl- |
| P.684 | difluoromethyl | fluoro | bond | 2,2,2-trifluoro-ethyl- |
| P.685 | difluoromethyl | fluoro | bond | 3,3,3-trifluoro-propyl- |
| P.686 | difluoromethyl | fluoro | bond | 2-methoxy-ethyl- |
| P.687 | difluoromethyl | fluoro | bond | 2-hydroxy-ethyl- |
| P.688 | difluoromethyl | fluoro | bond | cyclobutyl- |
| P.689 | difluoromethyl | fluoro | bond | phenyl-methyl- |
| P.690 | difluoromethyl | fluoro | bond | (pyrid-2-yl)-methyl- |
| P.691 | difluoromethyl | fluoro | bond | (pyrid-3-yl)-methyl- |
| P.692 | difluoromethyl | fluoro | bond | thietan-3-yl- |
| P.693 | difluoromethyl | fluoro | bond | 1-oxo-thietan-3-yl- |
| P.694 | difluoromethyl | fluoro | bond | 1,1-dioxo-thietan-3-yl- |
| P.695 | difluoromethyl | fluoro | bond | 3-methyl-thietan-3-yl- |
| P.696 | difluoromethyl | fluoro | bond | oxetan-3yl- |
| P.697 | difluoromethyl | fluoro | bond | tetrahydropyran-4-yl- |
| P.698 | difluoromethyl | fluoro | bond | cyclopropyl- |
| P.699 | difluoromethyl | fluoro | bond | 2-cyano-ethyl- |
| P.700 | difluoromethyl | fluoro | bond | 2,2-difluoro-ethyl- |
| P.701 | difluoromethyl | fluoro | bond | prop-2-ynyl- |
| P.702 | difluoromethyl | fluoro | bond | cyclopropylmethyl- |
| P.703 | difluoromethyl | fluoro | bond | cyclobutylmethyl- |
| P.704 | difluoromethyl | fluoro | bond | 3-cyano-propyl- |
| P.705 | difluoromethyl | fluoro | bond | 2-([1′,3′]dioxolan-2′-yl)- |
| | | | | eth-1-yl- |
| P.706 | difluoromethyl | fluoro | bond | (2-chloro-pyrid-5-yl)- |
| | | | | methyl- |
| P.707 | difluoromethyl | fluoro | bond | tetrahydro-pyran-2-ylmethyl- |
| P.708 | difluoromethyl | fluoro | bond | allyl- |
| P.709 | difluoromethyl | fluoro | bond | 3-methyl-but-2-enyl- |
| P.710 | difluoromethyl | fluoro | bond | butyl- |
| P.711 | difluoromethyl | fluoro | bond | but-2-ynyl- |
| P.712 | difluoromethyl | fluoro | bond | 2-methoxyimino-propyl |
| P.713 | difluoromethyl | fluoro | bond | (2,6-difluoro-phenyl)- |
| | | | | methyl- |
| P.714 | difluoromethyl | fluoro | bond | (4-fluoro-phenyl)-methyl- |
| P.715 | difluoromethyl | fluoro | bond | 3-phenyl-propyl- |
| P.716 | difluoromethyl | fluoro | bond | 2,5-dimethyl-2H- |
| | | | | [1,2,3]triazol- |
| | | | | 4-ylmethyl- |
| P.717 | difluoromethyl | fluoro | bond | cyclohexylmethyl- |
| P.718 | difluoromethyl | fluoro | bond | (tetrahydrofuran-2-yl)- |
| | | | | methyl- |
| P.719 | difluoromethyl | fluoro | bond | 5-trifluoromethyl-furan- |
| | | | | 2-ylmethyl- |
| P.720 | difluoromethyl | fluoro | bond | isopropyl- |
| P.721 | difluoromethyl | hydrogen | bond | hydrogen |
| P.722 | difluoromethyl | hydrogen | bond | methyl- |
| P.723 | difluoromethyl | hydrogen | bond | ethyl- |
| P.724 | difluoromethyl | hydrogen | bond | 2,2,2-trifluoro-ethyl- |
| P.725 | difluoromethyl | hydrogen | bond | 3,3,3-trifluoro-propyl- |
| P.726 | difluoromethyl | hydrogen | bond | 2-methoxy-ethyl- |
| P.727 | difluoromethyl | hydrogen | bond | 2-hydroxy-ethyl- |
| P.728 | difluoromethyl | hydrogen | bond | cyclobutyl- |
| P.729 | difluoromethyl | hydrogen | bond | phenyl-methyl- |
| P.730 | difluoromethyl | hydrogen | bond | (pyrid-2-yl)-methyl- |
| P.731 | difluoromethyl | hydrogen | bond | (pyrid-3-yl)-methyl- |
| P.732 | difluoromethyl | hydrogen | bond | thietan-3-yl- |
| P.733 | difluoromethyl | hydrogen | bond | 1-oxo-thietan-3-yl- |
| P.734 | difluoromethyl | hydrogen | bond | 1,1-dioxo-thietan-3-yl- |
| P.735 | difluoromethyl | hydrogen | bond | 3-methyl-thietan-3-yl- |
| P.736 | difluoromethyl | hydrogen | bond | oxetan-3yl- |
| P.737 | difluoromethyl | hydrogen | bond | tetrahydropyran-4-yl- |
| P.738 | difluoromethyl | hydrogen | bond | cyclopropyl- |
| P.739 | difluoromethyl | hydrogen | bond | 2-cyano-ethyl- |
| P.740 | difluoromethyl | hydrogen | bond | 2,2-difluoro-ethyl- |
| P.741 | difluoromethyl | hydrogen | bond | prop-2-ynyl- |
| P.742 | difluoromethyl | hydrogen | bond | cyclopropylmethyl- |
| P.743 | difluoromethyl | hydrogen | bond | cyclobutylmethyl- |
| P.744 | difluoromethyl | hydrogen | bond | 3-cyano-propyl- |
| P.745 | difluoromethyl | hydrogen | bond | 2-([1′,3′]dioxolan-2′-yl)- |
| | | | | eth-1-yl- |
| P.746 | difluoromethyl | hydrogen | bond | (2-chloro-pyrid-5-yl)- |
| | | | | methyl- |
| P.747 | difluoromethyl | hydrogen | bond | tetrahydro-pyran-2-ylmethyl- |
| P.748 | difluoromethyl | hydrogen | bond | allyl- |
| P.749 | difluoromethyl | hydrogen | bond | 3-methyl-but-2-enyl- |
| P.750 | difluoromethyl | hydrogen | bond | butyl- |
| P.751 | difluoromethyl | hydrogen | bond | but-2-ynyl- |
| P.752 | difluoromethyl | hydrogen | bond | 2-methoxyimino-propyl |
| P.753 | difluoromethyl | hydrogen | bond | (2,6-difluoro-phenyl)- |
| | | | | methyl- |
| P.754 | difluoromethyl | hydrogen | bond | (4-fluoro-phenyl)-methyl- |
| P.755 | difluoromethyl | hydrogen | bond | 3-phenyl-propyl- |
| P.756 | difluoromethyl | hydrogen | bond | 2,5-dimethyl-2H- |
| | | | | [1,2,3]triazol- |
| | | | | 4-ylmethyl- |
| P.757 | difluoromethyl | hydrogen | bond | cyclohexylmethyl- |
| P.758 | difluoromethyl | hydrogen | bond | (tetrahydrofuran-2-yl)- |
| | | | | methyl- |
| P.759 | difluoromethyl | hydrogen | bond | 5-trifluoromethyl-furan- |
| | | | | 2-ylmethyl- |
| P.760 | difluoromethyl | hydrogen | bond | isopropyl- |
| P.761 | difluoromethyl | methoxy | bond | hydrogen |
| P.762 | difluoromethyl | methoxy | bond | methyl- |
| P.763 | difluoromethyl | methoxy | bond | ethyl- |
| P.764 | difluoromethyl | methoxy | bond | 2,2,2-trifluoro-ethyl- |
| P.765 | difluoromethyl | methoxy | bond | 3,3,3-trifluoro-propyl- |
| P.766 | difluoromethyl | methoxy | bond | 2-methoxy-ethyl- |
| P.767 | difluoromethyl | methoxy | bond | 2-hydroxy-ethyl- |
| P.768 | difluoromethyl | methoxy | bond | cyclobutyl- |
| P.769 | difluoromethyl | methoxy | bond | phenyl-methyl- |
| P.770 | difluoromethyl | methoxy | bond | (pyrid-2-yl)-methyl- |
| P.771 | difluoromethyl | methoxy | bond | (pyrid-3-yl)-methyl- |
| P.772 | difluoromethyl | methoxy | bond | thietan-3-yl- |
| P.773 | difluoromethyl | methoxy | bond | 1-oxo-thietan-3-yl- |
| P.774 | difluoromethyl | methoxy | bond | 1,1-dioxo-thietan-3-yl- |
| P.775 | difluoromethyl | methoxy | bond | 3-methyl-thietan-3-yl- |
| P.776 | difluoromethyl | methoxy | bond | oxetan-3yl- |
| P.777 | difluoromethyl | methoxy | bond | tetrahydropyran-4-yl- |
| P.778 | difluoromethyl | methoxy | bond | cyclopropyl- |
| P.779 | difluoromethyl | methoxy | bond | 2-cyano-ethyl- |
| P.780 | difluoromethyl | methoxy | bond | 2,2-difluoro-ethyl- |
| P.781 | difluoromethyl | methoxy | bond | prop-2-ynyl- |
| P.782 | difluoromethyl | methoxy | bond | cyclopropylmethyl- |
| P.783 | difluoromethyl | methoxy | bond | cyclobutylmethyl- |
| P.784 | difluoromethyl | methoxy | bond | 3-cyano-propyl- |
| P.785 | difluoromethyl | methoxy | bond | 2-([1′,3′]dioxolan-2′-yl)- |
| | | | | eth-1-yl- |
| P.786 | difluoromethyl | methoxy | bond | (2-chloro-pyrid-5-yl)- |
| | | | | methyl- |
| P.787 | difluoromethyl | methoxy | bond | tetrahydro-pyran-2-ylmethyl- |
| P.788 | difluoromethyl | methoxy | bond | allyl- |
| P.789 | difluoromethyl | methoxy | bond | 3-methyl-but-2-enyl- |
| P.790 | difluoromethyl | methoxy | bond | butyl- |
| P.791 | difluoromethyl | methoxy | bond | but-2-ynyl- |
| P.792 | difluoromethyl | methoxy | bond | 2-methoxyimino-propyl |
| P.793 | difluoromethyl | methoxy | bond | (2,6-difluoro-phenyl)- |
| | | | | methyl- |
| P.794 | difluoromethyl | methoxy | bond | (4-fluoro-phenyl)-methyl- |
| P.795 | difluoromethyl | methoxy | bond | 3-phenyl-propyl- |
| P.796 | difluoromethyl | methoxy | bond | 2,5-dimethyl-2H- |
| | | | | [1,2,3]triazol- |
| | | | | 4-ylmethyl- |
| P.797 | difluoromethyl | methoxy | bond | cyclohexylmethyl- |
| P.798 | difluoromethyl | methoxy | bond | (tetrahydrofuran-2-yl)- |
| | | | | methyl- |
| P.799 | difluoromethyl | methoxy | bond | 5-trifluoromethyl-furan- |
| | | | | 2-ylmethyl- |
| P.800 | difluoromethyl | methoxy | bond | isopropyl- |
| P.801 | difluoromethyl | methyl | bond | hydrogen |
| P.802 | difluoromethyl | methyl | bond | methyl- |
| P.803 | difluoromethyl | methyl | bond | ethyl- |
| P.804 | difluoromethyl | methyl | bond | 2,2,2-trifluoro-ethyl- |
| P.805 | difluoromethyl | methyl | bond | 3,3,3-trifluoro-propyl- |
| P.806 | difluoromethyl | methyl | bond | 2-methoxy-ethyl- |
| P.807 | difluoromethyl | methyl | bond | 2-hydroxy-ethyl- |
| P.808 | difluoromethyl | methyl | bond | cyclobutyl- |
| P.809 | difluoromethyl | methyl | bond | phenyl-methyl- |
| P.810 | difluoromethyl | methyl | bond | (pyrid-2-yl)-methyl- |
| P.811 | difluoromethyl | methyl | bond | (pyrid-3-yl)-methyl- |
| P.812 | difluoromethyl | methyl | bond | thietan-3-yl- |
| P.813 | difluoromethyl | methyl | bond | 1-oxo-thietan-3-yl- |
| P.814 | difluoromethyl | methyl | bond | 1,1-dioxo-thietan-3-yl- |
| P.815 | difluoromethyl | methyl | bond | 3-methyl-thietan-3-yl- |
| P.816 | difluoromethyl | methyl | bond | oxetan-3yl- |
| P.817 | difluoromethyl | methyl | bond | tetrahydropyran-4-yl- |
| P.818 | difluoromethyl | methyl | bond | cyclopropyl- |
| P.819 | difluoromethyl | methyl | bond | 2-cyano-ethyl- |
| P.820 | difluoromethyl | methyl | bond | 2,2-difluoro-ethyl- |
| P.821 | difluoromethyl | methyl | bond | prop-2-ynyl- |
| P.822 | difluoromethyl | methyl | bond | cyclopropylmethyl- |
| P.823 | difluoromethyl | methyl | bond | cyclobutylmethyl- |
| P.824 | difluoromethyl | methyl | bond | 3-cyano-propyl- |
| P.825 | difluoromethyl | methyl | bond | 2-([1′,3′]dioxolan-2′-yl)- |
| | | | | eth-1-yl- |
| P.826 | difluoromethyl | methyl | bond | (2-chloro-pyrid-5-yl)- |
| | | | | methyl- |
| P.827 | difluoromethyl | methyl | bond | tetrahydro-pyran-2-ylmethyl- |
| P.828 | difluoromethyl | methyl | bond | allyl- |
| P.829 | difluoromethyl | methyl | bond | 3-methyl-but-2-enyl- |
| P.830 | difluoromethyl | methyl | bond | butyl- |
| P.831 | difluoromethyl | methyl | bond | but-2-ynyl- |
| P.832 | difluoromethyl | methyl | bond | 2-methoxyimino-propyl |
| P.833 | difluoromethyl | methyl | bond | (2,6-difluoro-phenyl)- |
| | | | | methyl- |
| P.834 | difluoromethyl | methyl | bond | (4-fluoro-phenyl)-methyl- |
| P.835 | difluoromethyl | methyl | bond | 3-phenyl-propyl- |
| P.836 | difluoromethyl | methyl | bond | 2,5-dimethyl-2H- |
| | | | | [1,2,3]triazol- |
| | | | | 4-ylmethyl- |
| P.837 | difluoromethyl | methyl | bond | cyclohexylmethyl- |
| P.838 | difluoromethyl | methyl | bond | (tetrahydrofuran-2-yl)- |
| | | | | methyl- |
| P.839 | difluoromethyl | methyl | bond | 5-trifluoromethyl-furan- |
| | | | | 2-ylmethyl- |
| P.840 | difluoromethyl | methyl | bond | isopropyl- |
| P.841 | difluoromethyl | nitro | bond | hydrogen |
| P.842 | difluoromethyl | nitro | bond | methyl- |
| P.843 | difluoromethyl | nitro | bond | ethyl- |
| P.844 | difluoromethyl | nitro | bond | 2,2,2-trifluoro-ethyl- |
| P.845 | difluoromethyl | nitro | bond | 3,3,3-trifluoro-propyl- |
| P.846 | difluoromethyl | nitro | bond | 2-methoxy-ethyl- |
| P.847 | difluoromethyl | nitro | bond | 2-hydroxy-ethyl- |
| P.848 | difluoromethyl | nitro | bond | cyclobutyl- |
| P.849 | difluoromethyl | nitro | bond | phenyl-methyl- |
| P.850 | difluoromethyl | nitro | bond | (pyrid-2-yl)-methyl- |
| P.851 | difluoromethyl | nitro | bond | (pyrid-3-yl)-methyl- |
| P.852 | difluoromethyl | nitro | bond | thietan-3-yl- |
| P.853 | difluoromethyl | nitro | bond | 1-oxo-thietan-3-yl- |
| P.854 | difluoromethyl | nitro | bond | 1,1-dioxo-thietan-3-yl- |
| P.855 | difluoromethyl | nitro | bond | 3-methyl-thietan-3-yl- |
| P.856 | difluoromethyl | nitro | bond | oxetan-3yl- |
| P.857 | difluoromethyl | nitro | bond | tetrahydropyran-4-yl- |
| P.858 | difluoromethyl | nitro | bond | cyclopropyl- |
| P.859 | difluoromethyl | nitro | bond | 2-cyano-ethyl- |
| P.860 | difluoromethyl | nitro | bond | 2,2-difluoro-ethyl- |
| P.861 | difluoromethyl | nitro | bond | prop-2-ynyl- |
| P.862 | difluoromethyl | nitro | bond | cyclopropylmethyl- |
| P.863 | difluoromethyl | nitro | bond | cyclobutylmethyl- |
| P.864 | difluoromethyl | nitro | bond | 3-cyano-propyl- |
| P.865 | difluoromethyl | nitro | bond | 2-([1′,3′]dioxolan-2′-yl)- |
| | | | | eth-1-yl- |
| P.866 | difluoromethyl | nitro | bond | (2-chloro-pyrid-5-yl)- |
| | | | | methyl- |
| P.867 | difluoromethyl | nitro | bond | tetrahydro-pyran-2-ylmethyl- |
| P.868 | difluoromethyl | nitro | bond | allyl- |
| P.869 | difluoromethyl | nitro | bond | 3-methyl-but-2-enyl- |
| P.870 | difluoromethyl | nitro | bond | butyl- |
| P.871 | difluoromethyl | nitro | bond | but-2-ynyl- |
| P.872 | difluoromethyl | nitro | bond | 2-methoxyimino-propyl |
| P.873 | difluoromethyl | nitro | bond | (2,6-difluoro-phenyl)- |
| | | | | methyl- |
| P.874 | difluoromethyl | nitro | bond | (4-fluoro-phenyl)-methyl- |
| P.875 | difluoromethyl | nitro | bond | 3-phenyl-propyl- |
| P.876 | difluoromethyl | nitro | bond | 2,5-dimethyl-2H- |
| | | | | [1,2,3]triazol- |
| | | | | 4-ylmethyl- |
| P.877 | difluoromethyl | nitro | bond | cyclohexylmethyl- |
| P.878 | difluoromethyl | nitro | bond | (tetrahydrofuran-2-yl)- |
| | | | | methyl- |
| P.879 | difluoromethyl | nitro | bond | 5-trifluoromethyl-furan- |
| | | | | 2-ylmethyl- |
| P.880 | difluoromethyl | nitro | bond | isopropyl- |
| P.881 | difluoromethyl | trifluoromethoxy | bond | hydrogen |
| P.882 | difluoromethyl | trifluoromethoxy | bond | methyl- |
| P.883 | difluoromethyl | trifluoromethoxy | bond | ethyl- |
| P.884 | difluoromethyl | trifluoromethoxy | bond | 2,2,2-trifluoro-ethyl- |
| P.885 | difluoromethyl | trifluoromethoxy | bond | 3,3,3-trifluoro-propyl- |
| P.886 | difluoromethyl | trifluoromethoxy | bond | 2-methoxy-ethyl- |
| P.887 | difluoromethyl | trifluoromethoxy | bond | 2-hydroxy-ethyl- |
| P.888 | difluoromethyl | trifluoromethoxy | bond | cyclobutyl- |
| P.889 | difluoromethyl | trifluoromethoxy | bond | phenyl-methyl- |
| P.890 | difluoromethyl | trifluoromethoxy | bond | (pyrid-2-yl)-methyl- |
| P.891 | difluoromethyl | trifluoromethoxy | bond | (pyrid-3-yl)-methyl- |
| P.892 | difluoromethyl | trifluoromethoxy | bond | thietan-3-yl- |
| P.893 | difluoromethyl | trifluoromethoxy | bond | 1-oxo-thietan-3-yl- |
| P.894 | difluoromethyl | trifluoromethoxy | bond | 1,1-dioxo-thietan-3-yl- |
| P.895 | difluoromethyl | trifluoromethoxy | bond | 3-methyl-thietan-3-yl- |
| P.896 | difluoromethyl | trifluoromethoxy | bond | oxetan-3yl- |
| P.897 | difluoromethyl | trifluoromethoxy | bond | tetrahydropyran-4-yl- |
| P.898 | difluoromethyl | trifluoromethoxy | bond | cyclopropyl- |
| P.899 | difluoromethyl | trifluoromethoxy | bond | 2-cyano-ethyl- |
| P.900 | difluoromethyl | trifluoromethoxy | bond | 2,2-difluoro-ethyl- |
| P.901 | difluoromethyl | trifluoromethoxy | bond | prop-2-ynyl- |
| P.902 | difluoromethyl | trifluoromethoxy | bond | cyclopropylmethyl- |
| P.903 | difluoromethyl | trifluoromethoxy | bond | cyclobutylmethyl- |
| P.904 | difluoromethyl | trifluoromethoxy | bond | 3-cyano-propyl- |
| P.905 | difluoromethyl | trifluoromethoxy | bond | 2-([1′,3′]dioxolan-2′-yl)- |
| | | | | eth-1-yl- |
| P.906 | difluoromethyl | trifluoromethoxy | bond | (2-chloro-pyrid-5-yl)- |
| | | | | methyl- |
| P.907 | difluoromethyl | trifluoromethoxy | bond | tetrahydro-pyran-2-ylmethyl- |
| P.908 | difluoromethyl | trifluoromethoxy | bond | allyl- |
| P.909 | difluoromethyl | trifluoromethoxy | bond | 3-methyl-but-2-enyl- |
| P.910 | difluoromethyl | trifluoromethoxy | bond | butyl- |
| P.911 | difluoromethyl | trifluoromethoxy | bond | but-2-ynyl- |
| P.912 | difluoromethyl | trifluoromethoxy | bond | 2-methoxyimino-propyl |
| P.913 | difluoromethyl | trifluoromethoxy | bond | (2,6-difluoro-phenyl)- |
| | | | | methyl- |
| P.914 | difluoromethyl | trifluoromethoxy | bond | (4-fluoro-phenyl)-methyl- |
| P.915 | difluoromethyl | trifluoromethoxy | bond | 3-phenyl-propyl- |
| P.916 | difluoromethyl | trifluoromethoxy | bond | 2,5-dimethyl-2H- |
| | | | | [1,2,3]triazol- |
| | | | | 4-ylmethyl- |
| P.917 | difluoromethyl | trifluoromethoxy | bond | cyclohexylmethyl- |
| P.918 | difluoromethyl | trifluoromethoxy | bond | (tetrahydrofuran-2-yl)- |
| | | | | methyl- |
| P.919 | difluoromethyl | trifluoromethoxy | bond | 5-trifluoromethyl-furan- |
| | | | | 2-ylmethyl- |
| P.920 | difluoromethyl | trifluoromethoxy | bond | isopropyl- |
| P.921 | difluoromethyl | trifluoromethyl | bond | hydrogen |
| P.922 | difluoromethyl | trifluoromethyl | bond | methyl- |
| P.923 | difluoromethyl | trifluoromethyl | bond | ethyl- |
| P.924 | difluoromethyl | trifluoromethyl | bond | 2,2,2-trifluoro-ethyl- |
| P.925 | difluoromethyl | trifluoromethyl | bond | 3,3,3-trifluoro-propyl- |
| P.926 | difluoromethyl | trifluoromethyl | bond | 2-methoxy-ethyl- |
| P.927 | difluoromethyl | trifluoromethyl | bond | 2-hydroxy-ethyl- |
| P.928 | difluoromethyl | trifluoromethyl | bond | cyclobutyl- |
| P.929 | difluoromethyl | trifluoromethyl | bond | phenyl-methyl- |
| P.930 | difluoromethyl | trifluoromethyl | bond | (pyrid-2-yl)-methyl- |
| P.931 | difluoromethyl | trifluoromethyl | bond | (pyrid-3-yl)-methyl- |
| P.932 | difluoromethyl | trifluoromethyl | bond | thietan-3-yl- |
| P.933 | difluoromethyl | trifluoromethyl | bond | 1-oxo-thietan-3-yl- |
| P.934 | difluoromethyl | trifluoromethyl | bond | 1,1-dioxo-thietan-3-yl- |
| P.935 | difluoromethyl | trifluoromethyl | bond | 3-methyl-thietan-3-yl- |
| P.936 | difluoromethyl | trifluoromethyl | bond | oxetan-3yl- |
| P.937 | difluoromethyl | trifluoromethyl | bond | tetrahydropyran-4-yl- |
| P.938 | difluoromethyl | trifluoromethyl | bond | cyclopropyl- |
| P.939 | difluoromethyl | trifluoromethyl | bond | 2-cyano-ethyl- |
| P.940 | difluoromethyl | trifluoromethyl | bond | 2,2-difluoro-ethyl- |
| P.941 | difluoromethyl | trifluoromethyl | bond | prop-2-ynyl- |
| P.942 | difluoromethyl | trifluoromethyl | bond | cyclopropylmethyl- |
| P.943 | difluoromethyl | trifluoromethyl | bond | cyclobutylmethyl- |
| P.944 | difluoromethyl | trifluoromethyl | bond | 3-cyano-propyl- |
| P.945 | difluoromethyl | trifluoromethyl | bond | 2-([1′,3′]dioxolan-2′-yl)- |
| | | | | eth-1-yl- |
| P.946 | difluoromethyl | trifluoromethyl | bond | (2-chloro-pyrid-5-yl)- |
| | | | | methyl- |
| P.947 | difluoromethyl | trifluoromethyl | bond | tetrahydro-pyran-2-ylmethyl- |
| P.948 | difluoromethyl | trifluoromethyl | bond | allyl- |
| P.949 | difluoromethyl | trifluoromethyl | bond | 3-methyl-but-2-enyl- |
| P.950 | difluoromethyl | trifluoromethyl | bond | butyl- |
| P.951 | difluoromethyl | trifluoromethyl | bond | but-2-ynyl- |
| P.952 | difluoromethyl | trifluoromethyl | bond | 2-methoxyimino-propyl |
| P.953 | difluoromethyl | trifluoromethyl | bond | (2,6-difluoro-phenyl)- |
| | | | | methyl- |
| P.954 | difluoromethyl | trifluoromethyl | bond | (4-fluoro-phenyl)-methyl- |
| P.955 | difluoromethyl | trifluoromethyl | bond | 3-phenyl-propyl- |
| P.956 | difluoromethyl | trifluoromethyl | bond | 2,5-dimethyl-2H- |
| | | | | [1,2,3]triazol- |
| | | | | 4-ylmethyl- |
| P.957 | difluoromethyl | trifluoromethyl | bond | cyclohexylmethyl- |
| P.958 | difluoromethyl | trifluoromethyl | bond | (tetrahydrofuran-2-yl)- |
| | | | | methyl- |
| P.959 | difluoromethyl | trifluoromethyl | bond | 5-trifluoromethyl-furan- |
| | | | | 2-ylmethyl- |
| P.960 | difluoromethyl | trifluoromethyl | bond | isopropyl- |
| P.961 | trifluoromethyl | bromo | bond | hydrogen |
| P.962 | trifluoromethyl | bromo | bond | methyl- |
| P.963 | trifluoromethyl | bromo | bond | ethyl- |
| P.964 | trifluoromethyl | bromo | bond | 2,2,2-trifluoro-ethyl- |
| P.965 | trifluoromethyl | bromo | bond | 3,3,3-trifluoro-propyl- |
| P.966 | trifluoromethyl | bromo | bond | 2-methoxy-ethyl- |
| P.967 | trifluoromethyl | bromo | bond | 2-hydroxy-ethyl- |
| P.968 | trifluoromethyl | bromo | bond | cyclobutyl- |
| P.969 | trifluoromethyl | bromo | bond | phenyl-methyl- |
| P.970 | trifluoromethyl | bromo | bond | (pyrid-2-yl)-methyl- |
| P.971 | trifluoromethyl | bromo | bond | (pyrid-3-yl)-methyl- |
| P.972 | trifluoromethyl | bromo | bond | thietan-3-yl- |
| P.973 | trifluoromethyl | bromo | bond | 1-oxo-thietan-3-yl- |
| P.974 | trifluoromethyl | bromo | bond | 1,1-dioxo-thietan-3-yl- |
| P.975 | trifluoromethyl | bromo | bond | 3-methyl-thietan-3-yl- |
| P.976 | trifluoromethyl | bromo | bond | oxetan-3yl- |
| P.977 | trifluoromethyl | bromo | bond | tetrahydropyran-4-yl- |
| P.978 | trifluoromethyl | bromo | bond | cyclopropyl- |
| P.979 | trifluoromethyl | bromo | bond | 2-cyano-ethyl- |
| P.980 | trifluoromethyl | bromo | bond | 2,2-difluoro-ethyl- |
| P.981 | trifluoromethyl | bromo | bond | prop-2-ynyl- |
| P.982 | trifluoromethyl | bromo | bond | cyclopropylmethyl- |
| P.983 | trifluoromethyl | bromo | bond | cyclobutylmethyl- |
| P.984 | trifluoromethyl | bromo | bond | 3-cyano-propyl- |
| P.985 | trifluoromethyl | bromo | bond | 2-([1′,3′]dioxolan-2′-yl)- |
| | | | | eth-1-yl- |
| P.986 | trifluoromethyl | bromo | bond | (2-chloro-pyrid-5-yl)- |
| | | | | methyl- |
| P.987 | trifluoromethyl | bromo | bond | tetrahydro-pyran-2-ylmethyl- |
| P.988 | trifluoromethyl | bromo | bond | allyl- |
| P.989 | trifluoromethyl | bromo | bond | 3-methyl-but-2-enyl- |
| P.990 | trifluoromethyl | bromo | bond | butyl- |
| P.991 | trifluoromethyl | bromo | bond | but-2-ynyl- |
| P.992 | trifluoromethyl | bromo | bond | 2-methoxyimino-propyl |
| P.993 | trifluoromethyl | bromo | bond | (2,6-difluoro-phenyl)- |
| | | | | methyl- |
| P.994 | trifluoromethyl | bromo | bond | (4-fluoro-phenyl)-methyl- |
| P.995 | trifluoromethyl | bromo | bond | 3-phenyl-propyl- |
| P.996 | trifluoromethyl | bromo | bond | 2,5-dimethyl-2H- |
| | | | | [1,2,3]triazol- |
| | | | | 4-ylmethyl- |
| P.997 | trifluoromethyl | bromo | bond | cyclohexylmethyl- |
| P.998 | trifluoromethyl | bromo | bond | (tetrahydrofuran-2-yl)- |
| | | | | methyl- |
| P.999 | trifluoromethyl | bromo | bond | 5-trifluoromethyl-furan- |
| | | | | 2-ylmethyl- |
| P.1000 | trifluoromethyl | bromo | bond | isopropyl- |
| P.1001 | trifluoromethyl | chloro | bond | hydrogen |
| P.1002 | trifluoromethyl | chloro | bond | methyl- |
| P.1003 | trifluoromethyl | chloro | bond | ethyl- |
| P.1004 | trifluoromethyl | chloro | bond | 2,2,2-trifluoro-ethyl- |
| P.1005 | trifluoromethyl | chloro | bond | 3,3,3-trifluoro-propyl- |
| P.1006 | trifluoromethyl | chloro | bond | 2-methoxy-ethyl- |
| P.1007 | trifluoromethyl | chloro | bond | 2-hydroxy-ethyl- |
| P.1008 | trifluoromethyl | chloro | bond | cyclobutyl- |
| P.1009 | trifluoromethyl | chloro | bond | phenyl-methyl- |
| P.1010 | trifluoromethyl | chloro | bond | (pyrid-2-yl)-methyl- |
| P.1011 | trifluoromethyl | chloro | bond | (pyrid-3-yl)-methyl- |
| P.1012 | trifluoromethyl | chloro | bond | thietan-3-yl- |
| P.1013 | trifluoromethyl | chloro | bond | 1-oxo-thietan-3-yl- |
| P.1014 | trifluoromethyl | chloro | bond | 1,1-dioxo-thietan-3-yl- |
| P.1015 | trifluoromethyl | chloro | bond | 3-methyl-thietan-3-yl- |
| P.1016 | trifluoromethyl | chloro | bond | oxetan-3yl- |
| P.1017 | trifluoromethyl | chloro | bond | tetrahydropyran-4-yl- |
| P.1018 | trifluoromethyl | chloro | bond | cyclopropyl- |
| P.1019 | trifluoromethyl | chloro | bond | 2-cyano-ethyl- |
| P.1020 | trifluoromethyl | chloro | bond | 2,2-difluoro-ethyl- |
| P.1021 | trifluoromethyl | chloro | bond | prop-2-ynyl- |
| P.1022 | trifluoromethyl | chloro | bond | cyclopropylmethyl- |
| P.1023 | trifluoromethyl | chloro | bond | cyclobutylmethyl- |
| P.1024 | trifluoromethyl | chloro | bond | 3-cyano-propyl- |
| P.1025 | trifluoromethyl | chloro | bond | 2-([1′,3′]dioxolan-2′-yl)- |
| | | | | eth-1-yl- |
| P.1026 | trifluoromethyl | chloro | bond | (2-chloro-pyrid-5-yl)- |
| | | | | methyl- |
| P.1027 | trifluoromethyl | chloro | bond | tetrahydro-pyran-2-ylmethyl- |
| P.1028 | trifluoromethyl | chloro | bond | allyl- |
| P.1029 | trifluoromethyl | chloro | bond | 3-methyl-but-2-enyl- |
| P.1030 | trifluoromethyl | chloro | bond | butyl- |
| P.1031 | trifluoromethyl | chloro | bond | but-2-ynyl- |
| P.1032 | trifluoromethyl | chloro | bond | 2-methoxyimino-propyl |
| P.1033 | trifluoromethyl | chloro | bond | (2,6-difluoro-phenyl)- |
| | | | | methyl- |
| P.1034 | trifluoromethyl | chloro | bond | (4-fluoro-phenyl)-methyl- |
| P.1035 | trifluoromethyl | chloro | bond | 3-phenyl-propyl- |
| P.1036 | trifluoromethyl | chloro | bond | 2,5-dimethyl-2H- |
| | | | | [1,2,3]triazol- |
| | | | | 4-ylmethyl- |
| P.1037 | trifluoromethyl | chloro | bond | cyclohexylmethyl- |
| P.1038 | trifluoromethyl | chloro | bond | (tetrahydrofuran-2-yl)- |
| | | | | methyl- |
| P.1039 | trifluoromethyl | chloro | bond | 5-trifluoromethyl-furan- |
| | | | | 2-ylmethyl- |
| P.1040 | trifluoromethyl | chloro | bond | isopropyl- |
| P.1041 | trifluoromethyl | cyano | bond | hydrogen |
| P.1042 | trifluoromethyl | cyano | bond | methyl- |
| P.1043 | trifluoromethyl | cyano | bond | ethyl- |
| P.1044 | trifluoromethyl | cyano | bond | 2,2,2-trifluoro-ethyl- |
| P.1045 | trifluoromethyl | cyano | bond | 3,3,3-trifluoro-propyl- |
| P.1046 | trifluoromethyl | cyano | bond | 2-methoxy-ethyl- |
| P.1047 | trifluoromethyl | cyano | bond | 2-hydroxy-ethyl- |
| P.1048 | trifluoromethyl | cyano | bond | cyclobutyl- |
| P.1049 | trifluoromethyl | cyano | bond | phenyl-methyl- |
| P.1050 | trifluoromethyl | cyano | bond | (pyrid-2-yl)-methyl- |
| P.1051 | trifluoromethyl | cyano | bond | (pyrid-3-yl)-methyl- |
| P.1052 | trifluoromethyl | cyano | bond | thietan-3-yl- |
| P.1053 | trifluoromethyl | cyano | bond | 1-oxo-thietan-3-yl- |
| P.1054 | trifluoromethyl | cyano | bond | 1,1-dioxo-thietan-3-yl- |
| P.1055 | trifluoromethyl | cyano | bond | 3-methyl-thietan-3-yl- |
| P.1056 | trifluoromethyl | cyano | bond | oxetan-3yl- |
| P.1057 | trifluoromethyl | cyano | bond | tetrahydropyran-4-yl- |
| P.1058 | trifluoromethyl | cyano | bond | cyclopropyl- |
| P.1059 | trifluoromethyl | cyano | bond | 2-cyano-ethyl- |
| P.1060 | trifluoromethyl | cyano | bond | 2,2-difluoro-ethyl- |
| P.1061 | trifluoromethyl | cyano | bond | prop-2-ynyl- |
| P.1062 | trifluoromethyl | cyano | bond | cyclopropylmethyl- |
| P.1063 | trifluoromethyl | cyano | bond | cyclobutylmethyl- |
| P.1064 | trifluoromethyl | cyano | bond | 3-cyano-propyl- |
| P.1065 | trifluoromethyl | cyano | bond | 2-([1′,3′]dioxolan-2′-yl)- |
| | | | | eth-1-yl- |
| P.1066 | trifluoromethyl | cyano | bond | (2-chloro-pyrid-5-yl)- |
| | | | | methyl- |
| P.1067 | trifluoromethyl | cyano | bond | tetrahydro-pyran-2-ylmethyl- |
| P.1068 | trifluoromethyl | cyano | bond | allyl- |
| P.1069 | trifluoromethyl | cyano | bond | 3-methyl-but-2-enyl- |
| P.1070 | trifluoromethyl | cyano | bond | butyl- |
| P.1071 | trifluoromethyl | cyano | bond | but-2-ynyl- |
| P.1072 | trifluoromethyl | cyano | bond | 2-methoxyimino-propyl |
| P.1073 | trifluoromethyl | cyano | bond | (2,6-difluoro-phenyl)- |
| | | | | methyl- |
| P.1074 | trifluoromethyl | cyano | bond | (4-fluoro-phenyl)-methyl- |
| P.1075 | trifluoromethyl | cyano | bond | 3-phenyl-propyl- |
| P.1076 | trifluoromethyl | cyano | bond | 2,5-dimethyl-2H- |
| | | | | [1,2,3]triazol- |
| | | | | 4-ylmethyl- |
| P.1077 | trifluoromethyl | cyano | bond | cyclohexylmethyl- |
| P.1078 | trifluoromethyl | cyano | bond | (tetrahydrofuran-2-yl)- |
| | | | | methyl- |
| P.1079 | trifluoromethyl | cyano | bond | 5-trifluoromethyl-furan- |
| | | | | 2-ylmethyl- |
| P.1080 | trifluoromethyl | cyano | bond | isopropyl- |
| P.1081 | trifluoromethyl | cyclopropyl | bond | hydrogen |
| P.1082 | trifluoromethyl | cyclopropyl | bond | methyl- |
| P.1083 | trifluoromethyl | cyclopropyl | bond | ethyl- |
| P.1084 | trifluoromethyl | cyclopropyl | bond | 2,2,2-trifluoro-ethyl- |
| P.1085 | trifluoromethyl | cyclopropyl | bond | 3,3,3-trifluoro-propyl- |
| P.1086 | trifluoromethyl | cyclopropyl | bond | 2-methoxy-ethyl- |
| P.1087 | trifluoromethyl | cyclopropyl | bond | 2-hydroxy-ethyl- |
| P.1088 | trifluoromethyl | cyclopropyl | bond | cyclobutyl- |
| P.1089 | trifluoromethyl | cyclopropyl | bond | phenyl-methyl- |
| P.1090 | trifluoromethyl | cyclopropyl | bond | (pyrid-2-yl)-methyl- |
| P.1091 | trifluoromethyl | cyclopropyl | bond | (pyrid-3-yl)-methyl- |
| P.1092 | trifluoromethyl | cyclopropyl | bond | thietan-3-yl- |
| P.1093 | trifluoromethyl | cyclopropyl | bond | 1-oxo-thietan-3-yl- |
| P.1094 | trifluoromethyl | cyclopropyl | bond | 1,1-dioxo-thietan-3-yl- |
| P.1095 | trifluoromethyl | cyclopropyl | bond | 3-methyl-thietan-3-yl- |
| P.1096 | trifluoromethyl | cyclopropyl | bond | oxetan-3yl- |
| P.1097 | trifluoromethyl | cyclopropyl | bond | tetrahydropyran-4-yl- |
| P.1098 | trifluoromethyl | cyclopropyl | bond | cyclopropyl- |
| P.1099 | trifluoromethyl | cyclopropyl | bond | 2-cyano-ethyl- |
| P.1100 | trifluoromethyl | cyclopropyl | bond | 2,2-difluoro-ethyl- |
| P.1101 | trifluoromethyl | cyclopropyl | bond | prop-2-ynyl- |
| P.1102 | trifluoromethyl | cyclopropyl | bond | cyclopropylmethyl- |
| P.1103 | trifluoromethyl | cyclopropyl | bond | cyclobutylmethyl- |
| P.1104 | trifluoromethyl | cyclopropyl | bond | 3-cyano-propyl- |
| P.1105 | trifluoromethyl | cyclopropyl | bond | 2-([1′,3′]dioxolan-2′-yl)- |
| | | | | eth-1-yl- |
| P.1106 | trifluoromethyl | cyclopropyl | bond | (2-chloro-pyrid-5-yl)- |
| | | | | methyl- |
| P.1107 | trifluoromethyl | cyclopropyl | bond | tetrahydro-pyran-2-ylmethyl- |
| P.1108 | trifluoromethyl | cyclopropyl | bond | allyl- |
| P.1109 | trifluoromethyl | cyclopropyl | bond | 3-methyl-but-2-enyl- |
| P.1110 | trifluoromethyl | cyclopropyl | bond | butyl- |
| P.1111 | trifluoromethyl | cyclopropyl | bond | but-2-ynyl- |
| P.1112 | trifluoromethyl | cyclopropyl | bond | 2-methoxyimino-propyl |
| P.1113 | trifluoromethyl | cyclopropyl | bond | (2,6-difluoro-phenyl)- |
| | | | | methyl- |
| P.1114 | trifluoromethyl | cyclopropyl | bond | (4-fluoro-phenyl)-methyl- |
| P.1115 | trifluoromethyl | cyclopropyl | bond | 3-phenyl-propyl- |
| P.1116 | trifluoromethyl | cyclopropyl | bond | 2,5-dimethyl-2H- |
| | | | | [1,2,3]triazol- |
| | | | | 4-ylmethyl- |
| P.1117 | trifluoromethyl | cyclopropyl | bond | cyclohexylmethyl- |
| P.1118 | trifluoromethyl | cyclopropyl | bond | (tetrahydrofuran-2-yl)- |
| | | | | methyl- |
| P.1119 | trifluoromethyl | cyclopropyl | bond | 5-trifluoromethyl-furan- |
| | | | | 2-ylmethyl- |
| P.1120 | trifluoromethyl | cyclopropyl | bond | isopropyl- |
| P.1121 | trifluoromethyl | ethyl | bond | hydrogen |
| P.1122 | trifluoromethyl | ethyl | bond | methyl- |
| P.1123 | trifluoromethyl | ethyl | bond | ethyl- |
| P.1124 | trifluoromethyl | ethyl | bond | 2,2,2-trifluoro-ethyl- |
| P.1125 | trifluoromethyl | ethyl | bond | 3,3,3-trifluoro-propyl- |
| P.1126 | trifluoromethyl | ethyl | bond | 2-methoxy-ethyl- |
| P.1127 | trifluoromethyl | ethyl | bond | 2-hydroxy-ethyl- |
| P.1128 | trifluoromethyl | ethyl | bond | cyclobutyl- |
| P.1129 | trifluoromethyl | ethyl | bond | phenyl-methyl- |
| P.1130 | trifluoromethyl | ethyl | bond | (pyrid-2-yl)-methyl- |
| P.1131 | trifluoromethyl | ethyl | bond | (pyrid-3-yl)-methyl- |
| P.1132 | trifluoromethyl | ethyl | bond | thietan-3-yl- |
| P.1133 | trifluoromethyl | ethyl | bond | 1-oxo-thietan-3-yl- |
| P.1134 | trifluoromethyl | ethyl | bond | 1,1-dioxo-thietan-3-yl- |
| P.1135 | trifluoromethyl | ethyl | bond | 3-methyl-thietan-3-yl- |
| P.1136 | trifluoromethyl | ethyl | bond | oxetan-3yl- |
| P.1137 | trifluoromethyl | ethyl | bond | tetrahydropyran-4-yl- |
| P.1138 | trifluoromethyl | ethyl | bond | cyclopropyl- |
| P.1139 | trifluoromethyl | ethyl | bond | 2-cyano-ethyl- |
| P.1140 | trifluoromethyl | ethyl | bond | 2,2-difluoro-ethyl- |
| P.1141 | trifluoromethyl | ethyl | bond | prop-2-ynyl- |
| P.1142 | trifluoromethyl | ethyl | bond | cyclopropylmethyl- |
| P.1143 | trifluoromethyl | ethyl | bond | cyclobutylmethyl- |
| P.1144 | trifluoromethyl | ethyl | bond | 3-cyano-propyl- |
| P.1145 | trifluoromethyl | ethyl | bond | 2-([1′,3′]dioxolan-2′-yl)- |
| | | | | eth-1-yl- |
| P.1146 | trifluoromethyl | ethyl | bond | (2-chloro-pyrid-5-yl)- |
| | | | | methyl- |
| P.1147 | trifluoromethyl | ethyl | bond | tetrahydro-pyran-2-ylmethyl- |
| P.1148 | trifluoromethyl | ethyl | bond | allyl- |
| P.1149 | trifluoromethyl | ethyl | bond | 3-methyl-but-2-enyl- |
| P.1150 | trifluoromethyl | ethyl | bond | butyl- |
| P.1151 | trifluoromethyl | ethyl | bond | but-2-ynyl- |
| P.1152 | trifluoromethyl | ethyl | bond | 2-methoxyimino-propyl |
| P.1153 | trifluoromethyl | ethyl | bond | (2,6-difluoro-phenyl)- |
| | | | | methyl- |
| P.1154 | trifluoromethyl | ethyl | bond | (4-fluoro-phenyl)-methyl- |
| P.1155 | trifluoromethyl | ethyl | bond | 3-phenyl-propyl- |
| P.1156 | trifluoromethyl | ethyl | bond | 2,5-dimethyl-2H- |
| | | | | [1,2,3]triazo |
| | | | | 4-ylmethyl- |
| P.1157 | trifluoromethyl | ethyl | bond | cyclohexylmethyl- |
| P.1158 | trifluoromethyl | ethyl | bond | (tetrahydrofuran-2-yl)- |
| | | | | methyl- |
| P.1159 | trifluoromethyl | ethyl | bond | 5-trifluoromethyl-furan- |
| | | | | 2-ylmethyl- |
| P.1160 | trifluoromethyl | fluoro | bond | isopropyl- |
| P.1161 | trifluoromethyl | fluoro | bond | hydrogen |
| P.1162 | trifluoromethyl | fluoro | bond | methyl- |
| P.1163 | trifluoromethyl | fluoro | bond | ethyl- |
| P.1164 | trifluoromethyl | fluoro | bond | 2,2,2-trifluoro-ethyl- |
| P.1165 | trifluoromethyl | fluoro | bond | 3,3,3-trifluoro-propyl- |
| P.1166 | trifluoromethyl | fluoro | bond | 2-methoxy-ethyl- |
| P.1167 | trifluoromethyl | fluoro | bond | 2-hydroxy-ethyl- |
| P.1168 | trifluoromethyl | fluoro | bond | cyclobutyl- |
| P.1169 | trifluoromethyl | fluoro | bond | phenyl-methyl- |
| P.1170 | trifluoromethyl | fluoro | bond | (pyrid-2-yl)-methyl- |
| P.1171 | trifluoromethyl | fluoro | bond | (pyrid-3-yl)-methyl- |
| P.1172 | trifluoromethyl | fluoro | bond | thietan-3-yl- |
| P.1173 | trifluoromethyl | fluoro | bond | 1-oxo-thietan-3-yl- |
| P.1174 | trifluoromethyl | fluoro | bond | 1,1-dioxo-thietan-3-yl- |
| P.1175 | trifluoromethyl | fluoro | bond | 3-methyl-thietan-3-yl- |
| P.1176 | trifluoromethyl | fluoro | bond | oxetan-3yl- |
| P.1177 | trifluoromethyl | fluoro | bond | tetrahydropyran-4-yl- |
| P.1178 | trifluoromethyl | fluoro | bond | cyclopropyl- |
| P.1179 | trifluoromethyl | fluoro | bond | 2-cyano-ethyl- |
| P.1180 | trifluoromethyl | fluoro | bond | 2,2-difluoro-ethyl- |
| P.1181 | trifluoromethyl | fluoro | bond | prop-2-ynyl- |
| P.1182 | trifluoromethyl | fluoro | bond | cyclopropylmethyl- |
| P.1183 | trifluoromethyl | fluoro | bond | cyclobutylmethyl- |
| P.1184 | trifluoromethyl | fluoro | bond | 3-cyano-propyl- |
| P.1185 | trifluoromethyl | fluoro | bond | 2-([1′,3′]dioxolan-2′-yl)- |
| | | | | eth-1-yl- |
| P.1186 | trifluoromethyl | fluoro | bond | (2-chloro-pyrid-5-yl)- |
| | | | | methyl- |
| P.1187 | trifluoromethyl | fluoro | bond | tetrahydro-pyran-2-ylmethyl- |
| P.1188 | trifluoromethyl | fluoro | bond | allyl- |
| P.1189 | trifluoromethyl | fluoro | bond | 3-methyl-but-2-enyl- |
| P.1190 | trifluoromethyl | fluoro | bond | butyl- |
| P.1191 | trifluoromethyl | fluoro | bond | but-2-ynyl- |
| P.1192 | trifluoromethyl | fluoro | bond | 2-methoxyimino-propyl |
| P.1193 | trifluoromethyl | fluoro | bond | (2,6-difluoro-phenyl)- |
| | | | | methyl- |
| P.1194 | trifluoromethyl | fluoro | bond | (4-fluoro-phenyl)-methyl- |
| P.1195 | trifluoromethyl | fluoro | bond | 3-phenyl-propyl- |
| P.1196 | trifluoromethyl | fluoro | bond | 2,5-dimethyl-2H- |
| | | | | [1,2,3]triazol- |
| | | | | 4-ylmethyl- |
| P.1197 | trifluoromethyl | fluoro | bond | cyclohexylmethyl- |
| P.1198 | trifluoromethyl | fluoro | bond | (tetrahydrofuran-2-yl)- |
| | | | | methyl- |
| P.1199 | trifluoromethyl | fluoro | bond | 5-trifluoromethyl-furan- |
| | | | | 2-ylmethyl- |
| P.1200 | trifluoromethyl | fluoro | bond | isopropyl- |
| P.1201 | trifluoromethyl | hydrogen | bond | hydrogen |
| P.1202 | trifluoromethyl | hydrogen | bond | methyl- |
| P.1203 | trifluoromethyl | hydrogen | bond | ethyl- |
| P.1204 | trifluoromethyl | hydrogen | bond | 2,2,2-trifluoro-ethyl- |
| P.1205 | trifluoromethyl | hydrogen | bond | 3,3,3-trifluoro-propyl- |
| P.1206 | trifluoromethyl | hydrogen | bond | 2-methoxy-ethyl- |
| P.1207 | trifluoromethyl | hydrogen | bond | 2-hydroxy-ethyl- |
| P.1208 | trifluoromethyl | hydrogen | bond | cyclobutyl- |
| P.1209 | trifluoromethyl | hydrogen | bond | phenyl-methyl- |
| P.1210 | trifluoromethyl | hydrogen | bond | (pyrid-2-yl)-methyl- |
| P.1211 | trifluoromethyl | hydrogen | bond | (pyrid-3-yl)-methyl- |
| P.1212 | trifluoromethyl | hydrogen | bond | thietan-3-yl- |
| P.1213 | trifluoromethyl | hydrogen | bond | 1-oxo-thietan-3-yl- |
| P.1214 | trifluoromethyl | hydrogen | bond | 1,1-dioxo-thietan-3-yl- |
| P.1215 | trifluoromethyl | hydrogen | bond | 3-methyl-thietan-3-yl- |
| P.1216 | trifluoromethyl | hydrogen | bond | oxetan-3yl- |
| P.1217 | trifluoromethyl | hydrogen | bond | tetrahydropyran-4-yl- |
| P.1218 | trifluoromethyl | hydrogen | bond | cyclopropyl- |
| P.1219 | trifluoromethyl | hydrogen | bond | 2-cyano-ethyl- |
| P.1220 | trifluoromethyl | hydrogen | bond | 2,2-difluoro-ethyl- |
| P.1221 | trifluoromethyl | hydrogen | bond | prop-2-ynyl- |
| P.1222 | trifluoromethyl | hydrogen | bond | cyclopropylmethyl- |
| P.1223 | trifluoromethyl | hydrogen | bond | cyclobutylmethyl- |
| P.1224 | trifluoromethyl | hydrogen | bond | 3-cyano-propyl- |
| P.1225 | trifluoromethyl | hydrogen | bond | 2-([1′,3′]dioxolan-2′-yl)- |
| | | | | eth-1-yl- |
| P.1226 | trifluoromethyl | hydrogen | bond | (2-chloro-pyrid-5-yl)- |
| | | | | methyl- |
| P.1227 | trifluoromethyl | hydrogen | bond | tetrahydro-pyran-2-ylmethyl- |
| P.1228 | trifluoromethyl | hydrogen | bond | allyl- |
| P.1229 | trifluoromethyl | hydrogen | bond | 3-methyl-but-2-enyl- |
| P.1230 | trifluoromethyl | hydrogen | bond | butyl- |
| P.1231 | trifluoromethyl | hydrogen | bond | but-2-ynyl- |
| P.1232 | trifluoromethyl | hydrogen | bond | 2-methoxyimino-propyl |
| P.1233 | trifluoromethyl | hydrogen | bond | (2,6-difluoro-phenyl)- |
| | | | | methyl- |
| P.1234 | trifluoromethyl | hydrogen | bond | (4-fluoro-phenyl)-methyl- |
| P.1235 | trifluoromethyl | hydrogen | bond | 3-phenyl-propyl- |
| P.1236 | trifluoromethyl | hydrogen | bond | 2,5-dimethyl-2H- |
| | | | | [1,2,3]triazol- |
| | | | | 4-ylmethyl- |
| P.1237 | trifluoromethyl | hydrogen | bond | cyclohexylmethyl- |
| P.1238 | trifluoromethyl | hydrogen | bond | (tetrahydrofuran-2-yl)- |
| | | | | methyl- |
| P.1239 | trifluoromethyl | hydrogen | bond | 5-trifluoromethyl-furan- |
| | | | | 2-ylmethyl- |
| P.1576 | trifluoromethyl | hydrogen | bond | isopropyl- |
| P.1241 | trifluoromethyl | methoxy | bond | hydrogen |
| P.1242 | trifluoromethyl | methoxy | bond | methyl- |
| P.1243 | trifluoromethyl | methoxy | bond | ethyl- |
| P.1244 | trifluoromethyl | methoxy | bond | 2,2,2-trifluoro-ethyl- |
| P.1245 | trifluoromethyl | methoxy | bond | 3,3,3-trifluoro-propyl- |
| P.1246 | trifluoromethyl | methoxy | bond | 2-methoxy-ethyl- |
| P.1247 | trifluoromethyl | methoxy | bond | 2-hydroxy-ethyl- |
| P.1248 | trifluoromethyl | methoxy | bond | cyclobutyl- |
| P.1249 | trifluoromethyl | methoxy | bond | phenyl-methyl- |
| P.1250 | trifluoromethyl | methoxy | bond | (pyrid-2-yl)-methyl- |
| P.1251 | trifluoromethyl | methoxy | bond | (pyrid-3-yl)-methyl- |
| P.1252 | trifluoromethyl | methoxy | bond | thietan-3-yl- |
| P.1253 | trifluoromethyl | methoxy | bond | 1-oxo-thietan-3-yl- |
| P.1254 | trifluoromethyl | methoxy | bond | 1,1-dioxo-thietan-3-yl- |
| P.1255 | trifluoromethyl | methoxy | bond | 3-methyl-thietan-3-yl- |
| P.1256 | trifluoromethyl | methoxy | bond | oxetan-3yl- |
| P.1257 | trifluoromethyl | methoxy | bond | tetrahydropyran-4-yl- |
| P.1258 | trifluoromethyl | methoxy | bond | cyclopropyl- |
| P.1259 | trifluoromethyl | methoxy | bond | 2-cyano-ethyl- |
| P.1260 | trifluoromethyl | methoxy | bond | 2,2-difluoro-ethyl- |
| P.1261 | trifluoromethyl | methoxy | bond | prop-2-ynyl- |
| P.1262 | trifluoromethyl | methoxy | bond | cyclopropylmethyl- |
| P.1263 | trifluoromethyl | methoxy | bond | cyclobutylmethyl- |
| P.1264 | trifluoromethyl | methoxy | bond | 3-cyano-propyl- |
| P.1265 | trifluoromethyl | methoxy | bond | 2-([1′,3′]dioxolan-2′-yl)- |
| | | | | eth-1-yl- |
| P.1266 | trifluoromethyl | methoxy | bond | (2-chloro-pyrid-5-yl)- |
| | | | | methyl- |
| P.1267 | trifluoromethyl | methoxy | bond | tetrahydro-pyran-2-ylmethyl- |
| P.1268 | trifluoromethyl | methoxy | bond | allyl- |
| P.1269 | trifluoromethyl | methoxy | bond | 3-methyl-but-2-enyl- |
| P.1270 | trifluoromethyl | methoxy | bond | butyl- |
| P.1271 | trifluoromethyl | methoxy | bond | but-2-ynyl- |
| P.1272 | trifluoromethyl | methoxy | bond | 2-methoxyimino-propyl |
| P.1273 | trifluoromethyl | methoxy | bond | (2,6-difluoro-phenyl)- |
| | | | | methyl- |
| P.1274 | trifluoromethyl | methoxy | bond | (4-fluoro-phenyl)-methyl- |
| P.1275 | trifluoromethyl | methoxy | bond | 3-phenyl-propyl- |
| P.1276 | trifluoromethyl | methoxy | bond | 2,5-dimethyl-2H- |
| | | | | [1,2,3]triazol- |
| | | | | 4-ylmethyl- |
| P.1277 | trifluoromethyl | methoxy | bond | cyclohexylmethyl- |
| P.1278 | trifluoromethyl | methoxy | bond | (tetrahydrofuran-2-yl)- |
| | | | | methyl- |
| P.1279 | trifluoromethyl | methoxy | bond | 5-trifluoromethyl-furan- |
| | | | | 2-ylmethyl- |
| P.1280 | trifluoromethyl | methoxy | bond | isopropyl- |
| P.1281 | trifluoromethyl | methyl | bond | hydrogen |
| P.1282 | trifluoromethyl | methyl | bond | methyl- |
| P.1283 | trifluoromethyl | methyl | bond | ethyl- |
| P.1284 | trifluoromethyl | methyl | bond | 2,2,2-trifluoro-ethyl- |
| P.1285 | trifluoromethyl | methyl | bond | 3,3,3-trifluoro-propyl- |
| P.1286 | trifluoromethyl | methyl | bond | 2-methoxy-ethyl- |
| P.1287 | trifluoromethyl | methyl | bond | 2-hydroxy-ethyl- |
| P.1288 | trifluoromethyl | methyl | bond | cyclobutyl- |
| P.1289 | trifluoromethyl | methyl | bond | phenyl-methyl- |
| P.1290 | trifluoromethyl | methyl | bond | (pyrid-2-yl)-methyl- |
| P.1291 | trifluoromethyl | methyl | bond | (pyrid-3-yl)-methyl- |
| P.1292 | trifluoromethyl | methyl | bond | thietan-3-yl- |
| P.1293 | trifluoromethyl | methyl | bond | 1-oxo-thietan-3-yl- |
| P.1294 | trifluoromethyl | methyl | bond | 1,1-dioxo-thietan-3-yl- |
| P.1295 | trifluoromethyl | methyl | bond | 3-methyl-thietan-3-yl- |
| P.1296 | trifluoromethyl | methyl | bond | oxetan-3yl- |
| P.1297 | trifluoromethyl | methyl | bond | tetrahydropyran-4-yl- |
| P.1298 | trifluoromethyl | methyl | bond | cyclopropyl- |
| P.1299 | trifluoromethyl | methyl | bond | 2-cyano-ethyl- |
| P.1300 | trifluoromethyl | methyl | bond | 2,2-difluoro-ethyl- |
| P.1301 | trifluoromethyl | methyl | bond | prop-2-ynyl- |
| P.1302 | trifluoromethyl | methyl | bond | cyclopropylmethyl- |
| P.1303 | trifluoromethyl | methyl | bond | cyclobutylmethyl- |
| P.1304 | trifluoromethyl | methyl | bond | 3-cyano-propyl- |
| P.1305 | trifluoromethyl | methyl | bond | 2-([1′,3′]dioxolan-2′-yl)- |
| | | | | eth-1-yl- |
| P.1306 | trifluoromethyl | methyl | bond | (2-chloro-pyrid-5-yl)- |
| | | | | methyl- |
| P.1307 | trifluoromethyl | methyl | bond | tetrahydro-pyran-2-ylmethyl- |
| P.1308 | trifluoromethyl | methyl | bond | allyl- |
| P.1309 | trifluoromethyl | methyl | bond | 3-methyl-but-2-enyl- |
| P.1310 | trifluoromethyl | methyl | bond | butyl- |
| P.1311 | trifluoromethyl | methyl | bond | but-2-ynyl- |
| P.1312 | trifluoromethyl | methyl | bond | 2-methoxyimino-propyl |
| P.1313 | trifluoromethyl | methyl | bond | (2,6-difluoro-phenyl)- |
| | | | | methyl- |
| P.1314 | trifluoromethyl | methyl | bond | (4-fluoro-phenyl)-methyl- |
| P.1315 | trifluoromethyl | methyl | bond | 3-phenyl-propyl- |
| P.1316 | trifluoromethyl | methyl | bond | 2,5-dimethyl-2H- |
| | | | | [1,2,3]triazol- |
| | | | | 4-ylmethyl- |
| P.1317 | trifluoromethyl | methyl | bond | cyclohexylmethyl- |
| P.1318 | trifluoromethyl | methyl | bond | (tetrahydrofuran-2-yl)- |
| | | | | methyl- |
| P.1319 | trifluoromethyl | methyl | bond | 5-trifluoromethyl-furan- |
| | | | | 2-ylmethyl- |
| P.1320 | trifluoromethyl | methyl | bond | isopropyl- |
| P.1321 | trifluoromethyl | nitro | bond | hydrogen |
| P.1322 | trifluoromethyl | nitro | bond | methyl- |
| P.1323 | trifluoromethyl | nitro | bond | ethyl- |
| P.1324 | trifluoromethyl | nitro | bond | 2,2,2-trifluoro-ethyl- |
| P.1325 | trifluoromethyl | nitro | bond | 3,3,3-trifluoro-propyl- |
| P.1326 | trifluoromethyl | nitro | bond | 2-methoxy-ethyl- |
| P.1327 | trifluoromethyl | nitro | bond | 2-hydroxy-ethyl- |
| P.1328 | trifluoromethyl | nitro | bond | cyclobutyl- |
| P.1329 | trifluoromethyl | nitro | bond | phenyl-methyl- |
| P.1330 | trifluoromethyl | nitro | bond | (pyrid-2-yl)-methyl- |
| P.1331 | trifluoromethyl | nitro | bond | (pyrid-3-yl)-methyl- |
| P.1332 | trifluoromethyl | nitro | bond | thietan-3-yl- |
| P.1333 | trifluoromethyl | nitro | bond | 1-oxo-thietan-3-yl- |
| P.1334 | trifluoromethyl | nitro | bond | 1,1-dioxo-thietan-3-yl- |
| P.1335 | trifluoromethyl | nitro | bond | 3-methyl-thietan-3-yl- |
| P.1336 | trifluoromethyl | nitro | bond | oxetan-3yl- |
| P.1337 | trifluoromethyl | nitro | bond | tetrahydropyran-4-yl- |
| P.1338 | trifluoromethyl | nitro | bond | cyclopropyl- |
| P.1339 | trifluoromethyl | nitro | bond | 2-cyano-ethyl- |
| P.1340 | trifluoromethyl | nitro | bond | 2,2-difluoro-ethyl- |
| P.1341 | trifluoromethyl | nitro | bond | prop-2-ynyl- |
| P.1342 | trifluoromethyl | nitro | bond | cyclopropylmethyl- |
| P.1343 | trifluoromethyl | nitro | bond | cyclobutylmethyl- |
| P.1344 | trifluoromethyl | nitro | bond | 3-cyano-propyl- |
| P.1345 | trifluoromethyl | nitro | bond | 2-([1′,3′]dioxolan-2′-yl)- |
| | | | | eth-1-yl- |
| P.1346 | trifluoromethyl | nitro | bond | (2-chloro-pyrid-5-yl)- |
| | | | | methyl- |
| P.1347 | trifluoromethyl | nitro | bond | tetrahydro-pyran-2-ylmethyl- |
| P.1348 | trifluoromethyl | nitro | bond | allyl- |
| P.1349 | trifluoromethyl | nitro | bond | 3-methyl-but-2-enyl- |
| P.1350 | trifluoromethyl | nitro | bond | butyl- |
| P.1351 | trifluoromethyl | nitro | bond | but-2-ynyl- |
| P.1352 | trifluoromethyl | nitro | bond | 2-methoxyimino-propyl |
| P.1353 | trifluoromethyl | nitro | bond | (2,6-difluoro-phenyl)- |
| | | | | methyl- |
| P.1354 | trifluoromethyl | nitro | bond | (4-fluoro-phenyl)-methyl- |
| P.1355 | trifluoromethyl | nitro | bond | 3-phenyl-propyl- |
| P.1356 | trifluoromethyl | nitro | bond | 2,5-dimethyl-2H- |
| | | | | [1,2,3]triazol- |
| | | | | 4-ylmethyl- |
| P.1357 | trifluoromethyl | nitro | bond | cyclohexylmethyl- |
| P.1358 | trifluoromethyl | nitro | bond | (tetrahydrofuran-2-yl)- |
| | | | | methyl- |
| P.1359 | trifluoromethyl | nitro | bond | 5-trifluoromethyl-furan- |
| | | | | 2-ylmethyl- |
| P.1360 | trifluoromethyl | nitro | bond | isopropyl- |
| P.1361 | trifluoromethyl | trifluoromethoxy | bond | hydrogen |
| P.1362 | trifluoromethyl | trifluoromethoxy | bond | methyl- |
| P.1363 | trifluoromethyl | trifluoromethoxy | bond | ethyl- |
| P.1364 | trifluoromethyl | trifluoromethoxy | bond | 2,2,2-trifluoro-ethyl- |
| P.1365 | trifluoromethyl | trifluoromethoxy | bond | 3,3,3-trifluoro-propyl- |
| P.1366 | trifluoromethyl | trifluoromethoxy | bond | 2-methoxy-ethyl- |
| P.1367 | trifluoromethyl | trifluoromethoxy | bond | 2-hydroxy-ethyl- |
| P.1368 | trifluoromethyl | trifluoromethoxy | bond | cyclobutyl- |
| P.1369 | trifluoromethyl | trifluoromethoxy | bond | phenyl-methyl- |
| P.1370 | trifluoromethyl | trifluoromethoxy | bond | (pyrid-2-yl)-methyl- |
| P.1371 | trifluoromethyl | trifluoromethoxy | bond | (pyrid-3-yl)-methyl- |
| P.1372 | trifluoromethyl | trifluoromethoxy | bond | thietan-3-yl- |
| P.1373 | trifluoromethyl | trifluoromethoxy | bond | 1-oxo-thietan-3-yl- |
| P.1374 | trifluoromethyl | trifluoromethoxy | bond | 1,1-dioxo-thietan-3-yl- |
| P.1375 | trifluoromethyl | trifluoromethoxy | bond | 3-methyl-thietan-3-yl- |
| P.1376 | trifluoromethyl | trifluoromethoxy | bond | oxetan-3yl- |
| P.1377 | trifluoromethyl | trifluoromethoxy | bond | tetrahydropyran-4-yl- |
| P.1378 | trifluoromethyl | trifluoromethoxy | bond | cyclopropyl- |
| P.1379 | trifluoromethyl | trifluoromethoxy | bond | 2-cyano-ethyl- |
| P.1380 | trifluoromethyl | trifluoromethoxy | bond | 2,2-difluoro-ethyl- |
| P.1381 | trifluoromethyl | trifluoromethoxy | bond | prop-2-ynyl- |
| P.1382 | trifluoromethyl | trifluoromethoxy | bond | cyclopropylmethyl- |
| P.1383 | trifluoromethyl | trifluoromethoxy | bond | cyclobutylmethyl- |
| P.1384 | trifluoromethyl | trifluoromethoxy | bond | 3-cyano-propyl- |
| P.1385 | trifluoromethyl | trifluoromethoxy | bond | 2-([1′,3′]dioxolan-2′-yl)- |
| | | | | eth-1-yl- |
| P.1386 | trifluoromethyl | trifluoromethoxy | bond | (2-chloro-pyrid-5-yl)- |
| | | | | methyl- |
| P.1387 | trifluoromethyl | trifluoromethoxy | bond | tetrahydro-pyran-2-ylmethyl- |
| P.1388 | trifluoromethyl | trifluoromethoxy | bond | allyl- |
| P.1389 | trifluoromethyl | trifluoromethoxy | bond | 3-methyl-but-2-enyl- |
| P.1390 | trifluoromethyl | trifluoromethoxy | bond | butyl- |
| P.1391 | trifluoromethyl | trifluoromethoxy | bond | but-2-ynyl- |
| P.1392 | trifluoromethyl | trifluoromethoxy | bond | 2-methoxyimino-propyl |
| P.1393 | trifluoromethyl | trifluoromethoxy | bond | (2,6-difluoro-phenyl)- |
| | | | | methyl- |
| P.1394 | trifluoromethyl | trifluoromethoxy | bond | (4-fluoro-phenyl)-methyl- |
| P.1395 | trifluoromethyl | trifluoromethoxy | bond | 3-phenyl-propyl- |
| P.1396 | trifluoromethyl | trifluoromethoxy | bond | 2,5-dimethyl-2H- |
| | | | | [1,2,3]triazol- |
| | | | | 4-ylmethyl- |
| P.1397 | trifluoromethyl | trifluoromethoxy | bond | cyclohexylmethyl- |
| P.1398 | trifluoromethyl | trifluoromethoxy | bond | (tetrahydrofuran-2-yl)- |
| | | | | methyl- |
| P.1399 | trifluoromethyl | trifluoromethoxy | bond | 5-trifluoromethyl-furan- |
| | | | | 2-ylmethyl- |
| P.1400 | trifluoromethyl | trifluoromethoxy | bond | isopropyl- |
| P.1401 | trifluoromethyl | trifluoromethyl | bond | hydrogen |
| P.1402 | trifluoromethyl | trifluoromethyl | bond | methyl- |
| P.1403 | trifluoromethyl | trifluoromethyl | bond | ethyl- |
| P.1404 | trifluoromethyl | trifluoromethyl | bond | 2,2,2-trifluoro-ethyl- |
| P.1405 | trifluoromethyl | trifluoromethyl | bond | 3,3,3-trifluoro-propyl- |
| P.1406 | trifluoromethyl | trifluoromethyl | bond | 2-methoxy-ethyl- |
| P.1407 | trifluoromethyl | trifluoromethyl | bond | 2-hydroxy-ethyl- |
| P.1408 | trifluoromethyl | trifluoromethyl | bond | cyclobutyl- |
| P.1409 | trifluoromethyl | trifluoromethyl | bond | phenyl-methyl- |
| P.1410 | trifluoromethyl | trifluoromethyl | bond | (pyrid-2-yl)-methyl- |
| P.1411 | trifluoromethyl | trifluoromethyl | bond | (pyrid-3-yl)-methyl- |
| P.1412 | trifluoromethyl | trifluoromethyl | bond | thietan-3-yl- |
| P.1413 | trifluoromethyl | trifluoromethyl | bond | 1-oxo-thietan-3-yl- |
| P.1414 | trifluoromethyl | trifluoromethyl | bond | 1,1-dioxo-thietan-3-yl- |
| P.1415 | trifluoromethyl | trifluoromethyl | bond | 3-methyl-thietan-3-yl- |
| P.1416 | trifluoromethyl | trifluoromethyl | bond | oxetan-3yl- |
| P.1417 | trifluoromethyl | trifluoromethyl | bond | tetrahydropyran-4-yl- |
| P.1418 | trifluoromethyl | trifluoromethyl | bond | cyclopropyl- |
| P.1419 | trifluoromethyl | trifluoromethyl | bond | 2-cyano-ethyl- |
| P.1420 | trifluoromethyl | trifluoromethyl | bond | 2,2-difluoro-ethyl- |
| P.1421 | trifluoromethyl | trifluoromethyl | bond | prop-2-ynyl- |
| P.1422 | trifluoromethyl | trifluoromethyl | bond | cyclopropylmethyl- |
| P.1423 | trifluoromethyl | trifluoromethyl | bond | cyclobutylmethyl- |
| P.1424 | trifluoromethyl | trifluoromethyl | bond | 3-cyano-propyl- |
| P.1425 | trifluoromethyl | trifluoromethyl | bond | 2-([1′,3′]dioxolan-2′-yl)- |
| | | | | eth-1-yl- |
| P.1426 | trifluoromethyl | trifluoromethyl | bond | (2-chloro-pyrid-5-yl)- |
| | | | | methyl- |
| P.1427 | trifluoromethyl | trifluoromethyl | bond | tetrahydro-pyran-2-ylmethyl- |
| P.1428 | trifluoromethyl | trifluoromethyl | bond | allyl- |
| P.1429 | trifluoromethyl | trifluoromethyl | bond | 3-methyl-but-2-enyl- |
| P.1430 | trifluoromethyl | trifluoromethyl | bond | butyl- |
| P.1431 | trifluoromethyl | trifluoromethyl | bond | but-2-ynyl- |
| P.1432 | trifluoromethyl | trifluoromethyl | bond | 2-methoxyimino-propyl |
| P.1433 | trifluoromethyl | trifluoromethyl | bond | (2,6-difluoro-phenyl)- |
| | | | | methyl- |
| P.1434 | trifluoromethyl | trifluoromethyl | bond | (4-fluoro-phenyl)-methyl- |
| P.1435 | trifluoromethyl | trifluoromethyl | bond | 3-phenyl-propyl- |
| P.1436 | trifluoromethyl | trifluoromethyl | bond | 2,5-dimethyl-2H- |
| | | | | [1,2,3]triazol- |
| | | | | 4-ylmethyl- |
| P.1437 | trifluoromethyl | trifluoromethyl | bond | cyclohexylmethyl- |
| P.1438 | trifluoromethyl | trifluoromethyl | bond | (tetrahydrofuran-2-yl)- |
| | | | | methyl- |
| P.1439 | trifluoromethyl | trifluoromethyl | bond | 5-trifluoromethyl-furan- |
| | | | | 2-ylmethyl- |
| P.1440 | trifluoromethyl | trifluoromethyl | bond | isopropyl- |
| P.1441 | chlorodifluoromethyl | bromo | CH₂ | hydrogen |
| P.1442 | chlorodifluoromethyl | bromo | CH₂ | methyl- |
| P.1443 | chlorodifluoromethyl | bromo | CH₂ | ethyl- |
| P.1444 | chlorodifluoromethyl | bromo | CH₂ | 2,2,2-trifluoro-ethyl- |
| P.1445 | difluoromethyl | bromo | CH₂ | hydrogen |
| P.1446 | difluoromethyl | bromo | CH₂ | methyl- |
| P.1447 | difluoromethyl | bromo | CH₂ | ethyl- |
| P.1448 | difluoromethyl | bromo | CH₂ | 2,2,2-trifluoro-ethyl- |
| P.1449 | trifluoromethyl | bromo | CH₂ | hydrogen |
| P.1450 | trifluoromethyl | bromo | CH₂ | methyl- |
| P.1451 | trifluoromethyl | bromo | CH₂ | ethyl- |
| P.1452 | trifluoromethyl | bromo | CH₂ | 2,2,2-trifluoro-ethyl- |
| P.1453 | chlorodifluoromethyl | bromo | CH₂CH₂ | hydrogen |
| P.1454 | chlorodifluoromethyl | bromo | CH₂CH₂ | methyl- |
| P.1455 | chlorodifluoromethyl | bromo | CH₂CH₂ | ethyl- |
| P.1456 | chlorodifluoromethyl | bromo | CH₂CH₂ | 2,2,2-trifluoro-ethyl- |
| P.1457 | difluoromethyl | bromo | CH₂CH₂ | hydrogen |
| P.1458 | difluoromethyl | bromo | CH₂CH₂ | methyl- |
| P.1459 | difluoromethyl | bromo | CH₂CH₂ | ethyl- |
| P.1460 | difluoromethyl | bromo | CH₂CH₂ | 2,2,2-trifluoro-ethyl- |
| P.1461 | trifluoromethyl | bromo | CH₂CH₂ | hydrogen |
| P.1462 | trifluoromethyl | bromo | CH₂CH₂ | methyl- |
| P.1463 | trifluoromethyl | bromo | CH₂CH₂ | ethyl- |
| P.1464 | trifluoromethyl | bromo | CH₂CH₂ | 2,2,2-trifluoro-ethyl- |
| P.1465 | chlorodifluoromethyl | chloro | CH₂ | hydrogen |
| P.1466 | chlorodifluoromethyl | chloro | CH₂ | methyl- |
| P.1467 | chlorodifluoromethyl | chloro | CH₂ | ethyl- |
| P.1468 | chlorodifluoromethyl | chloro | CH₂ | 2,2,2-trifluoro-ethyl- |
| P.1469 | difluoromethyl | chloro | CH₂ | hydrogen |
| P.1470 | difluoromethyl | chloro | CH₂ | methyl- |
| P.1471 | difluoromethyl | chloro | CH₂ | ethyl- |
| P.1472 | difluoromethyl | chloro | CH₂ | 2,2,2-trifluoro-ethyl- |
| P.1473 | trifluoromethyl | chloro | CH₂ | hydrogen |
| P.1474 | trifluoromethyl | chloro | CH₂ | methyl- |
| P.1475 | trifluoromethyl | chloro | CH₂ | ethyl- |
| P.1476 | trifluoromethyl | chloro | CH₂ | 2,2,2-trifluoro-ethyl- |
| P.1477 | chlorodifluoromethyl | chloro | CH₂CH₂ | hydrogen |
| P.1478 | chlorodifluoromethyl | chloro | CH₂CH₂ | methyl- |
| P.1479 | chlorodifluoromethyl | chloro | CH₂CH₂ | ethyl- |
| P.1480 | chlorodifluoromethyl | chloro | CH₂CH₂ | 2,2,2-trifluoro-ethyl- |
| P.1481 | difluoromethyl | chloro | CH₂CH₂ | hydrogen |
| P.1482 | difluoromethyl | chloro | CH₂CH₂ | methyl- |
| P.1483 | difluoromethyl | chloro | CH₂CH₂ | ethyl- |
| P.1484 | difluoromethyl | chloro | CH₂CH₂ | 2,2,2-trifluoro-ethyl- |
| P.1485 | trifluoromethyl | chloro | CH₂CH₂ | hydrogen |
| P.1486 | trifluoromethyl | chloro | CH₂CH₂ | methyl- |
| P.1487 | trifluoromethyl | chloro | CH₂CH₂ | ethyl- |
| P.1488 | trifluoromethyl | chloro | CH₂CH₂ | 2,2,2-trifluoro-ethyl- |
| P.1489 | chlorodifluoromethyl | cyano | CH₂ | hydrogen |
| P.1490 | chlorodifluoromethyl | cyano | CH₂ | methyl- |
| P.1491 | chlorodifluoromethyl | cyano | CH₂ | ethyl- |
| P.1492 | chlorodifluoromethyl | cyano | CH₂ | 2,2,2-trifluoro-ethyl- |
| P.1493 | difluoromethyl | cyano | CH₂ | hydrogen |
| P.1494 | difluoromethyl | cyano | CH₂ | methyl- |
| P.1495 | difluoromethyl | cyano | CH₂ | ethyl- |
| P.1496 | difluoromethyl | cyano | CH₂ | 2,2,2-trifluoro-ethyl- |
| P.1497 | trifluoromethyl | cyano | CH₂ | hydrogen |
| P.1498 | trifluoromethyl | cyano | CH₂ | methyl- |
| P.1499 | trifluoromethyl | cyano | CH₂ | ethyl- |
| P.1500 | trifluoromethyl | cyano | CH₂ | 2,2,2-trifluoro-ethyl- |
| P.1501 | chlorodifluoromethyl | cyano | CH₂CH₂ | hydrogen |
| P.1502 | chlorodifluoromethyl | cyano | CH₂CH₂ | methyl- |
| P.1503 | chlorodifluoromethyl | cyano | CH₂CH₂ | ethyl- |
| P.1504 | chlorodifluoromethyl | cyano | CH₂CH₂ | 2,2,2-trifluoro-ethyl- |
| P.1505 | difluoromethyl | cyano | CH₂CH₂ | hydrogen |
| P.1506 | difluoromethyl | cyano | CH₂CH₂ | methyl- |
| P.1507 | difluoromethyl | cyano | CH₂CH₂ | ethyl- |
| P.1508 | difluoromethyl | cyano | CH₂CH₂ | 2,2,2-trifluoro-ethyl- |
| P.1509 | trifluoromethyl | cyano | CH₂CH₂ | hydrogen |
| P.1510 | trifluoromethyl | cyano | CH₂CH₂ | methyl- |
| P.1511 | trifluoromethyl | cyano | CH₂CH₂ | ethyl- |
| P.1512 | trifluoromethyl | cyano | CH₂CH₂ | 2,2,2-trifluoro-ethyl- |
| P.1513 | chlorodifluoromethyl | cyclopropyl | CH₂ | hydrogen |
| P.1514 | chlorodifluoromethyl | cyclopropyl | CH₂ | methyl- |
| P.1515 | chlorodifluoromethyl | cyclopropyl | CH₂ | ethyl- |
| P.1516 | chlorodifluoromethyl | cyclopropyl | CH₂ | 2,2,2-trifluoro-ethyl- |
| P.1517 | difluoromethyl | cyclopropyl | CH₂ | hydrogen |
| P.1518 | difluoromethyl | cyclopropyl | CH₂ | methyl- |
| P.1519 | difluoromethyl | cyclopropyl | CH₂ | ethyl- |
| P.1520 | difluoromethyl | cyclopropyl | CH₂ | 2,2,2-trifluoro-ethyl- |
| P.1521 | trifluoromethyl | cyclopropyl | CH₂ | hydrogen |
| P.1522 | trifluoromethyl | cyclopropyl | CH₂ | methyl- |
| P.1523 | trifluoromethyl | cyclopropyl | CH₂ | ethyl- |
| P.1524 | trifluoromethyl | cyclopropyl | CH₂ | 2,2,2-trifluoro-ethyl- |
| P.1525 | chlorodifluoromethyl | cyclopropyl | CH₂CH₂ | hydrogen |
| P.1526 | chlorodifluoromethyl | cyclopropyl | CH₂CH₂ | methyl- |
| P.1527 | chlorodifluoromethyl | cyclopropyl | CH₂CH₂ | ethyl- |
| P.1528 | chlorodifluoromethyl | cyclopropyl | CH₂CH₂ | 2,2,2-trifluoro-ethyl- |
| P.1529 | difluoromethyl | cyclopropyl | CH₂CH₂ | hydrogen |
| P.1530 | difluoromethyl | cyclopropyl | CH₂CH₂ | methyl- |
| P.1531 | difluoromethyl | cyclopropyl | CH₂CH₂ | ethyl- |
| P.1532 | difluoromethyl | cyclopropyl | CH₂CH₂ | 2,2,2-trifluoro-ethyl- |
| P.1533 | trifluoromethyl | cyclopropyl | CH₂CH₂ | hydrogen |
| P.1534 | trifluoromethyl | cyclopropyl | CH₂CH₂ | methyl- |
| P.1535 | trifluoromethyl | cyclopropyl | CH₂CH₂ | ethyl- |
| P.1536 | trifluoromethyl | cyclopropyl | CH₂CH₂ | 2,2,2-trifluoro-ethyl- |
| P.1537 | chlorodifluoromethyl | ethyl | CH₂ | hydrogen |
| P.1538 | chlorodifluoromethyl | ethyl | CH₂ | methyl- |
| P.1539 | chlorodifluoromethyl | ethyl | CH₂ | ethyl- |
| P.1540 | chlorodifluoromethyl | ethyl | CH₂ | 2,2,2-trifluoro-ethyl- |
| P.1541 | difluoromethyl | ethyl | CH₂ | hydrogen |
| P.1542 | difluoromethyl | ethyl | CH₂ | methyl- |
| P.1543 | difluoromethyl | ethyl | CH₂ | ethyl- |
| P.1544 | difluoromethyl | ethyl | CH₂ | 2,2,2-trifluoro-ethyl- |
| P.1545 | trifluoromethyl | ethyl | CH₂ | hydrogen |
| P.1546 | trifluoromethyl | ethyl | CH₂ | methyl- |
| P.1547 | trifluoromethyl | ethyl | CH₂ | ethyl- |
| P.1548 | trifluoromethyl | ethyl | CH₂ | 2,2,2-trifluoro-ethyl- |
| P.1549 | chlorodifluoromethyl | ethyl | CH₂CH₂ | hydrogen |
| P.1550 | chlorodifluoromethyl | ethyl | CH₂CH₂ | methyl- |
| P.1551 | chlorodifluoromethyl | ethyl | CH₂CH₂ | ethyl- |
| P.1552 | chlorodifluoromethyl | ethyl | CH₂CH₂ | 2,2,2-trifluoro-ethyl- |
| P.1553 | difluoromethyl | ethyl | CH₂CH₂ | hydrogen |
| P.1554 | difluoromethyl | ethyl | CH₂CH₂ | methyl- |
| P.1555 | difluoromethyl | ethyl | CH₂CH₂ | ethyl- |
| P.1556 | difluoromethyl | ethyl | CH₂CH₂ | 2,2,2-trifluoro-ethyl- |
| P.1557 | trifluoromethyl | ethyl | CH₂CH₂ | hydrogen |
| P.1558 | trifluoromethyl | ethyl | CH₂CH₂ | methyl- |
| P.1559 | trifluoromethyl | ethyl | CH₂CH₂ | ethyl- |
| P.1560 | trifluoromethyl | ethyl | CH₂CH₂ | 2,2,2-trifluoro-ethyl- |
| P.1561 | chlorodifluoromethyl | fluoro | CH₂ | hydrogen |
| P.1562 | chlorodifluoromethyl | fluoro | CH₂ | methyl- |
| P.1563 | chlorodifluoromethyl | fluoro | CH₂ | ethyl- |
| P.1564 | chlorodifluoromethyl | fluoro | CH₂ | 2,2,2-trifluoro-ethyl- |
| P.1565 | difluoromethyl | fluoro | CH₂ | hydrogen |
| P.1566 | difluoromethyl | fluoro | CH₂ | methyl- |
| P.1567 | difluoromethyl | fluoro | CH₂ | ethyl- |
| P.1568 | difluoromethyl | fluoro | CH₂ | 2,2,2-trifluoro-ethyl- |
| P.1569 | trifluoromethyl | fluoro | CH₂ | hydrogen |
| P.1570 | trifluoromethyl | fluoro | CH₂ | methyl- |
| P.1571 | trifluoromethyl | fluoro | CH₂ | ethyl- |
| P.1572 | trifluoromethyl | fluoro | CH₂ | 2,2,2-trifluoro-ethyl- |
| P.1573 | chlorodifluoromethyl | fluoro | CH₂CH₂ | hydrogen |
| P.1574 | chlorodifluoromethyl | fluoro | CH₂CH₂ | methyl- |
| P.1575 | chlorodifluoromethyl | fluoro | CH₂CH₂ | ethyl- |
| P.1576 | chlorodifluoromethyl | fluoro | CH₂CH₂ | 2,2,2-trifluoro-ethyl- |
| P.1577 | difluoromethyl | fluoro | CH₂CH₂ | hydrogen |
| P.1578 | difluoromethyl | fluoro | CH₂CH₂ | methyl- |
| P.1579 | difluoromethyl | fluoro | CH₂CH₂ | ethyl- |
| P.1580 | difluoromethyl | fluoro | CH₂CH₂ | 2,2,2-trifluoro-ethyl- |
| P.1581 | trifluoromethyl | fluoro | CH₂CH₂ | hydrogen |
| P.1582 | trifluoromethyl | fluoro | CH₂CH₂ | methyl- |
| P.1583 | trifluoromethyl | fluoro | CH₂CH₂ | ethyl- |
| P.1584 | trifluoromethyl | fluoro | CH₂CH₂ | 2,2,2-trifluoro-ethyl- |
| P.1585 | chlorodifluoromethyl | hydrogen | CH₂ | hydrogen |
| P.1586 | chlorodifluoromethyl | hydrogen | CH₂ | methyl- |
| P.1587 | chlorodifluoromethyl | hydrogen | CH₂ | ethyl- |
| P.1588 | chlorodifluoromethyl | hydrogen | CH₂ | 2,2,2-trifluoro-ethyl- |
| P.1589 | difluoromethyl | hydrogen | CH₂ | hydrogen |
| P.1590 | difluoromethyl | hydrogen | CH₂ | methyl- |
| P.1591 | difluoromethyl | hydrogen | CH₂ | ethyl- |
| P.1592 | difluoromethyl | hydrogen | CH₂ | 2,2,2-trifluoro-ethyl- |
| P.1593 | trifluoromethyl | hydrogen | CH₂ | hydrogen |
| P.1594 | trifluoromethyl | hydrogen | CH₂ | methyl- |
| P.1595 | trifluoromethyl | hydrogen | CH₂ | ethyl- |
| P.1596 | trifluoromethyl | hydrogen | CH₂ | 2,2,2-trifluoro-ethyl- |
| P.1597 | chlorodifluoromethyl | hydrogen | CH₂CH₂ | hydrogen |
| P.1598 | chlorodifluoromethyl | hydrogen | CH₂CH₂ | methyl- |
| P.1599 | chlorodifluoromethyl | hydrogen | CH₂CH₂ | ethyl- |
| P.1600 | chlorodifluoromethyl | hydrogen | CH₂CH₂ | 2,2,2-trifluoro-ethyl- |
| P.1601 | difluoromethyl | hydrogen | CH₂CH₂ | hydrogen |
| P.1602 | difluoromethyl | hydrogen | CH₂CH₂ | methyl- |
| P.1603 | difluoromethyl | hydrogen | CH₂CH₂ | ethyl- |
| P.1604 | difluoromethyl | hydrogen | CH₂CH₂ | 2,2,2-trifluoro-ethyl- |
| P.1605 | trifluoromethyl | hydrogen | CH₂CH₂ | hydrogen |
| P.1606 | trifluoromethyl | hydrogen | CH₂CH₂ | methyl- |
| P.1607 | trifluoromethyl | hydrogen | CH₂CH₂ | ethyl- |
| P.1608 | trifluoromethyl | hydrogen | CH₂CH₂ | 2,2,2-trifluoro-ethyl- |
| P.1609 | chlorodifluoromethyl | methoxy | CH₂ | hydrogen |
| P.1610 | chlorodifluoromethyl | methoxy | CH₂ | methyl- |
| P.1611 | chlorodifluoromethyl | methoxy | CH₂ | ethyl- |
| P.1612 | chlorodifluoromethyl | methoxy | CH₂ | 2,2,2-trifluoro-ethyl- |
| P.1613 | difluoromethyl | methoxy | CH₂ | hydrogen |
| P.1614 | difluoromethyl | methoxy | CH₂ | methyl- |
| P.1615 | difluoromethyl | methoxy | CH₂ | ethyl- |
| P.1616 | difluoromethyl | methoxy | CH₂ | 2,2,2-trifluoro-ethyl- |
| P.1617 | trifluoromethyl | methoxy | CH₂ | hydrogen |
| P.1618 | trifluoromethyl | methoxy | CH₂ | methyl- |
| P.1619 | trifluoromethyl | methoxy | CH₂ | ethyl- |
| P.1620 | trifluoromethyl | methoxy | CH₂ | 2,2,2-trifluoro-ethyl- |
| P.1621 | chlorodifluoromethyl | methoxy | CH₂CH₂ | hydrogen |
| P.1622 | chlorodifluoromethyl | methoxy | CH₂CH₂ | methyl- |
| P.1623 | chlorodifluoromethyl | methoxy | CH₂CH₂ | ethyl- |
| P.1624 | chlorodifluoromethyl | methoxy | CH₂CH₂ | 2,2,2-trifluoro-ethyl- |
| P.1625 | difluoromethyl | methoxy | CH₂CH₂ | hydrogen |
| P.1626 | difluoromethyl | methoxy | CH₂CH₂ | methyl- |
| P.1627 | difluoromethyl | methoxy | CH₂CH₂ | ethyl- |
| P.1628 | difluoromethyl | methoxy | CH₂CH₂ | 2,2,2-trifluoro-ethyl- |
| P.1629 | trifluoromethyl | methoxy | CH₂CH₂ | hydrogen |
| P.1630 | trifluoromethyl | methoxy | CH₂CH₂ | methyl- |
| P.1631 | trifluoromethyl | methoxy | CH₂CH₂ | ethyl- |
| P.1632 | trifluoromethyl | methoxy | CH₂CH₂ | 2,2,2-trifluoro-ethyl- |
| P.1633 | chlorodifluoromethyl | methyl | CH₂ | hydrogen |
| P.1634 | chlorodifluoromethyl | methyl | CH₂ | methyl- |
| P.1635 | chlorodifluoromethyl | methyl | CH₂ | ethyl- |
| P.1636 | chlorodifluoromethyl | methyl | CH₂ | 2,2,2-trifluoro-ethyl- |
| P.1637 | difluoromethyl | methyl | CH₂ | hydrogen |
| P.1638 | difluoromethyl | methyl | CH₂ | methyl- |
| P.1639 | difluoromethyl | methyl | CH₂ | ethyl- |
| P.1640 | difluoromethyl | methyl | CH₂ | 2,2,2-trifluoro-ethyl- |
| P.1641 | trifluoromethyl | methyl | CH₂ | hydrogen |
| P.1642 | trifluoromethyl | methyl | CH₂ | methyl- |
| P.1643 | trifluoromethyl | methyl | CH₂ | ethyl- |
| P.1644 | trifluoromethyl | methyl | CH₂ | 2,2,2-trifluoro-ethyl- |
| P.1645 | chlorodifluoromethyl | methyl | CH₂CH₂ | hydrogen |
| P.1646 | chlorodifluoromethyl | methyl | CH₂CH₂ | methyl- |
| P.1647 | chlorodifluoromethyl | methyl | CH₂CH₂ | ethyl- |
| P.1648 | chlorodifluoromethyl | methyl | CH₂CH₂ | 2,2,2-trifluoro-ethyl- |
| P.1649 | difluoromethyl | methyl | CH₂CH₂ | hydrogen |
| P.1650 | difluoromethyl | methyl | CH₂CH₂ | methyl- |
| P.1651 | difluoromethyl | methyl | CH₂CH₂ | ethyl- |
| P.1652 | difluoromethyl | methyl | CH₂CH₂ | 2,2,2-trifluoro-ethyl- |
| P.1653 | trifluoromethyl | methyl | CH₂CH₂ | hydrogen |
| P.1654 | trifluoromethyl | methyl | CH₂CH₂ | methyl- |
| P.1655 | trifluoromethyl | methyl | CH₂CH₂ | ethyl- |
| P.1656 | trifluoromethyl | methyl | CH₂CH₂ | 2,2,2-trifluoro-ethyl- |
| P.1657 | chlorodifluoromethyl | nitro | CH₂ | hydrogen |
| P.1658 | chlorodifluoromethyl | nitro | CH₂ | methyl- |
| P.1659 | chlorodifluoromethyl | nitro | CH₂ | ethyl- |
| P.1660 | chlorodifluoromethyl | nitro | CH₂ | 2,2,2-trifluoro-ethyl- |
| P.1661 | difluoromethyl | nitro | CH₂ | hydrogen |
| P.1662 | difluoromethyl | nitro | CH₂ | methyl- |
| P.1663 | difluoromethyl | nitro | CH₂ | ethyl- |
| P.1664 | difluoromethyl | nitro | CH₂ | 2,2,2-trifluoro-ethyl- |
| P.1665 | trifluoromethyl | nitro | CH₂ | hydrogen |
| P.1666 | trifluoromethyl | nitro | CH₂ | methyl- |
| P.1667 | trifluoromethyl | nitro | CH₂ | ethyl- |
| P.1668 | trifluoromethyl | nitro | CH₂ | 2,2,2-trifluoro-ethyl- |
| P.1669 | chlorodifluoromethyl | nitro | CH₂CH₂ | hydrogen |
| P.1670 | chlorodifluoromethyl | nitro | CH₂CH₂ | methyl- |
| P.1671 | chlorodifluoromethyl | nitro | CH₂CH₂ | ethyl- |
| P.1672 | chlorodifluoromethyl | nitro | CH₂CH₂ | 2,2,2-trifluoro-ethyl- |
| P.1673 | difluoromethyl | nitro | CH₂CH₂ | hydrogen |
| P.1674 | difluoromethyl | nitro | CH₂CH₂ | methyl- |
| P.1675 | difluoromethyl | nitro | CH₂CH₂ | ethyl- |
| P.1676 | difluoromethyl | nitro | CH₂CH₂ | 2,2,2-trifluoro-ethyl- |
| P.1677 | trifluoromethyl | nitro | CH₂CH₂ | hydrogen |
| P.1678 | trifluoromethyl | nitro | CH₂CH₂ | methyl- |
| P.1679 | trifluoromethyl | nitro | CH₂CH₂ | ethyl- |
| P.1680 | trifluoromethyl | nitro | CH₂CH₂ | 2,2,2-trifluoro-ethyl- |
| P.1681 | chlorodifluoromethyl | trifluoromethoxy | CH₂ | hydrogen |
| P.1682 | chlorodifluoromethyl | trifluoromethoxy | CH₂ | methyl- |
| P.1683 | chlorodifluoromethyl | trifluoromethoxy | CH₂ | ethyl- |
| P.1684 | chlorodifluoromethyl | trifluoromethoxy | CH₂ | 2,2,2-trifluoro-ethyl- |
| P.1685 | difluoromethyl | trifluoromethoxy | CH₂ | hydrogen |
| P.1686 | difluoromethyl | trifluoromethoxy | CH₂ | methyl- |
| P.1687 | difluoromethyl | trifluoromethoxy | CH₂ | ethyl- |
| P.1688 | difluoromethyl | trifluoromethoxy | CH₂ | 2,2,2-trifluoro-ethyl- |
| P.1689 | trifluoromethyl | trifluoromethoxy | CH₂ | hydrogen |
| P.1690 | trifluoromethyl | trifluoromethoxy | CH₂ | methyl- |
| P.1691 | trifluoromethyl | trifluoromethoxy | CH2 | ethyl- |
| P.1692 | trifluoromethyl | trifluoromethoxy | CH₂ | 2,2,2-trifluoro-ethyl- |
| P.1693 | chlorodifluoromethyl | trifluoromethoxy | CH₂CH₂ | hydrogen |
| P.1694 | chlorodifluoromethyl | trifluoromethoxy | CH₂CH₂ | methyl- |
| P.1695 | chlorodifluoromethyl | trifluoromethoxy | CH₂CH₂ | ethyl- |
| P.1696 | chlorodifluoromethyl | trifluoromethoxy | CH₂CH₂ | 2,2,2-trifluoro-ethyl- |
| P.1697 | difluoromethyl | trifluoromethoxy | CH₂CH₂ | hydrogen |
| P.1698 | difluoromethyl | trifluoromethoxy | CH₂CH₂ | methyl- |
| P.1699 | difluoromethyl | trifluoromethoxy | CH₂CH₂ | ethyl- |
| P.1700 | difluoromethyl | trifluoromethoxy | CH₂CH₂ | 2,2,2-trifluoro-ethyl- |
| P.1701 | trifluoromethyl | trifluoromethoxy | CH₂CH₂ | hydrogen |
| P.1702 | trifluoromethyl | trifluoromethoxy | CH₂CH₂ | methyl- |
| P.1703 | trifluoromethyl | trifluoromethoxy | CH₂CH₂ | ethyl- |
| P.1704 | trifluoromethyl | trifluoromethoxy | CH₂CH₂ | 2,2,2-trifluoro-ethyl- |
| P.1705 | chlorodifluoromethyl | trifluoromethyl | CH₂ | hydrogen |
| P.1706 | chlorodifluoromethyl | trifluoromethyl | CH₂ | methyl- |
| P.1707 | chlorodifluoromethyl | trifluoromethyl | CH₂ | ethyl- |
| P.1708 | chlorodifluoromethyl | trifluoromethyl | CH₂ | 2,2,2-trifluoro-ethyl- |
| P.1709 | difluoromethyl | trifluoromethyl | CH₂ | hydrogen |
| P.1710 | difluoromethyl | trifluoromethyl | CH₂ | methyl- |
| P.1711 | difluoromethyl | trifluoromethyl | CH₂ | ethyl- |
| P.1712 | difluoromethyl | trifluoromethyl | CH₂ | 2,2,2-trifluoro-ethyl- |
| P.1713 | trifluoromethyl | trifluoromethyl | CH₂ | hydrogen |
| P.1714 | trifluoromethyl | trifluoromethyl | CH₂ | methyl- |
| P.1715 | trifluoromethyl | trifluoromethyl | CH₂ | ethyl- |
| P.1716 | trifluoromethyl | trifluoromethyl | CH₂ | 2,2,2-trifluoro-ethyl- |
| P.1717 | chlorodifluoromethyl | trifluoromethyl | CH₂CH₂ | hydrogen |
| P.1718 | chlorodifluoromethyl | trifluoromethyl | CH₂CH₂ | methyl- |
| P.1719 | chlorodifluoromethyl | trifluoromethyl | CH₂CH₂ | ethyl- |
| P.11728 | chlorodifluoromethyl | trifluoromethyl | CH₂CH₂ | 2,2,2-trifluoro-ethyl- |
| P.1721 | difluoromethyl | trifluoromethyl | CH₂CH₂ | hydrogen |
| P.1722 | difluoromethyl | trifluoromethyl | CH₂CH₂ | methyl- |
| P.1723 | difluoromethyl | trifluoromethyl | CH₂CH₂ | ethyl- |
| P.1724 | difluoromethyl | trifluoromethyl | CH₂CH₂ | 2,2,2-trifluoro-ethyl- |
| P.1725 | trifluoromethyl | trifluoromethyl | CH₂CH₂ | hydrogen |
| P.1726 | trifluoromethyl | trifluoromethyl | CH₂CH₂ | methyl- |
| P.1727 | trifluoromethyl | trifluoromethyl | CH₂CH₂ | ethyl- |
| P.1728 | trifluoromethyl | trifluoromethyl | CH₂CH₂ | 2,2,2-trifluoro-ethyl- |

### Table 1P:

Table 1P provides 1728 compounds of formula (I-A) wherein G¹ is oxygen, R¹ is hydrogen, X¹ is chloro, X² is CH, X³ is chloro, Y¹ is CH, Y² is CH, Y³ is CH and X⁴, R⁵ and R² have the values listed in the table P.

### Table 2P:

Table 2 P provides 1728 compounds of formula (I-A) wherein G¹ is oxygen, R¹ is hydrogen, X¹ is chloro, X² is CH, X³ is chloro, Y¹ is N, Y² is CH, Y³ is CH and X⁴, R⁵ and R² have the values listed in the table P.

### Table 3P:

Table 3 P provides 1728 compounds of formula (I-A) wherein G¹ is oxygen, R¹ is hydrogen, X¹ is chloro, X² is CH, X³ is chloro, Y¹ is N, Y² is N, Y³ is CH and X⁴, R⁵ and R² have the values listed in the table P.

### Table 4P:

Table 4 P provides 1728 compounds of formula (I-A) wherein G¹ is oxygen, R¹ is hydrogen, X¹ is chloro, X² is CH, X³ is chloro, Y¹ is CH, Y² is N, Y³ is CH and X⁴, R⁵ and R² have the values listed in the table P.

### Table 5P:

Table 5 P provides 1728 compounds of formula (I-A) wherein G¹ is oxygen, R¹ is hydrogen, X¹ is chloro, X² is CH, X³ is chloro, Y¹ is CH, Y² is CH, Y³ is N and X⁴, R⁵ and R² have the values listed in the table P.

### Table 6P:

Table 6 P provides 1728 compounds of formula (I-A) wherein G¹ is oxygen, R¹ is hydrogen, X¹ is chloro, X² is C—F, X³ is hydrogen, Y¹ is CH, Y² is CH, Y³ is CH and X⁴, R⁵ and R² have the values listed in the table P.

### Table 7P:

Table 7 P provides 1728 compounds of formula (I-A) wherein G¹ is oxygen, R¹ is hydrogen, X¹ is chloro, X² is C—F, X³ is hydrogen, Y¹ is N, Y² is CH, Y³ is CH and X⁴, R⁵ and R² have the values listed in the table P.

### Table 8P:

Table 8 P provides 1728 compounds of formula (I-A) wherein G¹ is oxygen, R¹ is hydrogen, X¹ is chloro, X² is C—F, X³ is hydrogen, Y¹ is N, Y² is N, Y³ is CH and X⁴, R⁵ and R² have the values listed in the table P.

### Table 9P:

Table 9 P provides 1728 compounds of formula (I-A) wherein G¹ is oxygen, R¹ is hydrogen, X¹ is chloro, X² is C—F, X³ is hydrogen, Y¹ is CH, Y² is N, Y³ is CH and X⁴, R⁵ and R² have the values listed in the table P.

### Table 10P:

Table 10 P provides 1728 compounds of formula (I-A) wherein G¹ is oxygen, R¹ is hydrogen, X¹ is chloro, X² is C—F, X³ is hydrogen, Y¹ is CH, Y² is CH, Y³ is N and X⁴, R⁵ and R² have the values listed in the table P.

### Table 11P:

Table 11 P provides 1728 compounds of formula (I-A) wherein G¹ is oxygen, R¹ is hydrogen, X¹ is fluoro, X² is C—Cl, X³ is hydrogen, Y¹ is CH, Y² is CH, Y³ is CH and X⁴, R⁵ and R² have the values listed in the table P.

### Table 12P:

Table 12 P provides 1728 compounds of formula (I-A) wherein G¹ is oxygen, R¹ is hydrogen, X¹ is fluoro, X² is C—Cl, X³ is hydrogen, Y¹ is N, Y² is CH, Y³ is CH and X⁴, R⁵ and R² have the values listed in the table P.

### Table 13P:

Table 13 P provides 1728 compounds of formula (I-A) wherein G¹ is oxygen, R¹ is hydrogen, X¹ is fluoro, X² is C—Cl, X³ is hydrogen, Y¹ is N, Y² is N, Y³ is CH and X⁴, R⁵ and R² have the values listed in the table P.

### Table 14P:

Table 14 P provides 1728 compounds of formula (I-A) wherein G¹ is oxygen, R¹ is hydrogen, X¹ is fluoro, X² is C—Cl, X³ is hydrogen, Y¹ is CH, Y² is N, Y³ is CH and X⁴, R⁵ and R² have the values listed in the table P.

### Table 15P:

Table 15 P provides 1728 compounds of formula (I-A) wherein G¹ is oxygen, R¹ is hydrogen, X¹ is fluoro, X² is C—Cl, X³ is hydrogen, Y¹ is CH, Y² is CH, Y³ is N and X⁴, R⁵ and R² have the values listed in the table P.

### Table 16P:

Table 16 P provides 1728 compounds of formula (I-A) wherein G¹ is oxygen, R¹ is hydrogen, X¹ is chloro, X² is C—Cl, X³ is hydrogen, Y¹ is CH, Y² is CH, Y³ is CH and X⁴, R⁵ and R² have the values listed in the table P.

### Table 17P:

Table 17 P provides 1728 compounds of formula (I-A) wherein G¹ is oxygen, R¹ is hydrogen, X¹ is chloro, X² is C—Cl, X³ is hydrogen, Y¹ is N, Y² is CH, Y³ is CH and X⁴, R⁵ and R² have the values listed in the table P.

### Table 18P:

Table 18 P provides 1728 compounds of formula (I-A) wherein G¹ is oxygen, R¹ is hydrogen, X¹ is chloro, X² is C—Cl, X³ is hydrogen, Y¹ is N, Y² is N, Y³ is CH and X⁴, R⁵ and R² have the values listed in the table P.

### Table 19P:

Table 19 P provides 1728 compounds of formula (I-A) wherein G¹ is oxygen, R¹ is hydrogen, X¹ is chloro, X² is C—Cl, X³ is hydrogen, Y¹ is CH, Y² is N, Y³ is CH and X⁴, R⁵ and R² have the values listed in the table P.

### Table 20P:

Table 20 P provides 1728 compounds of formula (I-A) wherein G¹ is oxygen, R¹ is hydrogen, X¹ is chloro, X² is C—Cl, X³ is hydrogen, Y¹ is CH, Y² is CH, Y³ is N and X⁴, R⁵ and R² have the values listed in the table P.

### Table 21P:

Table 21 P provides 1728 compounds of formula (I-A) wherein G¹ is oxygen, R¹ is hydrogen, X¹ is chloro, X² is C—F, X³ is chloro, Y¹ is CH, Y² is CH, Y³ is CH and X⁴, R⁵ and R² have the values listed in the table P.

### Table 22P:

Table 22 P provides 1728 compounds of formula (I-A) wherein G¹ is oxygen, R¹ is hydrogen, X¹ is chloro, X² is C—F, X³ is chloro, Y¹ is N, Y² is CH, Y³ is CH and X⁴, R⁵ and R² have the values listed in the table P.

### Table 23P:

Table 23 P provides 1728 compounds of formula (I-A) wherein G¹ is oxygen, R¹ is hydrogen X¹ is chloro, X² is C—F, X³ is chloro, Y¹ is N, Y² is N, Y³ is CH and X⁴, R⁵ and R² have the values listed in the table P.

### Table 24P:

Table 24 P provides 1728 compounds of formula (I-A) wherein G¹ is oxygen, R¹ is hydrogen, X¹ is chloro, X² is C—F, X³ is chloro, Y¹ is CH, Y² is N, Y³ is CH and X⁴, R⁵ and R² have the values listed in the table P.

### Table 25P:

Table 25 P provides 1728 compounds of formula (I-A) wherein G¹ is oxygen, R¹ is hydrogen, X¹ is chloro, X² is C—F, X³ is chloro, Y¹ is CH, Y² is CH, Y³ is N and X⁴, R⁵ and R² have the values listed in the table P.

### Table 26P:

Table 26 P provides 1728 compounds of formula (I-A) wherein G¹ is oxygen, R¹ is hydrogen X¹ is chloro, X² is C—Cl, X³ is chloro, Y¹ is CH, Y² is CH, Y³ is CH and X⁴, R⁵ and R² have the values listed in the table P.

### Table 27P:

Table 27 P provides 1728 compounds of formula (I-A) wherein G¹ is oxygen, R¹ is hydrogen, X¹ is chloro, X² is C—Cl, X³ is chloro, Y¹ is N, Y² is CH, Y³ is CH and X⁴, R⁵ and R² have the values listed in the table P.

### Table 28P:

Table 28 P provides 1728 compounds of formula (I-A) wherein G¹ is oxygen, R¹ is hydrogen, X¹ is chloro, X² is C—Cl, X³ is chloro, Y¹ is N, Y² is N, Y³ is CH and X⁴, R⁵ and R² have the values listed in the table P.

### Table 29P:

Table 29 P provides 1728 compounds of formula (I-A) wherein G¹ is oxygen, R¹ is hydrogen, X¹ is chloro, X² is C—Cl, X³ is chloro, Y¹ is CH, Y² is N, Y³ is CH and X⁴, R⁵ and R² have the values listed in the table P.

### Table 30P:

Table 30 P provides 1728 compounds of formula (I-A) wherein G¹ is oxygen, R¹ is hydrogen, X¹ is chloro, X² is C—Cl, X³ is chloro, Y¹ is CH, Y² is CH, Y³ is N and X⁴, R⁵ and R² have the values listed in the table P.

### Table 31P:

Table 31 P provides 1728 compounds of formula (I-A) wherein G¹ is oxygen, R¹ is hydrogen, X¹ is chloro, X² is C—Br, X³ is chloro, Y¹ is CH, Y² is CH, Y³ is CH and X⁴, R⁵ and R² have the values listed in the table P.

### Table 32P:

Table 32 P provides 1728 compounds of formula (I-A) wherein G¹ is oxygen, R¹ is hydrogen, X¹ is chloro, X² is C—Br, X³ is chloro, Y¹ is N, Y² is CH, Y³ is CH and X⁴, R⁵ and R² have the values listed in the table P.

### Table 33P:

Table 33 P provides 1728 compounds of formula (I-A) wherein G¹ is oxygen, R¹ is hydrogen, X¹ is chloro, X² is C—Br, X³ is chloro, Y¹ is N, Y² is N, Y³ is CH and X⁴, R⁵ and R² have the values listed in the table P.

### Table 34P:

Table 34 P provides 1728 compounds of formula (I-A) wherein G¹ is oxygen, R¹ is hydrogen, X¹ is chloro, X² is C—Br, X³ is chloro, Y¹ is CH, Y² is N, Y³ is CH and X⁴, R⁵ and R² have the values listed in the table P.

### Table 35P:

Table 35 P provides 1728 compounds of formula (I-A) wherein G¹ is oxygen, R¹ is hydrogen, X¹ is chloro, X² is C—Br, X³ is chloro, Y¹ is CH, Y² is CH, Y³ is N and X⁴, R⁵ and R² have the values listed in the table P.

### Table 36P:

Table 36 P provides 1728 compounds of formula (I-A) wherein G¹ is oxygen, R¹ is hydrogen, X¹ is chloro, X² is C—I, X³ is chloro, Y¹ is CH, Y² is CH, Y³ is CH and X⁴, R⁵ and R² have the values listed in the table P.

### Table 37P:

Table 37 P provides 1728 compounds of formula (I-A) wherein G¹ is oxygen, R¹ is hydrogen, X¹ is chloro, X² is C—I, X³ is chloro, Y¹ is N, Y² is CH, Y³ is CH and X⁴, R⁵ and R² have the values listed in the table P.

### Table 38P:

Table 38 P provides 1728 compounds of formula (I-A) wherein G¹ is oxygen, R¹ is hydrogen, X¹ is chloro, X² is C—I, X³ is chloro, Y¹ is N, Y² is N, Y³ is CH and X⁴, R⁵ and R² have the values listed in the table P.

### Table 39P:

Table 39 P provides 1728 compounds of formula (I-A) wherein G¹ is oxygen, R¹ is hydrogen, X¹ is chloro, X² is C—I, X³ is chloro, Y¹ is CH, Y² is N, Y³ is CH and X⁴, R⁵ and R² have the values listed in the table P.

### Table 40P:

Table 40 P provides 1728 compounds of formula (I-A) wherein G¹ is oxygen, R¹ is hydrogen, X¹ is chloro, X² is C—I, X³ is chloro, Y¹ is CH, Y² is CH, Y³ is N and X⁴, R⁵ and R² have the values listed in the table P.

### Table 41P:

Table 41 P provides 1728 compounds of formula (I-A) wherein G¹ is oxygen, R¹ is hydrogen, X¹ is fluoro, X² is C—F, X³ is fluoro, Y¹ is CH, Y² is CH, Y³ is CH and X⁴, R⁵ and R² have the values listed in the table P.

### Table 42P:

Table 42 P provides 1728 compounds of formula (I-A) wherein G¹ is oxygen, R¹ is hydrogen, X¹ is fluoro, X² is C—F, X³ is fluoro, Y¹ is N, Y² is CH, Y³ is CH and X⁴, R⁵ and R² have the values listed in the table P.

### Table 43P:

Table 43 P provides 1728 compounds of formula (I-A) wherein G¹ is oxygen, R¹ is hydrogen, X¹ is fluoro, X² is C—F, X³ is fluoro, Y¹ is N, Y² is N, Y³ is CH and X⁴, R⁵ and R² have the values listed in the table P.

### Table 44P:

Table 44 P provides 1728 compounds of formula (I-A) wherein G¹ is oxygen, R¹ is hydrogen, X¹ is fluoro, X² is C—F, X³ is fluoro, Y¹ is CH, Y² is N, Y³ is CH and X⁴, R⁵ and R² have the values listed in the table P.

### Table 45P:

Table 45 P provides 1728 compounds of formula (I-A) wherein G¹ is oxygen, R¹ is hydrogen, X¹ is fluoro, X² is C—F, X³ is fluoro, Y¹ is CH, Y² is CH, Y³ is N and X⁴, R⁵ and R² have the values listed in the table P.

### Table 46P:

Table 46 P provides 1728 compounds of formula (I-A) wherein G¹ is oxygen, R¹ is hydrogen, X¹ is chloro, X² is CH, X³ is bromo, Y¹ is CH, Y² is CH, Y³ is CH and X⁴, R⁵ and R² have the values listed in the table P.

### Table 47P:

Table 47 P provides 1728 compounds of formula (I-A) wherein G¹ is oxygen, R¹ is hydrogen, X¹ is chloro, X² is CH, X³ is bromo, Y¹ is N, Y² is CH, Y³ is CH and X⁴, R⁵ and R² have the values listed in the table P.

### Table 48P:

Table 48 P provides 1728 compounds of formula (I-A) wherein G¹ is oxygen, R¹ is hydrogen, X¹ is chloro, X² is CH, X³ is bromo, Y¹ is N, Y² is N, Y³ is CH and X⁴, R⁵ and R² have the values listed in the table P.

### Table 49P:

Table 49 P provides 1728 compounds of formula (I-A) wherein G¹ is oxygen, R¹ is hydrogen, X¹ is chloro, X² is CH, X³ is bromo, Y¹ is CH, Y² is N, Y³ is CH and X⁴, R⁵ and R² have the values listed in the table P.

### Table 50P:

Table 50 P provides 1728 compounds of formula (I-A) wherein G¹ is oxygen, R¹ is hydrogen, X¹ is chloro, X² is CH, X³ is bromo, Y¹ is CH, Y² is CH, Y³ is N and X⁴, R⁵ and R² have the values listed in the table P.

### Table 51P:

Table 51 P provides 1728 compounds of formula (I-A) wherein G¹ is oxygen, R¹ is hydrogen, X¹ is chloro, X² is CH, X³ is fluoro, Y¹ is CH, Y² is CH, Y³ is CH and X⁴, R⁵ and R² have the values listed in the table P.

### Table 52P:

Table 52 P provides 1728 compounds of formula (I-A) wherein G¹ is oxygen, R¹ is hydrogen, X¹ is chloro, X² is CH, X³ is fluoro, Y¹ is N, Y² is CH, Y³ is CH and X⁴, R⁵ and R² have the values listed in the table P.

### Table 53P:

Table 53 P provides 1728 compounds of formula (I-A) wherein G¹ is oxygen, R¹ is hydrogen, X¹ is chloro, X² is CH, X³ is fluoro, Y¹ is N, Y² is N, Y³ is CH and X⁴, R⁵ and R² have the values listed in the table P.

### Table 54P:

Table 54 P provides 1728 compounds of formula (I-A) wherein G¹ is oxygen, R¹ is hydrogen, X¹ is chloro, X² is CH, X³ is fluoro, Y¹ is CH, Y² is N, Y³ is CH and X⁴, R⁵ and R² have the values listed in the table P.

### Table 55P:

Table 55 P provides 1728 compounds of formula (I-A) wherein G¹ is oxygen, R¹ is hydrogen, X¹ is chloro, X² is CH, X³ is fluoro, Y¹ is CH, Y² is CH, Y³ is N and X⁴, R⁵ and R² have the values listed in the table P.

### Table 56P:

Table 56 P provides 1728 compounds of formula (I-A) wherein G¹ is oxygen, R¹ is hydrogen, X¹ is chloro, X² is CH, X³ is trifluoromethyl, Y¹ is CH, Y² is CH, Y³ is CH and X⁴, R⁵ and R² have the values listed in the table P.

### Table 57P:

Table 57 P provides 1728 compounds of formula (I-A) wherein G¹ is oxygen, R¹ is hydrogen, X¹ is chloro, X² is CH, X³ is trifluoromethyl, Y¹ is N, Y² is CH, Y³ is CH and X⁴, R⁵ and R² have the values listed in the table P.

### Table 58P:

Table 58 P provides 1728 compounds of formula (I-A) wherein G¹ is oxygen, R¹ is hydrogen, X¹ is chloro, X² is CH, X³ is trifluoromethyl, Y¹ is N, Y² is N, Y³ is CH and X⁴, R⁵ and R² have the values listed in the table P.

### Table 59P:

Table 59 P provides 1728 compounds of formula (I-A) wherein G¹ is oxygen, R¹ is hydrogen, X¹ is chloro, X² is CH, X³ is trifluoromethyl, Y¹ is CH, Y² is N, Y³ is CH and X⁴, R⁵ and R² have the values listed in the table P.

### Table 60P:

Table 60 P provides 1728 compounds of formula (I-A) wherein G¹ is oxygen, R¹ is hydrogen, X¹ is chloro, X² is CH, X³ is trifluoromethyl, Y¹ is CH, Y² is CH, Y³ is N and X⁴, R⁵ and R² have the values listed in the table P.

### Table 61P:

Table 61 P provides 1728 compounds of formula (I-A) wherein G¹ is oxygen, R¹ is hydrogen, X¹ is chloro, X² is C—Cl, X³ is trifluoromethyl, Y¹ is CH, Y² is CH, Y³ is CH and X⁴, R⁵ and R² have the values listed in the table P.

### Table 62P:

Table 62 P provides 1728 compounds of formula (I-A) wherein G¹ is oxygen, R¹ is hydrogen, X¹ is chloro, X² is C—Cl, X³ is trifluoromethyl, Y¹ is N, Y² is CH, Y³ is CH and X⁴, R⁵ and R² have the values listed in the table P.

### Table 63P:

Table 63 P provides 1728 compounds of formula (I-A) wherein G¹ is oxygen, R¹ is hydrogen, X¹ is chloro, X² is C—Cl, X³ is trifluoromethyl, Y¹ is N, Y² is N, Y³ is CH and X⁴, R⁵ and R² have the values listed in the table P.

### Table 64P:

Table 64 P provides 1728 compounds of formula (I-A) wherein G¹ is oxygen, R¹ is hydrogen, X¹ is chloro, X² is C—Cl, X³ is trifluoromethyl, Y¹ is CH, Y² is N, Y³ is CH and X⁴, R⁵ and R² have the values listed in the table P.

### Table 65P:

Table 65 P provides 1728 compounds of formula (I-A) wherein G¹ is oxygen, R¹ is hydrogen, X¹ is chloro, X² is C—Cl, X³ is trifluoromethyl, Y¹ is CH, Y² is CH, Y³ is N and X⁴, R⁵ and R² have the values listed in the table P.

### Table 66P:

Table 66 P provides 1728 compounds of formula (I-A) wherein G¹ is oxygen, R¹ is hydrogen, X¹ is trifluoromethyl, X² is CH, X³ is trifluoromethyl, Y¹ is CH, Y² is CH, Y³ is CH and X⁴, R⁵ and R² have the values listed in the table P.

### Table 67P:

Table 67 P provides 1728 compounds of formula (I-A) wherein G¹ is oxygen, R¹ is hydrogen, X¹ is trifluoromethyl, X² is CH, X³ is trifluoromethyl, Y¹ is N, Y² is CH, Y³ is CH and X⁴, R⁵ and R² have the values listed in the table P.

### Table 68P:

Table 68 P provides 1728 compounds of formula (I-A) wherein G¹ is oxygen, R¹ is hydrogen, X¹ is trifluoromethyl, X² is CH, X³ is trifluoromethyl, Y¹ is N, Y² is N, Y³ is CH and X⁴, R⁵ and R² have the values listed in the table P.

### Table 69P:

Table 69 P provides 1728 compounds of formula (I-A) wherein G¹ is oxygen, R¹ is hydrogen, X¹ is trifluoromethyl, X² is CH, X³ is trifluoromethyl, Y¹ is CH, Y² is N, Y³ is CH and X⁴, R⁵ and R² have the values listed in the table P.

### Table 70P:

Table 70 P provides 1728 compounds of formula (I-A) wherein G¹ is oxygen, R¹ is hydrogen, X¹ is trifluoromethyl, X² is CH, X³ is trifluoromethyl, Y¹ is CH, Y² is CH, Y³ is N and X⁴, R⁵ and R² have the values listed in the table P.

### Table 71P:

Table 71 P provides 1728 compounds of formula (I-A) wherein G¹ is oxygen, R¹ is hydrogen, X¹ is trifluoromethyl, X² is C—Cl, X³ is trifluoromethyl, Y¹ is CH, Y² is CH, Y³ is CH and X⁴, R⁵ and R² have the values listed in the table P.

### Table 72P:

Table 72 P provides 1728 compounds of formula (I-A) wherein G¹ is oxygen, R¹ is hydrogen, X¹ is trifluoromethyl, X² is C—Cl, X³ is trifluoromethyl, Y¹ is N, Y² is CH, Y³ is CH and X⁴, R⁵ and R² have the values listed in the table P.

### Table 73P:

Table 73 P provides 1728 compounds of formula (I-A) wherein G¹ is oxygen, R¹ is hydrogen, X¹ is trifluoromethyl, X² is C—Cl, X³ is trifluoromethyl, Y¹ is N, Y² is N, Y³ is CH and X⁴, R⁵ and R² have the values listed in the table P.

### Table 74P:

Table 74 P provides 1728 compounds of formula (I-A) wherein G¹ is oxygen, R¹ is hydrogen, X¹ is trifluoromethyl, X² is C—Cl, X³ is trifluoromethyl, Y¹ is CH, Y² is N, Y³ is CH and X⁴, R⁵ and R² have the values listed in the table P.

### Table 75P:

Table 75 P provides 1728 compounds of formula (I-A) wherein G¹ is oxygen, R¹ is hydrogen, X¹ is trifluoromethyl, X² is C—Cl, X³ is trifluoromethyl, Y¹ is CH, Y² is CH, Y³ is N and X⁴, R⁵ and R² have the values listed in the table P.

### Table 76P:

Table 76 P provides 1728 compounds of formula (I-A) wherein G¹ is oxygen, R¹ is hydrogen, X¹ is trifluoromethyl, X² is CH, X³ is hydrogen, Y¹ is CH, Y² is CH, Y³ is CH and X⁴, R⁵ and R² have the values listed in the table P.

### Table 77P:

Table 77 P provides 1728 compounds of formula (I-A) wherein G¹ is oxygen, R¹ is hydrogen, X¹ is trifluoromethyl, X² is CH, X³ is hydrogen, Y¹ is N, Y² is CH, Y³ is CH and X⁴, R⁵ and R² have the values listed in the table P.

### Table 78P:

Table 78 P provides 1728 compounds of formula (I-A) wherein G¹ is oxygen, R¹ is hydrogen, X¹ is trifluoromethyl, X² is CH, X³ is hydrogen, Y¹ is N, Y² is N, Y³ is CH and X⁴, R⁵ and R² have the values listed in the table P.

### Table 79P:

Table 79 P provides 1728 compounds of formula (I-A) wherein G¹ is oxygen, R¹ is hydrogen, X¹ is trifluoromethyl, X² is CH, X³ is hydrogen, Y¹ is CH, Y² is N, Y³ is CH and X⁴, R⁵ and R² have the values listed in the table P.

### Table 80P:

Table 80 P provides 1728 compounds of formula (I-A) wherein G¹ is oxygen, R¹ is hydrogen, X¹ is trifluoromethyl, X² is CH, X³ is hydrogen, Y¹ is CH, Y² is CH, Y³ is N and X⁴, R⁵ and R² have the values listed in the table P.

### Table 81P:

Table 81 P provides 1728 compounds of formula (I-A) wherein G¹ is oxygen, R¹ is hydrogen, X¹ is chloro, X² is N, X³ is chloro, Y¹ is CH, Y² is CH, Y³ is CH and X⁴, R⁵ and R² have the values listed in the table P.

### Table 82P:

Table 82 P provides 1728 compounds of formula (I-A) wherein G¹ is oxygen, R¹ is hydrogen, X¹ is chloro, X² is N, X³ is chloro, Y¹ is N, Y² is CH, Y³ is CH and X⁴, R⁵ and R² have the values listed in the table P.

### Table 83P:

Table 83 P provides 1728 compounds of formula (I-A) wherein G¹ is oxygen, R¹ is hydrogen, X¹ is chloro, X² is N, X³ is chloro, Y¹ is N, Y² is N, Y³ is CH and X⁴, R⁵ and R² have the values listed in the table P.

### Table 84P:

Table 84 P provides 1728 compounds of formula (I-A) wherein G¹ is oxygen, R¹ is hydrogen, X¹ is chloro, X² is N, X³ is chloro, Y¹ is CH, Y² is N, Y³ is CH and X⁴, R⁵ and R² have the values listed in the table P.

### Table 85P:

Table 85 P provides 1728 compounds of formula (I-A) wherein G¹ is oxygen, R¹ is hydrogen, X¹ is chloro, X² is N, X³ is chloro, Y¹ is CH, Y² is CH, Y³ is N and X⁴, R⁵ and R² have the values listed in the table P.

### Table 86P:

Table 86 P provides 1728 compounds of formula (I-A) wherein G¹ is oxygen, R¹ is hydrogen, X¹ is trifluoromethyl, X² is N, X³ is trifluoromethyl, Y¹ is CH, Y² is CH, Y³ is CH and X⁴, R⁵ and R² have the values listed in the table P.

### Table 87P:

Table 87 P provides 1728 compounds of formula (I-A) wherein G¹ is oxygen, R¹ is hydrogen, X¹ is trifluoromethyl, X² is N, X³ is trifluoromethyl, Y¹ is N, Y² is CH, Y³ is CH and X⁴, R⁵ and R² have the values listed in the table P.

### Table 88P:

Table 88 P provides 1728 compounds of formula (I-A) wherein G¹ is oxygen, R¹ is hydrogen, X¹ is trifluoromethyl, X² is N, X³ is trifluoromethyl, Y¹ is N, Y² is N, Y³ is CH and X⁴, R⁵ and R² have the values listed in the table P.

### Table 89P:

Table 89 P provides 1728 compounds of formula (I-A) wherein G¹ is oxygen, R¹ is hydrogen, X¹ is trifluoromethyl, X² is N, X³ is trifluoromethyl, Y¹ is CH, Y² is N, Y³ is CH and X⁴, R⁵ and R² have the values listed in the table P.

### Table 90P:

Table 90 P provides 1728 compounds of formula (I-A) wherein G¹ is oxygen, R¹ is hydrogen, X¹ is trifluoromethyl, X² is N, X³ is trifluoromethyl, Y¹ is CH, Y² is CH, Y³ is N and X⁴, R⁵ and R² have the values listed in the table P.

TABLE Q
(I-B)

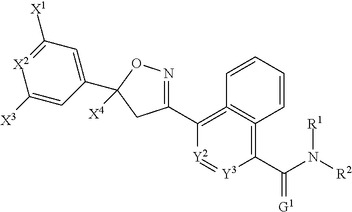

| | | | 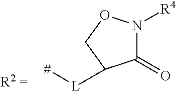 | |
|---|---|---|---|---|
| | X⁴ | R⁵ | L | R⁴ |
| Q.001 | chlorodifluoromethyl | bromo | bond | hydrogen |
| Q.002 | chlorodifluoromethyl | bromo | bond | methyl- |
| Q.003 | chlorodifluoromethyl | bromo | bond | ethyl- |
| Q.004 | chlorodifluoromethyl | bromo | bond | 2,2,2-trifluoro-ethyl- |
| Q.005 | chlorodifluoromethyl | bromo | bond | 3,3,3-trifluoro-propyl- |
| Q.006 | chlorodifluoromethyl | bromo | bond | 2-methoxy-ethyl- |
| Q.007 | chlorodifluoromethyl | bromo | bond | 2-hydroxy-ethyl- |
| Q.008 | chlorodifluoromethyl | bromo | bond | cyclobutyl- |
| Q.009 | chlorodifluoromethyl | bromo | bond | phenyl-methyl- |
| Q.010 | chlorodifluoromethyl | bromo | bond | (pyrid-2-yl)-methyl- |
| Q.011 | chlorodifluoromethyl | bromo | bond | (pyrid-3-yl)-methyl- |
| Q.012 | chlorodifluoromethyl | bromo | bond | thietan-3-yl- |
| Q.013 | chlorodifluoromethyl | bromo | bond | 1-oxo-thietan-3-yl- |
| Q.014 | chlorodifluoromethyl | bromo | bond | 1,1-dioxo-thietan-3-yl- |
| Q.015 | chlorodifluoromethyl | bromo | bond | 3-methyl-thietan-3-yl- |
| Q.016 | chlorodifluoromethyl | bromo | bond | oxetan-3yl- |
| Q.017 | chlorodifluoromethyl | bromo | bond | tetrahydropyran-4-yl- |
| Q.018 | chlorodifluoromethyl | bromo | bond | cyclopropyl- |
| Q.019 | chlorodifluoromethyl | bromo | bond | 2-cyano-ethyl- |
| Q.020 | chlorodifluoromethyl | bromo | bond | 2,2-difluoro-ethyl- |
| Q.021 | chlorodifluoromethyl | bromo | bond | prop-2-ynyl- |
| Q.022 | chlorodifluoromethyl | bromo | bond | cyclopropylmethyl- |
| Q.023 | chlorodifluoromethyl | bromo | bond | cyclobutylmethyl- |
| Q.024 | chlorodifluoromethyl | bromo | bond | 3-cyano-propyl- |
| Q.025 | chlorodifluoromethyl | bromo | bond | 2-([1′,3′]dioxolan-2′-yl)- |
| | | | | eth-1-yl- |
| Q.026 | chlorodifluoromethyl | bromo | bond | (2-chloro-pyrid-5-yl)- |
| | | | | methyl- |
| Q.027 | chlorodifluoromethyl | bromo | bond | tetrahydro-pyran-2-ylmethyl- |
| Q.028 | chlorodifluoromethyl | bromo | bond | allyl- |
| Q.029 | chlorodifluoromethyl | bromo | bond | 3-methyl-but-2-enyl- |
| Q.030 | chlorodifluoromethyl | bromo | bond | butyl- |
| Q.031 | chlorodifluoromethyl | bromo | bond | but-2-ynyl- |
| Q.032 | chlorodifluoromethyl | bromo | bond | 2-methoxyimino-propyl |
| Q.033 | chlorodifluoromethyl | bromo | bond | (2,6-difluoro-phenyl)- |
| | | | | methyl- |
| Q.034 | chlorodifluoromethyl | bromo | bond | (4-fluoro-phenyl)-methyl- |
| Q.035 | chlorodifluoromethyl | bromo | bond | 3-phenyl-propyl- |
| Q.036 | chlorodifluoromethyl | bromo | bond | 2,5-dimethyl-2H- |
| | | | | [1,2,3]triazol- |
| | | | | 4-ylmethyl- |
| Q.037 | chlorodifluoromethyl | bromo | bond | cyclohexylmethyl- |
| Q.038 | chlorodifluoromethyl | bromo | bond | (tetrahydrofuran-2-yl)- |
| | | | | methyl- |
| Q.039 | chlorodifluoromethyl | bromo | bond | 5-trifluoromethyl-furan- |
| | | | | 2-ylmethyl- |
| Q.040 | chlorodifluoromethyl | bromo | bond | isopropyl- |
| Q.041 | difluoromethyl | bromo | bond | hydrogen |
| Q.042 | difluoromethyl | bromo | bond | methyl- |
| Q.043 | difluoromethyl | bromo | bond | ethyl- |
| Q.044 | difluoromethyl | bromo | bond | 2,2,2-trifluoro-ethyl- |
| Q.045 | difluoromethyl | bromo | bond | 3,3,3-trifluoro-propyl- |
| Q.046 | difluoromethyl | bromo | bond | 2-methoxy-ethyl- |
| Q.047 | difluoromethyl | bromo | bond | 2-hydroxy-ethyl- |
| Q.048 | difluoromethyl | bromo | bond | cyclobutyl- |
| Q.049 | difluoromethyl | bromo | bond | phenyl-methyl- |
| Q.050 | difluoromethyl | bromo | bond | (pyrid-2-yl)-methyl- |
| Q.051 | difluoromethyl | bromo | bond | (pyrid-3-yl)-methyl- |
| Q.052 | difluoromethyl | bromo | bond | thietan-3-yl- |
| Q.053 | difluoromethyl | bromo | bond | 1-oxo-thietan-3-yl- |
| Q.054 | difluoromethyl | bromo | bond | 1,1-dioxo-thietan-3-yl- |
| Q.055 | difluoromethyl | bromo | bond | 3-methyl-thietan-3-yl- |
| Q.056 | difluoromethyl | bromo | bond | oxetan-3yl- |
| Q.057 | difluoromethyl | bromo | bond | tetrahydropyran-4-yl- |
| Q.058 | difluoromethyl | bromo | bond | cyclopropyl- |
| Q.059 | difluoromethyl | bromo | bond | 2-cyano-ethyl- |
| Q.060 | difluoromethyl | bromo | bond | 2,2-difluoro-ethyl- |
| Q.061 | difluoromethyl | bromo | bond | prop-2-ynyl- |
| Q.062 | difluoromethyl | bromo | bond | cyclopropylmethyl- |
| Q.063 | difluoromethyl | bromo | bond | cyclobutylmethyl- |
| Q.064 | difluoromethyl | bromo | bond | 3-cyano-propyl- |
| Q.065 | difluoromethyl | bromo | bond | 2-([1′,3′]dioxolan-2′-yl)- |
| | | | | eth-1-yl- |
| Q.066 | difluoromethyl | bromo | bond | (2-chloro-pyrid-5-yl)- |
| | | | | methyl- |
| Q.067 | difluoromethyl | bromo | bond | tetrahydro-pyran-2-ylmethyl- |
| Q.068 | difluoromethyl | bromo | bond | allyl- |
| Q.069 | difluoromethyl | bromo | bond | 3-methyl-but-2-enyl- |
| Q.070 | difluoromethyl | bromo | bond | butyl- |
| Q.071 | difluoromethyl | bromo | bond | but-2-ynyl- |
| Q.072 | difluoromethyl | bromo | bond | 2-methoxyimino-propyl |
| Q.073 | difluoromethyl | bromo | bond | (2,6-difluoro-phenyl)- |
| | | | | methyl- |
| Q.074 | difluoromethyl | bromo | bond | (4-fluoro-phenyl)-methyl- |
| Q.075 | difluoromethyl | bromo | bond | 3-phenyl-propyl- |
| Q.076 | difluoromethyl | bromo | bond | 2,5-dimethyl-2H- |
| | | | | [1,2,3]triazol- |
| | | | | 4-ylmethyl- |
| Q.077 | difluoromethyl | bromo | bond | cyclohexylmethyl- |
| Q.078 | difluoromethyl | bromo | bond | (tetrahydrofuran-2-yl)- |
| | | | | methyl- |
| Q.079 | difluoromethyl | bromo | bond | 5-trifluoromethyl-furan- |
| | | | | 2-ylmethyl- |
| Q.080 | difluoromethyl | bromo | bond | isopropyl- |
| Q.081 | trifluoromethyl | bromo | bond | hydrogen |
| Q.082 | trifluoromethyl | bromo | bond | methyl- |
| Q.083 | trifluoromethyl | bromo | bond | ethyl- |
| Q.084 | trifluoromethyl | bromo | bond | 2,2,2-trifluoro-ethyl- |
| Q.085 | trifluoromethyl | bromo | bond | 3,3,3-trifluoro-propyl- |
| Q.086 | trifluoromethyl | bromo | bond | 2-methoxy-ethyl- |
| Q.087 | trifluoromethyl | bromo | bond | 2-hydroxy-ethyl- |
| Q.088 | trifluoromethyl | bromo | bond | cyclobutyl- |
| Q.089 | trifluoromethyl | bromo | bond | phenyl-methyl- |
| Q.090 | trifluoromethyl | bromo | bond | (pyrid-2-yl)-methyl- |
| Q.091 | trifluoromethyl | bromo | bond | (pyrid-3-yl)-methyl- |
| Q.092 | trifluoromethyl | bromo | bond | thietan-3-yl- |
| Q.093 | trifluoromethyl | bromo | bond | 1-oxo-thietan-3-yl- |
| Q.094 | trifluoromethyl | bromo | bond | 1,1-dioxo-thietan-3-yl- |
| Q.095 | trifluoromethyl | bromo | bond | 3-methyl-thietan-3-yl- |
| Q.096 | trifluoromethyl | bromo | bond | oxetan-3yl- |
| Q.097 | trifluoromethyl | bromo | bond | tetrahydropyran-4-yl- |
| Q.098 | trifluoromethyl | bromo | bond | cyclopropyl- |
| Q.099 | trifluoromethyl | bromo | bond | 2-cyano-ethyl- |
| Q.100 | trifluoromethyl | bromo | bond | 2,2-difluoro-ethyl- |
| Q.101 | trifluoromethyl | bromo | bond | prop-2-ynyl- |
| Q.102 | trifluoromethyl | bromo | bond | cyclopropylmethyl- |
| Q.103 | trifluoromethyl | bromo | bond | cyclobutylmethyl- |
| Q.104 | trifluoromethyl | bromo | bond | 3-cyano-propyl- |
| Q.105 | trifluoromethyl | bromo | bond | 2-([1′,3′]dioxolan-2′-yl)- |
| | | | | eth-1-yl- |
| Q.106 | trifluoromethyl | bromo | bond | (2-chloro-pyrid-5-yl)- |
| | | | | methyl- |
| Q.107 | trifluoromethyl | bromo | bond | tetrahydro-pyran-2-ylmethyl- |
| Q.108 | trifluoromethyl | bromo | bond | allyl- |
| Q.109 | trifluoromethyl | bromo | bond | 3-methyl-but-2-enyl- |
| Q.110 | trifluoromethyl | bromo | bond | butyl- |
| Q.111 | trifluoromethyl | bromo | bond | but-2-ynyl- |
| Q.112 | trifluoromethyl | bromo | bond | 2-methoxyimino-propyl |
| Q.113 | trifluoromethyl | bromo | bond | (2,6-difluoro-phenyl)- |
| | | | | methyl- |
| Q.114 | trifluoromethyl | bromo | bond | (4-fluoro-phenyl)-methyl- |
| Q.115 | trifluoromethyl | bromo | bond | 3-phenyl-propyl- |
| Q.116 | trifluoromethyl | bromo | bond | 2,5-dimethyl-2H- |
| | | | | [1,2,3]triazol- |
| | | | | 4-ylmethyl- |
| Q.117 | trifluoromethyl | bromo | bond | cyclohexylmethyl- |
| Q.118 | trifluoromethyl | bromo | bond | (tetrahydrofuran-2-yl)- |
| | | | | methyl- |
| Q.119 | trifluoromethyl | bromo | bond | 5-trifluoromethyl-furan- |
| | | | | 2-ylmethyl- |
| Q.120 | trifluoromethyl | bromo | bond | isopropyl- |

### Table 1Q:

Table 1Q provides 120 compounds of formula (I-B) wherein G¹ is oxygen, R¹ is hydrogen, X¹ is chloro, X² is CH, X³ is chloro, Y² is CH, Y³ is CH and X⁴ and R² have the values listed in the table Q.

### Table 2Q:

Table 2 Q provides 120 compounds of formula (I-B) wherein G¹ is oxygen, R¹ is hydrogen, X¹ is chloro, X² is CH, X³ is chloro, Y² is N, Y³ is CH and X⁴ and R² have the values listed in the table Q.

### Table 3Q:

Table 3 Q provides 120 compounds of formula (I-B) wherein G¹ is oxygen, R¹ is hydrogen, X¹ is chloro, X² is CH, X³ is chloro, Y² is CH, Y³ is N and X⁴ and R² have the values listed in the table Q.

### Table 4Q:

Table 4 Q provides 120 compounds of formula (I-B) wherein G¹ is oxygen, R¹ is hydrogen, X¹ is chloro, X² is C—F, X³ is hydrogen, Y² is CH, Y³ is CH and X⁴ and R² have the values listed in the table Q.

### Table 5Q:

Table 5 Q provides 120 compounds of formula (I-B) wherein G¹ is oxygen, R¹ is hydrogen, X¹ is chloro, X² is C—F, X³ is hydrogen, Y² is N, Y³ is CH and X⁴ and R² have the values listed in the table Q.

### Table 6Q:

Table 6 Q provides 120 compounds of formula (I-B) wherein G¹ is oxygen, R¹ is hydrogen, X¹ is chloro, X² is C—F, X³ is hydrogen, Y² is CH, Y³ is N and X⁴ and R² have the values listed in the table Q.

### Table 7Q:

Table 7 Q provides 120 compounds of formula (I-B) wherein G¹ is oxygen, R¹ is hydrogen, X¹ is fluoro, X² is C—Cl, X³ is hydrogen, Y² is CH, Y³ is CH and X⁴ and R² have the values listed in the table Q.

### Table 8Q:

Table 8 Q provides 120 compounds of formula (I-B) wherein G¹ is oxygen, R¹ is hydrogen, X¹ is fluoro, X² is C—Cl, X³ is hydrogen, Y² is N, Y³ is CH and X⁴ and R² have the values listed in the table Q.

### Table 9Q:

Table 9 Q provides 120 compounds of formula (I-B) wherein G¹ is oxygen, R¹ is hydrogen, X¹ is fluoro, X² is C—Cl, X³ is hydrogen, Y² is CH, Y³ is N and X⁴ and R² have the values listed in the table Q.

### Table 10Q:

Table 10 Q provides 120 compounds of formula (I-B) wherein G¹ is oxygen, R¹ is hydrogen, X¹ is chloro, X² is C—Cl, X³ is hydrogen, Y² is CH, Y³ is CH and X⁴ and R² have the values listed in the table Q.

### Table 11Q:

Table 11Q provides 120 compounds of formula (I-B) wherein G¹ is oxygen, R¹ is hydrogen, X¹ is chloro, X² is C—Cl, X³ is hydrogen, Y² is N, Y³ is CH and X⁴ and R² have the values listed in the table Q.

### Table 12Q:

Table 12 Q provides 120 compounds of formula (I-B) wherein G¹ is oxygen, R¹ is hydrogen, X¹ is chloro, X² is C—Cl, X³ is hydrogen, Y² is CH, Y³ is N and X⁴ and R² have the values listed in the table Q.

### Table 13Q:

Table 13 Q provides 120 compounds of formula (I-B) wherein G¹ is oxygen, R¹ is hydrogen, X¹ is chloro, X² is C—F, X³ is chloro, Y² is CH, Y³ is CH and X⁴ and R² have the values listed in the table Q.

### Table 14Q:

Table 14 Q provides 120 compounds of formula (I-B) wherein G¹ is oxygen, R¹ is hydrogen, X¹ is chloro, X² is C—F, X³ is chloro, Y² is N, Y³ is CH and X⁴ and R² have the values listed in the table Q.

### Table 15Q:

Table 15 Q provides 120 compounds of formula (I-B) wherein G¹ is oxygen, R¹ is hydrogen, X¹ is chloro, X² is C—F, X³ is chloro, Y² is CH, Y³ is N and X⁴ and R² have the values listed in the table Q.

### Table 16Q:

Table 16 Q provides 120 compounds of formula (I-B) wherein G¹ is oxygen, R¹ is hydrogen, X¹ is chloro, X² is C—Cl, X³ is chloro, Y² is CH, Y³ is CH and X⁴ and R² have the values listed in the table Q.

### Table 17Q:

Table 17 Q provides 120 compounds of formula (I-B) wherein G¹ is oxygen, R¹ is hydrogen, X¹ is chloro, X² is C—Cl, X³ is chloro, Y² is N, Y³ is CH and X⁴ and R² have the values listed in the table Q.

### Table 18Q:

Table 18 Q provides 120 compounds of formula (I-B) wherein G¹ is oxygen, R¹ is hydrogen, X¹ is chloro, X² is C—Cl, X³ is chloro, Y² is CH, Y³ is N and X⁴ and R² have the values listed in the table Q.

### Table 19Q:

Table 19 Q provides 120 compounds of formula (I-B) wherein G¹ is oxygen, R¹ is hydrogen, X¹ is chloro, X² is C—Br, X³ is chloro, Y² is CH, Y³ is CH and X⁴ and R² have the values listed in the table Q.

### Table 20Q:

Table 20 Q provides 120 compounds of formula (I-B) wherein G¹ is oxygen, R¹ is hydrogen, X¹ is chloro, X² is C—Br, X³ is chloro, Y² is N, Y³ is CH and X⁴ and R² have the values listed in the table Q.

### Table 21Q:

Table 21 Q provides 120 compounds of formula (I-B) wherein G¹ is oxygen, R¹ is hydrogen, X¹ is chloro, X² is C—Br, X³ is chloro, Y² is CH, Y³ is N and X⁴ and R² have the values listed in the table Q.

### Table 22Q:

Table 22 Q provides 120 compounds of formula (I-B) wherein G¹ is oxygen, R¹ is hydrogen, X¹ is fluoro, X² is C—F, X³ is fluoro, Y² is CH, Y³ is CH and X⁴ and R² have the values listed in the table Q.

### Table 23Q:

Table 23 Q provides 120 compounds of formula (I-B) wherein G¹ is oxygen, R¹ is hydrogen, X¹ is fluoro, X² is C—F, X³ is fluoro, Y² is N, Y³ is CH and X⁴ and R² have the values listed in the table Q.

### Table 24Q:

Table 24 Q provides 120 compounds of formula (I-B) wherein G¹ is oxygen, R¹ is hydrogen, X¹ is fluoro, X² is C—F, X³ is fluoro, Y² is CH, Y³ is N and X⁴ and R² have the values listed in the table Q.

### Table 25Q:

Table 25 Q provides 120 compounds of formula (I-B) wherein G¹ is oxygen, R¹ is hydrogen, X¹ is chloro, X² is CH, X³ is bromo, Y² is CH, Y³ is CH and X⁴ and R² have the values listed in the table Q.

### Table 26Q:

Table 26 Q provides 120 compounds of formula (I-B) wherein G¹ is oxygen, R¹ is hydrogen, X¹ is chloro, X² is CH, X³ is bromo, Y² is N, Y³ is CH and X⁴ and R² have the values listed in the table Q.

### Table 27Q:

Table 27 Q provides 120 compounds of formula (I-B) wherein G¹ is oxygen, R¹ is hydrogen, X¹ is chloro, X² is CH, X³ is bromo, Y² is CH, Y³ is N and X⁴ and R² have the values listed in the table Q.

### Table 28Q:

Table 28 Q provides 120 compounds of formula (I-B) wherein G¹ is oxygen, R¹ is hydrogen, X¹ is chloro, X² is CH, X³ is fluoro, Y² is CH, Y³ is CH and X⁴ and R² have the values listed in the table Q.

### Table 29Q:

Table 29 Q provides 120 compounds of formula (I-B) wherein G¹ is oxygen, R¹ is hydrogen, X¹ is chloro, X² is CH, X³ is fluoro, Y² is N, Y³ is CH and X⁴ and R² have the values listed in the table Q.

### Table 30Q:

Table 30 Q provides 120 compounds of formula (I-B) wherein G¹ is oxygen, R¹ is hydrogen, X¹ is chloro, X² is CH, X³ is fluoro, Y² is CH, Y³ is N and X⁴ and R² have the values listed in the table Q.

### Table 31Q:

Table 31 Q provides 120 compounds of formula (I-B) wherein G¹ is oxygen, R¹ is hydrogen, X¹ is trifluoromethyl, X² is CH, X³ is trifluoromethyl, Y² is CH, Y³ is CH and X⁴ and R² have the values listed in the table Q.

### Table 32Q:

Table 32 Q provides 120 compounds of formula (I-B) wherein G¹ is oxygen, R¹ is hydrogen, X¹ is trifluoromethyl, X² is CH, X³ is trifluoromethyl, Y² is N, Y³ is CH and X⁴ and R² have the values listed in the table Q.

### Table 33Q:

Table 33 Q provides 120 compounds of formula (I-B) wherein G¹ is oxygen, R¹ is hydrogen, X¹ is trifluoromethyl, X² is CH, X³ is trifluoromethyl, Y² is CH, Y³ is N and X⁴ and R² have the values listed in the table Q.

### Table 34Q:

Table 34 Q provides 120 compounds of formula (I-B) wherein G¹ is oxygen, R¹ is hydrogen, X¹ is trifluoromethyl, X² is C—Cl, X³ is trifluoromethyl, Y² is CH, Y³ is CH and X⁴ and R² have the values listed in the table Q.

### Table 35Q:

Table 35 Q provides 120 compounds of formula (I-B) wherein G¹ is oxygen, R¹ is hydrogen, X¹ is trifluoromethyl, X² is C—Cl, X³ is trifluoromethyl, Y² is N, Y³ is CH and X⁴ and R² have the values listed in the table Q.

### Table 36Q:

Table 36 Q provides 120 compounds of formula (I-B) wherein G¹ is oxygen, R¹ is hydrogen, X¹ is trifluoromethyl, X² is C—Cl, X³ is trifluoromethyl, Y² is CH, Y³ is N and X⁴ and R² have the values listed in the table Q.

### Table 37Q:

Table 37 Q provides 120 compounds of formula (I-B) wherein G¹ is oxygen, R¹ is hydrogen, X¹ is trifluoromethyl, X² is CH, X³ is hydrogen, Y² is CH, Y³ is CH and X⁴ and R² have the values listed in the table Q.

### Table 38Q:

Table 38 Q provides 120 compounds of formula (I-B) wherein G¹ is oxygen, R¹ is hydrogen, X¹ is trifluoromethyl, X² is CH, X³ is hydrogen, Y² is N, Y³ is CH and X⁴ and R² have the values listed in the table Q.

### Table 39Q:

Table 39 Q provides 120 compounds of formula (I-B) wherein G¹ is oxygen, R¹ is hydrogen, X¹ is trifluoromethyl, X² is CH, X³ is hydrogen, Y² is CH, Y³ is N and X⁴ and R² have the values listed in the table Q.

### Table 40Q:

Table 40 Q provides 120 compounds of formula (I-B) wherein G¹ is oxygen, R¹ is hydrogen, X¹ is chloro, X² is N, X³ is chloro, Y² is CH, Y³ is CH and X⁴ and R² have the values listed in the table Q.

### Table 41Q:

Table 41 Q provides 120 compounds of formula (I-B) wherein G¹ is oxygen, R¹ is hydrogen, X¹ is chloro, X² is N, X³ is chloro, Y² is N, Y³ is CH and X⁴ and R² have the values listed in the table Q.

### Table 42Q:

Table 42 Q provides 120 compounds of formula (I-B) wherein G¹ is oxygen, R¹ is hydrogen, X¹ is chloro, X² is N, X³ is chloro, Y² is CH, Y³ is N and X⁴ and R² have the values listed in the table Q.

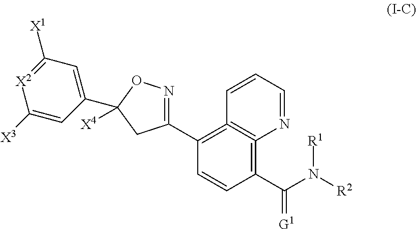

### Table 43Q:

Table 43 Q provides 120 compounds of formula (I-C) wherein G¹ is oxygen, R¹ is hydrogen, X¹ is chloro, X² is CH, X³ is chloro and X⁴ and R² have the values listed in the table Q.

### Table 44Q:

Table 44 Q provides 120 compounds of formula (I-C) wherein G¹ is oxygen, R¹ is hydrogen, X¹ is chloro, X² is C—F, X³ is hydrogen and X⁴ and R² have the values listed in the table Q.

### Table 45Q:

Table 45 Q provides 120 compounds of formula (I-C) wherein G¹ is oxygen, R¹ is hydrogen, X¹ is fluoro, X² is C—Cl, X³ is hydrogen and X⁴ and R² have the values listed in the table Q.

### Table 46Q:

Table 46 Q provides 120 compounds of formula (I-C) wherein G¹ is oxygen, R¹ is hydrogen, X¹ is chloro, X² is C—Cl, X³ is hydrogen and X⁴ and R² have the values listed in the table Q.

### Table 47Q:

Table 47 Q provides 120 compounds of formula (I-C) wherein G¹ is oxygen, R¹ is hydrogen, X¹ is chloro, X² is C—F, X³ is chloro and X⁴ and R² have the values listed in the table Q.

### Table 48Q:

Table 48Q provides 120 compounds of formula (I-C) wherein G¹ is oxygen, R¹ is hydrogen, X¹ is chloro, X² is C—Cl, X³ is chloro and X⁴ and R² have the values listed in the table Q.

### Table 49Q:

Table 49 Q provides 120 compounds of formula (I-C) wherein G¹ is oxygen, R¹ is hydrogen, X¹ is chloro, X² is C—Br, X³ is chloro and X⁴ and R² have the values listed in the table Q.

### Table 50Q:

Table 50 Q provides 120 compounds of formula (I-C) wherein G¹ is oxygen, R¹ is hydrogen, X¹ is fluoro, X² is C—F, X³ is fluoro and X⁴ and R² have the values listed in the table Q.

### Table 51Q:

Table 51 Q provides 120 compounds of formula (I-C) wherein G¹ is oxygen, R¹ is hydrogen, X¹ is chloro, X² is CH, X³ is bromo and X⁴ and R² have the values listed in the table Q.

### Table 52Q:

Table 52 Q provides 120 compounds of formula (I-C) wherein G¹ is oxygen, R¹ is hydrogen, X¹ is chloro, X² is CH, X³ is fluoro and X⁴ and R² have the values listed in the table Q.

### Table 53Q:

Table 53 Q provides 120 compounds of formula (I-C) wherein G¹ is oxygen, R¹ is hydrogen, X¹ is trifluoromethyl, X² is CH, X³ is trifluoromethyl and X⁴ and R² have the values listed in the table Q.

### Table 54Q:

Table 54 Q provides 120 compounds of formula (I-C) wherein G¹ is oxygen, R¹ is hydrogen, X¹ is trifluoromethyl, X² is C—Cl, X³ is trifluoromethyl and X⁴ and R² have the values listed in the table Q.

### Table 55Q:

Table 55 Q provides 120 compounds of formula (I-C) wherein G¹ is oxygen, R¹ is hydrogen, X¹ is trifluoromethyl, X² is CH, X³ is hydrogen and X⁴ and R² have the values listed in the table Q.

### Table 56Q:

Table 56 Q provides 120 compounds of formula (I-C) wherein G¹ is oxygen, R¹ is hydrogen, X¹ is chloro, X² is N, X³ is chloro and X⁴ and R² have the values listed in the table Q.

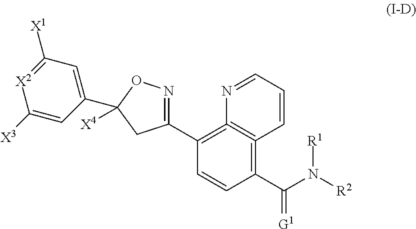

### Table 57Q:

Table 57 Q provides 120 compounds of formula (I-D) wherein G¹ is oxygen, R¹ is hydrogen, X¹ is chloro, X² is CH, X³ is chloro and X⁴ and R² have the values listed in the table Q.

### Table 58Q:

Table 58 Q provides 120 compounds of formula (I-D) wherein G¹ is oxygen, R¹ is hydrogen, X¹ is chloro, X² is C—F, X³ is hydrogen and X⁴ and R² have the values listed in the table Q.

### Table 59Q:

Table 59 Q provides 120 compounds of formula (I-D) wherein G¹ is oxygen, R¹ is hydrogen, X¹ is fluoro, X² is C—Cl, X³ is hydrogen and X⁴ and R² have the values listed in the table Q.

### Table 60Q:

Table 60 Q provides 120 compounds of formula (I-D) wherein G¹ is oxygen, R¹ is hydrogen, X¹ is chloro, X² is C—Cl, X³ is hydrogen and X⁴ and R² have the values listed in the table Q.

### Table 61Q:

Table 61 Q provides 120 compounds of formula (I-D) wherein G¹ is oxygen, R¹ is hydrogen, X¹ is chloro, X² is C—F, X³ is chloro and X⁴ and R² have the values listed in the table Q.

### Table 62Q:

Table 62Q provides 120 compounds of formula (I-D) wherein G¹ is oxygen, R¹ is hydrogen, X¹ is chloro, X² is C—Cl, X³ is chloro and X⁴ and R² have the values listed in the table Q.

### Table 63Q:

Table 63 Q provides 120 compounds of formula (I-D) wherein G¹ is oxygen, R¹ is hydrogen, X¹ is chloro, X² is C—Br, X³ is chloro and X⁴ and R² have the values listed in the table Q.

### Table 64Q:

Table 64 Q provides 120 compounds of formula (I-D) wherein G¹ is oxygen, R¹ is hydrogen, X¹ is fluoro, X² is C—F, X³ is fluoro and X⁴ and R² have the values listed in the table Q.

### Table 65Q:

Table 65 Q provides 120 compounds of formula (I-D) wherein G¹ is oxygen, R¹ is hydrogen, X¹ is chloro, X² is CH, X³ is bromo and X⁴ and R² have the values listed in the table Q.

### Table 66Q:

Table 66 Q provides 120 compounds of formula (I-D) wherein G¹ is oxygen, R¹ is hydrogen, X¹ is chloro, X² is CH, X³ is fluoro and X⁴ and R² have the values listed in the table Q.

### Table 67Q:

Table 67 Q provides 120 compounds of formula (I-D) wherein G¹ is oxygen, R¹ is hydrogen, X¹ is trifluoromethyl, X² is CH, X³ is trifluoromethyl and X⁴ and R² have the values listed in the table Q.

### Table 68Q:

Table 68 Q provides 120 compounds of formula (I-D) wherein G¹ is oxygen, R¹ is hydrogen, X¹ is trifluoromethyl, X² is C—Cl, X³ is trifluoromethyl and X⁴ and R² have the values listed in the table Q.

### Table 69Q:

Table 69 Q provides 120 compounds of formula (I-D) wherein G¹ is oxygen, R¹ is hydrogen, X¹ is trifluoromethyl, X² is CH, X³ is hydrogen and X⁴ and R² have the values listed in the table Q.

### Table 70Q:

Table 70 Q provides 120 compounds of formula (I-D) wherein G¹ is oxygen, R¹ is hydrogen, X¹ is chloro, X² is N, X³ is chloro and X⁴ and R² have the values listed in the table Q.

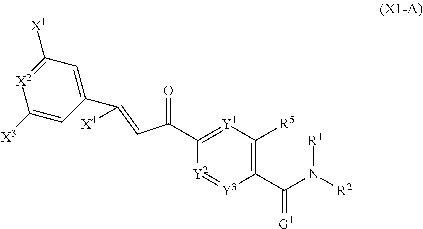

### Table 91P:

Table 91 P provides 1728 compounds of formula (X1-A) wherein G¹ is oxygen, R¹ is hydrogen, X¹ is chloro, X² is CH, X³ is chloro, Y¹ is CH, Y² is CH, Y³ is CH and X⁴, R⁵ and R² have the values listed in the table P.

### Table 92 P:

Table 92 P provides 1728 compounds of formula (X1-A) wherein G¹ is oxygen, R¹ is hydrogen, X¹ is chloro, X² is CH, X³ is chloro, Y¹ is N, Y² is CH, Y³ is CH and X⁴, R⁵ and R² have the values listed in the table P.

### Table 93 P:

Table 93 P provides 1728 compounds of formula (X1-A) wherein G¹ is oxygen, R¹ is hydrogen, X¹ is chloro, X² is CH, X³ is chloro, Y¹ is N, Y² is N, Y³ is CH and X⁴, R⁵ and R² have the values listed in the table P.

### Table 94 P:

Table 94 P provides 1728 compounds of formula (X1-A) wherein G¹ is oxygen, R¹ is hydrogen, X¹ is chloro, X² is CH, X³ is chloro, Y¹ is CH, Y² is N, Y³ is CH and X⁴, R⁵ and R² have the values listed in the table P.

### Table 95 P:

Table 95 P provides 1728 compounds of formula (X1-A) wherein G¹ is oxygen, R¹ is hydrogen, X¹ is chloro, X² is CH, X³ is chloro, Y¹ is CH, Y² is CH, Y³ is N and X⁴, R⁵ and R² have the values listed in the table P.

### Table 96 P:

Table 96 P provides 1728 compounds of formula (X1-A) wherein G¹ is oxygen, R¹ is hydrogen, X¹ is chloro, X² is C—F, X³ is hydrogen, Y¹ is CH, Y² is CH, Y³ is CH and X⁴, R⁵ and R² have the values listed in the table P.

### Table 97 P:

Table 97 P provides 1728 compounds of formula (X1-A) wherein G¹ is oxygen, R¹ is hydrogen, X¹ is chloro, X² is C—F, X³ is hydrogen, Y¹ is N, Y² is CH, Y³ is CH and X⁴, R⁵ and R² have the values listed in the table P.

### Table 98 P:

Table 98 P provides 1728 compounds of formula (X1-A) wherein G¹ is oxygen, R¹ is hydrogen, X¹ is chloro, X² is C—F, X³ is hydrogen, Y¹ is N, Y² is N, Y³ is CH and X⁴, R⁵ and R² have the values listed in the table P.

### Table 99 P:

Table 99 P provides 1728 compounds of formula (X1-A) wherein G¹ is oxygen, R¹ is hydrogen, X¹ is chloro, X² is C—F, X³ is hydrogen, Y¹ is CH, Y² is N, Y³ is CH and X⁴, R⁵ and R² have the values listed in the table P.

### Table 100 P:

Table 100 P provides 1728 compounds of formula (X1-A) wherein G¹ is oxygen, R¹ is hydrogen, X¹ is chloro, X² is C—F, X³ is hydrogen, Y¹ is CH, Y² is CH, Y³ is N and X⁴, R⁵ and R² have the values listed in the table P.

### Table 101 P:

Table 101 P provides 1728 compounds of formula (X1-A) wherein G¹ is oxygen, R¹ is hydrogen, X¹ is fluoro, X² is C—Cl, X³ is hydrogen, Y¹ is CH, Y² is CH, Y³ is CH and X⁴, R⁵ and R² have the values listed in the table P.

### Table 102 P:

Table 102 P provides 1728 compounds of formula (X1-A) wherein G¹ is oxygen, R¹ is hydrogen, X¹ is fluoro, X² is C—Cl, X³ is hydrogen, Y¹ is N, Y² is CH, Y³ is CH and X⁴, R⁵ and R² have the values listed in the table P.

### Table 103 P:

Table 103 P provides 1728 compounds of formula (X1-A) wherein G¹ is oxygen, R¹ is hydrogen, X¹ is fluoro, X² is C—Cl, X³ is hydrogen, Y¹ is N, Y² is N, Y³ is CH and X⁴, R⁵ and R² have the values listed in the table P.

### Table 104 P:

Table 104 P provides 1728 compounds of formula (X1-A) wherein G¹ is oxygen, R¹ is hydrogen, X¹ is fluoro, X² is C—Cl, X³ is hydrogen, Y¹ is CH, Y² is N, Y³ is CH and X⁴, R⁵ and R² have the values listed in the table P.

### Table 105 P:

Table 105 P provides 1728 compounds of formula (X1-A) wherein G¹ is oxygen, R¹ is hydrogen, X¹ is fluoro, X² is C—Cl, X³ is hydrogen, Y¹ is CH, Y² is CH, Y³ is N and X⁴, R⁵ and R² have the values listed in the table P.

### Table 106 P:

Table 106 P provides 1728 compounds of formula (X1-A) wherein G¹ is oxygen, R¹ is hydrogen, X¹ is chloro, X² is C—Cl, X³ is hydrogen, Y¹ is CH, Y² is CH, Y³ is CH and X⁴, R⁵ and R² have the values listed in the table P.

### Table 107 P:

Table 107 P provides 1728 compounds of formula (X1-A) wherein G¹ is oxygen, R¹ is hydrogen, X¹ is chloro, X² is C—Cl, X³ is hydrogen, Y¹ is N, Y² is CH, Y³ is CH and X⁴, R⁵ and R² have the values listed in the table P.

### Table 108 P:

Table 108 P provides 1728 compounds of formula (X1-A) wherein G¹ is oxygen, R¹ is hydrogen, X¹ is chloro, X² is C—Cl, X³ is hydrogen, Y¹ is N, Y² is N, Y³ is CH and X⁴, R⁵ and R² have the values listed in the table P.

### Table 109 P:

Table 109 P provides 1728 compounds of formula (X1-A) wherein G¹ is oxygen, R¹ is hydrogen, X¹ is chloro, X² is C—Cl, X³ is hydrogen, Y¹ is CH, Y² is N, Y³ is CH and X⁴, R⁵ and R² have the values listed in the table P.

### Table 110 P:

Table 110 P provides 1728 compounds of formula (X1-A) wherein G¹ is oxygen, R¹ is hydrogen, X¹ is chloro, X² is C—Cl, X³ is hydrogen, Y¹ is CH, Y² is CH, Y³ is N and X⁴, R⁵ and R² have the values listed in the table P.

### Table 111 P:

Table 111 P provides 1728 compounds of formula (X1-A) wherein G¹ is oxygen, R¹ is hydrogen, X¹ is chloro, X² is C—F, X³ is chloro, Y¹ is CH, Y² is CH, Y³ is CH and X⁴, R⁵ and R² have the values listed in the table P.

### Table 112 P:

Table 112 P provides 1728 compounds of formula (X1-A) wherein G¹ is oxygen, R¹ is hydrogen, X¹ is chloro, X² is C—F, X³ is chloro, Y¹ is N, Y² is CH, Y³ is CH and X⁴, R⁵ and R² have the values listed in the table P.

### Table 113 P:

Table 113 P provides 1728 compounds of formula (X1-A) wherein G¹ is oxygen, R¹ is hydrogen X¹ is chloro, X² is C—F, X³ is chloro, Y¹ is N, Y² is N, Y³ is CH and X⁴, R⁵ and R² have the values listed in the table P.

### Table 114 P:

Table 114 P provides 1728 compounds of formula (X1-A) wherein G¹ is oxygen, R¹ is hydrogen, X¹ is chloro, X² is C—F, X³ is chloro, Y¹ is CH, Y² is N, Y³ is CH and X⁴, R⁵ and R² have the values listed in the table P.

### Table 115 P:

Table 115 P provides 1728 compounds of formula (X1-A) wherein G¹ is oxygen, R¹ is hydrogen, X¹ is chloro, X² is C—F, X³ is chloro, Y¹ is CH, Y² is CH, Y³ is N and X⁴, R⁵ and R² have the values listed in the table P.

### Table 116 P:

Table 116 P provides 1728 compounds of formula (X1-A) wherein G¹ is oxygen, R¹ is hydrogen X¹ is chloro, X² is C—Cl, X³ is chloro, Y¹ is CH, Y² is CH, Y³ is CH and X⁴, R⁵ and R² have the values listed in the table P.

### Table 117 P:

Table 117 P provides 1728 compounds of formula (X1-A) wherein G¹ is oxygen, R¹ is hydrogen, X¹ is chloro, X² is C—Cl, X³ is chloro, Y¹ is N, Y² is CH, Y³ is CH and X⁴, R⁵ and R² have the values listed in the table P

### Table 118 P:

Table 118 P provides 1728 compounds of formula (X1-A) wherein G¹ is oxygen, R¹ is hydrogen, X¹ is chloro, X² is C—Cl, X³ is chloro, Y¹ is N, Y² is N, Y³ is CH and X⁴, R⁵ and R² have the values listed in the table P.

### Table 119 P:

Table 119 P provides 1728 compounds of formula (X1-A) wherein G¹ is oxygen, R¹ is hydrogen, X¹ is chloro, X² is C—Cl, X³ is chloro, Y¹ is CH, Y² is N, Y³ is CH and X⁴, R⁵ and R² have the values listed in the table P.

### Table 120 P:

Table 120 P provides 1728 compounds of formula (X1-A) wherein G¹ is oxygen, R¹ is hydrogen, X¹ is chloro, X² is C—Cl, X³ is chloro, Y¹ is CH, Y² is CH, Y³ is N and X⁴, R⁵ and R² have the values listed in the table P.

### Table 121 P:

Table 121 P provides 1728 compounds of formula (X1-A) wherein G¹ is oxygen, R¹ is hydrogen, X¹ is chloro, X² is C—Br, X³ is chloro, Y¹ is CH, Y² is CH, Y³ is CH and X⁴, R⁵ and R² have the values listed in the table P.

### Table 122 P:

Table 122 P provides 1728 compounds of formula (X1-A) wherein G¹ is oxygen, R¹ is hydrogen, X¹ is chloro, X² is C—Br, X³ is chloro, Y¹ is N, Y² is CH, Y³ is CH and X⁴, R⁵ and R² have the values listed in the table P.

### Table 123 P:

Table 123 P provides 1728 compounds of formula (X1-A) wherein G¹ is oxygen, R¹ is hydrogen, X¹ is chloro, X² is C—Br, X³ is chloro, Y¹ is N, Y² is N, Y³ is CH and X⁴, R⁵ and R² have the values listed in the table P.

### Table 124 P:

Table 124 P provides 1728 compounds of formula (X1-A) wherein G¹ is oxygen, R¹ is hydrogen, X¹ is chloro, X² is C—Br, X³ is chloro, Y¹ is CH, Y² is N, Y³ is CH and X⁴, R⁵ and R² have the values listed in the table P.

### Table 125 P:

Table 125 P provides 1728 compounds of formula (X1-A) wherein G¹ is oxygen, R¹ is hydrogen, X¹ is chloro, X² is C—Br, X³ is chloro, Y¹ is CH, Y² is CH, Y³ is N and X⁴, R⁵ and R² have the values listed in the table P.

### Table 126 P:

Table 126 P provides 1728 compounds of formula (X1-A) wherein G¹ is oxygen, R¹ is hydrogen, X¹ is chloro, X² is C—I, X³ is chloro, Y¹ is CH, Y² is CH, Y³ is CH and X⁴, R⁵ and R² have the values listed in the table P.

### Table 127 P:

Table 127 P provides 1728 compounds of formula (X1-A) wherein G¹ is oxygen, R¹ is hydrogen, X¹ is chloro, X² is C—I, X³ is chloro, Y¹ is N, Y² is CH, Y³ is CH and X⁴, R⁵ and R² have the values listed in the table P.

### Table 128 P:

Table 128 P provides 1728 compounds of formula (X1-A) wherein G¹ is oxygen, R¹ is hydrogen, X¹ is chloro, X² is C—I, X³ is chloro, Y¹ is N, Y² is N, Y³ is CH and X⁴, R⁵ and R² have the values listed in the table P.

### Table 129 P:

Table 129 P provides 1728 compounds of formula (X1-A) wherein G¹ is oxygen, R¹ is hydrogen, X¹ is chloro, X² is C—I, X³ is chloro, Y¹ is CH, Y² is N, Y³ is CH and X⁴, R⁵ and R² have the values listed in the table P.

### Table 130 P:

Table 130 P provides 1728 compounds of formula (X1-A) wherein G¹ is oxygen, R¹ is hydrogen, X¹ is chloro, X² is C—I, X³ is chloro, Y¹ is CH, Y² is CH, Y³ is N and X⁴, R⁵ and R² have the values listed in the table P.

### Table 131 P:

Table 131 P provides 1728 compounds of formula (X1-A) wherein G¹ is oxygen, R¹ is hydrogen, X¹ is fluoro, X² is C—F, X³ is fluoro, Y¹ is CH, Y² is CH, Y³ is CH and X⁴, R⁵ and R² have the values listed in the table P.

### Table 132 P:

Table 132 P provides 1728 compounds of formula (X1-A) wherein G¹ is oxygen, R¹ is hydrogen, X¹ is fluoro, X² is C—F, X³ is fluoro, Y¹ is N, Y² is CH, Y³ is CH and X⁴, R⁵ and R² have the values listed in the table P.

### Table 133 P:

Table 133 P provides 1728 compounds of formula (X1-A) wherein G¹ is oxygen, R¹ is hydrogen, X¹ is fluoro, X² is C—F, X³ is fluoro, Y¹ is N, Y² is N, Y³ is CH and X⁴, R⁵ and R² have the values listed in the table P.

### Table 134 P:

Table 134 P provides 1728 compounds of formula (X1-A) wherein G¹ is oxygen, R¹ is hydrogen, X¹ is fluoro, X² is C—F, X³ is fluoro, Y¹ is CH, Y² is N, Y³ is CH and X⁴, R⁵ and R² have the values listed in the table P.

### Table 135 P:

Table 135 P provides 1728 compounds of formula (X1-A) wherein G¹ is oxygen, R¹ is hydrogen, X¹ is fluoro, X² is C—F, X³ is fluoro, Y¹ is CH, Y² is CH, Y³ is N and X⁴, R⁵ and R² have the values listed in the table P.

### Table 136 P:

Table 136 P provides 1728 compounds of formula (X1-A) wherein G¹ is oxygen, R¹ is hydrogen, X¹ is chloro, X² is CH, X³ is bromo, Y¹ is CH, Y² is CH, Y³ is CH and X⁴, R⁵ and R² have the values listed in the table P.

### Table 137 P:

Table 137 P provides 1728 compounds of formula (X1-A) wherein G¹ is oxygen, R¹ is hydrogen, X¹ is chloro, X² is CH, X³ is bromo, Y¹ is N, Y² is CH, Y³ is CH and X⁴, R⁵ and R² have the values listed in the table P.

### Table 138 P:

Table 138 P provides 1728 compounds of formula (X1-A) wherein G¹ is oxygen, R¹ is hydrogen, X¹ is chloro, X² is CH, X³ is bromo, Y¹ is N, Y² is N, Y³ is CH and X⁴, R⁵ and R² have the values listed in the table P.

### Table 139 P:

Table 139 P provides 1728 compounds of formula (X1-A) wherein G¹ is oxygen, R¹ is hydrogen, X¹ is chloro, X² is CH, X³ is bromo, Y¹ is CH, Y² is N, Y³ is CH and X⁴, R⁵ and R² have the values listed in the table P.

### Table 140 P:

Table 140 P provides 1728 compounds of formula (X1-A) wherein G¹ is oxygen, R¹ is hydrogen, X¹ is chloro, X² is CH, X³ is bromo, Y¹ is CH, Y² is CH, Y³ is N and X⁴, R⁵ and R² have the values listed in the table P.

### Table 141 P:

Table 141 P provides 1728 compounds of formula (X1-A) wherein G¹ is oxygen, R¹ is hydrogen, X¹ is chloro, X² is CH, X³ is fluoro, Y¹ is CH, Y² is CH, Y³ is CH and X⁴, R⁵ and R² have the values listed in the table P.

### Table 142 P:

Table 142 P provides 1728 compounds of formula (X1-A) wherein G¹ is oxygen, R¹ is hydrogen, X¹ is chloro, X² is CH, X³ is fluoro, Y¹ is N, Y² is CH, Y³ is CH and X⁴, R⁵ and R² have the values listed in the table P.

### Table 143 P:

Table 143 P provides 1728 compounds of formula (X1-A) wherein G¹ is oxygen, R¹ is hydrogen, X¹ is chloro, X² is CH, X³ is fluoro, Y¹ is N, Y² is N, Y³ is CH and X⁴, R⁵ and R² have the values listed in the table P.

### Table 144 P:

Table 144 P provides 1728 compounds of formula (X1-A) wherein G¹ is oxygen, R¹ is hydrogen, X¹ is chloro, X² is CH, X³ is fluoro, Y¹ is CH, Y² is N, Y³ is CH and X⁴, R⁵ and R² have the values listed in the table P.

### Table 145 P:

Table 145 P provides 1728 compounds of formula (X1-A) wherein G¹ is oxygen, R¹ is hydrogen, X¹ is chloro, X² is CH, X³ is fluoro, Y¹ is CH, Y² is CH, Y³ is N and X⁴, R⁵ and R² have the values listed in the table P.

### Table 146 P:

Table 146 P provides 1728 compounds of formula (X1-A) wherein G¹ is oxygen, R¹ is hydrogen, X¹ is chloro, X² is CH, X³ is trifluoromethyl, Y¹ is CH, Y² is CH, Y³ is CH and X⁴, R⁵ and R² have the values listed in the table P.

### Table 147 P:

Table 147 P provides 1728 compounds of formula (X1-A) wherein G¹ is oxygen, R¹ is hydrogen, X¹ is chloro, X² is CH, X³ is trifluoromethyl, Y¹ is N, Y² is CH, Y³ is CH and X⁴, R⁵ and R² have the values listed in the table P.

### Table 148 P:

Table 148 P provides 1728 compounds of formula (X1-A) wherein G¹ is oxygen, R¹ is hydrogen, X¹ is chloro, X² is CH, X³ is trifluoromethyl, Y¹ is N, Y² is N, Y³ is CH and X⁴, R⁵ and R² have the values listed in the table P.

### Table 149 P:

Table 149 P provides 1728 compounds of formula (X1-A) wherein G¹ is oxygen, R¹ is hydrogen, X¹ is chloro, X² is CH, X³ is trifluoromethyl, Y¹ is CH, Y² is N, Y³ is CH and X⁴, R⁵ and R² have the values listed in the table P.

### Table 150 P:

Table 150 P provides 1728 compounds of formula (X1-A) wherein G¹ is oxygen, R¹ is hydrogen, X¹ is chloro, X² is CH, X³ is trifluoromethyl, Y¹ is CH, Y² is CH, Y³ is N and X⁴, R⁵ and R² have the values listed in the table P.

### Table 151 P:

Table 151 P provides 1728 compounds of formula (X1-A) wherein G¹ is oxygen, R¹ is hydrogen, X¹ is chloro, X² is C—Cl, X³ is trifluoromethyl, Y¹ is CH, Y² is CH, Y³ is CH and X⁴, R⁵ and R² have the values listed in the table P.

### Table 152 P:

Table 152 P provides 1728 compounds of formula (X1-A) wherein G¹ is oxygen, R¹ is hydrogen, X¹ is chloro, X² is C—Cl, X³ is trifluoromethyl, Y¹ is N, Y² is CH, Y³ is CH and X⁴, R⁵ and R² have the values listed in the table P.

### Table 153 P:

Table 153 P provides 1728 compounds of formula (X1-A) wherein G¹ is oxygen, R¹ is hydrogen, X¹ is chloro, X² is C—Cl, X³ is trifluoromethyl, Y¹ is N, Y² is N, Y³ is CH and X⁴, R⁵ and R² have the values listed in the table P.

### Table 154 P:

Table 154 P provides 1728 compounds of formula (X1-A) wherein G¹ is oxygen, R¹ is hydrogen, X¹ is chloro, X² is C—Cl, X³ is trifluoromethyl, Y¹ is CH, Y² is N, Y³ is CH and X⁴, R⁵ and R² have the values listed in the table P.

### Table 155 P:

Table 155 P provides 1728 compounds of formula (X1-A) wherein G¹ is oxygen, R¹ is hydrogen, X¹ is chloro, X² is C—Cl, X³ is trifluoromethyl, Y¹ is CH, Y² is CH, Y³ is N and X⁴, R⁵ and R² have the values listed in the table P.

### Table 156 P:

Table 156 P provides 1728 compounds of formula (X1-A) wherein G¹ is oxygen, R¹ is hydrogen, X¹ is trifluoromethyl, X² is CH, X³ is trifluoromethyl, Y¹ is CH, Y² is CH, Y³ is CH and X⁴, R⁵ and R² have the values listed in the table P.

### Table 157 P:

Table 157 P provides 1728 compounds of formula (X1-A) wherein G¹ is oxygen, R¹ is hydrogen, X¹ is trifluoromethyl, X² is CH, X³ is trifluoromethyl, Y¹ is N, Y² is CH, Y³ is CH and X⁴, R⁵ and R² have the values listed in the table P.

### Table 158 P:

Table 158 P provides 1728 compounds of formula (X1-A) wherein G¹ is oxygen, R¹ is hydrogen, X¹ is trifluoromethyl, X² is CH, X³ is trifluoromethyl, Y¹ is N, Y² is N, Y³ is CH and X⁴, R⁵ and R² have the values listed in the table P.

### Table 159 P:

Table 159 P provides 1728 compounds of formula (X1-A) wherein G¹ is oxygen, R¹ is hydrogen, X¹ is trifluoromethyl, X² is CH, X³ is trifluoromethyl, Y¹ is CH, Y² is N, Y³ is CH and X⁴, R⁵ and R² have the values listed in the table P.

### Table 160 P:

Table 160 P provides 1728 compounds of formula (X1-A) wherein G¹ is oxygen, R¹ is hydrogen, X¹ is trifluoromethyl, X² is CH, X³ is trifluoromethyl, Y¹ is CH, Y² is CH, Y³ is N and X⁴, R⁵ and R² have the values listed in the table P.

### Table 161 P:

Table 161 P provides 1728 compounds of formula (X1-A) wherein G¹ is oxygen, R¹ is hydrogen, X¹ is trifluoromethyl, X² is C—Cl, X³ is trifluoromethyl, Y¹ is CH, Y² is CH, Y³ is CH and X⁴, R⁵ and R² have the values listed in the table P.

### Table 162 P:

Table 162 P provides 1728 compounds of formula (X1-A) wherein G¹ is oxygen, R¹ is hydrogen, X¹ is trifluoromethyl, X² is C—Cl, X³ is trifluoromethyl, Y¹ is N, Y² is CH, Y³ is CH and X⁴, R⁵ and R² have the values listed in the table P.

### Table 163 P:

Table 163 P provides 1728 compounds of formula (X1-A) wherein G¹ is oxygen, R¹ is hydrogen, X¹ is trifluoromethyl, X² is C—Cl, X³ is trifluoromethyl, Y¹ is N, Y² is N, Y³ is CH and X⁴, R⁵ and R² have the values listed in the table P.

### Table 164 P:

Table 164 P provides 1728 compounds of formula (X1-A) wherein G¹ is oxygen, R¹ is hydrogen, X¹ is trifluoromethyl, X² is C—Cl, X³ is trifluoromethyl, Y¹ is CH, Y² is N, Y³ is CH and X⁴, R⁵ and R² have the values listed in the table P.

### Table 165 P:

Table 165 P provides 1728 compounds of formula (X1-A) wherein G¹ is oxygen, R¹ is hydrogen, X¹ is trifluoromethyl, X² is C—Cl, X³ is trifluoromethyl, Y¹ is CH, Y² is CH, Y³ is N and X⁴, R⁵ and R² have the values listed in the table P.

### Table 166 P:

Table 166 P provides 1728 compounds of formula (X1-A) wherein G¹ is oxygen, R¹ is hydrogen, X¹ is trifluoromethyl, X² is CH, X³ is hydrogen, Y¹ is CH, Y² is CH, Y³ is CH and X⁴, R⁵ and R² have the values listed in the table P.

### Table 167 P:

Table 167 P provides 1728 compounds of formula (X1-A) wherein G¹ is oxygen, R¹ is hydrogen, X¹ is trifluoromethyl, X² is CH, X³ is hydrogen, Y¹ is N, Y² is CH, Y³ is CH and X⁴, R⁵ and R² have the values listed in the table P.

### Table 168 P:

Table 168 P provides 1728 compounds of formula (X1-A) wherein G¹ is oxygen, R¹ is hydrogen, X¹ is trifluoromethyl, X² is CH, X³ is hydrogen, Y¹ is N, Y² is N, Y³ is CH and X⁴, R⁵ and R² have the values listed in the table P.

### Table 169 P:

Table 169 P provides 1728 compounds of formula (X1-A) wherein G¹ is oxygen, R¹ is hydrogen, X¹ is trifluoromethyl, X² is CH, X³ is hydrogen, Y¹ is CH, Y² is N, Y³ is CH and X⁴, R⁵ and R² have the values listed in the table P.

### Table 170 P:

Table 170 P provides 1728 compounds of formula (X1-A) wherein G¹ is oxygen, R¹ is hydrogen, X¹ is trifluoromethyl, X² is CH, X³ is hydrogen, Y¹ is CH, Y² is CH, Y³ is N and X⁴, R⁵ and R² have the values listed in the table P.

### Table 171 P:

Table 171 P provides 1728 compounds of formula (X1-A) wherein G¹ is oxygen, R¹ is hydrogen, X¹ is chloro, X² is N, X³ is chloro, Y¹ is CH, Y² is CH, Y³ is CH and X⁴, R⁵ and R² have the values listed in the table P.

### Table 172 P:

Table 172 P provides 1728 compounds of formula (X1-A) wherein G¹ is oxygen, R¹ is hydrogen, X¹ is chloro, X² is N, X³ is chloro, Y¹ is N, Y² is CH, Y³ is CH and X⁴, R⁵ and R² have the values listed in the table P.

### Table 173 P:

Table 173 P provides 1728 compounds of formula (X1-A) wherein G¹ is oxygen, R¹ is hydrogen, X¹ is chloro, X² is N, X³ is chloro, Y¹ is N, Y² is N, Y³ is CH and X⁴, R⁵ and R² have the values listed in the table P.

### Table 174 P:

Table 174 P provides 1728 compounds of formula (X1-A) wherein G¹ is oxygen, R¹ is hydrogen, X¹ is chloro, X² is N, X³ is chloro, Y¹ is CH, Y² is N, Y³ is CH and X⁴, R⁵ and R² have the values listed in the table P.

### Table 175 P:

Table 175 P provides 1728 compounds of formula (X1-A) wherein G¹ is oxygen, R¹ is hydrogen, X¹ is chloro, X² is N, X³ is chloro, Y¹ is CH, Y² is CH, Y³ is N and X⁴, R⁵ and R² have the values listed in the table P.

### Table 176 P:

Table 176 P provides 1728 compounds of formula (X1-A) wherein G¹ is oxygen, R¹ is hydrogen, X¹ is trifluoromethyl, X² is N, X³ is trifluoromethyl, Y¹ is CH, Y² is CH, Y³ is CH and X⁴, R⁵ and R² have the values listed in the table P.

### Table 177 P:

Table 177 P provides 1728 compounds of formula (X1-A) wherein G¹ is oxygen, R¹ is hydrogen, X¹ is trifluoromethyl, X² is N, X³ is trifluoromethyl, Y¹ is N, Y² is CH, Y³ is CH and X⁴, R⁵ and R² have the values listed in the table P.

### Table 178 P:

Table 178 P provides 1728 compounds of formula (X1-A) wherein G¹ is oxygen, R¹ is hydrogen, X¹ is trifluoromethyl, X² is N, X³ is trifluoromethyl, Y¹ is N, Y² is N, Y³ is CH and X⁴, R⁵ and R² have the values listed in the table P.

### Table 179 P:

Table 179 P provides 1728 compounds of formula (X1-A) wherein G¹ is oxygen, R¹ is hydrogen, X¹ is trifluoromethyl, X² is N, X³ is trifluoromethyl, Y¹ is CH, Y² is N, Y³ is CH and X⁴, R⁵ and R² have the values listed in the table P.

### Table 180 P:

Table 180 P provides 1728 compounds of formula (X1-A) wherein G¹ is oxygen, R¹ is hydrogen, X¹ is trifluoromethyl, X² is N, X³ is trifluoromethyl, Y¹ is CH, Y² is CH, Y³ is N and X⁴, R⁵ and R² have the values listed in the table P.

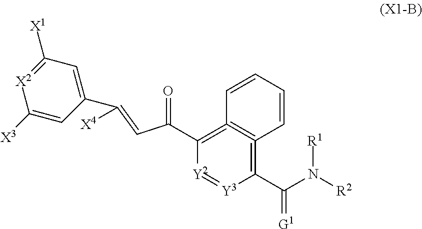

### Table 71Q:

Table 71 Q provides 120 compounds of formula (X1-B) wherein G¹ is oxygen, R¹ is hydrogen, X¹ is chloro, X² is CH, X³ is chloro, Y² is CH, Y³ is CH and X⁴ and R² have the values listed in the table Q.

### Table 72Q:

Table 72 Q provides 120 compounds of formula (X1-B) wherein G¹ is oxygen, R¹ is hydrogen, X¹ is chloro, X² is CH, X³ is chloro, Y² is N, Y³ is CH and X⁴ and R² have the values listed in the table Q.

### Table 73Q:

Table 73 Q provides 120 compounds of formula (X1-B) wherein G¹ is oxygen, R¹ is hydrogen, X¹ is chloro, X² is CH, X³ is chloro, Y² is CH, Y³ is N and X⁴ and R² have the values listed in the table Q.

### Table 74Q:

Table 74 Q provides 120 compounds of formula (X1-B) wherein G¹ is oxygen, R¹ is hydrogen, X¹ is chloro, X² is C—F, X³ is hydrogen, Y² is CH, Y³ is CH and X⁴ and R² have the values listed in the table Q.

### Table 75Q:

Table 75 Q provides 120 compounds of formula (X1-B) wherein G¹ is oxygen, R¹ is hydrogen, X¹ is chloro, X² is C—F, X³ is hydrogen, Y² is N, Y³ is CH and X⁴ and R² have the values listed in the table Q.

### Table 76Q:

Table 76 Q provides 120 compounds of formula (X1-B) wherein G¹ is oxygen, R¹ is hydrogen, X¹ is chloro, X² is C—F, X³ is hydrogen, Y² is CH, Y³ is N and X⁴ and R² have the values listed in the table Q.

### Table 77Q:

Table 77 Q provides 120 compounds of formula (X1-B) wherein G¹ is oxygen, R¹ is hydrogen, X¹ is fluoro, X² is C—Cl, X³ is hydrogen, Y² is CH, Y³ is CH and X⁴ and R² have the values listed in the table Q.

### Table 78Q:

Table 78 Q provides 120 compounds of formula (X1-B) wherein G¹ is oxygen, R¹ is hydrogen, X¹ is fluoro, X² is C—Cl, X³ is hydrogen, Y² is N, Y³ is CH and X⁴ and R² have the values listed in the table Q.

### Table 79Q:

Table 79 Q provides 120 compounds of formula (X1-B) wherein G¹ is oxygen, R¹ is hydrogen, X¹ is fluoro, X² is C—Cl, X³ is hydrogen, Y² is CH, Y³ is N and X⁴ and R² have the values listed in the table Q.

### Table 80Q:

Table 80 Q provides 120 compounds of formula (X1-B) wherein G¹ is oxygen, R¹ is hydrogen, X¹ is chloro, X² is C—Cl, X³ is hydrogen, Y² is CH, Y³ is CH and X⁴ and R² have the values listed in the table Q.

### Table 81Q:

Table 81Q provides 120 compounds of formula (X1-B) wherein G¹ is oxygen, R¹ is hydrogen, X¹ is chloro, X² is C—Cl, X³ is hydrogen, Y² is N, Y³ is CH and X⁴ and R² have the values listed in the table Q.

### Table 82Q:

Table 82 Q provides 120 compounds of formula (X1-B) wherein G¹ is oxygen, R¹ is hydrogen, X¹ is chloro, X² is C—Cl, X³ is hydrogen, Y² is CH, Y³ is N and X⁴ and R² have the values listed in the table Q.

### Table 83Q:

Table 83 Q provides 120 compounds of formula (X1-B) wherein G¹ is oxygen, R¹ is hydrogen, X¹ is chloro, X² is C—F, X³ is chloro, Y² is CH, Y³ is CH and X⁴ and R² have the values listed in the table Q.

### Table 84Q:

Table 84 Q provides 120 compounds of formula (X1-B) wherein G¹ is oxygen, R¹ is hydrogen, X¹ is chloro, X² is C—F, X³ is chloro, Y² is N, Y³ is CH and X⁴ and R² have the values listed in the table Q.

### Table 85Q:

Table 85 Q provides 120 compounds of formula (X1-B) wherein G¹ is oxygen, R¹ is hydrogen, X¹ is chloro, X² is C—F, X³ is chloro, Y² is CH, Y³ is N and X⁴ and R² have the values listed in the table Q.

### Table 86Q:

Table 86 Q provides 120 compounds of formula (X1-B) wherein G¹ is oxygen, R¹ is hydrogen, X¹ is chloro, X² is C—Cl, X³ is chloro, Y² is CH, Y³ is CH and X⁴ and R² have the values listed in the table Q.

### Table 87Q:

Table 87 Q provides 120 compounds of formula (X1-B) wherein G¹ is oxygen, R¹ is hydrogen, X¹ is chloro, X² is C—Cl, X³ is chloro, Y² is N, Y³ is CH and X⁴ and R² have the values listed in the table Q.

### Table 88Q:

Table 88 Q provides 120 compounds of formula (X1-B) wherein G¹ is oxygen, R¹ is hydrogen, X¹ is chloro, X² is C—Cl, X³ is chloro, Y² is CH, Y³ is N and X⁴ and R² have the values listed in the table Q.

### Table 89Q:

Table 89 Q provides 120 compounds of formula (X1-B) wherein G¹ is oxygen, R¹ is hydrogen, X¹ is chloro, X² is C—Br, X³ is chloro, Y² is CH, Y³ is CH and X⁴ and R² have the values listed in the table Q.

### Table 90Q:

Table 90 Q provides 120 compounds of formula (X1-B) wherein G¹ is oxygen, R¹ is hydrogen, X¹ is chloro, X² is C—Br, X³ is chloro, Y² is N, Y³ is CH and X⁴ and R² have the values listed in the table Q.

### Table 91Q:

Table 91 Q provides 120 compounds of formula (X1-B) wherein G¹ is oxygen, R¹ is hydrogen, X¹ is chloro, X² is C—Br, X³ is chloro, Y² is CH, Y³ is N and X⁴ and R² have the values listed in the table Q.

### Table 92Q:

Table 92 Q provides 120 compounds of formula (X1-B) wherein G¹ is oxygen, R¹ is hydrogen, X¹ is fluoro, X² is C—F, X³ is fluoro, Y² is CH, Y³ is CH and X⁴ and R² have the values listed in the table Q.

### Table 93Q:

Table 93 Q provides 120 compounds of formula (X1-B) wherein G¹ is oxygen, R¹ is hydrogen, X¹ is fluoro, X² is C—F, X³ is fluoro, Y² is N, Y³ is CH and X⁴ and R² have the values listed in the table Q.

### Table 94Q:

Table 94 Q provides 120 compounds of formula (X1-B) wherein G¹ is oxygen, R¹ is hydrogen, X¹ is fluoro, X² is C—F, X³ is fluoro, Y² is CH, Y³ is N and X⁴ and R² have the values listed in the table Q.

### Table 95Q:

Table 95 Q provides 120 compounds of formula (X1-B) wherein G¹ is oxygen, R¹ is hydrogen, X¹ is chloro, X² is CH, X³ is bromo, Y² is CH, Y³ is CH and X⁴ and R² have the values listed in the table Q.

### Table 96Q:

Table 96 Q provides 120 compounds of formula (X1-B) wherein G¹ is oxygen, R¹ is hydrogen, X¹ is chloro, X² is CH, X³ is bromo, Y² is N, Y³ is CH and X⁴ and R² have the values listed in the table Q.

### Table 97Q:

Table 97 Q provides 120 compounds of formula (X1-B) wherein G¹ is oxygen, R¹ is hydrogen, X¹ is chloro, X² is CH, X³ is bromo, Y² is CH, Y³ is N and X⁴ and R² have the values listed in the table Q.

### Table 98Q:

Table 98 Q provides 120 compounds of formula (X1-B) wherein G¹ is oxygen, R¹ is hydrogen, X¹ is chloro, X² is CH, X³ is fluoro, Y² is CH, Y³ is CH and X⁴ and R² have the values listed in the table Q.

### Table 99Q:

Table 99 Q provides 120 compounds of formula (X1-B) wherein G¹ is oxygen, R¹ is hydrogen, X¹ is chloro, X² is CH, X³ is fluoro, Y² is N, Y³ is CH and X⁴ and R² have the values listed in the table Q.

### Table 100Q:

Table 100 Q provides 120 compounds of formula (X1-B) wherein G¹ is oxygen, R¹ is hydrogen, X¹ is chloro, X² is CH, X³ is fluoro, Y² is CH, Y³ is N and X⁴ and R² have the values listed in the table Q.

### Table 101Q:

Table 101 Q provides 120 compounds of formula (X1-B) wherein G¹ is oxygen, R¹ is hydrogen, X¹ is trifluoromethyl, X² is CH, X³ is trifluoromethyl, Y² is CH, Y³ is CH and X⁴ and R² have the values listed in the table Q.

### Table 102Q:

Table 102 Q provides 120 compounds of formula (X1-B) wherein G¹ is oxygen, R¹ is hydrogen, X¹ is trifluoromethyl, X² is CH, X³ is trifluoromethyl, Y² is N, Y³ is CH and X⁴ and R² have the values listed in the table Q.

### Table 103Q:

Table 103 Q provides 120 compounds of formula (X1-B) wherein G¹ is oxygen, R¹ is hydrogen, X¹ is trifluoromethyl, X² is CH, X³ is trifluoromethyl, Y² is CH, Y³ is N and X⁴ and R² have the values listed in the table Q.

### Table 104Q:

Table 104 Q provides 120 compounds of formula (X1-B) wherein G¹ is oxygen, R¹ is hydrogen, X¹ is trifluoromethyl, X² is C—Cl, X³ is trifluoromethyl, Y² is CH, Y³ is CH and X⁴ and R² have the values listed in the table Q.

### Table 105Q:

Table 105 Q provides 120 compounds of formula (X1-B) wherein G¹ is oxygen, R¹ is hydrogen, X¹ is trifluoromethyl, X² is C—Cl, X³ is trifluoromethyl, Y² is N, Y³ is CH and X⁴ and R² have the values listed in the table Q.

### Table 106Q:

Table 106 Q provides 120 compounds of formula (X1-B) wherein G¹ is oxygen, R¹ is hydrogen, X¹ is trifluoromethyl, X² is C—Cl, X³ is trifluoromethyl, Y² is CH, Y³ is N and X⁴ and R² have the values listed in the table Q.

### Table 107Q:

Table 107 Q provides 120 compounds of formula (X1-B) wherein G¹ is oxygen, R¹ is hydrogen, X¹ is trifluoromethyl, X² is CH, X³ is hydrogen, Y² is CH, Y³ is CH and X⁴ and R² have the values listed in the table Q.

### Table 108Q:

Table 108 Q provides 120 compounds of formula (X1-B) wherein G¹ is oxygen, R¹ is hydrogen, X¹ is trifluoromethyl, X² is CH, X³ is hydrogen, Y² is N, Y³ is CH and X⁴ and R² have the values listed in the table Q.

### Table 109Q:

Table 109 Q provides 120 compounds of formula (X1-B) wherein G¹ is oxygen, R¹ is hydrogen, X¹ is trifluoromethyl, X² is CH, X³ is hydrogen, Y² is CH, Y³ is N and X⁴ and R² have the values listed in the table Q.

### Table 110Q:

Table 110 Q provides 120 compounds of formula (X1-B) wherein G¹ is oxygen, R¹ is hydrogen, X¹ is chloro, X² is N, X³ is chloro, Y² is CH, Y³ is CH and X⁴ and R² have the values listed in the table Q.

### Table 111Q:

Table 111 Q provides 120 compounds of formula (X1-B) wherein G¹ is oxygen, R¹ is hydrogen, X¹ is chloro, X² is N, X³ is chloro, Y² is N, Y³ is CH and X⁴ and R² have the values listed in the table Q.

### Table 112Q:

Table 112 Q provides 120 compounds of formula (X1-B) wherein G¹ is oxygen, R¹ is hydrogen, X¹ is chloro, X² is N, X³ is chloro, Y² is CH, Y³ is N and X⁴ and R² have the values listed in the table Q.

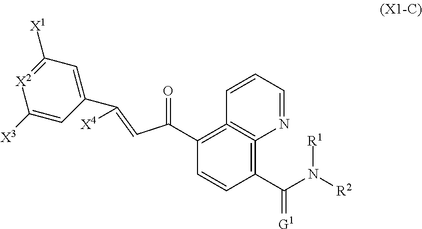

### Table 113Q:

Table 113 Q provides 120 compounds of formula (X1-C) wherein G¹ is oxygen, R¹ is hydrogen, X¹ is chloro, X² is CH, X³ is chloro and X⁴ and R² have the values listed in the table Q.

### Table 114Q:

Table 114 Q provides 120 compounds of formula (X1-C) wherein G¹ is oxygen, R¹ is hydrogen, X¹ is chloro, X² is C—F, X³ is hydrogen and X⁴ and R² have the values listed in the table Q.

### Table 115Q:

Table 115 Q provides 120 compounds of formula (X1-C) wherein G¹ is oxygen, R¹ is hydrogen, X¹ is fluoro, X² is C—Cl, X³ is hydrogen and X⁴ and R² have the values listed in the table Q.

### Table 116Q:

Table 116 Q provides 120 compounds of formula (X1-C) wherein G¹ is oxygen, R¹ is hydrogen, X¹ is chloro, X² is C—Cl, X³ is hydrogen and X⁴ and R² have the values listed in the table Q.

### Table 117Q:

Table 117 Q provides 120 compounds of formula (X1-C) wherein G¹ is oxygen, R¹ is hydrogen, X¹ is chloro, X² is C—F, X³ is chloro and X⁴ and R² have the values listed in the table Q.

### Table 118Q:

Table 118Q provides 120 compounds of formula (X1-C) wherein G¹ is oxygen, R¹ is hydrogen, X¹ is chloro, X² is C—Cl, X³ is chloro and X⁴ and R² have the values listed in the table Q.

### Table 119Q:

Table 119 Q provides 120 compounds of formula (X1-C) wherein G¹ is oxygen, R¹ is hydrogen, X¹ is chloro, X² is C—Br, X³ is chloro and X⁴ and R² have the values listed in the table Q.

### Table 120Q:

Table 120 Q provides 120 compounds of formula (X1-C) wherein G¹ is oxygen, R¹ is hydrogen, X¹ is fluoro, X² is C—F, X³ is fluoro and X⁴ and R² have the values listed in the table Q.

### Table 121Q:

Table 121 Q provides 120 compounds of formula (X1-C) wherein G¹ is oxygen, R¹ is hydrogen, X¹ is chloro, X² is CH, X³ is bromo and X⁴ and R² have the values listed in the table Q.

### Table 122Q:

Table 122 Q provides 120 compounds of formula (X1-C) wherein G¹ is oxygen, R¹ is hydrogen, X¹ is chloro, X² is CH, X³ is fluoro and X⁴ and R² have the values listed in the table Q.

### Table 123Q:

Table 123 Q provides 120 compounds of formula (X1-C) wherein G¹ is oxygen, R¹ is hydrogen, X¹ is trifluoromethyl, X² is CH, X³ is trifluoromethyl and X⁴ and R² have the values listed in the table Q.

### Table 124Q:

Table 124 Q provides 120 compounds of formula (X1-C) wherein G¹ is oxygen, R¹ is hydrogen, X¹ is trifluoromethyl, X² is C—Cl, X³ is trifluoromethyl and X⁴ and R² have the values listed in the table Q.

### Table 125Q:

Table 125 Q provides 120 compounds of formula (X1-C) wherein G¹ is oxygen, R¹ is hydrogen, X¹ is trifluoromethyl, X² is CH, X³ is hydrogen and X⁴ and R² have the values listed in the table Q.

### Table 126Q:

Table 126 Q provides 120 compounds of formula (X1-C) wherein G¹ is oxygen, R¹ is hydrogen, X¹ is chloro, X² is N, X³ is chloro and X⁴ and R² have the values listed in the table Q.

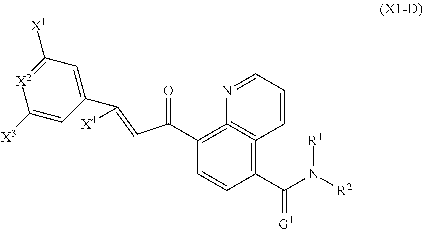

### Table 127Q:

Table 127 Q provides 120 compounds of formula (X1-D) wherein G¹ is oxygen, R¹ is hydrogen, X¹ is chloro, X² is CH, X³ is chloro and X⁴ and R² have the values listed in the table Q.

### Table 128Q:

Table 128 Q provides 120 compounds of formula (X1-D) wherein G¹ is oxygen, R¹ is hydrogen, X¹ is chloro, X² is C—F, X³ is hydrogen and X⁴ and R² have the values listed in the table Q.

### Table 129Q:

Table 129 Q provides 120 compounds of formula (X1-D) wherein G¹ is oxygen, R¹ is hydrogen, X¹ is fluoro, X² is C—Cl, X³ is hydrogen and X⁴ and R² have the values listed in the table Q.

### Table 130Q:

Table 130 Q provides 120 compounds of formula (X1-D) wherein G¹ is oxygen, R¹ is hydrogen, X¹ is chloro, X² is C—Cl, X³ is hydrogen and X⁴ and R² have the values listed in the table Q.

### Table 131Q:

Table 131 Q provides 120 compounds of formula (X1-D) wherein G¹ is oxygen, R¹ is hydrogen, X¹ is chloro, X² is C—F, X³ is chloro and X⁴ and R² have the values listed in the table Q.

### Table 132Q:

Table 312Q provides 120 compounds of formula (X1-D) wherein G¹ is oxygen, R¹ is hydrogen, X¹ is chloro, X² is C—Cl, X³ is chloro and X⁴ and R² have the values listed in the table Q.

### Table 133Q:

Table 313 Q provides 120 compounds of formula (X1-D) wherein G¹ is oxygen, R¹ is hydrogen, X¹ is chloro, X² is C—Br, X³ is chloro and X⁴ and R² have the values listed in the table Q.

### Table 134Q:

Table 134 Q provides 120 compounds of formula (X1-D) wherein G¹ is oxygen, R¹ is hydrogen, X¹ is fluoro, X² is C—F, X³ is fluoro and X⁴ and R² have the values listed in the table Q.

### Table 135Q:

Table 135 Q provides 120 compounds of formula (X1-D) wherein G¹ is oxygen, R¹ is hydrogen, X¹ is chloro, X² is CH, X³ is bromo and X⁴ and R² have the values listed in the table Q.

### Table 136Q:

Table 136 Q provides 120 compounds of formula (X1-D) wherein G¹ is oxygen, R¹ is hydrogen, X¹ is chloro, X² is CH, X³ is fluoro and X⁴ and R² have the values listed in the table Q.

### Table 137Q:

Table 137 Q provides 120 compounds of formula (X1-D) wherein G¹ is oxygen, R¹ is hydrogen, X¹ is trifluoromethyl, X² is CH, X³ is trifluoromethyl and X⁴ and R² have the values listed in the table Q.

### Table 138Q:

Table 138 Q provides 120 compounds of formula (X1-D) wherein G¹ is oxygen, R¹ is hydrogen, X¹ is trifluoromethyl, X² is C—Cl, X³ is trifluoromethyl and X⁴ and R² have the values listed in the table Q.

### Table 139Q:

Table 139 Q provides 120 compounds of formula (X1-D) wherein G¹ is oxygen, R¹ is hydrogen, X¹ is trifluoromethyl, X² is CH, X³ is hydrogen and X⁴ and R² have the values listed in the table Q.

### Table 140Q:

Table 140 Q provides 120 compounds of formula (X1-D) wherein G¹ is oxygen, R¹ is hydrogen, X¹ is chloro, X² is N, X³ is chloro and X⁴ and R² have the values listed in the table Q.

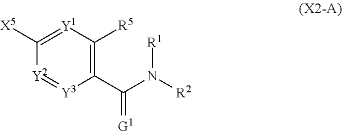

TABLE X

| | | 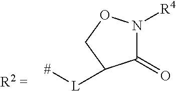 | |
|---|---|---|---|
| | R⁵ | L | R⁴ |
| X.001 | bromo | bond | hydrogen |
| X.002 | bromo | bond | methyl- |
| X.003 | bromo | bond | ethyl- |
| X.004 | bromo | bond | 2,2,2-trifluoro-ethyl- |
| X.005 | bromo | bond | 3,3,3-trifluoro-propyl- |
| X.006 | bromo | bond | 2-methoxy-ethyl- |
| X.007 | bromo | bond | 2-hydroxy-ethyl- |
| X.008 | bromo | bond | cyclobutyl- |
| X.009 | bromo | bond | phenyl-methyl- |
| X.010 | bromo | bond | (pyrid-2-yl)-methyl- |
| X.011 | bromo | bond | (pyrid-3-yl)-methyl- |
| X.012 | bromo | bond | thietan-3-yl- |
| X.013 | bromo | bond | 1-oxo-thietan-3-yl- |
| X.014 | bromo | bond | 1,1-dioxo-thietan-3-yl- |
| X.015 | bromo | bond | 3-methyl-thietan-3-yl- |
| X.016 | bromo | bond | oxetan-3yl- |
| X.017 | bromo | bond | tetrahydropyran-4-yl- |
| X.018 | bromo | bond | cyclopropyl- |
| X.019 | bromo | bond | 2-cyano-ethyl- |
| X.020 | bromo | bond | 2,2-difluoro-ethyl- |
| X.021 | bromo | bond | prop-2-ynyl- |
| X.022 | bromo | bond | cyclopropylmethyl- |
| X.023 | bromo | bond | cyclobutylmethyl- |
| X.024 | bromo | bond | 3-cyano-propyl- |
| X.025 | bromo | bond | 2-([1′,3′]dioxolan-2′-yl)-eth- |
| | | | 1-yl- |
| X.026 | bromo | bond | (2-chloro-pyrid-5-yl)-methyl- |
| X.027 | bromo | bond | tetrahydro-pyran-2-ylmethyl- |
| X.028 | bromo | bond | allyl- |
| X.029 | bromo | bond | 3-methyl-but-2-enyl- |
| X.030 | bromo | bond | butyl- |
| X.031 | bromo | bond | but-2-ynyl- |
| X.032 | bromo | bond | 2-methoxyimino-propyl |
| X.033 | bromo | bond | (2,6-difluoro-phenyl)-methyl- |
| X.034 | bromo | bond | (4-fluoro-phenyl)-methyl- |
| X.035 | bromo | bond | 3-phenyl-propyl- |
| X.036 | bromo | bond | 2,5-dimethyl-2H-[1,2,3]triazol- |
| | | | 4-ylmethyl- |
| X.037 | bromo | bond | cyclohexylmethyl- |
| X.038 | bromo | bond | (tetrahydrofuran-2-yl)- |
| | | | methyl- |
| X.039 | bromo | bond | 5-trifluoromethyl-furan- |
| | | | 2-ylmethyl- |
| X.040 | bromo | bond | isopropyl- |
| X.041 | chloro | bond | hydrogen |
| X.042 | chloro | bond | methyl- |
| X.043 | chloro | bond | ethyl- |
| X.044 | chloro | bond | 2,2,2-trifluoro-ethyl- |
| X.045 | chloro | bond | 3,3,3-trifluoro-propyl- |
| X.046 | chloro | bond | 2-methoxy-ethyl- |
| X.047 | chloro | bond | 2-hydroxy-ethyl- |
| X.048 | chloro | bond | cyclobutyl- |
| X.049 | chloro | bond | phenyl-methyl- |
| X.050 | chloro | bond | (pyrid-2-yl)-methyl- |
| X.051 | chloro | bond | (pyrid-3-yl)-methyl- |
| X.052 | chloro | bond | thietan-3-yl- |
| X.053 | chloro | bond | 1-oxo-thietan-3-yl- |
| X.054 | chloro | bond | 1,1-dioxo-thietan-3-yl- |
| X.055 | chloro | bond | 3-methyl-thietan-3-yl- |
| X.056 | chloro | bond | oxetan-3yl- |
| X.057 | chloro | bond | tetrahydropyran-4-yl- |
| X.058 | chloro | bond | cyclopropyl- |
| X.059 | chloro | bond | 2-cyano-ethyl- |
| X.060 | chloro | bond | 2,2-difluoro-ethyl- |
| X.061 | chloro | bond | prop-2-ynyl- |
| X.062 | chloro | bond | cyclopropylmethyl- |
| X.063 | chloro | bond | cyclobutylmethyl- |
| X.064 | chloro | bond | 3-cyano-propyl- |
| X.065 | chloro | bond | 2-([1′,3′]dioxolan-2′-yl)-eth- |
| | | | 1-yl- |
| X.066 | chloro | bond | (2-chloro-pyrid-5-yl)-methyl- |
| X.067 | chloro | bond | tetrahydro-pyran-2-ylmethyl- |
| X.068 | chloro | bond | allyl- |
| X.069 | chloro | bond | 3-methyl-but-2-enyl- |
| X.070 | chloro | bond | butyl- |
| X.071 | chloro | bond | but-2-ynyl- |
| X.072 | chloro | bond | 2-methoxyimino-propyl |
| X.073 | chloro | bond | (2,6-difluoro-phenyl)-methyl- |
| X.074 | chloro | bond | (4-fluoro-phenyl)-methyl- |
| X.075 | chloro | bond | 3-phenyl-propyl- |
| X.076 | chloro | bond | 2,5-dimethyl-2H-[1,2,3]triazol- |
| | | | 4-ylmethyl- |
| X.077 | chloro | bond | cyclohexylmethyl- |
| X.078 | chloro | bond | (tetrahydrofuran-2-yl)- |
| | | | methyl- |
| X.079 | chloro | bond | 5-trifluoromethyl-furan- |
| | | | 2-ylmethyl- |
| X.080 | chloro | bond | isopropyl- |
| X.081 | cyano | bond | hydrogen |
| X.082 | cyano | bond | methyl- |
| X.083 | cyano | bond | ethyl- |
| X.084 | cyano | bond | 2,2,2-trifluoro-ethyl- |
| X.085 | cyano | bond | 3,3,3-trifluoro-propyl- |
| X.086 | cyano | bond | 2-methoxy-ethyl- |
| X.087 | cyano | bond | 2-hydroxy-ethyl- |
| X.088 | cyano | bond | cyclobutyl- |
| X.089 | cyano | bond | phenyl-methyl- |
| X.090 | cyano | bond | (pyrid-2-yl)-methyl- |
| X.091 | cyano | bond | (pyrid-3-yl)-methyl- |
| X.092 | cyano | bond | thietan-3-yl- |
| X.093 | cyano | bond | 1-oxo-thietan-3-yl- |
| X.094 | cyano | bond | 1,1-dioxo-thietan-3-yl- |
| X.095 | cyano | bond | 3-methyl-thietan-3-yl- |
| X.096 | cyano | bond | oxetan-3yl- |
| X.097 | cyano | bond | tetrahydropyran-4-yl- |
| X.098 | cyano | bond | cyclopropyl- |
| X.099 | cyano | bond | 2-cyano-ethyl- |
| X.100 | cyano | bond | 2,2-difluoro-ethyl- |
| X.101 | cyano | bond | prop-2-ynyl- |
| X.102 | cyano | bond | cyclopropylmethyl- |
| X.103 | cyano | bond | cyclobutylmethyl- |
| X.104 | cyano | bond | 3-cyano-propyl- |
| X.105 | cyano | bond | 2-([1′,3′]dioxolan-2′-yl)-eth- |
| | | | 1-yl- |
| X.106 | cyano | bond | (2-chloro-pyrid-5-yl)-methyl- |
| X.107 | cyano | bond | tetrahydro-pyran-2-ylmethyl- |
| X.108 | cyano | bond | allyl- |
| X.109 | cyano | bond | 3-methyl-but-2-enyl- |
| X.110 | cyano | bond | butyl- |
| X.111 | cyano | bond | but-2-ynyl- |
| X.112 | cyano | bond | 2-methoxyimino-propyl |
| X.113 | cyano | bond | (2,6-difluoro-phenyl)-methyl- |
| X.114 | cyano | bond | (4-fluoro-phenyl)-methyl- |
| X.115 | cyano | bond | 3-phenyl-propyl- |
| X.116 | cyano | bond | 2,5-dimethyl-2H-[1,2,3]triazol- |
| | | | 4-ylmethyl- |
| X.117 | cyano | bond | cyclohexylmethyl- |
| X.118 | cyano | bond | (tetrahydrofuran-2-yl)- |
| | | | methyl- |
| X.119 | cyano | bond | 5-trifluoromethyl-furan- |
| | | | 2-ylmethyl- |
| X.120 | cyano | bond | isopropyl- |
| X.121 | cyclopropyl | bond | hydrogen |
| X.122 | cyclopropyl | bond | methyl- |
| X.123 | cyclopropyl | bond | ethyl- |
| X.124 | cyclopropyl | bond | 2,2,2-trifluoro-ethyl- |
| X.125 | cyclopropyl | bond | 3,3,3-trifluoro-propyl- |
| X.126 | cyclopropyl | bond | 2-methoxy-ethyl- |
| X.127 | cyclopropyl | bond | 2-hydroxy-ethyl- |
| X.128 | cyclopropyl | bond | cyclobutyl- |
| X.129 | cyclopropyl | bond | phenyl-methyl- |
| X.130 | cyclopropyl | bond | (pyrid-2-yl)-methyl- |
| X.131 | cyclopropyl | bond | (pyrid-3-yl)-methyl- |
| X.132 | cyclopropyl | bond | thietan-3-yl- |
| X.133 | cyclopropyl | bond | 1-oxo-thietan-3-yl- |
| X.134 | cyclopropyl | bond | 1,1-dioxo-thietan-3-yl- |
| X.135 | cyclopropyl | bond | 3-methyl-thietan-3-yl- |
| X.136 | cyclopropyl | bond | oxetan-3yl- |
| X.137 | cyclopropyl | bond | tetrahydropyran-4-yl- |
| X.138 | cyclopropyl | bond | cyclopropyl- |
| X.139 | cyclopropyl | bond | 2-cyano-ethyl- |
| X.140 | cyclopropyl | bond | 2,2-difluoro-ethyl- |
| X.141 | cyclopropyl | bond | prop-2-ynyl- |
| X.142 | cyclopropyl | bond | cyclopropylmethyl- |
| X.143 | cyclopropyl | bond | cyclobutylmethyl- |
| X.144 | cyclopropyl | bond | 3-cyano-propyl- |
| X.145 | cyclopropyl | bond | 2-([1′,3′]dioxolan-2′-yl)-eth- |
| | | | 1-yl- |
| X.146 | cyclopropyl | bond | (2-chloro-pyrid-5-yl)-methyl- |
| X.147 | cyclopropyl | bond | tetrahydro-pyran-2-ylmethyl- |
| X.148 | cyclopropyl | bond | allyl- |
| X.149 | cyclopropyl | bond | 3-methyl-but-2-enyl- |
| X.150 | cyclopropyl | bond | butyl- |
| X.151 | cyclopropyl | bond | but-2-ynyl- |
| X.152 | cyclopropyl | bond | 2-methoxyimino-propyl |
| X.153 | cyclopropyl | bond | (2,6-difluoro-phenyl)-methyl- |
| X.154 | cyclopropyl | bond | (4-fluoro-phenyl)-methyl- |
| X.155 | cyclopropyl | bond | 3-phenyl-propyl- |
| X.156 | cyclopropyl | bond | 2,5-dimethyl-2H-[1,2,3]triazol- |
| | | | 4-ylmethyl- |
| X.157 | cyclopropyl | bond | cyclohexylmethyl- |
| X.158 | cyclopropyl | bond | (tetrahydrofuran-2-yl)- |
| | | | methyl- |
| X.159 | cyclopropyl | bond | 5-trifluoromethyl-furan- |
| | | | 2-ylmethyl- |
| X.160 | cyclopropyl | bond | isopropyl- |
| X.161 | ethyl | bond | hydrogen |
| X.162 | ethyl | bond | methyl- |
| X.163 | ethyl | bond | ethyl- |
| X.164 | ethyl | bond | 2,2,2-trifluoro-ethyl- |
| X.165 | ethyl | bond | 3,3,3-trifluoro-propyl- |
| X.166 | ethyl | bond | 2-methoxy-ethyl- |
| X.167 | ethyl | bond | 2-hydroxy-ethyl- |
| X.168 | ethyl | bond | cyclobutyl- |
| X.169 | ethyl | bond | phenyl-methyl- |
| X.170 | ethyl | bond | (pyrid-2-yl)-methyl- |
| X.171 | ethyl | bond | (pyrid-3-yl)-methyl- |
| X.172 | ethyl | bond | thietan-3-yl- |
| X.173 | ethyl | bond | 1-oxo-thietan-3-yl- |
| X.174 | ethyl | bond | 1,1-dioxo-thietan-3-yl- |
| X.175 | ethyl | bond | 3-methyl-thietan-3-yl- |
| X.176 | ethyl | bond | oxetan-3yl- |
| X.177 | ethyl | bond | tetrahydropyran-4-yl- |
| X.178 | ethyl | bond | cyclopropyl- |
| X.179 | ethyl | bond | 2-cyano-ethyl- |
| X.180 | ethyl | bond | 2,2-difluoro-ethyl- |
| X.181 | ethyl | bond | prop-2-ynyl- |
| X.182 | ethyl | bond | cyclopropylmethyl- |
| X.183 | ethyl | bond | cyclobutylmethyl- |
| X.184 | ethyl | bond | 3-cyano-propyl- |
| X.185 | ethyl | bond | 2-([1′,3′]dioxolan-2′-yl)-eth- |
| | | | 1-yl- |
| X.186 | ethyl | bond | (2-chloro-pyrid-5-yl)-methyl- |
| X.187 | ethyl | bond | tetrahydro-pyran-2-ylmethyl- |
| X.188 | ethyl | bond | allyl- |
| X.189 | ethyl | bond | 3-methyl-but-2-enyl- |
| X.190 | ethyl | bond | butyl- |
| X.191 | ethyl | bond | but-2-ynyl- |
| X.192 | ethyl | bond | 2-methoxyimino-propyl |
| X.193 | ethyl | bond | (2,6-difluoro-phenyl)-methyl- |
| X.194 | ethyl | bond | (4-fluoro-phenyl)-methyl- |
| X.195 | ethyl | bond | 3-phenyl-propyl- |
| X.196 | ethyl | bond | 2,5-dimethyl-2H-[1,2,3]triazol- |
| | | | 4-ylmethyl- |
| X.197 | ethyl | bond | cyclohexylmethyl- |
| X.198 | ethyl | bond | (tetrahydrofuran-2-yl)- |
| | | | methyl- |
| X.199 | ethyl | bond | 5-trifluoromethyl-furan- |
| | | | 2-ylmethyl- |
| X.200 | fluoro | bond | isopropyl- |
| X.201 | fluoro | bond | hydrogen |
| X.202 | fluoro | bond | methyl- |
| X.203 | fluoro | bond | ethyl- |
| X.204 | fluoro | bond | 2,2,2-trifluoro-ethyl- |
| X.205 | fluoro | bond | 3,3,3-trifluoro-propyl- |
| X.206 | fluoro | bond | 2-methoxy-ethyl- |
| X.207 | fluoro | bond | 2-hydroxy-ethyl- |
| X.208 | fluoro | bond | cyclobutyl- |
| X.209 | fluoro | bond | phenyl-methyl- |
| X.210 | fluoro | bond | (pyrid-2-yl)-methyl- |
| X.211 | fluoro | bond | (pyrid-3-yl)-methyl- |
| X.212 | fluoro | bond | thietan-3-yl- |
| X.213 | fluoro | bond | 1-oxo-thietan-3-yl- |
| X.214 | fluoro | bond | 1,1-dioxo-thietan-3-yl- |
| X.215 | fluoro | bond | 3-methyl-thietan-3-yl- |
| X.216 | fluoro | bond | oxetan-3yl- |
| X.217 | fluoro | bond | tetrahydropyran-4-yl- |
| X.218 | fluoro | bond | cyclopropyl- |
| X.219 | fluoro | bond | 2-cyano-ethyl- |
| X.220 | fluoro | bond | 2,2-difluoro-ethyl- |
| X.221 | fluoro | bond | prop-2-ynyl- |
| X.222 | fluoro | bond | cyclopropylmethyl- |
| X.223 | fluoro | bond | cyclobutylmethyl- |
| X.224 | fluoro | bond | 3-cyano-propyl- |
| X.225 | fluoro | bond | 2-([1′,3′]dioxolan-2′-yl)-eth- |
| | | | 1-yl- |
| X.226 | fluoro | bond | (2-chloro-pyrid-5-yl)-methyl- |
| X.227 | fluoro | bond | tetrahydro-pyran-2-ylmethyl- |
| X.228 | fluoro | bond | allyl- |
| X.229 | fluoro | bond | 3-methyl-but-2-enyl- |
| X.230 | fluoro | bond | butyl- |
| X.231 | fluoro | bond | but-2-ynyl- |
| X.232 | fluoro | bond | 2-methoxyimino-propyl |
| X.233 | fluoro | bond | (2,6-difluoro-phenyl)-methyl- |
| X.234 | fluoro | bond | (4-fluoro-phenyl)-methyl- |
| X.235 | fluoro | bond | 3-phenyl-propyl- |
| X.236 | fluoro | bond | 2,5-dimethyl-2H-[1,2,3]triazol- |
| | | | 4-ylmethyl- |
| X.237 | fluoro | bond | cyclohexylmethyl- |
| X.238 | fluoro | bond | (tetrahydrofuran-2-yl)- |
| | | | methyl- |
| X.239 | fluoro | bond | 5-trifluoromethyl-furan- |
| | | | 2-ylmethyl- |
| X.240 | fluoro | bond | isopropyl- |
| X.241 | hydrogen | bond | hydrogen |
| X.242 | hydrogen | bond | methyl- |
| X.243 | hydrogen | bond | ethyl- |
| X.244 | hydrogen | bond | 2,2,2-trifluoro-ethyl- |
| X.245 | hydrogen | bond | 3,3,3-trifluoro-propyl- |
| X.246 | hydrogen | bond | 2-methoxy-ethyl- |
| X.247 | hydrogen | bond | 2-hydroxy-ethyl- |
| X.248 | hydrogen | bond | cyclobutyl- |
| X.249 | hydrogen | bond | phenyl-methyl- |
| X.250 | hydrogen | bond | (pyrid-2-yl)-methyl- |
| X.251 | hydrogen | bond | (pyrid-3-yl)-methyl- |
| X.252 | hydrogen | bond | thietan-3-yl- |
| X.253 | hydrogen | bond | 1-oxo-thietan-3-yl- |
| X.254 | hydrogen | bond | 1,1-dioxo-thietan-3-yl- |
| X.255 | hydrogen | bond | 3-methyl-thietan-3-yl- |
| X.256 | hydrogen | bond | oxetan-3yl- |
| X.257 | hydrogen | bond | tetrahydropyran-4-yl- |
| X.258 | hydrogen | bond | cyclopropyl- |
| X.259 | hydrogen | bond | 2-cyano-ethyl- |
| X.260 | hydrogen | bond | 2,2-difluoro-ethyl- |
| X.261 | hydrogen | bond | prop-2-ynyl- |
| X.262 | hydrogen | bond | cyclopropylmethyl- |
| X.263 | hydrogen | bond | cyclobutylmethyl- |
| X.264 | hydrogen | bond | 3-cyano-propyl- |
| X.265 | hydrogen | bond | 2-([1′,3′]dioxolan-2′-yl)-eth- |
| | | | 1-yl- |
| X.266 | hydrogen | bond | (2-chloro-pyrid-5-yl)-methyl- |
| X.267 | hydrogen | bond | tetrahydro-pyran-2-ylmethyl- |
| X.268 | hydrogen | bond | allyl- |
| X.269 | hydrogen | bond | 3-methyl-but-2-enyl- |
| X.270 | hydrogen | bond | butyl- |
| X.271 | hydrogen | bond | but-2-ynyl- |
| X.272 | hydrogen | bond | 2-methoxyimino-propyl |
| X.273 | hydrogen | bond | (2,6-difluoro-phenyl)-methyl- |
| X.274 | hydrogen | bond | (4-fluoro-phenyl)-methyl- |
| X.275 | hydrogen | bond | 3-phenyl-propyl- |
| X.276 | hydrogen | bond | 2,5-dimethyl-2H-[1,2,3]triazol- |
| | | | 4-ylmethyl- |
| X.277 | hydrogen | bond | cyclohexylmethyl- |
| X.278 | hydrogen | bond | (tetrahydrofuran-2-yl)- |
| | | | methyl- |
| X.279 | hydrogen | bond | 5-trifluoromethyl-furan- |
| | | | 2-ylmethyl- |
| X.280 | hydrogen | bond | isopropyl- |
| X.281 | methoxy | bond | hydrogen |
| X.282 | methoxy | bond | methyl- |
| X.283 | methoxy | bond | ethyl- |
| X.284 | methoxy | bond | 2,2,2-trifluoro-ethyl- |
| X.285 | methoxy | bond | 3,3,3-trifluoro-propyl- |
| X.286 | methoxy | bond | 2-methoxy-ethyl- |
| X.287 | methoxy | bond | 2-hydroxy-ethyl- |
| X.288 | methoxy | bond | cyclobutyl- |
| X.289 | methoxy | bond | phenyl-methyl- |
| X.290 | methoxy | bond | (pyrid-2-yl)-methyl- |
| X.291 | methoxy | bond | (pyrid-3-yl)-methyl- |
| X.292 | methoxy | bond | thietan-3-yl- |
| X.293 | methoxy | bond | 1-oxo-thietan-3-yl- |
| X.294 | methoxy | bond | 1,1-dioxo-thietan-3-yl- |
| X.295 | methoxy | bond | 3-methyl-thietan-3-yl- |
| X.296 | methoxy | bond | oxetan-3yl- |
| X.297 | methoxy | bond | tetrahydropyran-4-yl- |
| X.298 | methoxy | bond | cyclopropyl- |
| X.299 | methoxy | bond | 2-cyano-ethyl- |
| X.300 | methoxy | bond | 2,2-difluoro-ethyl- |
| X.301 | methoxy | bond | prop-2-ynyl- |
| X.302 | methoxy | bond | cyclopropylmethyl- |
| X.303 | methoxy | bond | cyclobutylmethyl- |
| X.304 | methoxy | bond | 3-cyano-propyl- |
| X.305 | methoxy | bond | 2-([1′,3′]dioxolan-2′-yl)-eth- |
| | | | 1-yl- |
| X.306 | methoxy | bond | (2-chloro-pyrid-5-yl)-methyl- |
| X.307 | methoxy | bond | tetrahydro-pyran-2-ylmethyl- |
| X.308 | methoxy | bond | allyl- |
| X.309 | methoxy | bond | 3-methyl-but-2-enyl- |
| X.310 | methoxy | bond | butyl- |
| X.311 | methoxy | bond | but-2-ynyl- |
| X.312 | methoxy | bond | 2-methoxyimino-propyl |
| X.313 | methoxy | bond | (2,6-difluoro-phenyl)-methyl- |
| X.314 | methoxy | bond | (4-fluoro-phenyl)-methyl- |
| X.315 | methoxy | bond | 3-phenyl-propyl- |
| X.316 | methoxy | bond | 2,5-dimethyl-2H-[1,2,3]triazol- |
| | | | 4-ylmethyl- |
| X.317 | methoxy | bond | cyclohexylmethyl- |
| X.318 | methoxy | bond | (tetrahydrofuran-2-yl)- |
| | | | methyl- |
| X.319 | methoxy | bond | 5-trifluoromethyl-furan- |
| | | | 2-ylmethyl- |
| X.320 | methoxy | bond | isopropyl- |
| X.321 | methyl | bond | hydrogen |
| X.322 | methyl | bond | methyl- |
| X.323 | methyl | bond | ethyl- |
| X.324 | methyl | bond | 2,2,2-trifluoro-ethyl- |
| X.325 | methyl | bond | 3,3,3-trifluoro-propyl- |
| X.326 | methyl | bond | 2-methoxy-ethyl- |
| X.327 | methyl | bond | 2-hydroxy-ethyl- |
| X.328 | methyl | bond | cyclobutyl- |
| X.329 | methyl | bond | phenyl-methyl- |
| X.330 | methyl | bond | (pyrid-2-yl)-methyl- |
| X.331 | methyl | bond | (pyrid-3-yl)-methyl- |
| X.332 | methyl | bond | thietan-3-yl- |
| X.333 | methyl | bond | 1-oxo-thietan-3-yl- |
| X.334 | methyl | bond | 1,1-dioxo-thietan-3-yl- |
| X.335 | methyl | bond | 3-methyl-thietan-3-yl- |
| X.336 | methyl | bond | oxetan-3yl- |
| X.337 | methyl | bond | tetrahydropyran-4-yl- |
| X.338 | methyl | bond | cyclopropyl- |
| X.339 | methyl | bond | 2-cyano-ethyl- |
| X.340 | methyl | bond | 2,2-difluoro-ethyl- |
| X.341 | methyl | bond | prop-2-ynyl- |
| X.342 | methyl | bond | cyclopropylmethyl- |
| X.343 | methyl | bond | cyclobutylmethyl- |
| X.344 | methyl | bond | 3-cyano-propyl- |
| X.345 | methyl | bond | 2-([1′,3′]dioxolan-2′-yl)-eth- |
| | | | 1-yl- |
| X.346 | methyl | bond | (2-chloro-pyrid-5-yl)-methyl- |
| X.347 | methyl | bond | tetrahydro-pyran-2-ylmethyl- |
| X.348 | methyl | bond | allyl- |
| X.349 | methyl | bond | 3-methyl-but-2-enyl- |
| X.350 | methyl | bond | butyl- |
| X.351 | methyl | bond | but-2-ynyl- |
| X.352 | methyl | bond | 2-methoxyimino-propyl |
| X.353 | methyl | bond | (2,6-difluoro-phenyl)-methyl- |
| X.354 | methyl | bond | (4-fluoro-phenyl)-methyl- |
| X.355 | methyl | bond | 3-phenyl-propyl- |
| X.356 | methyl | bond | 2,5-dimethyl-2H-[1,2,3]triazol- |
| | | | 4-ylmethyl- |
| X.357 | methyl | bond | cyclohexylmethyl- |
| X.358 | methyl | bond | (tetrahydrofuran-2-yl)- |
| | | | methyl- |
| X.359 | methyl | bond | 5-trifluoromethyl-furan- |
| | | | 2-ylmethyl- |
| X.360 | methyl | bond | isopropyl- |
| X.361 | nitro | bond | hydrogen |
| X.362 | nitro | bond | methyl- |
| X.363 | nitro | bond | ethyl- |
| X.364 | nitro | bond | 2,2,2-trifluoro-ethyl- |
| X.365 | nitro | bond | 3,3,3-trifluoro-propyl- |
| X.366 | nitro | bond | 2-methoxy-ethyl- |
| X.367 | nitro | bond | 2-hydroxy-ethyl- |
| X.368 | nitro | bond | cyclobutyl- |
| X.369 | nitro | bond | phenyl-methyl- |
| X.370 | nitro | bond | (pyrid-2-yl)-methyl- |
| X.371 | nitro | bond | (pyrid-3-yl)-methyl- |
| X.372 | nitro | bond | thietan-3-yl- |
| X.373 | nitro | bond | 1-oxo-thietan-3-yl- |
| X.374 | nitro | bond | 1,1-dioxo-thietan-3-yl- |
| X.375 | nitro | bond | 3-methyl-thietan-3-yl- |
| X.376 | nitro | bond | oxetan-3yl- |
| X.377 | nitro | bond | tetrahydropyran-4-yl- |
| X.378 | nitro | bond | cyclopropyl- |
| X.379 | nitro | bond | 2-cyano-ethyl- |
| X.380 | nitro | bond | 2,2-difluoro-ethyl- |
| X.381 | nitro | bond | prop-2-ynyl- |
| X.382 | nitro | bond | cyclopropylmethyl- |
| X.383 | nitro | bond | cyclobutylmethyl- |
| X.384 | nitro | bond | 3-cyano-propyl- |
| X.385 | nitro | bond | 2-([1′,3′]dioxolan-2′-yl)-eth- |
| | | | 1-yl- |
| X.386 | nitro | bond | (2-chloro-pyrid-5-yl)-methyl- |
| X.387 | nitro | bond | tetrahydro-pyran-2-ylmethyl- |
| X.388 | nitro | bond | allyl- |
| X.389 | nitro | bond | 3-methyl-but-2-enyl- |
| X.390 | nitro | bond | butyl- |
| X.391 | nitro | bond | but-2-ynyl- |
| X.392 | nitro | bond | 2-methoxyimino-propyl |
| X.393 | nitro | bond | (2,6-difluoro-phenyl)-methyl- |
| X.394 | nitro | bond | (4-fluoro-phenyl)-methyl- |
| X.395 | nitro | bond | 3-phenyl-propyl- |
| X.396 | nitro | bond | 2,5-dimethyl-2H-[1,2,3]triazol- |
| | | | 4-ylmethyl- |
| X.397 | nitro | bond | cyclohexylmethyl- |
| X.398 | nitro | bond | (tetrahydrofuran-2-yl)- |
| | | | methyl- |
| X.399 | nitro | bond | 5-trifluoromethyl-furan- |
| | | | 2-ylmethyl- |
| X.400 | nitro | bond | isopropyl- |
| X.401 | trifluoromethoxy | bond | hydrogen |
| X.402 | trifluoromethoxy | bond | methyl- |
| X.403 | trifluoromethoxy | bond | ethyl- |
| X.404 | trifluoromethoxy | bond | 2,2,2-trifluoro-ethyl- |
| X.405 | trifluoromethoxy | bond | 3,3,3-trifluoro-propyl- |
| X.406 | trifluoromethoxy | bond | 2-methoxy-ethyl- |
| X.407 | trifluoromethoxy | bond | 2-hydroxy-ethyl- |
| X.408 | trifluoromethoxy | bond | cyclobutyl- |
| X.409 | trifluoromethoxy | bond | phenyl-methyl- |
| X.410 | trifluoromethoxy | bond | (pyrid-2-yl)-methyl- |
| X.411 | trifluoromethoxy | bond | (pyrid-3-yl)-methyl- |
| X.412 | trifluoromethoxy | bond | thietan-3-yl- |
| X.413 | trifluoromethoxy | bond | 1-oxo-thietan-3-yl- |
| X.414 | trifluoromethoxy | bond | 1,1-dioxo-thietan-3-yl- |
| X.415 | trifluoromethoxy | bond | 3-methyl-thietan-3-yl- |
| X.416 | trifluoromethoxy | bond | oxetan-3yl- |
| X.417 | trifluoromethoxy | bond | tetrahydropyran-4-yl- |
| X.418 | trifluoromethoxy | bond | cyclopropyl- |
| X.419 | trifluoromethoxy | bond | 2-cyano-ethyl- |
| X.420 | trifluoromethoxy | bond | 2,2-difluoro-ethyl- |
| X.421 | trifluoromethoxy | bond | prop-2-ynyl- |
| X.422 | trifluoromethoxy | bond | cyclopropylmethyl- |
| X.423 | trifluoromethoxy | bond | cyclobutylmethyl- |
| X.424 | trifluoromethoxy | bond | 3-cyano-propyl- |
| X.425 | trifluoromethoxy | bond | 2-([1′,3′]dioxolan-2′-yl)-eth- |
| | | | 1-yl- |
| X.426 | trifluoromethoxy | bond | (2-chloro-pyrid-5-yl)-methyl- |
| X.427 | trifluoromethoxy | bond | tetrahydro-pyran-2-ylmethyl- |
| X.428 | trifluoromethoxy | bond | allyl- |
| X.429 | trifluoromethoxy | bond | 3-methyl-but-2-enyl- |
| X.430 | trifluoromethoxy | bond | butyl- |
| X.431 | trifluoromethoxy | bond | but-2-ynyl- |
| X.432 | trifluoromethoxy | bond | 2-methoxyimino-propyl |
| X.433 | trifluoromethoxy | bond | (2,6-difluoro-phenyl)-methyl- |
| X.434 | trifluoromethoxy | bond | (4-fluoro-phenyl)-methyl- |
| X.435 | trifluoromethoxy | bond | 3-phenyl-propyl- |
| X.436 | trifluoromethoxy | bond | 2,5-dimethyl-2H-[1,2,3]triazol- |
| | | | 4-ylmethyl- |
| X.437 | trifluoromethoxy | bond | cyclohexylmethyl- |
| X.438 | trifluoromethoxy | bond | (tetrahydrofuran-2-yl)- |
| | | | methyl- |
| X.439 | trifluoromethoxy | bond | 5-trifluoromethyl-furan- |
| | | | 2-ylmethyl- |
| X.440 | trifluoromethoxy | bond | isopropyl- |
| X.441 | trifluoromethyl | bond | hydrogen |
| X.442 | trifluoromethyl | bond | methyl- |
| X.443 | trifluoromethyl | bond | ethyl- |
| X.444 | trifluoromethyl | bond | 2,2,2-trifluoro-ethyl- |
| X.445 | trifluoromethyl | bond | 3,3,3-trifluoro-propyl- |
| X.446 | trifluoromethyl | bond | 2-methoxy-ethyl- |
| X.447 | trifluoromethyl | bond | 2-hydroxy-ethyl- |
| X.448 | trifluoromethyl | bond | cyclobutyl- |
| X.449 | trifluoromethyl | bond | phenyl-methyl- |
| X.450 | trifluoromethyl | bond | (pyrid-2-yl)-methyl- |
| X.451 | trifluoromethyl | bond | (pyrid-3-yl)-methyl- |
| X.452 | trifluoromethyl | bond | thietan-3-yl- |
| X.453 | trifluoromethyl | bond | 1-oxo-thietan-3-yl- |
| X.454 | trifluoromethyl | bond | 1,1-dioxo-thietan-3-yl- |
| X.455 | trifluoromethyl | bond | 3-methyl-thietan-3-yl- |
| X.456 | trifluoromethyl | bond | oxetan-3yl- |
| X.457 | trifluoromethyl | bond | tetrahydropyran-4-yl- |
| X.458 | trifluoromethyl | bond | cyclopropyl- |
| X.459 | trifluoromethyl | bond | 2-cyano-ethyl- |
| X.460 | trifluoromethyl | bond | 2,2-difluoro-ethyl- |
| X.461 | trifluoromethyl | bond | prop-2-ynyl- |
| X.462 | trifluoromethyl | bond | cyclopropylmethyl- |
| X.463 | trifluoromethyl | bond | cyclobutylmethyl- |
| X.464 | trifluoromethyl | bond | 3-cyano-propyl- |
| X.465 | trifluoromethyl | bond | 2-([1′,3′]dioxolan-2′-yl)-eth- |
| | | | 1-yl- |
| X.466 | trifluoromethyl | bond | (2-chloro-pyrid-5-yl)-methyl- |
| X.467 | trifluoromethyl | bond | tetrahydro-pyran-2-ylmethyl- |
| X.468 | trifluoromethyl | bond | allyl- |
| X.469 | trifluoromethyl | bond | 3-methyl-but-2-enyl- |
| X.470 | trifluoromethyl | bond | butyl- |
| X.471 | trifluoromethyl | bond | but-2-ynyl- |
| X.472 | trifluoromethyl | bond | 2-methoxyimino-propyl |
| X.473 | trifluoromethyl | bond | (2,6-difluoro-phenyl)-methyl- |
| X.474 | trifluoromethyl | bond | (4-fluoro-phenyl)-methyl- |
| X.475 | trifluoromethyl | bond | 3-phenyl-propyl- |
| X.476 | trifluoromethyl | bond | 2,5-dimethyl-2H-[1,2,3]triazol- |
| | | | 4-ylmethyl- |
| X.477 | trifluoromethyl | bond | cyclohexylmethyl- |
| X.478 | trifluoromethyl | bond | (tetrahydrofuran-2-yl)- |
| | | | methyl- |
| X.479 | trifluoromethyl | bond | 5-trifluoromethyl-furan- |
| | | | 2-ylmethyl- |
| X.480 | trifluoromethyl | bond | isopropyl- |
| X.481 | bromo | CH₂ | hydrogen |
| X.482 | bromo | CH₂ | methyl- |
| X.483 | bromo | CH₂ | ethyl- |
| X.484 | bromo | CH₂ | 2,2,2-trifluoro-ethyl- |
| X.485 | bromo | CH₂CH₂ | hydrogen |
| X.486 | bromo | CH₂CH₂ | methyl- |
| X.487 | bromo | CH₂CH₂ | ethyl- |
| X.488 | bromo | CH₂CH₂ | 2,2,2-trifluoro-ethyl- |
| X.489 | chloro | CH₂ | hydrogen |
| X.490 | chloro | CH₂ | methyl- |
| X.491 | chloro | CH₂ | ethyl- |
| X.492 | chloro | CH₂ | 2,2,2-trifluoro-ethyl- |
| X.493 | chloro | CH₂CH₂ | hydrogen |
| X.494 | chloro | CH₂CH₂ | methyl- |
| X.495 | chloro | CH₂CH₂ | ethyl- |
| X.496 | chloro | CH₂CH₂ | 2,2,2-trifluoro-ethyl- |
| X.497 | cyano | CH₂ | hydrogen |
| X.498 | cyano | CH₂ | methyl- |
| X.499 | cyano | CH₂ | ethyl- |
| X.500 | cyano | CH₂ | 2,2,2-trifluoro-ethyl- |
| X.501 | cyano | CH₂CH₂ | hydrogen |
| X.502 | cyano | CH₂CH₂ | methyl- |
| X.503 | cyano | CH₂CH₂ | ethyl- |
| X.504 | cyano | CH₂CH₂ | 2,2,2-trifluoro-ethyl- |
| X.505 | cyclopropyl | CH₂ | hydrogen |
| X.506 | cyclopropyl | CH₂ | methyl- |
| X.507 | cyclopropyl | CH₂ | ethyl- |
| X.508 | cyclopropyl | CH₂ | 2,2,2-trifluoro-ethyl- |
| X.509 | cyclopropyl | CH₂CH₂ | hydrogen |
| X.510 | cyclopropyl | CH₂CH₂ | methyl- |
| X.511 | cyclopropyl | CH₂CH₂ | ethyl- |
| X.512 | cyclopropyl | CH₂CH₂ | 2,2,2-trifluoro-ethyl- |
| X.513 | ethyl | CH₂ | hydrogen |
| X.514 | ethyl | CH₂ | methyl- |
| X.515 | ethyl | CH₂ | ethyl- |
| X.516 | ethyl | CH₂ | 2,2,2-trifluoro-ethyl- |
| X.517 | ethyl | CH₂CH₂ | hydrogen |
| X.518 | ethyl | CH₂CH₂ | methyl- |
| X.519 | ethyl | CH₂CH₂ | ethyl- |
| X.520 | ethyl | CH₂CH₂ | 2,2,2-trifluoro-ethyl- |
| X.521 | fluoro | CH₂ | hydrogen |
| X.522 | fluoro | CH₂ | methyl- |
| X.523 | fluoro | CH₂ | ethyl- |
| X.524 | fluoro | CH₂ | 2,2,2-trifluoro-ethyl- |
| X.525 | fluoro | CH₂CH₂ | hydrogen |
| X.526 | fluoro | CH₂CH₂ | methyl- |
| X.527 | fluoro | CH₂CH₂ | ethyl- |
| X.528 | fluoro | CH₂CH₂ | 2,2,2-trifluoro-ethyl- |
| X.529 | hydrogen | CH₂ | hydrogen |
| X.530 | hydrogen | CH₂ | methyl- |
| X.531 | hydrogen | CH₂ | ethyl- |
| X.532 | hydrogen | CH₂ | 2,2,2-trifluoro-ethyl- |
| X.533 | hydrogen | CH₂CH₂ | hydrogen |
| X.534 | hydrogen | CH₂CH₂ | methyl- |
| X.535 | hydrogen | CH₂CH₂ | ethyl- |
| X.536 | hydrogen | CH₂CH₂ | 2,2,2-trifluoro-ethyl- |
| X.537 | methoxy | CH₂ | hydrogen |
| X.538 | methoxy | CH₂ | methyl- |
| X.539 | methoxy | CH₂ | ethyl- |
| X.540 | methoxy | CH₂ | 2,2,2-trifluoro-ethyl- |
| X.541 | methoxy | CH₂CH₂ | hydrogen |
| X.542 | methoxy | CH₂CH₂ | methyl- |
| X.543 | methoxy | CH₂CH₂ | ethyl- |
| X.544 | methoxy | CH₂CH₂ | 2,2,2-trifluoro-ethyl- |
| X.545 | methyl | CH₂ | hydrogen |
| X.546 | methyl | CH₂ | methyl- |
| X.547 | methyl | CH₂ | ethyl- |
| X.548 | methyl | CH₂ | 2,2,2-trifluoro-ethyl- |
| X.549 | methyl | CH₂CH₂ | hydrogen |
| X.550 | methyl | CH₂CH₂ | methyl- |
| X.551 | methyl | CH₂CH₂ | ethyl- |
| X.552 | methyl | CH₂CH₂ | 2,2,2-trifluoro-ethyl- |
| X.553 | nitro | CH₂ | hydrogen |
| X.554 | nitro | CH₂ | methyl- |
| X.555 | nitro | CH₂ | ethyl- |
| X.556 | nitro | CH₂ | 2,2,2-trifluoro-ethyl- |
| X.557 | nitro | CH₂CH₂ | hydrogen |
| X.558 | nitro | CH₂CH₂ | methyl- |
| X.559 | nitro | CH₂CH₂ | ethyl- |
| X.560 | nitro | CH₂CH₂ | 2,2,2-trifluoro-ethyl- |
| X.561 | trifluoromethoxy | CH₂ | hydrogen |
| X.562 | trifluoromethoxy | CH₂ | methyl- |
| X.563 | trifluoromethoxy | CH₂ | ethyl- |
| X.564 | trifluoromethoxy | CH₂ | 2,2,2-trifluoro-ethyl- |
| X.565 | trifluoromethoxy | CH₂CH₂ | hydrogen |
| X.566 | trifluoromethoxy | CH₂CH₂ | methyl- |
| X.567 | trifluoromethoxy | CH₂CH₂ | ethyl- |
| X.568 | trifluoromethoxy | CH₂CH₂ | 2,2,2-trifluoro-ethyl- |
| X.569 | trifluoromethyl | CH₂ | hydrogen |
| X.570 | trifluoromethyl | CH₂ | methyl- |
| X.571 | trifluoromethyl | CH₂ | ethyl- |
| X.572 | trifluoromethyl | CH₂ | 2,2,2-trifluoro-ethyl- |
| X.573 | trifluoromethyl | CH₂CH₂ | hydrogen |
| X.574 | trifluoromethyl | CH₂CH₂ | methyl- |
| X.575 | trifluoromethyl | CH₂CH₂ | ethyl- |
| X.576 | trifluoromethyl | CH₂CH₂ | 2,2,2-trifluoro-ethyl- |

### Table 1X:

Table 1X provides 576 compounds of formula (X2-A) wherein G¹ is oxygen, R¹ is hydrogen, Y¹ is CH, Y² is CH, Y³ is CH, X⁵ is chloro, R⁵ and R² have the values listed in the table X.

### Table 2X:

Table 2X provides 576 compounds of formula (X2-A) wherein G¹ is oxygen, R¹ is hydrogen, Y¹ is CH, Y² is CH, Y³ is CH, X⁵ is bromo, R⁵ and R² have the values listed in the table X.

### Table 3X:

Table 3X provides 576 compounds of formula (X2-A) wherein G¹ is oxygen, R¹ is hydrogen, Y¹ is CH, Y² is CH, Y³ is CH, X⁵ is iodo, R⁵ and R² have the values listed in the table X.

### Table 4X:

Table 4X provides 576 compounds of formula (X2-A) wherein G¹ is oxygen, R¹ is hydrogen, Y¹ is CH, Y² is CH, Y³ is CH, X⁵ is amino, R⁵ and R² have the values listed in the table X.

### Table 5X:

Table 5X provides 576 compounds of formula (X2-A) wherein G¹ is oxygen, R¹ is hydrogen, Y¹ is CH, Y² is CH, Y³ is CH, X⁵ is CHO, R⁵ and R² have the values listed in the table X.

### Table 6X:

Table 6X provides 576 compounds of formula (X2-A) wherein G¹ is oxygen, R¹ is hydrogen, Y¹ is CH, Y² is CH, Y³ is CH, X⁵ is CN, R⁵ and R² have the values listed in the table X.

### Table 7X:

Table 7X provides 576 compounds of formula (X2-A) wherein G¹ is oxygen, R¹ is hydrogen, Y¹ is CH, Y² is CH, Y³ is CH, X⁵ is OH, R⁵ and R² have the values listed in the table X.

### Table 8X:

Table 8X provides 576 compounds of formula (X2-A) wherein G¹ is oxygen, R¹ is hydrogen, Y¹ is CH, Y² is CH, Y³ is CH, X⁵ is C(═O)OH, R⁵ and R² have the values listed in the table X.

### Table 9X:

Table 9X provides 576 compounds of formula (X2-A) wherein G¹ is oxygen, R¹ is hydrogen, Y¹ is CH, Y² is CH, Y³ is CH, X⁵ is C(═NOH)H, R⁵ and R² have the values listed in the table X.

### Table 10X:

Table 10X provides 576 compounds of formula (X2-A) wherein G¹ is oxygen, R¹ is hydrogen, Y¹ is CH, Y² is CH, Y³ is CH, X⁵ is C(═NOH)Cl, R⁵ and R² have the values listed in the table X.

### Table 11X:

Table 11X provides 576 compounds of formula (X2-A) wherein G¹ is oxygen, R¹ is hydrogen, Y¹ is CH, Y² is CH, Y³ is CH, X⁵ is C(═NOH)NH₂, R⁵ and R² have the values listed in the table X.

### Table 12X:

Table 12X provides 576 compounds of formula (X2-A) wherein G¹ is oxygen, R¹ is hydrogen, Y¹ is CH, Y² is CH, Y³ is CH, X⁵ is C(═O)CH₃, R⁵ and R² have the values listed in the table X.

### Table 13X:

Table 13X provides 576 compounds of formula (X2-A) wherein G¹ is oxygen, R¹ is hydrogen, Y¹ is CH, Y² is CH, Y³ is CH, X⁵ is C(═NOH)CH₃, R⁵ and R² have the values listed in the table X.

### Table 14X:

Table 14X provides 576 compounds of formula (X2-A) wherein G¹ is oxygen, R¹ is hydrogen, Y¹ is CH, Y² is CH, Y³ is CH, X⁵ is C(═O)CH₂Cl, R⁵ and R² have the values listed in the table X.

### Table 15X:

Table 15X provides 576 compounds of formula (X2-A) wherein G¹ is oxygen, R¹ is hydrogen, Y¹ is CH, Y² is CH, Y³ is CH, X⁵ is C(═O)CH₂Br, R⁵ and R² have the values listed in the table X.

### Table 16X:

Table 16X provides 576 compounds of formula (X2-A) wherein G¹ is oxygen, R¹ is hydrogen, Y¹ is N, Y² is CH, Y³ is CH, X⁵ is chloro, R⁵ and R² have the values listed in the table X.

### Table 17X:

Table 17X provides 576 compounds of formula (X2-A) wherein G¹ is oxygen, R¹ is hydrogen, Y¹ is N, Y² is CH, Y³ is CH, X⁵ is bromo, R⁵ and R² have the values listed in the table X.

### Table 18X:

Table 18X provides 576 compounds of formula (X2-A) wherein G¹ is oxygen, R¹ is hydrogen, Y¹ is N, Y² is CH, Y³ is CH, X⁵ is iodo, R⁵ and R² have the values listed in the table X.

### Table 19X:

Table 19X provides 576 compounds of formula (X2-A) wherein G¹ is oxygen, R¹ is hydrogen, Y¹ is N, Y² is CH, Y³ is CH, X⁵ is amino, R⁵ and R² have the values listed in the table X.

### Table 20X:

Table 20X provides 576 compounds of formula (X2-A) wherein G¹ is oxygen, R¹ is hydrogen, Y¹ is N, Y² is CH, Y³ is CH, X⁵ is CHO, R⁵ and R² have the values listed in the table X.

### Table 21X:

Table 21X provides 576 compounds of formula (X2-A) wherein G¹ is oxygen, R¹ is hydrogen, Y¹ is N, Y² is CH, Y³ is CH, X⁵ is CN, R⁵ and R² have the values listed in the table X.

### Table 22X:

Table 22X provides 576 compounds of formula (X2-A) wherein G¹ is oxygen, R¹ is hydrogen, Y¹ is N, Y² is CH, Y³ is CH, X⁵ is OH, R⁵ and R² have the values listed in the table X.

### Table 23X:

Table 23X provides 576 compounds of formula (X2-A) wherein G¹ is oxygen, R¹ is hydrogen, Y¹ is N, Y² is CH, Y³ is CH, X⁵ is C(═O)OH, R⁵ and R² have the values listed in the table X.

### Table 24X:

Table 24X provides 576 compounds of formula (X2-A) wherein G¹ is oxygen, R¹ is hydrogen, Y¹ is N, Y² is CH, Y³ is CH, X⁵ is C(═NOH)H, R⁵ and R² have the values listed in the table X.

### Table 25X:

Table 25X provides 576 compounds of formula (X2-A) wherein G¹ is oxygen, R¹ is hydrogen, Y¹ is N, Y² is CH, Y³ is CH, X⁵ is C(═NOH)Cl, R⁵ and R² have the values listed in the table X.

### Table 26X:

Table 26X provides 576 compounds of formula (X2-A) wherein G¹ is oxygen, R¹ is hydrogen, Y¹ is N, Y² is CH, Y³ is CH, X⁵ is C(═NOH)NH₂, R⁵ and R² have the values listed in the table X.

### Table 27X:

Table 27X provides 576 compounds of formula (X2-A) wherein G¹ is oxygen, R¹ is hydrogen, Y¹ is N, Y² is CH, Y³ is CH, X⁵ is C(═O)CH₃, R⁵ and R² have the values listed in the table X.

### Table 28X:

Table 28X provides 576 compounds of formula (X2-A) wherein G¹ is oxygen, R¹ is hydrogen, Y¹ is N, Y² is CH, Y³ is CH, X⁵ is C(═NOH)CH₃, R⁵ and R² have the values listed in the table X.

### Table 29X:

Table 29X provides 576 compounds of formula (X2-A) wherein G¹ is oxygen, R¹ is hydrogen, Y¹ is N, Y² is CH, Y³ is CH, X⁵ is C(═O)CH₂Cl, R⁵ and R² have the values listed in the table X.

### Table 30X:

Table 30X provides 576 compounds of formula (X2-A) wherein G¹ is oxygen, R¹ is hydrogen, Y¹ is N, Y² is CH, Y³ is CH, X⁵ is C(═O)CH₂Br, R⁵ and R² have the values listed in the table X.

### Table 31X:

Table 31X provides 576 compounds of formula (X2-A) wherein G¹ is oxygen, R¹ is hydrogen, Y¹ is N, Y² is N, Y³ is CH, X⁵ is chloro, R⁵ and R² have the values listed in the table X.

### Table 32X:

Table 32X provides 576 compounds of formula (X2-A) wherein G¹ is oxygen, R¹ is hydrogen, Y¹ is N, Y² is N, Y³ is CH, X⁵ is bromo, R⁵ and R² have the values listed in the table X.

### Table 33X:

Table 33X provides 576 compounds of formula (X2-A) wherein G¹ is oxygen, R¹ is hydrogen, Y¹ is N, Y² is N, Y³ is CH, X⁵ is iodo, R⁵ and R² have the values listed in the table X.

### Table 34X:

Table 34X provides 576 compounds of formula (X2-A) wherein G¹ is oxygen, R¹ is hydrogen, Y¹ is N, Y² is N, Y³ is CH, X⁵ is amino, R⁵ and R² have the values listed in the table X.

### Table 35X:

Table 35X provides 576 compounds of formula (X2-A) wherein G¹ is oxygen, R¹ is hydrogen, Y¹ is N, Y² is N, Y³ is CH, X⁵ is CHO, R⁵ and R² have the values listed in the table X.

### Table 36X:

Table 36X provides 576 compounds of formula (X2-A) wherein G¹ is oxygen, R¹ is hydrogen, Y¹ is N, Y² is N, Y³ is CH, X⁵ is CN, R⁵ and R² have the values listed in the table X.

### Table 37X:

Table 37X provides 576 compounds of formula (X2-A) wherein G¹ is oxygen, R¹ is hydrogen, Y¹ is N, Y² is N, Y³ is CH, X⁵ is OH, R⁵ and R² have the values listed in the table X.

### Table 38X:

Table 38X provides 576 compounds of formula (X2-A) wherein G¹ is oxygen, R¹ is hydrogen, Y¹ is N, Y² is N, Y³ is CH, X⁵ is C(═O)OH, R⁵ and R² have the values listed in the table X.

### Table 39X:

Table 39X provides 576 compounds of formula (X2-A) wherein G¹ is oxygen, R¹ is hydrogen, Y¹ is N, Y² is N, Y³ is CH, X⁵ is C(═NOH)H, R⁵ and R² have the values listed in the table X.

### Table 40X:

Table 40X provides 576 compounds of formula (X2-A) wherein G¹ is oxygen, R¹ is hydrogen, Y¹ is N, Y² is N, Y³ is CH, X⁵ is C(═NOH)Cl, R⁵ and R² have the values listed in the table X.

### Table 41X:

Table 41X provides 576 compounds of formula (X2-A) wherein G¹ is oxygen, R¹ is hydrogen, Y¹ is N, Y² is N, Y³ is CH, X⁵ is C(═NOH)NH₂, R⁵ and R² have the values listed in the table X.

### Table 42X:

Table 42X provides 576 compounds of formula (X2-A) wherein G¹ is oxygen, R¹ is hydrogen, Y¹ is N, Y² is N, Y³ is CH, X⁵ is C(═O)CH₃, R⁵ and R² have the values listed in the table X.

### Table 43X:

Table 43X provides 576 compounds of formula (X2-A) wherein G¹ is oxygen, R¹ is hydrogen, Y¹ is N, Y² is N, Y³ is CH, X⁵ is C(═NOH)CH₃, R⁵ and R² have the values listed in the table X.

### Table 44X:

Table 44X provides 576 compounds of formula (X2-A) wherein G¹ is oxygen, R¹ is hydrogen, Y¹ is N, Y² is N, Y³ is CH, X⁵ is C(═O)CH₂Cl, R⁵ and R² have the values listed in the table X.

### Table 45X:

Table 45X provides 576 compounds of formula (X2-A) wherein G¹ is oxygen, R¹ is hydrogen, Y¹ is N, Y² is N, Y³ is CH, X⁵ is C(═O)CH₂Br, R⁵ and R² have the values listed in the table X.

### Table 46X:

Table 46X provides 576 compounds of formula (X2-A) wherein G¹ is oxygen, R¹ is hydrogen, Y¹ is CH, Y² is N, Y³ is CH, X⁵ is chloro, R⁵ and R² have the values listed in the table X.

### Table 47X:

Table 47X provides 576 compounds of formula (X2-A) wherein G¹ is oxygen, R¹ is hydrogen, Y¹ is CH, Y² is N, Y³ is CH, X⁵ is bromo, R⁵ and R² have the values listed in the table X.

### Table 48X:

Table 48X provides 576 compounds of formula (X2-A) wherein G¹ is oxygen, R¹ is hydrogen, Y¹ is CH, Y² is N, Y³ is CH, X⁵ is iodo, R⁵ and R² have the values listed in the table X.

### Table 49X:

Table 49X provides 576 compounds of formula (X2-A) wherein G¹ is oxygen, R¹ is hydrogen, Y¹ is CH, Y² is N, Y³ is CH, X⁵ is amino, R⁵ and R² have the values listed in the table X.

### Table 50X:

Table 50X provides 576 compounds of formula (X2-A) wherein G¹ is oxygen, R¹ is hydrogen, Y¹ is CH, Y² is N, Y³ is CH, X⁵ is CHO, R⁵ and R² have the values listed in the table X.

### Table 51X:

Table 51X provides 576 compounds of formula (X2-A) wherein G¹ is oxygen, R¹ is hydrogen, Y¹ is CH, Y² is N, Y³ is CH, X⁵ is CN, R⁵ and R² have the values listed in the table X.

### Table 52X:

Table 52X provides 576 compounds of formula (X2-A) wherein G¹ is oxygen, R¹ is hydrogen, Y¹ is CH, Y² is N, Y³ is CH, X⁵ is OH, R⁵ and R² have the values listed in the table X.

### Table 53X:

Table 53X provides 576 compounds of formula (X2-A) wherein G¹ is oxygen, R¹ is hydrogen, Y¹ is CH, Y² is N, Y³ is CH, X⁵ is C(═O)OH, R⁵ and R² have the values listed in the table X.

### Table 54X:

Table 54X provides 576 compounds of formula (X2-A) wherein G¹ is oxygen, R¹ is hydrogen, Y¹ is CH, Y² is N, Y³ is CH, X⁵ is C(═NOH)H, R⁵ and R² have the values listed in the table X.

### Table 55X:

Table 55X provides 576 compounds of formula (X2-A) wherein G¹ is oxygen, R¹ is hydrogen, Y¹ is CH, Y² is N, Y³ is CH, X⁵ is C(═NOH)Cl, R⁵ and R² have the values listed in the table X.

### Table 56X:

Table 56X provides 576 compounds of formula (X2-A) wherein G¹ is oxygen, R¹ is hydrogen, Y¹ is CH, Y² is N, Y³ is CH, X⁵ is C(═NOH)NH₂, R⁵ and R² have the values listed in the table X.

### Table 57X:

Table 57X provides 576 compounds of formula (X2-A) wherein G¹ is oxygen, R¹ is hydrogen, Y¹ is CH, Y² is N, Y³ is CH, X⁵ is C(═O)CH₃, R⁵ and R² have the values listed in the table X.

### Table 58X:

Table 58X provides 576 compounds of formula (X2-A) wherein G¹ is oxygen, R¹ is hydrogen, Y¹ is CH, Y² is N, Y³ is CH, X⁵ is C(═NOH)CH₃, R⁵ and R² have the values listed in the table X.

### Table 59X:

Table 59X provides 576 compounds of formula (X2-A) wherein G¹ is oxygen, R¹ is hydrogen, Y¹ is CH, Y² is N, Y³ is CH, X⁵ is C(═O)CH₂Cl, R⁵ and R² have the values listed in the table X.

### Table 60X:

Table 60X provides 576 compounds of formula (X2-A) wherein G¹ is oxygen, R¹ is hydrogen, Y¹ is CH, Y² is N, Y³ is CH, X⁵ is C(═O)CH₂Br, R⁵ and R² have the values listed in the table X.

### Table 61X:

Table 61X provides 576 compounds of formula (X2-A) wherein G¹ is oxygen, R¹ is hydrogen, Y¹ is CH, Y² is CH, Y³ is N, X⁵ is chloro, R⁵ and R² have the values listed in the table X.

### Table 62X:

Table 62X provides 576 compounds of formula (X2-A) wherein G¹ is oxygen, R¹ is hydrogen, Y¹ is CH, Y² is CH, Y³ is N, X⁵ is bromo, R⁵ and R² have the values listed in the table X.

### Table 63X:

Table 63X provides 576 compounds of formula (X2-A) wherein G¹ is oxygen, R¹ is hydrogen, Y¹ is CH, Y² is CH, Y³ is N, X⁵ is iodo, R⁵ and R² have the values listed in the table X.

### Table 64X:

Table 64X provides 576 compounds of formula (X2-A) wherein G¹ is oxygen, R¹ is hydrogen, Y¹ is CH, Y² is CH, Y³ is N, X⁵ is amino, R⁵ and R² have the values listed in the table X.

### Table 65X:

Table 65X provides 576 compounds of formula (X2-A) wherein G¹ is oxygen, R¹ is hydrogen, Y¹ is CH, Y² is CH, Y³ is N, X⁵ is CHO, R⁵ and R² have the values listed in the table X.

### Table 66X:

Table 66X provides 576 compounds of formula (X2-A) wherein G¹ is oxygen, R¹ is hydrogen, Y¹ is CH, Y² is CH, Y³ is N, X⁵ is CN, R⁵ and R² have the values listed in the table X.

### Table 67X:

Table 67X provides 576 compounds of formula (X2-A) wherein G¹ is oxygen, R¹ is hydrogen, Y¹ is CH, Y² is CH, Y³ is N, X⁵ is OH, R⁵ and R² have the values listed in the table X.

### Table 68X:

Table 68X provides 576 compounds of formula (X2-A) wherein G¹ is oxygen, R¹ is hydrogen, Y¹ is CH, Y² is CH, Y³ is N, X⁵ is C(═O)OH, R⁵ and R² have the values listed in the table X.

### Table 69X:

Table 69X provides 576 compounds of formula (X2-A) wherein G¹ is oxygen, R¹ is hydrogen, Y¹ is CH, Y² is CH, Y³ is N, X⁵ is C(═NOH)H, R⁵ and R² have the values listed in the table X.

### Table 70X:

Table 70X provides 576 compounds of formula (X2-A) wherein G¹ is oxygen, R¹ is hydrogen, Y¹ is CH, Y² is CH, Y³ is N, X⁵ is C(═NOH)Cl, R⁵ and R² have the values listed in the table X.

### Table 71X:

Table 71X provides 576 compounds of formula (X2-A) wherein G¹ is oxygen, R¹ is hydrogen, Y¹ is CH, Y² is CH, Y³ is N, X⁵ is C(═NOH)NH₂, R⁵ and R² have the values listed in the table X.

### Table 72X:

Table 72X provides 576 compounds of formula (X2-A) wherein G¹ is oxygen, R¹ is hydrogen, Y¹ is CH, Y² is CH, Y³ is N, X⁵ is C(═O)CH₃, R⁵ and R² have the values listed in the table X.

### Table 73X:

Table 73X provides 576 compounds of formula (X2-A) wherein G¹ is oxygen, R¹ is hydrogen, Y¹ is CH, Y² is CH, Y³ is N, X⁵ is C(═NOH)CH₃, R⁵ and R² have the values listed in the table X.

### Table 74X:

Table 74X provides 576 compounds of formula (X2-A) wherein G¹ is oxygen, R¹ is hydrogen, Y¹ is CH, Y² is CH, Y³ is N, X⁵ is C(═O)CH₂Cl, R⁵ and R² have the values listed in the table X.

### Table 75X:

Table 75X provides 576 compounds of formula (X2-A) wherein G¹ is oxygen, R¹ is hydrogen, Y¹ is CH, Y² is CH, Y³ is N, X⁵ is C(═O)CH₂Br, R⁵ and R² have the values listed in the table X.

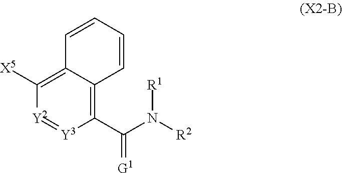

### Table 76X:

Table 76X provides 576 compounds of formula (X2-B) wherein G¹ is oxygen, R¹ is hydrogen, Y¹ is CH, Y² is CH, X⁵ is chloro, R⁵ and R² have the values listed in the table X.

### Table 77X:

Table 77X provides 576 compounds of formula (X2-B) wherein G¹ is oxygen, R¹ is hydrogen, Y¹ is CH, Y² is CH, X⁵ is bromo, R⁵ and R² have the values listed in the table X.

### Table 78X:

Table 78X provides 576 compounds of formula (X2-B) wherein G¹ is oxygen, R¹ is hydrogen, Y¹ is CH, Y² is CH, X⁵ is iodo, R⁵ and R² have the values listed in the table X.

### Table 79X:

Table 79X provides 576 compounds of formula (X2-B) wherein G¹ is oxygen, R¹ is hydrogen, Y¹ is CH, Y² is CH, X⁵ is amino, R⁵ and R² have the values listed in the table X.

### Table 80X:

Table 80X provides 576 compounds of formula (X2-B) wherein G¹ is oxygen, R¹ is hydrogen, Y¹ is CH, Y² is CH, X⁵ is CHO, R⁵ and R² have the values listed in the table X.

### Table 81X:

Table 81X provides 576 compounds of formula (X2-B) wherein G¹ is oxygen, R¹ is hydrogen, Y¹ is CH, Y² is CH, X⁵ is CN, R⁵ and R² have the values listed in the table X.

### Table 82X:

Table 82X provides 576 compounds of formula (X2-B) wherein G¹ is oxygen, R¹ is hydrogen, Y¹ is CH, Y² is CH, X⁵ is OH, R⁵ and R² have the values listed in the table X.

### Table 83X:

Table 83X provides 576 compounds of formula (X2-B) wherein G¹ is oxygen, R¹ is hydrogen, Y¹ is CH, Y² is CH, X⁵ is C(═O)OH, R⁵ and R² have the values listed in the table X.

### Table 84X:

Table 84X provides 576 compounds of formula (X2-B) wherein G¹ is oxygen, R¹ is hydrogen, Y¹ is CH, Y² is CH, X⁵ is C(═NOH)H, R⁵ and R² have the values listed in the table X.

### Table 85X:

Table 85X provides 576 compounds of formula (X2-B) wherein G¹ is oxygen, R¹ is hydrogen, Y¹ is CH, Y² is CH, X⁵ is C(═NOH)Cl, R⁵ and R² have the values listed in the table X.

### Table 86X:

Table 86X provides 576 compounds of formula (X2-B) wherein G¹ is oxygen, R¹ is hydrogen, Y¹ is CH, Y² is CH, X⁵ is C(═NOH)NH₂, R⁵ and R² have the values listed in the table X.

### Table 87X:

Table 87X provides 576 compounds of formula (X2-B) wherein G¹ is oxygen, R¹ is hydrogen, Y¹ is CH, Y² is CH, X⁵ is C(═O)CH₃, R⁵ and R² have the values listed in the table X.

### Table 88X:

Table 88X provides 576 compounds of formula (X2-B) wherein G¹ is oxygen, R¹ is hydrogen, Y¹ is CH, Y² is CH, X⁵ is C(═NOH)CH₃, R⁵ and R² have the values listed in the table X.

### Table 89X:

Table 89X provides 576 compounds of formula (X2-B) wherein G¹ is oxygen, R¹ is hydrogen, Y¹ is CH, Y² is CH, X⁵ is C(═O)CH₂Cl, R⁵ and R² have the values listed in the table X.

### Table 90X:

Table 90X provides 576 compounds of formula (X2-B) wherein G¹ is oxygen, R¹ is hydrogen, Y¹ is CH, Y² is CH, X⁵ is C(═O)CH₂Br, R⁵ and R² have the values listed in the table X.

### Table 91X:

Table 92X provides 576 compounds of formula (X2-B) wherein G¹ is oxygen, R¹ is hydrogen, Y¹ is N, Y² is CH, X⁵ is chloro, R⁵ and R² have the values listed in the table X.

### Table 93X:

Table 93X provides 576 compounds of formula (X2-B) wherein G¹ is oxygen, R¹ is hydrogen, Y¹ is N, Y² is CH, X⁵ is bromo, R⁵ and R² have the values listed in the table X.

### Table 94X:

Table 94X provides 576 compounds of formula (X2-B) wherein G¹ is oxygen, R¹ is hydrogen, Y¹ is N, Y² is CH, X⁵ is iodo, R⁵ and R² have the values listed in the table X.

### Table 95X:

Table 95X provides 576 compounds of formula (X2-B) wherein G¹ is oxygen, R¹ is hydrogen, Y¹ is N, Y² is CH, X⁵ is amino, R⁵ and R² have the values listed in the table X.

### Table 96X:

Table 96X provides 576 compounds of formula (X2-B) wherein G¹ is oxygen, R¹ is hydrogen, Y¹ is N, Y² is CH, X⁵ is CHO, R⁵ and R² have the values listed in the table X.

### Table 97X:

Table 97X provides 576 compounds of formula (X2-B) wherein G¹ is oxygen, R¹ is hydrogen, Y¹ is N, Y² is CH, X⁵ is CN, R⁵ and R² have the values listed in the table X.

### Table 98X:

Table 98X provides 576 compounds of formula (X2-B) wherein G¹ is oxygen, R¹ is hydrogen, Y¹ is N, Y² is CH, X⁵ is OH, R⁵ and R² have the values listed in the table X.

### Table 99X:

Table 99X provides 576 compounds of formula (X2-B) wherein G¹ is oxygen, R¹ is hydrogen, Y¹ is N, Y² is CH, X⁵ is C(═O)OH, R⁵ and R² have the values listed in the table X.

### Table 100X:

Table 100X provides 576 compounds of formula (X2-B) wherein G¹ is oxygen, R¹ is hydrogen, Y¹ is N, Y² is CH, X⁵ is C(═NOH)H, R⁵ and R² have the values listed in the table X.

### Table 101X:

Table 101X provides 576 compounds of formula (X2-B) wherein G¹ is oxygen, R¹ is hydrogen, Y¹ is N, Y² is CH, X⁵ is C(═NOH)Cl, R⁵ and R² have the values listed in the table X.

### Table 102X:

Table 102X provides 576 compounds of formula (X2-B) wherein G¹ is oxygen, R¹ is hydrogen, Y¹ is N, Y² is CH, X⁵ is C(═NOH)NH₂, R⁵ and R² have the values listed in the table X.

### Table 103X:

Table 103X provides 576 compounds of formula (X2-B) wherein G¹ is oxygen, R¹ is hydrogen, Y¹ is N, Y² is CH, X⁵ is C(═O)CH₃, R⁵ and R² have the values listed in the table X.

### Table 104X:

Table 104X provides 576 compounds of formula (X2-B) wherein G¹ is oxygen, R¹ is hydrogen, Y¹ is N, Y² is CH, X⁵ is C(═NOH)CH₃, R⁵ and R² have the values listed in the table X.

### Table 105X:

Table 106X provides 576 compounds of formula (X2-B) wherein G¹ is oxygen, R¹ is hydrogen, Y¹ is N, Y² is CH, X⁵ is C(═O)CH₂Cl, R⁵ and R² have the values listed in the table X.

### Table 107X:

Table 107X provides 576 compounds of formula (X2-B) wherein G¹ is oxygen, R¹ is hydrogen, Y¹ is N, Y² is CH, X⁵ is C(═O)CH₂Br, R⁵ and R² have the values listed in the table X.

### Table 108X:

Table 108X provides 576 compounds of formula (X2-B) wherein G¹ is oxygen, R¹ is hydrogen, Y¹ is H, Y² is N, X⁵ is chloro, R⁵ and R² have the values listed in the table X.

### Table 109X:

Table 109X provides 576 compounds of formula (X2-B) wherein G¹ is oxygen, R¹ is hydrogen, Y¹ is H, Y² is N, X⁵ is bromo, R⁵ and R² have the values listed in the table X.

### Table 110X:

Table 110X provides 576 compounds of formula (X2-B) wherein G¹ is oxygen, R¹ is hydrogen, Y¹ is H, Y² is N, X⁵ is iodo, R⁵ and R² have the values listed in the table X.

### Table 111X:

Table 111X provides 576 compounds of formula (X2-B) wherein G¹ is oxygen, R¹ is hydrogen, Y¹ is H, Y² is N, X⁵ is amino, R⁵ and R² have the values listed in the table X.

### Table 112X:

Table 112X provides 576 compounds of formula (X2-B) wherein G¹ is oxygen, R¹ is hydrogen, Y¹ is H, Y² is N, X⁵ is CHO, R⁵ and R² have the values listed in the table X.

### Table 113X:

Table 114X provides 576 compounds of formula (X2-B) wherein G¹ is oxygen, R¹ is hydrogen, Y¹ is H, Y² is N, X⁵ is CN, R⁵ and R² have the values listed in the table X.

### Table 115X:

Table 115X provides 576 compounds of formula (X2-B) wherein G¹ is oxygen, R¹ is hydrogen, Y¹ is H, Y² is N, X⁵ is OH, R⁵ and R² have the values listed in the table X.

### Table 116X:

Table 116X provides 576 compounds of formula (X2-B) wherein G¹ is oxygen, R¹ is hydrogen, Y¹ is H, Y² is N, X⁵ is C(═O)OH, R⁵ and R² have the values listed in the table X.

### Table 117X:

Table 117X provides 576 compounds of formula (X2-B) wherein G¹ is oxygen, R¹ is hydrogen, Y¹ is H, Y² is N, X⁵ is C(═NOH)H, R⁵ and R² have the values listed in the table X.

### Table 118X:

Table 118X provides 576 compounds of formula (X2-B) wherein G¹ is oxygen, R¹ is hydrogen, Y¹ is H, Y² is N, X⁵ is C(═NOH)Cl, R⁵ and R² have the values listed in the table X.

### Table 119X:

Table 119X provides 576 compounds of formula (X2-B) wherein G¹ is oxygen, R¹ is hydrogen, Y¹ is H, Y² is N, X⁵ is C(═NOH)NH₂, R⁵ and R² have the values listed in the table X.

### Table 120X:

Table 120X provides 576 compounds of formula (X2-B) wherein G¹ is oxygen, R¹ is hydrogen, Y¹ is H, Y² is N, X⁵ is C(═O)CH₃, R⁵ and R² have the values listed in the table X.

### Table 121X:

Table 121X provides 576 compounds of formula (X2-B) wherein G¹ is oxygen, R¹ is hydrogen, Y¹ is H, Y² is N, X⁵ is C(═NOH)CH₃, R⁵ and R² have the values listed in the table X.

### Table 122X:

Table 122X provides 576 compounds of formula (X2-B) wherein G¹ is oxygen, R¹ is hydrogen, Y¹ is H, Y² is N, X⁵ is C(═O)CH₂Cl, R⁵ and R² have the values listed in the table X.

### Table 123X:

Table 123X provides 576 compounds of formula (X2-B) wherein G¹ is oxygen, R¹ is hydrogen, Y¹ is H, Y² is N, X⁵ is C(═O)CH₂Br, R⁵ and R² have the values listed in the table X.

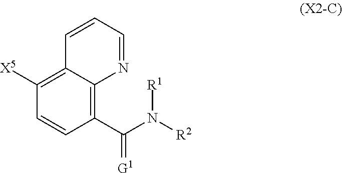

### Table 124X:

Table 124X provides 576 compounds of formula (X2-C) wherein G¹ is oxygen, R¹ is hydrogen, X⁵ is chloro, R⁵ and R² have the values listed in the table X.

### Table 125X:

Table 125X provides 576 compounds of formula (X2-C) wherein G¹ is oxygen, R¹ is hydrogen, X⁵ is bromo, R⁵ and R² have the values listed in the table X.

### Table 126X:

Table 126X provides 576 compounds of formula (X2-C) wherein G¹ is oxygen, R¹ is hydrogen, X⁵ is iodo, R⁵ and R² have the values listed in the table X.

### Table 127X:

Table 127X provides 576 compounds of formula (X2-C) wherein G¹ is oxygen, R¹ is hydrogen, X⁵ is amino, R⁵ and R² have the values listed in the table X.

### Table 128X:

Table 128X provides 576 compounds of formula (X2-C) wherein G¹ is oxygen, R¹ is hydrogen, X⁵ is CHO, R⁵ and R² have the values listed in the table X.

### Table 129X:

Table 129X provides 576 compounds of formula (X2-C) wherein G¹ is oxygen, R¹ is hydrogen, X⁵ is CN, R⁵ and R² have the values listed in the table X.

### Table 130X:

Table 130X provides 576 compounds of formula (X2-C) wherein G¹ is oxygen, R¹ is hydrogen, X⁵ is OH, R⁵ and R² have the values listed in the table X.

### Table 131X:

Table 131X provides 576 compounds of formula (X2-C) wherein G¹ is oxygen, R¹ is hydrogen, X⁵ is C(═O)OH, R⁵ and R² have the values listed in the table X.

### Table 132X:

Table 132X provides 576 compounds of formula (X2-C) wherein G¹ is oxygen, R¹ is hydrogen, X⁵ is C(═NOH)H, R⁵ and R² have the values listed in the table X.

### Table 133X:

Table 133X provides 576 compounds of formula (X2-C) wherein G¹ is oxygen, R¹ is hydrogen, X⁵ is C(═NOH)Cl, R⁵ and R² have the values listed in the table X.

### Table 134X:

Table 134X provides 576 compounds of formula (X2-C) wherein G¹ is oxygen, R¹ is hydrogen, X⁵ is C(═NOH)NH₂, R⁵ and R² have the values listed in the table X.

### Table 135X:

Table 135X provides 576 compounds of formula (X2-C) wherein G¹ is oxygen, R¹ is hydrogen, X⁵ is C(═O)CH₃, R⁵ and R² have the values listed in the table X.

### Table 136X:

Table 136X provides 576 compounds of formula (X2-C) wherein G¹ is oxygen, R¹ is hydrogen, X⁵ is C(═NOH)CH₃, R⁵ and R² have the values listed in the table X.

### Table 137X:

Table 137X provides 576 compounds of formula (X2-C) wherein G¹ is oxygen, R¹ is hydrogen, X⁵ is C(═O)CH₂Cl, R⁵ and R² have the values listed in the table X.

### Table 138X:

Table 138X provides 576 compounds of formula (X2-C) wherein G¹ is oxygen, R¹ is hydrogen, X⁵ is C(═O)CH₂Br, R⁵ and R² have the values listed in the table X.

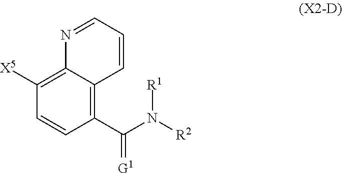

### Table 139X:

Table 139X provides 576 compounds of formula (X2-C) wherein G¹ is oxygen, R¹ is hydrogen, X⁵ is chloro, R⁵ and R² have the values listed in the table X.

### Table 140X:

Table 141X provides 576 compounds of formula (X2-C) wherein G¹ is oxygen, R¹ is hydrogen, X⁵ is bromo, R⁵ and R² have the values listed in the table X.

### Table 142X:

Table 142X provides 576 compounds of formula (X2-C) wherein G¹ is oxygen, R¹ is hydrogen, X⁵ is iodo, R⁵ and R² have the values listed in the table X.

### Table 143X:

Table 143X provides 576 compounds of formula (X2-C) wherein G¹ is oxygen, R¹ is hydrogen, X⁵ is amino, R⁵ and R² have the values listed in the table X.

### Table 144X:

Table 144X provides 576 compounds of formula (X2-C) wherein G¹ is oxygen, R¹ is hydrogen, X⁵ is CHO, R⁵ and R² have the values listed in the table X.

### Table 145X:

Table 145X provides 576 compounds of formula (X2-C) wherein G¹ is oxygen, R¹ is hydrogen, X⁵ is CN, R⁵ and R² have the values listed in the table X.

### Table 146X:

Table 146X provides 576 compounds of formula (X2-C) wherein G¹ is oxygen, R¹ is hydrogen, X⁵ is OH, R⁵ and R² have the values listed in the table X.

### Table 147X:

Table 147X provides 576 compounds of formula (X2-C) wherein G¹ is oxygen, R¹ is hydrogen, X⁵ is C(═O)OH, R⁵ and R² have the values listed in the table X.

### Table 148X:

Table 148X provides 576 compounds of formula (X2-C) wherein G¹ is oxygen, R¹ is hydrogen, X⁵ is C(═NOH)H, R⁵ and R² have the values listed in the table X.

### Table 149X:

Table 149X provides 576 compounds of formula (X2-C) wherein G¹ is oxygen, R¹ is hydrogen, X⁵ is C(═NOH)Cl, R⁵ and R² have the values listed in the table X.

### Table 150X:

Table 150X provides 576 compounds of formula (X2-C) wherein G¹ is oxygen, R¹ is hydrogen, X⁵ is C(═NOH)NH₂, R⁵ and R² have the values listed in the table X.

### Table 151X:

Table 151X provides 576 compounds of formula (X2-C) wherein G¹ is oxygen, R¹ is hydrogen, X⁵ is C(═O)CH₃, R⁵ and R² have the values listed in the table X.

### Table 152X:

Table 152X provides 576 compounds of formula (X2-C) wherein G¹ is oxygen, R¹ is hydrogen, X⁵ is C(═NOH)CH₃, R⁵ and R² have the values listed in the table X.

### Table 153X:

Table 153X provides 576 compounds of formula (X2-C) wherein G¹ is oxygen, R¹ is hydrogen, X⁵ is C(═O)CH₂Cl, R⁵ and R² have the values listed in the table X.

### Table 154X:

Table 154X provides 576 compounds of formula (X2-C) wherein G¹ is oxygen, R¹ is hydrogen, X⁵ is C(═O)CH₂Br, R⁵ and R² have the values listed in the table X.

In one embodiment the invention provides a compound selected from Tables 1P to 90P for use in controlling and/or preventing insects of the family Curculionidae, preferably in for use in controlling and/or preventing Anthonomus grandis.

Additional examples of insects from the family of Curculionidae are Anthonomus corvulus, Anthonomus elutus, Anthonomus elongatus, Anthonomus eugenii, Anthonomus consors, Anthonomus haematopus, Anthonomus lecontei, Anthonomus molochinus, Anthonomus morticinus, Anthonomus musculus, Anthonomus nigrinus, Anthonomus phyllocola, Anthonomus pictus, Anthonomus pomorum, Anthonomus quadrigibbus, Anthonomus rectirostris, Anthonomus rubi, Anthonomus santacruzi, Anthonomus signatus, Anthonomus subfasciatus, and Anthonomus tenebrosus.

In one embodiment the invention provides a compound selected from Tables 1P to 90P for use against Anthonomus grandis in cotton.

In one embodiment the invention provides a compound selected from Tables 1P to 90P for use in controlling and/or preventing soil pests.

In one embodiment the invention provides a compound selected from Tables 1P to 90P for use in controlling and/or preventing corn rootworm, in particular for use against corn root worm from the genus Diabrotica.

In one embodiment the invention provides a compound selected from Tables 1P to 90P for use in controlling and/or preventing Diabrotica virgifera.

In one embodiment the invention provides a compound selected from Tables 1P to 90P for use in controlling and/or preventing Diabrotica barberi.

In one embodiment the invention provides a compound selected from Tables 1P to 90P for use in controlling and/or preventing Diabrotica undecimpunctata howardi.

In one embodiment the invention provides a compound selected from Tables 1P to 90P for use in controlling and/or preventing wireworms, in particular Agriotes spp.

In one embodiment the invention provides a compound selected from Tables 1P to 90P for use in controlling and/or preventing Agriotes spp. in cereals, potato or corn.

Additional examples of Agriotes spp. include Agriotes lineatus, Agriotes obscurus, Agriotes brevis, Agriotes gurgistanus, Agriotes sputator, Agriotes ustulatus, Ctenicera destructor, and Limonius californicus.

In one embodiment the invention provides a compound selected from Tables 1P to 90P for use in controlling and/or preventing grubs, in particular white grubs.

In one embodiment the invention provides a compound selected from Tables 1P to 90P for use in controlling and/or preventing Phyllophaga spp., particularly on corn, soybean or cotton.

In one embodiment the invention provides a compound selected from Tables 1P to 90P for use in controlling and/or preventing Diloboderus spp. particularly on corn, soybean or cotton.

In one embodiment the invention provides a compound selected from Tables 1P to 90P for use in controlling and/or preventing Popillia japonica, particularly on corn, soybean or cotton.

Additional examples of white grubs include Phyllophaga anxia, Phyllophaga crinite, Phyllophaga subnitida, Diloboderus abderus.

In one embodiment the invention provides a compound selected from Tables 1P to 90P for use in controlling and/or preventing termites, e.g. on sugarcane.

Examples of termites include Reticulitermes, Coptotermes, Macrotermes, Microtermes, Globitermes. Specific of subterranean termites include Reticulitermes flavipes, Reticulitermes hesperus, Reticulitermes verginicus, Reticulitermes hageni, Reticulitermes speratus, Reticulitermes lucifugus, Heterotermes aureus, Coptotermes formosanus, Coptotermes acinaciformis, Coptotermes curvignathus, Nasutitermes exitiosus, Nasutitermes walkeri, Mastotermes darwiniensis, Schedorhinotermes spp, Macrotermes bellicosus, Macrotermes spp., Globitermes sulphureus, Odontotermes spp. Specific examples of dry wood termites include Incisitermes minor, Marginitermes hubbardi, Cryptotermes brevis, Kalotermes flavicollis. Additional examples of termites include procornitermes spp. and procornitermes araujoi

In one embodiment the invention provides a compound selected from Tables 1P to 90P for use in controlling and/or preventing subterraneous stinkbugs, e.g. Scaptocoris spp.

In one embodiment the invention provides a compound selected from Tables 1P to 90P for use in controlling and/or preventing Scaptocoris castaneus, in particular on cereals, soybean or corn.

In one embodiment the invention provides a compound selected from Tables 1P to 90P for use in controlling and/or preventing cutworms, e.g. agrotis spp.

In one embodiment the invention provides a compound selected from Tables 1P to 90P for use in controlling and/or preventing Agrotis ipsilon, particularly on cereals, canola, soybean or corn.

In one embodiment the invention provides a compound selected from Tables 1P to 90P for use in controlling and/or preventing millipedes, e.g. Julus spp.

In one embodiment the invention provides a compound selected from Tables 1P to 90P for use in controlling and/or preventing Julus spp., particularly on cereals, canola, soybean & corn.

In one embodiment the invention provides a compound selected from Tables 1P to 90P for use in controlling and/or preventing broca gigante, e.g. Telchin licus, particularly on sugarcane.

In one embodiment the invention provides a compound selected from Tables 1P to 90P for use in controlling and/or preventing whitefly.

In one embodiment the invention provides a compound selected from Tables 1P to 90P for use in controlling and/or preventing Bemisia tabaci, particularly on vegetables, cotton, soybean, or potatoes.

In one embodiment the invention provides a compound selected from Tables 1P to 90P for use in controlling and/or preventing Trialeurodes vaporariorum, particularly on vegetables, cotton, soybean, or potatoes.

In one embodiment the invention provides a compound selected from Tables 1P to 90P for use in controlling and/or preventing stinkbugs, in particular Euschistus spp.

In one embodiment the invention provides a compound selected from Tables 1P to 90P for use in controlling and/or preventing Euschistus spp., particularly in soybean.

Examples of stinkbugs include Nezara spp. (e.g. Nezara viridula, Nezara antennata, Nezara hilare), Piezodorus spp. (e.g. Piezodorus guildinii), Acrosternum spp. Euchistus spp. (e.g. Euchistus heros, Euschistus servus), Halyomorpha halys, Plautia crossota, Riptortus clavatus, Rhopalus msculatus, Antestiopsis orbitalus, Dichelops spp. (e.g. Dichelops furcatus, Dichelops melacanthus), Eurygaster spp. (e.g. Eurygaster intergriceps, Eurygaster maura), Oebalus spp. (e.g. Oebalus mexicana, Oebalus poecilus, Oebalus pugnase, Scotinophara spp. (e.g. Scotinophara lurida, Scotinophara coarctata). Preferred targets include Antestiopsis orbitalus, Dichelops furcatus, Dichelops melacanthus, Euchistus heros, Euschistus servus, Nezara viridula, Nezara hilare, Piezodorus guildinii, Halyomorpha halys. In one embodiment the stinkbug target is Nezara viridula, Piezodorus spp., Acrosternum spp, Euchistus heros.

In one embodiment the invention provides a compound selected from Tables 1P to 90P for use against rice pests.

In one embodiment the invention provides a compound selected from Tables 1P to 90P for use against stemborer, particularly in rice.

Examples of stemborers include Chilo sp, Chilo suppressalis, Chilo polychrysus, Chilo auricilius, Scirpophaga spp., Scirpophaga incertulas, Scirpophaga innotata, Scirpophaga nivella Sesamia sp, Sesamia inferens.

In one embodiment the invention provides a compound selected from Tables 1P to 90P for use against leaffolder, particularly in rice.

Examples of leaffolders include Cnaphalocrocis spp., Cnaphalocrocis medinalis, Marasmia spp., Marasmia patnalis, Marasmia exigua.

In one embodiment the invention provides a compound selected from Tables 1P to 90P for use against hoppers, particularly in rice.

Examples of Hoppers include Nephotettix spp., Nephotettix virescens, Nephotettix nigropictus, Nephotettix malayanus, Nephotettix cincticeps, Nilaparvata lugens, Sogatella furcifera.

In one embodiment the invention provides a compound selected from Tables 1P to 90P for use against gallmidge, particularly in rice.

Examples of Gall midge include Orseolia sp, Orseolia oryzae.

In one embodiment the invention provides a compound selected from Tables 1P to 90P for use against whorl maggot, particularly in rice.

Examples of whorl maggots include Hydrellia sp, Hydrellia philippina.

In one embodiment the invention provides a compound selected from Tables 1P to 90P for use against Rice bugs, particularly in rice.

Examples of rice bugs include Leptocorisa sp, Leptocorisa oratorius, Leptocorisa chinensis, Leptocorisa acuta.

In one embodiment the invention provides a compound selected from Tables 1P to 90P for use against Black bugs, particularly in rice.

Examples of Black bugs include Scotinophara sp, Scotinophara coarctata, Scotinophara lurida, Scotinophara latiuscula.

In one embodiment the invention provides a compound selected from Tables 1P to 90P for use against plutella spp.

In one embodiment the invention provides a compound selected from Tables 1P to 90P for use against Plutella xylostella, particularly in brassica crops.

In one embodiment the invention provides a compound selected from Tables 1Q to 70Q for use in controlling and/or preventing insects of the family Curculionidae, preferably in for use in controlling and/or preventing Anthonomus grandis.

Additional examples of insects from the family of Curculionidae are Anthonomus corvulus, Anthonomus elutus, Anthonomus elongatus, Anthonomus eugenii, Anthonomus consors, Anthonomus haematopus, Anthonomus lecontei, Anthonomus molochinus, Anthonomus morticinus, Anthonomus musculus, Anthonomus nigrinus, Anthonomus phyllocola, Anthonomus pictus, Anthonomus pomorum, Anthonomus quadrigibbus, Anthonomus rectirostris, Anthonomus rubi, Anthonomus santacruzi, Anthonomus signatus, Anthonomus subfasciatus, and Anthonomus tenebrosus.

In one embodiment the invention provides a compound selected from Tables 1Q to 70Q for use against Anthonomus grandis in cotton.

In one embodiment the invention provides a compound selected from Tables 1Q to 70Q for use in controlling and/or preventing soil pests.

In one embodiment the invention provides a compound selected from Tables 1Q to 70Q for use in controlling and/or preventing corn rootworm, in particular for use against corn root worm from the genus Diabrotica.

In one embodiment the invention provides a compound selected from Tables 1Q to 70Q for use in controlling and/or preventing Diabrotica virgifera.

In one embodiment the invention provides a compound selected from Tables 1Q to 70Q for use in controlling and/or preventing Diabrotica barberi.

In one embodiment the invention provides a compound selected from Tables 1Q to 70Q for use in controlling and/or preventing Diabrotica undecimpunctata howardi.

In one embodiment the invention provides a compound selected from Tables 1Q to 70Q for use in controlling and/or preventing wireworms, in particular Agriotes spp.

In one embodiment the invention provides a compound selected from Tables 1Q to 70Q for use in controlling and/or preventing Agriotes spp. in cereals, potato or corn.

Additional examples of Agriotes spp. include Agriotes lineatus, Agriotes obscurus, Agriotes brevis, Agriotes gurgistanus, Agriotes sputator, Agriotes ustulatus, Ctenicera destructor, and Limonius californicus.

In one embodiment the invention provides a compound selected from Tables 1Q to 70Q for use in controlling and/or preventing grubs, in particular white grubs.

In one embodiment the invention provides a compound selected from Tables 1Q to 70Q for use in controlling and/or preventing Phyllophaga spp., particularly on corn, soybean or cotton.

In one embodiment the invention provides a compound selected from Tables 1Q to 70Q for use in controlling and/or preventing Diloboderus spp. particularly on corn, soybean or cotton.

In one embodiment the invention provides a compound selected from Tables 1Q to 70Q for use in controlling and/or preventing Popillia japonica, particularly on corn, soybean or cotton.

Additional examples of white grubs include Phyllophaga anxia, Phyllophaga crinite, Phyllophaga subnitida, Diloboderus abderus.

In one embodiment the invention provides a compound selected from Tables 1Q to 70Q for use in controlling and/or preventing termites, e.g. on sugarcane.

Examples of termites include Reticulitermes, Coptotermes, Macrotermes, Microtermes, Globitermes. Specific of subterranean termites include Reticulitermes flavipes, Reticulitermes hesperus, Reticulitermes verginicus, Reticulitermes hageni, Reticulitermes speratus, Reticulitermes lucifugus, Heterotermes aureus, Coptotermes formosanus, Coptotermes acinaciformis, Coptotermes curvignathus, Nasutitermes exitiosus, Nasutitermes walkeri, Mastotermes darwiniensis, Schedorhinotermes spp, Macrotermes bellicosus, Macrotermes spp., Globitermes sulphureus, Odontotermes spp. Specific examples of dry wood termites include Incisitermes minor, Marginitermes hubbardi, Cryptotermes brevis, Kalotermes flavicollis. Additional examples of termites include procornitermes spp. and procornitermes araujoi

In one embodiment the invention provides a compound selected from Tables 1Q to 70Q for use in controlling and/or preventing subterraneous stinkbugs, e.g. Scaptocoris spp.

In one embodiment the invention provides a compound selected from Tables 1Q to 70Q for use in controlling and/or preventing Scaptocoris castaneus, in particular on cereals, soybean or corn.

In one embodiment the invention provides a compound selected from Tables 1Q to 70Q for use in controlling and/or preventing cutworms, e.g. agrotis spp.

In one embodiment the invention provides a compound selected from Tables 1Q to 70Q for use in controlling and/or preventing Agrotis ipsilon, particularly on cereals, canola, soybean or corn.

In one embodiment the invention provides a compound selected from Tables 1Q to 70Q for use in controlling and/or preventing millipedes, e.g. Julus spp.

In one embodiment the invention provides a compound selected from Tables 1Q to 70Q for use in controlling and/or preventing Julus spp., particularly on cereals, canola, soybean & corn.

In one embodiment the invention provides a compound selected from Tables 1Q to 70Q for use in controlling and/or preventing broca gigante, e.g. Telchin licus, particularly on sugarcane.

In one embodiment the invention provides a compound selected from Tables 1Q to 70Q for use in controlling and/or preventing whitefly.

In one embodiment the invention provides a compound selected from Tables 1Q to 70Q for use in controlling and/or preventing Bemisia tabaci, particularly on vegetables, cotton, soybean, or potatoes.

In one embodiment the invention provides a compound selected from Tables 1Q to 70Q for use in controlling and/or preventing Trialeurodes vaporariorum, particularly on vegetables, cotton, soybean, or potatoes.

In one embodiment the invention provides a compound selected from Tables 1Q to 70Q for use in controlling and/or preventing stinkbugs, in particular Euschistus spp.

In one embodiment the invention provides a compound selected from Tables 1Q to 70Q for use in controlling and/or preventing Euschistus spp., particularly in soybean.

Examples of stinkbugs include Nezara spp. (e.g. Nezara viridula, Nezara antennata, Nezara hilare), Piezodorus spp. (e.g. Piezodorus guildinii), Acrosternum spp. Euchistus spp. (e.g. Euchistus heros, Euschistus servus), Halyomorpha halys, Plautia crossota, Riptortus clavatus, Rhopalus msculatus, Antestiopsis orbitalus, Dichelops spp. (e.g. Dichelops furcatus, Dichelops melacanthus), Eurygaster spp. (e.g. Eurygaster intergriceps, Eurygaster maura), Oebalus spp. (e.g. Oebalus mexicana, Oebalus poecilus, Oebalus pugnase, Scotinophara spp. (e.g. Scotinophara lurida, Scotinophara coarctata). Preferred targets include Antestiopsis orbitalus, Dichelops furcatus, Dichelops melacanthus, Euchistus heros, Euschistus servus, Nezara viridula, Nezara hilare, Piezodorus guildinii, Halyomorpha halys. In one embodiment the stinkbug target is Nezara viridula, Piezodorus spp., Acrosternum spp, Euchistus heros.

In one embodiment the invention provides a compound selected from Tables 1Q to 70Q for use against rice pests.

In one embodiment the invention provides a compound selected from Tables 1Q to 70Q for use against stemborer, particularly in rice.

Examples of stemborers include Chilo sp, Chilo suppressalis, Chilo polychrysus, Chilo auricilius, Scirpophaga spp., Scirpophaga incertulas, Scirpophaga innotata, Scirpophaga nivella Sesamia sp, Sesamia inferens.

In one embodiment the invention provides a compound selected from Tables 1Q to 70Q for use against leaffolder, particularly in rice.

Examples of leaffolders include Cnaphalocrocis spp., Cnaphalocrocis medinalis, Marasmia spp., Marasmia patnalis, Marasmia exigua.

In one embodiment the invention provides a compound selected from Tables 1Q to 70Q for use against hoppers, particularly in rice.

Examples of Hoppers include Nephotettix spp., Nephotettix virescens, Nephotettix nigropictus, Nephotettix malayanus, Nephotettix cincticeps, Nilaparvata lugens, Sogatella furcifera.

In one embodiment the invention provides a compound selected from Tables 1Q to 70Q for use against gallmidge, particularly in rice.

Examples of Gall midge include Orseolia sp, Orseolia oryzae.

In one embodiment the invention provides a compound selected from Tables 1Q to 70Q for use against whorl maggot, particularly in rice.

Examples of whorl maggots include Hydrellia sp, Hydrellia philippina.

In one embodiment the invention provides a compound selected from Tables 1Q to 70Q for use against Rice bugs, particularly in rice.

Examples of rice bugs include Leptocorisa sp, Leptocorisa oratorius, Leptocorisa chinensis, Leptocorisa acuta.

In one embodiment the invention provides a compound selected from Tables 1Q to 70Q for use against Black bugs, particularly in rice.

Examples of Black bugs include Scotinophara sp, Scotinophara coarctata, Scotinophara lurida, Scotinophara latiuscula.

In one embodiment the invention provides a compound selected from Tables 1Q to 70Q for use against plutella spp.

In one embodiment the invention provides a compound selected from Tables 1Q to 70Q for use against Plutella xylostella, particularly in brassica crops.

Compounds of formula I include at least one chiral centre and may exist as compounds of formula I* or compounds of formula I**.

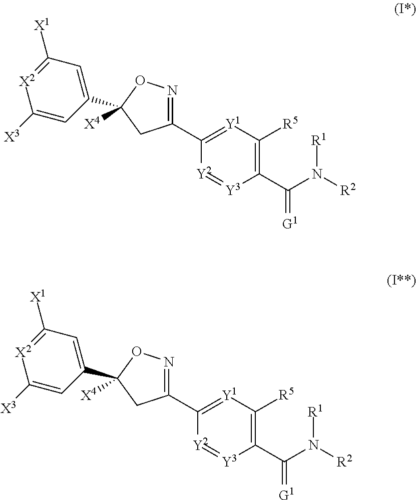

includes mixtures of compounds I* and I** in any ratio e.g. in a molar ratio of 1:99 to 99:1, e.g. 10:1 to 1:10, e.g. a substantially 50:50 molar ratio. In an enriched mixture of formula I**, the molar proportion of compound I** compared to the total amount of both I* and I** is for example greater than 50%, e.g. at least 55, 60, 65, 70, 75, 80, 85, 90, 95, 96, 97, 98, or at least 99% Likewise, in an enriched mixture of formula I*, the molar proportion of the compound of formula I* compared to the total amount of both I* and I** is for example greater than 50%, e.g. at least 55, 60, 65, 70, 75, 80, 85, 90, 95, 96, 97, 98, or at least 99%. Enriched mixtures of formula I** are preferred. Each of the compounds disclosed in Tables 1P to 90P and 1Q to 70Q represents a specific disclosure of a compound with the R configuration (i.e. at the corresponding position indicated for compounds I* and I**) and a specific disclosure of a compound having the S configuration (i.e. at the corresponding position indicated for compounds I* and I**).

In addition, R² contains a chiral centre and may be group P* or group P**

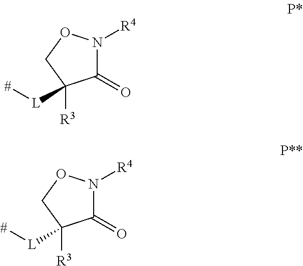

When L is a bond group P* and P** are group P*a and group P**a respectively

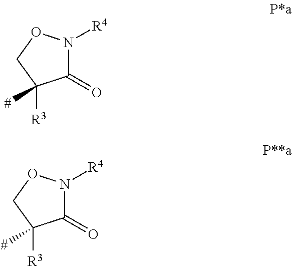

The invention includes mixtures of compounds of formula I in which R² is group P* and P** in any ratio e.g. in a molar ratio of 1:99 to 99:1, e.g. 10:1 to 1:10, e.g. a substantially 50:50 molar ratio. In an enriched mixture of compound of formula I with P*, the molar proportion of compound of formula I with P* compared to the total amount of compound of formula I with P* and compound of formula I with P** is for example greater than 50%, e.g. at least 55, 60, 65, 70, 75, 80, 85, 90, 95, 96, 97, 98, or at least 99%. Likewise, in an enriched mixture of compound of formula I with P** the molar proportion of the compound of formula I with P* compared to the total amount of compound of formula I with P* and compound of formula I with P** is for example greater than 50%, e.g. at least 55, 60, 65, 70, 75, 80, 85, 90, 95, 96, 97, 98, or at least 99%. Each of the compounds disclosed in Tables 1P to 180P, 1Q to 140Q and 1X to 154X represents a specific disclosure of a compound with the R configuration (i.e. at the corresponding position indicated for P* and P**) and a specific disclosure of a compound having the S configuration (i.e. at the corresponding position indicated for P* and P**).

The stereoisomers arising from the above two chiral centres include the following isomers:

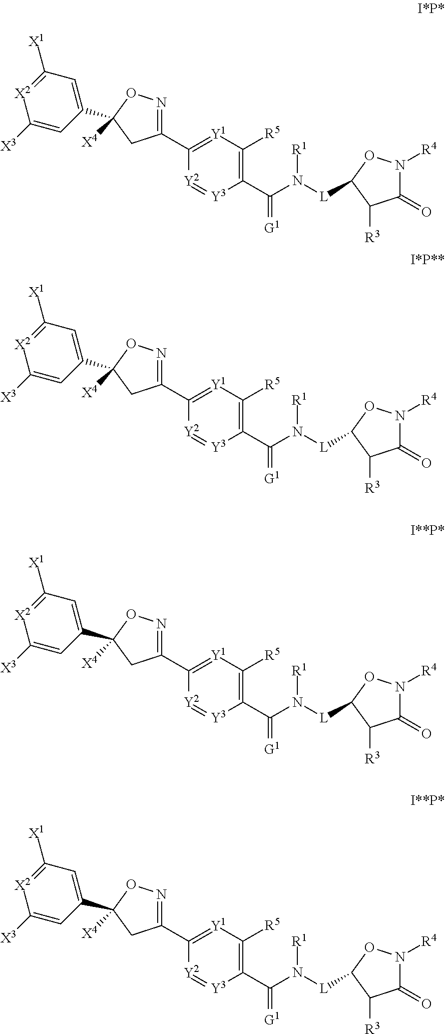

Each of the compounds disclosed in Tables 1P to 90P and 1Q to 70Q represents a specific disclosure of a compound having the configuration of compound I*P*. Each of the compounds disclosed in Tables 1P to 90P and 1Q to 70Q represents a specific disclosure of a compound having the configuration of compound I*P**. Each of the compounds disclosed in Tables 1P to 90P and 1Q to 70Q represents a specific disclosure of a compound having the configuration of compound I**P*. Each of the compounds disclosed in Tables 1P to 90P and 1Q to 70Q represents a specific disclosure of a compound having the configuration of compound I**P**.

Compounds of formula I can be prepared according to the schemes illustrated in WO2011/067272, which is incorporated herein by reference. Further details regarding possible routes to the compounds of the invention are given below.

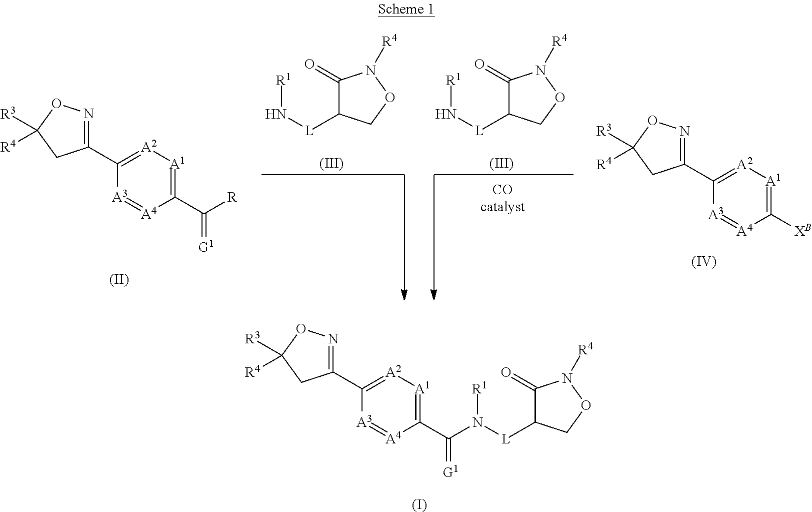

1) Compounds of formula (I) wherein G¹ is oxygen, can be prepared by reacting a compound of formula (II) wherein G¹ is oxygen and R is OH, C₁-C₆alkoxy or Cl, F or Br, with an amine of formula (III) as shown in Scheme 1. When R is OH such reactions are usually carried out in the presence of a coupling reagent, such as N,N′-dicyclohexylcarbodiimide (“DCC”), 1-ethyl-3-(3-dimethylamino-propyl)carbodiimide hydrochloride (“EDC”) or bis(2-oxo-3-oxazolidinyl)phosphonic chloride (“BOP-Cl”), in the presence of a base, and optionally in the presence of a nucleophilic catalyst, such as hydroxybenzotriazole (“HOBT”). When R is Cl, such reactions are usually carried out in the presence of a base, and optionally in the presence of a nucleophilic catalyst. Alternatively, it is possible to conduct the reaction in a biphasic system comprising an organic solvent, preferably ethyl acetate, and an aqueous solvent, preferably a solution of sodium hydrogen carbonate. When R is C₁-C₆alkoxy it is sometimes possible to convert the ester directly to the amide by heating the ester and amine together in a thermal process. Suitable bases include pyridine, triethylamine, 4-(dimethylamino)-pyridine (“DMAP”) or diisopropylethylamine (Hunig's base). Preferred solvents are N,N-dimethylacetamide, tetrahydrofuran, dioxane, 1,2-dimethoxyethane, ethyl acetate and toluene. The reaction is carried out at a temperature of from 0° C. to 100° C., preferably from 15° C. to 30° C., in particular at ambient temperature. Amines of formula (III) are either known in the literature or can be prepared using methods known to a person skilled in the art.

2) Acid halides of formula (II), wherein G¹ is oxygen and R is Cl, F or Br, may be made from carboxylic acids of formula (II), wherein G¹ is oxygen and R is OH, under standard conditions, as described for example in WO09080250.

3) Carboxylic acids of formula (II), wherein G¹ is oxygen and R is OH, may be formed from esters of formula (II), wherein G¹ is oxygen and R is C₁-C₆alkoxy as described for example in WO09080250.

4) Compounds of formula (I) wherein G¹ is oxygen, can be prepared by reacting a compound of formula (IV) wherein X^{B} is a leaving group, for example a halogen, such as bromo, with carbon monoxide and an amine of formula (III), in the presence of a catalyst, such as palladium(II) acetate or bis(triphenylphosphine)palladium(II) dichloride, optionally in the presence of a ligand, such as triphenylphosphine, and a base, such as sodium carbonate, pyridine, triethylamine, 4-(dimethylamino)-pyridine (“DMAP”) or diisopropylethylamine (Hunig's base), in a solvent, such as water, N,N-dimethylformamide or tetrahydrofuran. The reaction is carried out at a temperature of from 50° C. to 200° C., preferably from 100° C. to 150° C. The reaction is carried out at a pressure of from 50 to 200 bar, preferably from 100 to 150 bar.

5) Compounds of formula (IV) wherein X^{B} is a leaving group, for example a halogen, such as bromo, can be made by a various of methods, for example as described in WO09080250.

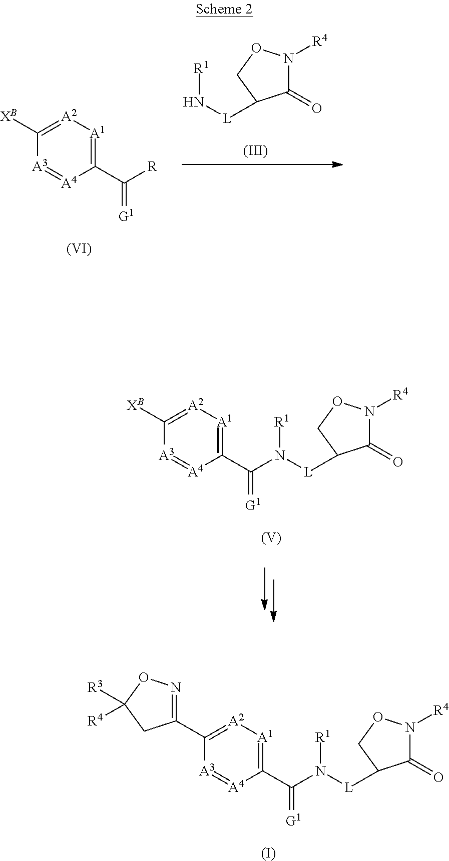

6) Alternatively, compounds of formula (I) wherein G¹ is oxygen, can be prepared by various methods from an intermediate of formula (V) as shown in Scheme 2 wherein G¹ is oxygen and X^{B} is a leaving group, for example a halogen, such as bromo, or X^{B} is cyano, formyl or acetyl according to similar methods to those described in WO09080250. An intermediate of formula (V) can be prepared for example from an intermediate of formula (VI) as described in the same reference.

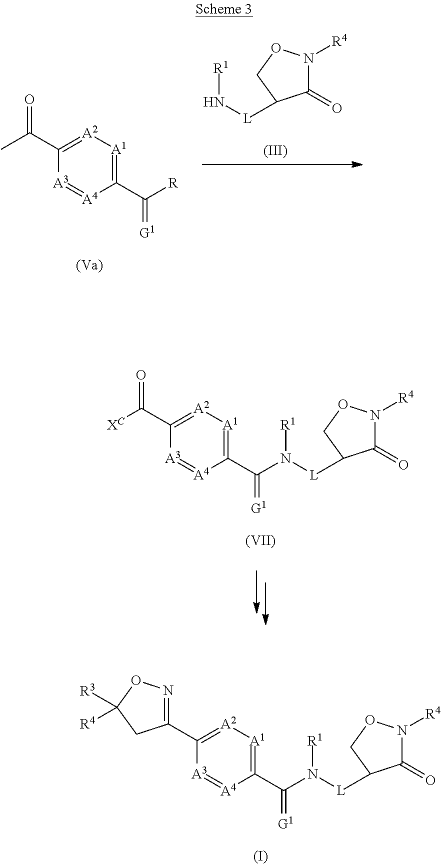

7) Alternatively, compounds of formula (I) wherein G¹ is oxygen, can be prepared by various methods from an intermediate of formula (VII) as shown in Scheme 3 wherein G¹ is oxygen and X^{C} is CH═C(R³)R⁴, or CH₂C(OH)(R³)R⁴ wherein R³ and R⁴ are as defined for a compound of formula (I) according to similar methods to those described in WO09080250.

8) Compounds of formula (VII) wherein G¹ is oxygen and X^{C} is CH═C(R³)R⁴, or CH₂C(OH)(R³)R⁴ can be prepared from a compound of formula (Va) wherein G¹ is oxygen or from a compound of formula (VII) wherein G¹ is oxygen and X^{C} is CH₂-halogen using similar methods to those described in WO09080250.

9) Compounds of formula (VII) wherein G¹ is oxygen and X^{C} is CH₂-halogen, such as bromo or chloro, can be prepared by reacting a methyl ketone of formula (Va) wherein G¹ is oxygen, with a halogenating agent, such as bromine or chlorine, in a solvent, such as acetic acid, at a temperature of from 0° C. to 50° C., preferably from ambient temperature to 40° C.

10) Compounds of formula (III) are either known compounds or can be be prepared by known methods to the person skilled in the art.

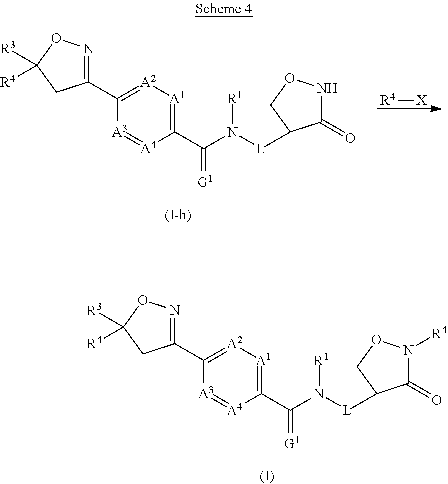

11) Alternatively, compounds of formula (I) wherein R⁴ is different than hydrogen, can be prepared from a compound of formula I-h wherein R⁴ is hydrogen, by alkylation using an alkylating reagent such as R⁴—X wherein X is halogen, mesylate, para-toluenesulfonate or trifluoromethanesulfonate in the presence of a base such as potassium carbonate or triethylamine, in a solvent such as dimethylormamide, N-methylpyrrolidone, dimethylacetamide or acetonitrile at a temperature of between 0° C. and 100° C. preferably at room temperature.

The compounds according to Protecting a crop of useful plants from insects, acarines, nematodes or molluscs, means e.g. controlling the population of insects, acarines, nematodes or molluscs in said crop of useful plants, e.g. such that the population of said insects, acarines, nematodes or molluscs is less than would be present in the absence of said compound, preferably significantly less, e.g. at least 5, 10, 15, 20, 25, 30, 35, 40, 45 50, 55, 60, 65, 70, 75, 80, 85, 90, 95 or even at least 99% less than in the absence of said compound.

The compounds of formula (I) can be used to combat and control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are hereinafter collectively referred to as pests. The pests which may be combated and controlled by the use of the compounds of the invention include those pests associated with agriculture (which term includes the growing of crops for food and fiber products), horticulture and animal husbandry, companion animals, forestry and the storage of products of vegetable origin (such as fruit, grain and timber); those pests associated with the damage of man-made structures and the transmission of diseases of man and animals; and also nuisance pests (such as flies). The compounds of the invention may be used for example on turf, ornamentals, such as flowers, shrubs, broad-leaved trees or evergreens, for example conifers, as well as for tree injection, pest management and the like. Compositions comprising the compound of formula I may be used on ornamental garden plants (e.g. flowers, shrubs, broad-leaved trees or evergreens), e.g. to control aphids, whitefly, scales, meelybug, beetles and caterpillars. Compositions comprising the compound of formula I may be used on garden plants (e.g. flowers, shrubs, broad-leaved trees or evergreens), on indoor plants (e.g. flowers and shrubs) and on indoor pest e.g. to control aphids, whitefly, scales, meelybug, beetles and caterpillars.

Furthermore, the compounds of the invention may be effective against harmful insects, without substantially imposing any harmful side effects to cultivated plants. Application of the compounds of the invention may increase the harvest yields, and may improve the quality of the harvested material. The compounds of the invention may have favourable properties with respect to amount appled, residue formulation, selectivity, toxicity, production methodology, high activity, wide spectrum of control, safety, control of resistant organisms, e.g. pests that are resistant to organic phosphorus agents and/or carbamate agents.

Examples of pest speciesAs for insects, which may be controlled by the compounds of formula (I) include: coleopterans, for example, Callosobruchus chinensis, Sitophilus zeamais, Tribolium castaneum, Epilachna vigintioctomaculata, Agriotes fuscicollis, Anomala rufocuprea, Leptinotarsa decemlineata, Diabrotica spp., Monochamus alternatus, Lissorhoptrus oryzophilus, Lyctus bruneus, Aulacophora femoralis; lepidopterans, for example, Lymantria dispar, Malacosoma neustria), Pieris rapae, Spodoptera litura, Mamestra brassicae, Chilo suppressalis), Pyrausta nubilalis, Ephestia cautella, Adoxophyes orana, Carpocapsa pomonella, Agrotisfucosa, Galleria mellonella, Plutella maculipennis, Heliothis virescens, Phyllocnistis citrella; hemipterans, for example, Nephotettix cincticeps, Nilaparvata lugens, Pseudococcus comstocki, Unaspis yanonensis, Myzus persicas, Aphis pomi, Aphis gossypii, Rhopalosiphum pseudobrassicas, Stephanitis nashi, Nezara spp., Trialeurodes vaporariorm, Psylla spp.; thysanopterans, for example, Thrips palmi, Franklinella occidental; orthopterans, for example, Blatella germanica, Periplaneta americana, Gryllotalpa Africana, Locusta migratoria migratoriodes; isopterans, for example, Reticulitermes speratus, Coptotermes formosanus; dipterans, for example, Musca domestica, Aedes aegypti, Hylemia platura, Culex pipiens, Anopheles sinensis, Culex tritaeniorhynchus, Liriomyza trifolii; acari, for example, Tetranychus cinnabarinus, Tetranychus urticae, Panonychus citri, Aculops pelekassi, Tarsonemus sppAs for.; nematodes, for example, Meloidogyne incognita, Bursaphelenchus lignicolus Mamiya et Kiyohara, Aphelenchoides besseyi, Heterodera glycines, Pratylenchus spp.

Examples of further pest species which may be controlled by the compounds of formula (I) include: from the order of the Anoplura (Phthiraptera), for example, Damalinia spp., Haematopinus spp., Linognathus spp., Pediculus spp., Trichodectes spp From.; from the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici; from the class of the Bivalva, for example, Dreissena spp.; from the order of the Chilopoda, for example, Geophilus spp., Scutigera spp From.; from the order of the Coleoptera, for example, Acanthoscehdes obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.; from the order of the Collembola, for example, Onychiurus armatus; from the order of the Dermaptera, for example, Forficula auricularia; from the order of the Diplopoda, for example, Blaniulus guttulatus From; from the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.; from the class of the Gastropoda, for example, Anion spp., Biomphalaria spp., Bulinus spp., Deroceras spp., Galba spp., Lymnaea spp., Oncomelania spp., Succinea spp From.; from the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti; ft may be furthermore possible to control protozoa, such as Eimeria From; from the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp From.; from the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma pini, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii; from the order of the Hymenoptera, for example, Diprion spp., Hoplocampa spp., Lasius spp., Mono-morium pharaonis, Vespa spp.; from the order of the Isopoda, for example, Armadillidium vulgare, Oniscus asellus, Porcellio scaber; from the order of the Isoptera, for example, Reticulitermes spp., Odontotermes spp From.; from the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofinannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.; from the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria; from the order of the Siphonaptera, for example, Ceratophyllus spp., Xenopsylla cheopis. From; from the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.; from the order of the Thysanura, for example, Lepisma saccharina. The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Mphinema spp.

In particular, the compounds of the invention may be used to control the following pest spcies:

Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds. Treatment according to the invention of the plants and plant parts with the active compounds is carried out directly or by allowing the compounds to act on their surroundings, habitat or storage space by the customary treatment methods, for example by immersion, spraying, evaporation, fogging, scattering, painting on, injecting and, in the case of propagation material, in particular in the case of seed, also by applying one or more coats.

Depending on the plant species or plant cultivars, their location and growth conditions (soils, climate, vegetation period, diet), the treatment according to the invention may also result in superadditive “synergistic”) effects.

Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

which are to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products.

Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds.

acari include Ornithodoros spp., Ixodes spp., Boophilus spp the order of the Anoplurida, for example Haematopinus spp., Linognathus spp., Pediculus spp., Phtirus spp., Solenopotes spp.; particular examples are: Linognathus setosus, Linognathus vituli, Linognathus ovillus, Linognathus oviformis, Linognathus pedalis, Linognathus stenopsis, Haematopinus asini macrocephalus, Haematopinus eurysternus, Haematopinus suis, Pediculus humanus capitis, Pediculus humanus corporis, Phylloera vastatrix, Phthirus pubis, Solenopotes capillatus; from the order of the Mallophagida and the suborders Amblycerina and Ischnocerina, for example Trimenopon spp., Menopon spp., Trinoton spp., Bovicola spp., Werneckiella spp., Lepikentron spp., Damalina spp., Trichodectes spp., Felicola spp.; particular examples are: Bovicola bovis, Bovicola ovis, Bovicola limbata, Damalina bovis, Trichodectes canis, Felicola subrostratus, Bovicola caprae, Lepikentron ovis, Werneckiella equi; from the order of the Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Odagmia spp., Wilhelmia spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp., Rhinoestrus spp., Tipula spp.; particular examples are: Aedes aegypti, Aedes albopictus, Aedes taeniorhynchus, Anopheles gambiae, Anopheles maculipennis, Calliphora erythrocephala, Chrysozona pluvialis, Culex quinquefasciatus, Culex pipiens, Culex tarsalis, Fannia canicularis, Sarcophaga carnaria, Stomoxys calcitrans, Tipula paludosa, Lucilia cuprina, Lucilia sericata, Simuliumreptans, Phlebotomus papatasi, Phlebotomus longipalpis, Odagmia ornata, Wilhelmia equina, Boophthora erythrocephala, Tabanus bromius, Tabanus spodopterus, Tabanus atratus, Tabanus sudeticus, Hybomitra ciurea, Chrysops caecutiens, Chrysops relictus, Haematopota pluvialis, Haematopota italica, Musca autumnalis, Musca domestica, Haematobia irritans irritans, Haematobia irritans exigua, Haematobia stimulans, Hydrotaea irritans, Hydrotaea albipuncta, Chrysomya chloropyga, Chrysomya bezziana, Oestrus ovis, Hypoderma bovis, Hypoderma lineatum, Przhevalskiana silenus, Dermatobia hominis, Melophagus ovinus, Lipoptena capreoli, Lipoptena cervi, Hippobosca variegata, Hippobosca equina, Gasterophilus intestinalis, Gasterophilus haemorroidalis, Gasterophilus inermis, Gasterophilus nasalis, Gasterophilus nigricornis, Gasterophilus pecorum, Braula coeca; from the order of the Siphonapterida, for example Pulex spp., Ctenocephalides spp., Tunga spp., Xenopsylla spp., Ceratophyllus spp.; particular examples are: Ctenocephalides canis, Ctenocephalides felis, Pulex irritans, Tunga penetrans, Xenopsylla cheopis; from the order of the Heteropterida, for example Cimex spp., Triatoma spp., Rhodnius spp., Panstrongylus spp the subclass of the Acari (Acarina) and the orders of the Meta- and Mesostigmata, for example Argas spp., Ornithodorus spp., Otobius spp., Ixodes spp., Amblyomma spp., Rhipicephalus (Boophilus) spp Dermacentor spp., Haemophysalis spp., Hyalomma spp., Dermanyssus spp., Rhipicephalus spp. (the original genus of multi host ticks) Ornithonyssus spp., Pneumonyssus spp., Raillietia spp., Pneumonyssus spp., Sternostoma spp., Varroa spp., Acarapis spp.; particular examples are: Argas persicus, Argas reflexus, Ornithodorus moubata, Otobius megnini, Rhipicephalus (Boophilus) microplus, Rhipicephalus (Boophilus) decoloratus, Rhipicephalus (Boophilus) annulatus, Rhipicephalus (Boophilus) calceratus, Hyalomma anatolicum, Hyalomma aegypticum, Hyalomma marginatum, Hyalomma transiens, Rhipicephalus evertsi, Ixodes ricinus, Ixodes hexagonus, Ixodes canisuga, Ixodes pilosus, Ixodes rubicundus, Ixodes scapularis, Ixodes holocyclus, Haemaphysalis concinna, Haemaphysalis punctata, Haemaphysalis cinnabarina, Haemaphysalis otophila, Haemaphysalis leachi, Haemaphysalis longicorni, Dermacentor marginatus, Dermacentor reticulatus, Dermacentor pictus, Dermacentor albipictus, Dermacentor andersoni, Dermacentor variabilis, Hyalomma mauritanicum, Rhipicephalus sanguineus, Rhipicephalus bursa, Rhipicephalus appendiculatus, Rhipicephalus capensis, Rhipicephalus turanicus, Rhipicephalus zambeziensis, Amblyomma americanum, Amblyomma variegatum, Amblyomma maculatum, Amblyomma hebraeum, Amblyomma cajennense, Dermanyssus gallinae, Ornithonyssus bursa, Ornithonyssus sylviarum, Varroa jacobsoni; from the order of the Actinedida (Prostigmata) and Acaridida (Astigmata), for example Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.; particular examples are: Cheyletiella yasguri, Cheyletiella blakei, Demodex canis, Demodex bovis, Demodex ovis, Demodex caprae, Demodex equi, Demodex caballi, Demodex suis, Neotrombicula autumnalis, Neotrombicula desaleri, Neoschongastia xerothermobia, Trombicula akamushi, Otodectes cynotis, Notoedres cati, Sarcoptis canis, Sarcoptes bovis, Sarcoptes ovis, Sarcoptes rupicaprae (S. caprae), Sarcoptes equi, Sarcoptes suis, Psoroptes ovis, Psoroptes cuniculi, Psoroptes equi, Chorioptes bovis, Psoergates ovis, Pneumonyssoidic mange, Pneumonyssoides caninum, Acarapis woodi the active compound is effective in killing the respective parasite, inhibiting its growth, or inhibiting its proliferation.

The compounds of the invention may have favourable properties with respect to amount appled, residue formulation, selectivity, toxicity, production methodology, high activity, wide spectrum of control, safety, control of resistant organisms, e.g. pests that are resistant to organic phosphorus agents and/or carbamate agents.

The compounds of formula (I) can be used to combat and control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are hereinafter collectively referred to as pests.Examples of pest species which may be controlled by the compounds of formula (I) include: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Boophilus microplus (cattle tick), Dermacentor variabilis (American dog tick), Ctenocephalides felis (cat flea), Liriomyza spp. (leafminer), Musca domestica (housefly), Aedes aegypti (mosquito), Anopheles spp. (mosquitoes), Culex spp. (mosquitoes), Lucillia spp. (blowflies), Blattella germanica (cockroach), Periplaneta americana (cockroach), Blatta orientalis (cockroach), termites of the Mastotermitidae (for example Mastotermes spp.), the Kalotermitidae (for example Neotermes spp.), the Rhinotermitidae (for example Coptotermes formosanus, Reticulitermes flavipes, R. speratu, R. virginicus, R. hesperus, and R. santonensis) and the Termitidae (for example Globitermes sulfureus), Solenopsis geminata (fire ant), Monomorium pharaonis (pharaoh's ant), Damalinia spp. and Linognathus spp. (biting and sucking lice), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug).

The compound of formula I may be used for pest control on various plants, including soybean (e.g. in some cases 10-70 g/ha), corn (e.g. in some cases 10-70 g/ha), sugarcane (e.g. in some cases 20-200 g/ha), alfalfa (e.g. in some cases 10-70 g/ha), brassicas (e.g. in some cases 10-50 g/ha), oilseed rape (e.g. canola) (e.g. in some cases 20-70 g/ha), potatoes (including sweet potatoes) (e.g. in some cases 10-70 g/ha), cotton (e.g. in some cases 10-70 g/ha), rice (e.g. in some cases 10-70 g/ha), coffee (e.g. in some cases 30-150 g/ha), citrus (e.g. in some cases 60-200 g/ha), almonds (e.g. in some cases 40-180 g/ha), fruiting vegetables, cucurbits and pulses (e.g. tomatoes, pepper, chili, eggplant, cucumber, squash etc.) (e.g. in some cases 10-80 g/ha), tea (e.g. in some cases 20-150 g/ha), bulb vegetables (e.g. onion, leek etc.) (e.g. in some cases 30-90 g/ha), grapes (e.g. in some cases 30-180 g/ha), pome fruit (e.g. apples, pears etc.) (e.g. in some cases 30-180 g/ha), and stone fruit (e.g. pears, plums etc.) (e.g. in some cases 30-180 g/ha).

The compounds of the invention may be used for pest control on various plants, including soybean, corn, sugarcane, alfalfa, brassicas, oilseed rape (e.g. canola), potatoes (including sweet potatoes), cotton, rice, coffee, citrus, almonds, fruiting vegetables, cucurbits and pulses (e.g. tomatoes, pepper, chili, eggplant, cucumber, squash etc.), tea, bulb vegetables (e.g. onion, leek etc.), grapes, pome fruit (e.g. apples, pears etc.), stone fruit (e.g. pears, plums etc.), and cereals.

Elasmopalpus lignosellus, Diloboderus abderus, Diabrotica speciosa, Trialeurodes spp., Bemisia spp., aphids, Sternechus subsignatus, Formicidae, Agrotis ypsilon, Julus spp., Murgantia spp., Halyomorpha spp., Thyanta spp., Megascelis ssp., Procornitermes ssp., Gryllotalpidae, Nezara viridula, Piezodorus spp., Acrosternum spp., Neomegalotomus spp., Cerotoma trifurcata, Popillia japonica, Edessa spp., Liogenys fuscus, stalk borer, Scaptocoris castanea, phyllophaga spp., Migdolus spp., Pseudoplusia includens, Anticarsia gemmatalis, Epinotia spp., Rachiplusia spp., Spodoptera spp. (e.g. Spodoptera frugiperda), Bemisia tabaci, Tetranychus spp., Agriotes spp., Euschistus spp. (e.g. Euschistus heros). The compounds of the invention are preferably used on soybean to control Diloboderus abderus, Diabrotica speciosa, Trialeurodes spp., Bemisia spp., Nezara viridula, Piezodorus spp., Acrosternum spp., Cerotoma trifurcata, Popillia japonica, Euschistus heros, Scaptocoris castanea, phyllophaga spp., Migdolus spp., Agriotes spp., Euschistus spp.

The compounds of the invention may be used on corn to control, for example, Euschistus spp. (e.g. Euschistus heros), Dichelops furcatus, Diloboderus abderus, Thyanta spp., Elasmopalpus lignosellus, Halyomorpha spp., Spodoptera frugiperda, Nezara viridula, Cerotoma trifurcata, Popillia japonica, Agrotis ypsilon, Diabrotica speciosa, aphids, Heteroptera, Procornitermes spp., Scaptocoris castanea, Formicidae, Julus ssp., Dalbulus maidis, Diabrotica spp. (e.g. Diabrotica virgifera), Mocis latipes, Bemisia tabaci, heliothis spp., Tetranychus spp., thrips spp., phyllophaga spp., Migdolus spp., scaptocoris spp., Liogenys fuscus, Spodoptera spp., Ostrinia spp., Sesamia spp., wireworms, Agriotes spp., Halotydeus destructor. The compounds of the invention are preferably used on corn to control Euschistus spp., (e.g. Euschistus heros), Dichelops furcatus, Diloboderus abderus, Nezara viridula, Cerotoma trifurcata, Popillia japonica, Diabrotica spp. (e.g. Diabrotica speciosa, Diabrotica virgifera), Tetranychus spp., Thrips spp., Phyllophaga spp., Migdolus spp., Scaptocoris spp., Agriotes spp.

Sphenophorus spp., termites, Migdolus spp., Diloboderus spp., Telchin licus, Diatrea saccharalis, Mahanarva spp., Mealybugs, Chilo spp.

The compounds of the invention may be used on alfalfa to control, for example, Hypera brunneipennis, Hypera postica, Colias eurytheme, Collops spp., Empoasca solana, Epitrix spp., Geocoris spp., Lygus hesperus, Lygus lineolaris, Spissistilus spp., Spodoptera spp., Aphids, Trichoplusia ni. The compounds of the invention are preferably used on alfalfa to control Hypera brunneipennis, Hypera postica, Empoasca solana, Epitrix spp., Lygus hesperus, Lygus lineolaris, Trichoplusia ni.

The compounds of the invention may be used on brassicas to control, for example, Chrysodeixis spp., Plutella xylostella, Pieris spp. (e.g. Pieris brassicae, Pieris rapae, Pieris napi), Mamestra spp. (e.g. Mamestra brassicae), Plusia spp., Trichoplusia spp. (e.g. Trichoplusia ni), Phyllotreta spp. (e.g. Phyllotreta cruciferae, Phyllotreta striolata), Spodoptera spp., Empoasca spp., thrips spp., Delia spp., Murgantia spp., Trialeurodes spp., Bemisia spp., Microtheca spp., Aphids, Chaetocnema spp., Psylliodes spp. (e.g. Psylliodes chrysocephala). The compounds of the invention are preferably used on brassicas to control Plutella xylostella, Pieris spp., Plusia spp., Trichoplusia ni, Phyllotreta spp., Thrips spp., Chaetocnema spp., Meligethes spp. (e.g. Meligethes aeneus), Ceutorhynchus spp., (e.g. Ceutorhynchus assimilis, Ceutorhynchus napi), Halotydeus destructor, Psylloides spp. (e.g. Psylliodes chrysocephala), Phyllotreta spp. (e.g. Phyllotreta cruciferae, Phyllotreta striolata), Chaetocnema spp.

The compounds of the invention may be used on potatoes, including sweet potatoes, to control, for example, Empoasca spp., Leptinotarsa spp., Diabrotica speciosa, Phthorimaea spp., Paratrioza spp., Maladera matrida, Agriotes spp., Aphids, wireworms. The compounds of the invention are preferably used on potatoes, including sweet potatoes, to control Empoasca spp., Leptinotarsa spp., Diabrotica speciosa, Phthorimaea spp., Paratrioza spp., Agriotes spp.

The compounds of the invention may be used on cotton to control, for example, Anthonomus grandis, Pectinophora spp., heliothis spp., Spodoptera spp., Tetranychus spp. (e.g. Tetranychus urticae), Empoasca spp., Thrips spp. (e.g. Thrips tabaci, Thrips palmi), Bemisia tabaci, Trialeurodes spp., Aphids, Lygus spp. (e.g. Lygus lineolaris, Lygus Hesperus), phyllophaga spp., Scaptocoris spp., Austroasca viridigrisea, Creontiades spp., Nezara spp., Piezodorus spp., Halotydeus destructor, Oxycaraenus hyalinipennis, Dysdercus cingulatus, Amrasca spp. (e.g. Amrasca biguttula biguttula), Frankliniella spp. (e.g. Frankliniella schultzei), Scirtothrips spp. (e.g. Scirtothrips dorsali), Anaphothrips spp., Polyphagotarsonemus latus. The compounds of the invention are preferably used on cotton to control Anthonomus grandis, Tetranychus spp., Empoasca spp., thrips spp., Lygus spp., phyllophaga spp., Scaptocoris spp.

The compounds of the invention may be used on rice to control, for example, Leptocorisa spp. (e.g. Leptocorisa oratorius, Leptocorisa chinensis, Leptocorisa acuta), Cnaphalocrosis spp., Chilo spp. (e.g. Chilo suppressalis, Chilo polychrysus, Chilo auricilius), Scirpophaga spp. (e.g. Scirpophaga incertulas, Scirpophaga innotata, Scirpophaga nivella), Lissorhoptrus spp., Oebalus pugnax, Scotinophara spp. (e.g. Scotinophara coarctata, Scotinophara lurida, Scotinophara latiuscula), Nephotettix spp. (e.g. Nephotettix malayanus, Nephotettix nigropictus, Nephotettix parvus, Nephottetix virescens, Nephotettix cincticeps), Mealybugs, Sogatella furcifera, Nilaparvata lugens, Orseolia spp. (e.g. Orseolia oryzae), Cnaphalocrocis medinalis, Marasmia spp. (e.g. Marasmia patnalis, Marasmia exigua), Stenchaetothrips biformis, Thrips spp., Hydrellia spp. (e.g. Hydrellia philippina), Grasshoppers, Pomacea canaliculata, Scirpophaga innotata, Sesamia inferens, Laodelphax striatellus, Nymphula depunctalis, Oulema oryzae, Stinkbugs. The compounds of the invention are preferably used on rice to control Leptocorisa spp., Lissorhoptrus spp., Oebalus pugnax, Nephotettix spp. (e.g. Nephotettix malayanus, Nephotettix nigropictus, Nephotettix parvus, Nephottetix virescens, Nephotettix cincticeps), Sogatella furcifera, Stenchaetothrips biformis, Thrips spp., Hydrellia spp. (e.g. Hydrellia philippina), Grasshoppers, Pomacea canaliculata, Scirpophaga innotata, Chilo spp., Oulema oryzae.

The compounds of the invention may be used on coffee to control, for example, Hypothenemus spp. (e.g. Hypothenemus Hampei), Perileucoptera Coffeella, Tetranychus spp., Brevipalpus spp., Mealybugs. The compounds of the invention are preferably used on coffee to control Hypothenemus Hampei, Perileucoptera Coffeella.

The compounds of the invention may be used on citrus to control, for example, Panonychus citri, Phyllocoptruta oleivora, Brevipalpus spp. (e.g. Brevipalpus californicus, Brevipalpus phoenicis), Diaphorina citri, Scirtothrips spp. (e.g. Scirtothrips dorsalis), Thrips spp., Unaspis spp., Ceratitis capitata, Phyllocnistis spp. (e.g. Phyllocnistis citrella), Aphids, Hardscales, Softscales, Mealybugs. The compounds of the invention are preferably used on citrus to control Panonychus citri, Phyllocoptruta oleivora, Brevipalpus spp., Diaphorina citri, Scirtothrips spp., thrips spp., Phyllocnistis spp.

The compounds of the invention may be used on almonds to control, for example, Amyelois transitella, Tetranychus spp.

The compounds of the invention may be used on fruiting vegetables, cucurbits and pulses, including tomatoes, pepper, chili, eggplant, cucumber, squash etc., to control, for example, Thrips spp., Tetranychus spp. (e.g. Tetranychus urticae), Polyphagotarsonemus spp. (e.g. Polyphagotarsonemus latus), Aculops spp. (e.g. Aculops lycopersici), Empoasca spp. (e.g. Empoasca fabae), Spodoptera spp., heliothis spp., Tuta absoluta, Liriomyza spp. (e.g. Liriomyza brassicae, Liriomyza bryoniae, Liriomyza huidobrensis, Liriomyza sativae, Liriomyza trifolii), Bemisia tabaci, Trialeurodes spp., Aphids, Paratrioza spp., Frankliniella spp. (e.g. Frankliniella occidentalis, Frankliniella intonsa, Frankliniella bispinosa), Spodoptera spp. (e.g. Spodoptera exigua, Spodoptera littoralis, Spodoptera litura, Spodoptera frugiperda, Spodoptera eridania), Anthonomus spp., Phyllotreta spp., Amrasca spp. (e.g. Amrasca biguttula biguttula), Epilachna spp., Halyomorpha spp., Scirtothrips spp., Leucinodes spp. (e.g. Leucinodes orbonalis), Neoleucinodes spp. (e.g. Neoleucinodes elegantalis), Maruca spp., Fruit flies, Stinkbugs, Lepidopteras, Coleopteras, Helicoverpa spp. (e.g. Helicoverpa armigera), Heliothis spp. (e.g. Heliothis virescens), Paratrioza spp. (e.g. Paratrioza cockerelli), The compounds of the invention are preferably used on fruiting vegetables, cucurbits and pulses, including tomatoes, pepper, chili, eggplant, cucumber, squash etc., to control Thrips spp., Tetranychus spp., Polyphagotarsonemus spp., Aculops spp., Empoasca spp., Spodoptera spp., heliothis spp., Tuta absoluta, Liriomyza spp., Paratrioza spp., Frankliniella occidentalis, Frankliniella spp., Amrasca spp., Scirtothrips spp., Leucinodes spp., Neoleucinodes spp.

The compounds of the invention may be used on tea to control, for example, Pseudaulacaspis spp., Empoasca spp., Scirtothrips spp., Caloptilia theivora, Tetranychus spp. The compounds of the invention are preferably used on tea to control Empoasca spp., Scirtothrips spp.

The compounds of the invention may be used on bulb vegetables, including onion, leek etc. to control, for example, Thrips spp., Spodoptera spp., heliothis spp. The compounds of the invention are preferably used on bulb vegetables, including onion, leek etc. to control Thrips spp.

The compounds of the invention may be used on grapes to control, for example, Empoasca spp., Lobesia spp., Eupoecilia ambiguella, Frankliniella spp., Thrips spp., Tetranychus spp., Rhipiphorothrips Cruentatus, Eotetranychus Willamettei, Erythroneura Elegantula, Scaphoides spp., Scelodonta strigicollis, Mealybugs. The compounds of the invention are preferably used on grapes to control Frankliniella spp., Thrips spp., Tetranychus spp., Rhipiphorothrips Cruentatus, Scaphoides spp.

The compounds of the invention may be used on pome fruit, including apples, pears etc., to control, for example, Cacopsylla spp., Psylla spp., Panonychus ulmi, Cydia pomonella, Lepidopteras, Aphids, Hardscales, Softscales. The compounds of the invention are preferably used on pome fruit, including apples, pears etc., to control Cacopsylla spp., Psylla spp., Panonychus ulmi.

The compounds of the invention may be used on stone fruit to control, for example, Grapholita molesta, Scirtothrips spp., Thrips spp., Frankliniella spp., Tetranychus spp., Aphids, Hardscales, Softscales, Mealybugs. The compounds of the invention are preferably used on stone fruit to control Scirtothrips spp., Thrips spp., Frankliniella spp., Tetranychus spp.

The compounds of the invention may be used on cereals to control, for example, Aphids, Stinkbugs, earthmites, Eurygaster integriceps, Zabrus tenebrioides, Anisoplia austriaca, Chaetocnema aridula, Phyllotreta spp., Oulema melanopus, Oscinella spp., Delia spp., Mayetiola spp., Contarinia spp., Cephus spp., Steneotarsonemus spp., Apamea spp.

In another embodiment compounds of formula I may be used on rice to control Baliothrips biformis (Thrips), Chilo spp. (e.g. Chilo polychrysus (Dark headed striped borer), Chilo suppressalis (Rice stemborer), Chilo indicus (Paddy stem borer), Chilo polychrysus (Dark-headed rice borer), Chilo suppressalis (Stripe stem borer)), Cnaphalocrocis medinalis (Rice leaf folder), Dicladispa armigera (Hispa), Hydrellia philipina (Rice whorl-maggot), Laodelphax spp. (Smaller brown planthopper) (e.g. Laodelphax striatellus), Lema oryzae (Rice leafbeetle), Leptocorsia acuta (Rice bug), Leptocorsia oratorius (rice bug), Lissorhoptrus oryzophilus (rice water weevil), Mythemina separata (armyworm), Nephottetix spp. (Green leafhopper) (e.g. Nephotettix cincticeps, Nephotettix malayanus, Nephotettix nigropictus, Nephotettix parvus, Nephottetix virescens), Nilaparvata lugens (Brown Planthopper), Nymphula depunctalis (Rice caseworm), Orseolia oryzae (Rice Gall midge), Oulema oryzae (Rice leafbeetle), Scirpophaga incertulas (Yellow Stemborer), Scirpophaga innotata (White Stemborer), Scotinophara coarctata (Rice black bug), Sogaella frucifera (White-backed planthopper), Steneotarsonemus spinki.

The compounds of the invention may be used to control animal housing pests including: Ants, Bedbugs (adult), Bees, Beetles, Boxelder Bugs, Carpenter Bees, Carpet Beetles, Centipedes, Cigarette, Beetles, Clover Mites, Cockroaches, Confused Flour Beetle, Crickets, Earwigs, Firebrats, Fleas, Flies, Lesser Grain Borers, Millipedes, Mosquitoes, Red Flour Beetles, Rice Weevils, Saw-toothed Grain Beetles, Silverfish, Sowbugs, Spiders, Termites, Ticks, Wasps, Cockroaches, Crickets, Flies, Litter Beetles (such as Darkling, Hide, and Carrion), Mosquitoes, Pillbugs, Scorpions, Spiders, Spider Mites (Twospotted, Spruce), Ticks.

The compounds of the invention may be used to control ornamental pests including: Ants (Including Imported fire ants), Armyworms, Azalea caterpillars, Aphids, Bagworms, Black vine weevils (adult), Boxelder bugs, Budworms, California oakworms, Cankerworms, Cockroaches, Crickets, Cutworms, Eastern tent caterpillars, Elm leaf beetles, European sawflies, Fall webworms, Flea beetles, Forest tent caterpillars, Gypsy moth larvae, Japanese beetles (adults), June beetles (adults), Lace bugs, Leaf-feeding caterpillars, Leafhoppers, Leafminers (adults), Leaf rollers, Leaf skeletonizers, Midges, Mosquitoes, Oleander moth larvae, Pillbugs, Pine sawflies, Pine shoot beetles, Pinetip moths, Plant bugs, Root weevils, Sawflies, Scale insects (crawlers), Spiders, Spittlebugs, Striped beetles, Striped oakworms, Thrips, Tip moths, Tussock moth larvae, Wasps, Broadmites, Brown softscales, California redscales (crawlers), Clover mites, Mealybugs, Pineneedlescales (crawlers), Spider mites, Whiteflies

The compounds of the invention may be used to control turf pests including: Ants (Including Imported fire ants, Armyworms, Centipedes, Crickets, Cutworms, Earwigs, Fleas (adult), Grasshoppers, Japanese beetles (adult), Millipedes, Mites, Mosquitoes (adult), Pillbugs, Sod webworms, Sow bugs, Ticks (including species which transmit Lyme disease), Bluegrass billbugs (adult), Black turfgrass ataenius (adult), Chiggers, Fleas (adult), Grubs (suppression), Hyperodes weevils (adult), Mole crickets (nymphs and young adults), Mole Crickets (mature adults), Chinch Bugs.

The compounds of formula (I), in particular those in the tables above, may be used for soil applications, including as a seed application, to target at least the following: sucking pests such as aphids, thrips, brown plant hopper (e.g. on rice), sting bugs, white flies (e.g. on cotton and vegetables), mites; on soil pests such as corn root worm, wireworms, white grubs, zabrus, termites (e.g. on sugar cane, soy, pasture), maggots, cabbage root fly, red legged earth mite; on lepidoptera, such as spodoptera, cutworms, elasmoplpus, plutella (e.g. brassica), stem borers, leaf miners, flea beetle, Sternechus; on nematicides, such as Heterodera glycines (e.g. on soybean), Pratylenchus brachyurus (e.g. on corn), P. zeae (e.g. oncorn), P. penetrans (e.g. on corn), Meloidogyne incognita (e.g. on vegetables), Heterodera schachtii (e.g. on sugar beet), Rotylenchus reniformis (e.g. on cotton), Heterodera avenae (e.g. on cereals), Pratylenchus neglectus (e.g. on cereals), thornei (e.g. on cereals).

The compounds of formula (I), in particular those in the tables above may be used for seed applications at least on the following: soil grubs for corn, soybeans, sugarcane: Migdolus spp; Phyllophaga spp.; Diloboderus spp; Cyclocephala spp; Lyogenys fuscus; sugarcane weevils: Sphenophorus levis & Metamasius hemipterus; termites for soybeans, sugarcane, pasture, others: Heterotermes tenuis; Heterotermes longiceps; Cornitermes cumulans; Procornitermes triacifer; Neocapritermes opacus; Neocapritermes parvus; corn root worms for corn and potatoes: Diabrotica spp., seed Maggot: Delia platura; soil stinkbugs: Scaptocoris castanea; wireworms: Agriotes spp; Athous spp Hipnodes bicolor; Ctenicera destructor; Limonius canu; Limonius californicus; rice water weevil: Lissorhoptrus oryzophilus; Red Legged earth mites: Halotydeus destructor.

The invention therefore provides a method of combating and/or controlling an animal pest, e.g. an invertebrate animal pest, which comprises applying to the pest, to a locus of the pest, or to a plant susceptible to attack by the pest a pesticidally effective amount of a compound of formula (I). In particular, the invention provides a method of combating and/or controlling insects, acarines, nematodes or molluscs which comprises applying an insecticidally, acaricidally, nematicidally or molluscicidally effective amount of a compound of formula (I), or a composition containing a compound of formula (I), to a pest, a locus of pest, preferably a plant, or to a plant susceptible to attack by a pest, The compounds of formula (I) are preferably used against insects, acarines or nematodes.

The term “plant” as used herein includes seedlings, bushes and trees. Crops are to be understood as also including those crops which have been rendered tolerant to herbicides or classes of herbicides (e.g. ALS-, GS-, EPSPS-, PPO- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

The compounds of the invention may be applied to plant parts. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds. Treatment according to the invention of the plants and plant parts with the active compounds is carried out directly or by allowing the compounds to act on their surroundings, habitat or storage space by the customary treatment methods, for example by immersion, spraying, evaporation, fogging, scattering, painting on, injecting and, in the case of propagation material, in particular in the case of seed, also by applying one or more coats.

The term “plant” as used herein includes seedlings, bushes and trees. Crops are to be understood as also including those crops which have been rendered tolerant to herbicides or classes of herbicides (e.g. ALS-, GS-, EPSPS-, PPO- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

Compounds of formula I may be used on transgenic plants (including cultivars) obtained by genetic engineering methods and/or by conventional methods. These are understood as meaning plants having novel properties (“traits”) which have been obtained by conventional breeding, by mutagenesis or by recombinant DNA techniques. Depending on the plant species or plant cultivars, their location and growth conditions (soils, climate, vegetation period, diet), the treatment according to the invention may also result in superadditive “synergistic”) effects.

Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

The preferred transgenic plants or plant cultivars which are to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products.

Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds.

methods, for exampleExamples of transgenic plants which may be mentioned are the important crop plants, such as cereals (wheat, rice), maize, soybean, potatoes, sugar beet, tomatoes, peas and other vegetable varieties, cotton, tobacco, oilseed rape and also fruit plants (with the fruits apples, pears, citrus fruits and grapes).

Compounds of formula I may be used on transgenic plants that are capable of producing one or more pesticidal proteins which confer upon the transgenic plant tolerance or resistance to harmful pests, e.g. insect pests, nematode pests and the like. Such pesticidal proteins include, without limitation, Cry proteins from Bacillus thuringiensis Cry1Ab, Cry1Ac, Cry1F, Cry2Ab, Cry2Ae, Cry3A, Cry3Bb, or Cry9C; engineered proteins such as modified Cry3A (U.S. Pat. No. 7,030,295) or CryIA.105; or vegetative insecticidal proteins such as Vip1, Vip2 or Vip3. A full list of Bt Cry proteins and VIPs useful in the invention can be found on the worldwide web at Bacillus thuringiensis Toxin Nomenclature Database maintained by the University of Sussex (see also, Crickmore et al. (1998) Microbiol. Mol. Biol. Rev. 62:807-813). Other pesticidal proteins useful in the invention include proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. Further examples of such pesticidal proteins or transgenic plants capable of synthesizing such proteins are disclosed, e.g., in EP-A 374753, WO 93/007278, WO 95/34656, EP-A 427529, EP-A 451878, WO 03/18810 and WO 03/52073. The methods for producing such transgenic plants are generally known to the person skilled in the art and some of which are commercially available such as Agrisure®CB (corn producing Cry1Ab), Agrisure®RW (corn producing mCry3A), Agrisure® Viptera (corn hybrids producing Vip3Aa); Agrisure300GT (corn hybrids producing Cry1Ab and mCry3A); YieldGard® (corn hybrids producing the Cry1Ab protein), YieldGard® Plus (corn hybrids producing Cry1Ab and Cry3Bb1), Genuity® SmartStax® (corn hybrids with Cry1A.105, Cry2Ab2, Cry1F, Cry34/35, Cry3Bb); Herculex® I (corn hybrids producing CrylFa) and Herculex®RW (corn hybrids producing Cry34Ab1, Cry35Ab1 and the enzyme Phosphinothricin-N-Acetyltransferase [PAT]); NuCOTN®33B (cotton cultivars producing Cry1Ac), Bollgard®I (cotton cultivars producing Cry1Ac), Bollgard®II (cotton cultivars producing Cry1Ac and Cry2Ab2) and VIPCOT® (cotton cultivars producing a Vip3Aa). Soybean Cyst Nematode resistance soybean (SCN®-Syngenta) and soybean with Aphid resistant trait (AMT®) are also of interest.

Further examples of such transgenic crops are:

Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Bt11 maize also transgenically expresses the enzyme PAT to achieve tolerance to the herbicide glufosinate ammonium.

Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.

3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.

4. MON 863 Maize from Monsanto Europe S.A. 270-272 Avenue de Tervuren, B-1150 Brussels, Belgium, registration number C/DE/02/9. MON 863 expresses a CryIIIB(b1) toxin and has resistance to certain Coleoptera insects.

5. IPC 531 Cotton from Monsanto Europe S.A. 270-272 Avenue de Tervuren, B-1150 Brussels, Belgium, registration number C/ES/96/02.

6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.

7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, include the European corn borer.

Further examples of transgenic plants, and of very high interest, are those carrying traits conferring resistance to 2.4D (e.g. Enlist®) (e.g. WO 2011066384), glyphosate (e.g. Roundup Ready®, Roundup Ready 2 Yield®), sulfonylurea (e.g. STS®), glufosinate (e.g. Liberty Link®, Ignite®), Dicamba (Monsanto), HPPD tolerance (e.g. isoxaflutole herbicide) (Bayer CropScience, Syngenta). Double or triple stacks of any of the traits described here are also of interest, including glyphosate and sulfonyl-urea tolerance ((e.g. Optimum GAT®), plants stacked with STS® and Roundup Ready® or plants stacked with STS® and Roundup Ready 2 Yield®), dicamba and glyphosate tolerance (Monsanto). Of particular interest are soybean plants carrying trains conferring resistance to 2.4D (e.g. Enlist®), glyphosate (e.g. Roundup Ready®, Roundup Ready 2 Yield®), sulfonylurea (e.g. STS®), glufosinate (e.g. Liberty Link®, Ignite®), Dicamba (Monsanto) HPPD tolerance (e.g. isoxaflutole herbicide) (Bayer CropScience, Syngenta). Double or triple stack in soybean plants of any of the traits described here are also of interest, including glyphosate and sulfonyl-urea tolerance (e.g. Optimum GAT®, plants stacked with STS® and Roundup Ready® or Roundup Ready 2 Yield®), dicamba and glyphosate tolerance (Monsanto).

Transgenic crops of insect-resistant plants are also described in BATS (Zentrum für Biosicherheit and Nachhaltigkeit, Zentrum BATS, Clarastrasse 13, 4058 Basel, Switzerland) Report 2003, (http://bats.ch).

Examples of cotton transgenic events include MON 531/757/1076 (Bollgard I®-Monsanto), MON1445 (Roundup Ready Cotton®-Monsanto), MON531×MON1445 (Bollgard I+RR®-Monsanto), MON15985 (Genuity Bollgard II Cotton®-Monsanto), MON88913 (Genuity RR FLEX Cotton®-Monsanto), MON15985×MON1445 (Genuity Bollgard II+RR FELX Cotton®-Monsanto), MON15983×MON88913 (Genuity Bollgard II+RR FLEX Cotton®-Monsanto), MON15985 (FibreMax Bollgard II Cotton®-Monsanto), LL25 (FibreMax LL Cotton®-BCS Stoneville), GHB614 (FibreMax GlyTol Cotton®-BCS Stoneville), LL25×MON15985 (FibreMax LL Bollgard II Cotton®-BCS Stoneville/Monsanto), GHB614×LL25 (FibreMax LL GlyTol Cotton®-BCS Stoneville), GHB614×LL25×MON15985 (FibreMax RR GlyTol Bollgard II Cotton®-BCS Stoneville), MON88913×MON15985 (FibreMax LL GlyTol Bollgard II Cotton®-Monsanto), MON88913 (FibreMax RR Flex Cotton®-Monsanto), GHB 119+T304-40 (Twinlink®-BCS Stoneville), GHB 119+T304-40×LL25×GHB614 (Twinlink LL GT®-BCS Stoneville), 3006-210-23×281-24-236 (PhytoGen Widestrike Insect Protection®-Dow), 3006-210-23×281-24-236×MON88913 (PhytoGen Widestrike Insect Protection+RR FLEX-® Dow/Monsanto), 3006-210-23×281-24-236×MON1445 ((PhytoGen Widestrike Insect Protection+RR®-Dow/Monsanto), MON1445 (PhytoGen Roundup Ready®-Monsanto), MON88913 (PhytoGen Roundup Ready FLEX®-Monsanto), COT102×COT67B (Vipcot®-Syngenta), COT102×COT67B×MON88913 (Vipcot RR FLEX®-Syngenta/Monsanto), 281-24-236 (Dow), 3006-210-23 (Dow), COT102 (Syngenta), COT67B (Syngenta), T304-40 (BCS Stoneville).

Examples of Soy transgenic events include MON87701×MON89788 (Genuity Roundup ready 2 Yield Soybeans®-Monsanto), MON89788 (Roundup Ready2Yield®, RR2Y®-Monsanto), MON87708 (Monsanto), 40-3-2 (Roundup Ready®, RR1®-Monsanto), MON87701 (Monsanto), DAS-68416 (Enlist Weed Control System®-Dow), DP356043 (Optimum GAT®-Pioneer), A5547-127 (LibertyLink Soybean®-Bayercropscience), A2704-12 (Bayercropscience), GU262 (Bayercropscience), W62 W98 (Bayercropscience), CRV127 (Cultivance®-BASF/EMBRAPA), SYHT0H2 (WO2012/082548).

Examples of Maize transgenic events include T25 (LibertyLink®, LL®-Bayerscropscience),

DHT-1 (Dow), TC1507 (Herculex I®-Dow), DAS59122-7 (Herculex RW®-Dow), TC1507+DAS59122-7-Herculex Xtra®-Dow), TC1507×DAS-59122-7×NK603 (Herculex Xtra+RR®-Dow), TC1507×DAS-59122-×MON88017×MON89034 (Genuity Smartstax Corn®, Genuity Smartstax RIB Complete®-Monsanto/Dow), MON89034×NK603 (Genuity VT double PRO®-Monsanto), MON89034+MON88017 (Genuity VT Triple PRO®-Monsanto), NK603 (Roundup Ready 2®, RR2®-Monsanto), MON810 (YieldGard BT®, Yieldgard Cornborer®-Monsanto), MON810×NK603 (YieldGard cornborer RR Corn 2®-Monasnto), MON810×MON863 (YieldGard Plus®-Monsanto), MON863×MON810×NK603 (YieldGard Plus+RR Corn2®/YieldGard RR Maize®-Monsanto), MON863×NK603 (YieldGard Rotworm+RR Corn 2®-Monsanto), MON863 (YieldBard RW®-Monsanto), MON89034 (YieldGard RW®-Monsanto), MON88017 (YieldGard VT RW®-Monsanto), MON810+MON88017 (YieldGard VT Triple®-Monsanto), MON88017+MON89034 (YieldGard VT Triple Pro®-Monsanto), Bt11+MIR604+GA21 (Agrisure 3000®-Syngenta), Bt11+TC1507+MIR604+5307+GA21 (Syngenta), Bt11+TC1507+MIR604+DAS59122+GA21 (Agrisure 3122®-Syngenta), BT11 (Agrisure CB®-Syngenta), GA21—(Agrisure GT®-Syngenta), MIR604 (Agrisure RW®-Syngenta), Bt11+MIR162 (Agrisure TL VIP®-Syngenta), BT11+MIR162+GA21 (Agrisure Viptra 3110®-Syngenta), BT11+MIR162+MIR604 (Agrisure™ 3100®-Syngenta), Event3272+BT11+MIR604+GA21 (Syngenta), BT11+MIR1692+MIR604+GA21 (Agrisure Viptera 3111®-Syngenta), BT11+MIR 162+TC1507+GA21 (Agrisure Viptera 3220®-Syngenta), BT11+MIR162+TC1507+MIR604+5307+GA21 (Agrisure Viptera 3222®-Syngenta), MIR162 (Syngenta), BT11+GA21+MIR162+MIR604+5307 (Syngenta), 5307 (Syngenta).

In order to apply a compound of formula (I) as an insecticide, acaricide, nematicide or molluscicide to a pest, a locus of pest, or to a plant susceptible to attack by a pest, a compound of formula (I) is usually formulated into a composition which includes, in addition to the compound of formula (I), a suitable inert diluent or carrier and, optionally, a surface active agent (SFA). SFAs are chemicals which are able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, for example 5 to 60%, of a compound of formula (I). The composition is generally used for the control of pests such that a compound of formula (I) is applied at a rate of from 0.1 g to 10 kg per hectare, preferably from 1 g to 6 kg per hectare, more preferably from 1 g to 1 kg per hectare.

When used in a seed dressing, a compound of formula (I) is generally used at a rate of 0.0001 g to 10 g (for example 0.001 g or 0.05 g), preferably 0.005 g to 10 g, more preferably 0.005 g to 4 g, per kilogram of seed.

In another aspect the present invention provides a composition comprising a pesticidally effective amount of a compound of formula (I), in particular an insecticidal, acaricidal, nematicidal or molluscicidal composition comprising an insecticidally, acaricidally, nematicidally or molluscicidally effective amount of a compound of formula (I) and a suitable carrier or diluent therefor. The composition is preferably an insecticidal, acaricidal, nematicidal or molluscicidal composition.

The compositions can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), microemulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the compound of formula (I).

Dustable powders (DP) may be prepared by mixing a compound of formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers) and mechanically grinding the mixture to a fine powder.

Soluble powders (SP) may be prepared by mixing a compound of formula (I) with one or more water-soluble inorganic salts (such as sodium bicarbonate, sodium carbonate or magnesium sulfate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of formula (I) and one or more powdered solid diluents or carriers, or from pre-formed blank granules by absorbing a compound of formula (I) (or a solution thereof, in a suitable agent) in a porous granular material (such as pumice, attapulgite clays, fuller's earth, kieselguhr, diatomaceous earths or ground corn cobs) or by adsorbing a compound of formula (I) (or a solution thereof, in a suitable agent) on to a hard core material (such as sands, silicates, mineral carbonates, sulfates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of formula (I) in water or an organic solvent, such as a ketone, alcohol or glycol ether. These solutions may contain a surface active agent (for example to improve water dilution or prevent crystallization in a spray tank).

Emulsifiable concentrates (EC) or oil-in-water emulsions (EW) may be prepared by dissolving a compound of formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a compound of formula (I) either as a liquid (if it is not a liquid at room temperature, it may be melted at a reasonable temperature, typically below 70° C.) or in solution (by dissolving it in an appropriate solvent) and then emulsifiying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid formulation. A compound of formula (I) is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of formula (I). SCs may be prepared by ball or bead milling the solid compound of formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of formula (I) may be dry milled and added to water, containing agents hereinbefore described, to produce the desired end product.

Aerosol formulations comprise a compound of formula (I) and a suitable propellant (for example n-butane). A compound of formula (I) may also be dissolved or dispersed in a suitable medium (for example water or a water miscible liquid, such as n-propanol) to provide compositions for use in non-pressurized, hand-actuated spray pumps.

A compound of formula (I) may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerization stage such that an aqueous dispersion of oil droplets is obtained, in which each oil droplet is encapsulated by a polymeric shell and contains a compound of formula (I) and, optionally, a carrier or diluent therefor. The polymeric shell may be produced by either an interfacial polycondensation reaction or by a coacervation procedure. The compositions may provide for controlled release of the compound of formula (I) and they may be used for seed treatment. A compound of formula (I) may also be formulated in a biodegradable polymeric matrix to provide a slow, controlled release of the compound.

A composition may include one or more additives to improve the biological performance of the composition (for example by improving wetting, retention or distribution on surfaces; resistance to rain on treated surfaces; or uptake or mobility of a compound of formula (I)). Such additives include surface active agents, spray additives based on oils, for example certain mineral oils or natural plant oils (such as soy bean and rape seed oil), and blends of these with other bio-enhancing adjuvants (ingredients which may aid or modify the action of a compound of formula (I)).

A compound of formula (I) may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating seed may include an agent for assisting the adhesion of the composition to the seed (for example a mineral oil or a film-forming barrier).

Wetting agents, dispersing agents and emulsifying agents may be surface SFAs of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulfuric acid (for example sodium lauryl sulfate), salts of sulfonated aromatic compounds (for example sodium dodecylbenzenesulfonate, calcium dodecylbenzenesulfonate, butylnaphthalene sulfonate and mixtures of sodium di-isopropyl- and tri-isopropyl-naphthalene sulfonates), ether sulfates, alcohol ether sulfates (for example sodium laureth-3-sulfate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulfosuccinamates, paraffin or olefine sulfonates, taurates and lignosulfonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

A compound of formula (I) may be applied by any of the known means of applying pesticidal compounds. For example, it may be applied, formulated or unformulated, to the pests or to a locus of the pests (such as a habitat of the pests, or a growing plant liable to infestation by the pests) or to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapor or applied through distribution or incorporation of a composition (such as a granular composition or a composition packed in a water-soluble bag) in soil or an aqueous environment.

A compound of formula (I) may also be injected into plants or sprayed onto vegetation using electrodynamic spraying techniques or other low volume methods, or applied by land or aerial irrigation systems.

Compositions for use as aqueous preparations (aqueous solutions or dispersions) are generally supplied in the form of a concentrate containing a high proportion of the active ingredient, the concentrate being added to water before use. These concentrates, which may include DCs, SCs, ECs, EWs, MEs, SGs, SPs, WPs, WGs and CSs, are often required to withstand storage for prolonged periods and, after such storage, to be capable of addition to water to form aqueous preparations which remain homogeneous for a sufficient time to enable them to be applied by conventional spray equipment. Such aqueous preparations may contain varying amounts of a compound of formula (I) (for example 0.0001 to 10%, by weight) depending upon the purpose for which they are to be used.

A compound of formula (I) may be used in mixtures with fertilizers (for example nitrogen-, potassium- or phosphorus-containing fertilizers). Suitable formulation types include granules of fertilizer. The mixtures preferably contain up to 25% by weight of the compound of formula (I).

The invention therefore also provides a fertilizer composition comprising a fertilizer and a compound of formula (I).

The compositions of this invention may contain other compounds having biological activity, for example micronutrients or compounds having fungicidal activity or which possess plant growth regulating, herbicidal, insecticidal, nematicidal or acaricidal activity.

The compound of formula (I) may be the sole active ingredient of the composition or it may be admixed with one or more additional active ingredients such as a pesticide, e.g. a insecticide, fungicide or herbicide, or a synergist or plant growth regulator where appropriate. An additional active ingredient may provide a composition having a broader spectrum of activity or increased persistence at a locus; synergize the activity or complement the activity (for example by increasing the speed of effect or overcoming repellency) of the compound of formula (I); or help to overcome or prevent the development of resistance to individual components. The particular additional active ingredient will depend upon the intended utility of the composition.

Examples of suitable pesticides include the following (where “Tx” means a compound of formula (I), and in particular a compound selected from Tables 1P to 90P and 1Q to 36Q, which may result in a synergistic combination with the given active ingredient):

a) Pyrethroids, such as permethrin+Tx, cypermethrin+Tx, fenvalerate+Tx, esfenvalerate+Tx, deltamethrin+Tx, cyhalothrin+Tx (in particular lambda-cyhalothrin+Tx and gamma cyhalothrin+Tx), bifenthrin+Tx, fenpropathrin+Tx, cyfluthrin+Tx, tefluthrin+Tx, fish safe pyrethroids+Tx (for example ethofenprox+Tx), natural pyrethrin+Tx, tetramethrin+Tx, S-bioallethrin+Tx, fenfluthrin+Tx, prallethrin+Tx, acrinathirin+Tx, etofenprox+Tx or 5-benzyl-3-furylmethyl-(E)-(1R,3S)-2,2-dimethyl-3-(2-oxothiolan-3-ylidenemethyl)cyclopropane carboxylate+Tx;

b) Organophosphates, such as profenofos+Tx, sulprofos+Tx, acephate+Tx, methyl parathion+Tx, azinphos-methyl+Tx, demeton-s-methy+Tx 1, heptenophos+Tx, thiometon+Tx, fenamiphos+Tx, monocrotophos+Tx, profenofos+Tx, triazophos+Tx, methamidophos+Tx, dimethoate+Tx, phosphamidon+Tx, malathion+Tx, chlorpyrifos+Tx, phosalone+Tx, terbufos+Tx, fensulfothion+Tx, fonofos+Tx, phorate+Tx, phoxim+Tx, pirimiphos-methyl+Tx, pirimiphos-ethyl+Tx, fenitrothion+Tx, fosthiazate+Tx or diazinon+Tx;

c) Carbamates (including aryl carbamates), such as pirimicarb+Tx, triazamate+Tx, cloethocarb+Tx, carbofuran+Tx, furathiocarb+Tx, ethiofencarb+Tx, aldicarb+Tx, thiofurox+Tx, carbosulfan+Tx, bendiocarb+Tx, fenobucarb+Tx, propoxur+Tx, methomyl+Tx or oxamyl+Tx;

d) Benzoyl ureas, such as diflubenzuron+Tx, triflumuron+Tx, hexaflumuron+Tx, flufenoxuron+Tx, diafenthiuron+Tx, lufeneron+Tx, novaluron+Tx, noviflumuron+Tx or chlorfluazuron+Tx;

e) Organic tin compounds, such as cyhexatin+Tx, fenbutatin oxide+Tx or azocyclotin+Tx;

f) Pyrazoles, such as tebufenpyrad+Tx, tolfenpyrad+Tx, ethiprole+Tx, pyriprole+Tx, fipronil+Tx, and fenpyroximate+Tx;

g) Macrolides, such as avermectins or milbemycins, for example abamectin+Tx, emamectin benzoate+Tx, ivermectin+Tx, milbemycin+Tx, spinosad+Tx, azadirachtin+Tx, milbemectin+Tx, lepimectin+Tx or spinetoram+Tx;

h) Hormones+Tx or pheromones+Tx;

i) Organochlorine compounds, such as endosulfan+Tx (in particular alpha-endosulfan+Tx), benzene hexachloride+Tx, DDT+Tx, chlordane+Tx or dieldrin+Tx;

j) Amidines, such as chlordimeform+Tx or amitraz+Tx;

k) Fumigant agents, such as chloropicrin+Tx, dichloropropane+Tx, methyl bromide+Tx or metam+Tx;

l) Neonicotinoid compounds, such as imidacloprid+Tx, thiacloprid+Tx, acetamiprid+Tx, nitenpyram+Tx, dinotefuran+Tx, thiamethoxam+Tx, clothianidin+Tx, or nithiazine+Tx;

m) Diacylhydrazines+Tx, such as tebufenozide+Tx, chromafenozide+Tx or methoxyfenozide+Tx;

n) Diphenyl ethers, such as diofenolan+Tx or pyriproxifen+Tx;

Pyrazolines such as Indoxacarbq) Pymetrozine+Tx or metaflumizone+Tx;

r) p) Ketoenols, such as Spirotetramat+Tx, spirodiclofen+Tx or spiromesifen+Tx;

sq) Diamides, such as flubendiamide+Tx, chlorantraniliprole+Tx (Rynaxypyr®) or cyantraniliprole+Tx;

y) r) Essential oils such as Bugoil®-(PlantImpact); or

s) a comopund selected from buprofezine+Tx, flonicamid+Tx, acequinocy+Tx 1, bifenazate+Tx, cyenopyrafen+Tx, cyflumetofen+Tx, etoxazole+Tx, flometoquin+Tx, fluacrypyrim+Tx, fluensulfone+Tx, flufenerim+Tx, flupyradifuone+Tx, harpin+Tx, iodomethane+Tx, dodecadienol+Tx, pyridaben+Tx, pyridalyl+Tx, pyrimidifen+Tx, flupyradifurone+Tx, 4-[(6-Chloro-pyridin-3-ylmethyl)-(2,2-difluoro-ethyl)-amino]-5H-furan-2-one (DE 102006015467), CAS: 915972-17-7+Tx (WO 2006129714; WO2011/147953; WO2011/147952), CAS: 26914-55-8 (WO 2007020986), chlorfenapyr+Tx, pymetrozine+Tx, sulfoxaflor+Tx and pyrifluqinazon+Tx.

In addition to the major chemical classes of pesticide listed above, other pesticides having particular targets may be employed in the composition, if appropriate for the intended utility of the composition. For instance, selective insecticides for particular crops, for example stemborer specific insecticide (combinations such as cartap+Tx) or hopper specific insecticides (combinations such as buprofezin+Tx) for use in rice may be employed. Alternatively insecticides or acaricides specific for particular insect species/stages may also be included in the compositions (for example acaricidal ovo-larvicides, to give combinations such as clofentezine+Tx, flubenzimine+Tx, hexythiazox+Tx or tetradifon+Tx; acaricidal motilicides, to give combinations such as dicofol+Tx or propargite+Tx; acaricides, to give combinations such as bromopropylate+Tx or chlorobenzilate+Tx; or growth regulators, such as hydramethylnon+Tx, cyromazine+Tx, methoprene+Tx, chlorfluazuron+Tx or diflubenzuron+Tx).

Examples of fungicidal compounds and combinations which may be included in the composition of the invention are (E)-N-methyl-2-[2-(2,5-dimethylphenoxymethyl)phenyl]-2-methoxy-iminoacetamide (SSF-129)+Tx, 4-bromo-2-cyano-N,N-dimethyl-6-trifluoromethyl-benzimidazole-1-sulfonamide+Tx, α-[N-(3-chloro-2,6-xylyl)-2-methoxyacetamido]-γ-butyrolactone+Tx, 4-chloro-2-cyano-N,N-dimethyl-5-p-tolylimidazole-1-sulfonamide (IKF-916, cyamidazosulfamid)+Tx, 3-5-dichloro-N-(3-chloro-1-ethyl-1-methyl-2-oxopropyl)-4-methylbenzamide (RH-7281, zoxamide)+Tx, N-allyl-4,5,-dimethyl-2-trimethylsilylthiophene-3-carboxamide (MON65500)+Tx, N-(1-cyano-1,2-dimethylpropyl)-2-(2,4-dichlorophenoxy)-propionamide (AC382042)+Tx, N-(2-methoxy-5-pyridyl)-cyclopropane carboxamide+Tx, acibenzolar (CGA245704) (e.g. acibenzolar-5-methyl)+Tx, alanycarb+Tx, aldimorph+Tx, anilazine+Tx, azaconazole+Tx, azoxystrobin+Tx, benalaxyl+Tx, benomyl+Tx, benthiavalicarb+Tx, biloxazol+Tx, bitertanol+Tx, bixafen+Tx, blasticidin S+Tx, boscalid+Tx, bromuconazole+Tx, bupirimate+Tx, captafol+Tx, captan+Tx, carbendazim+Tx, carbendazim+Tx, chlorhydrate+Tx, carboxin+Tx, carpropamid+Tx, carvone+Tx, CGA41396+Tx, CGA41397+Tx, chinomethionate+Tx, chlorothalonil+Tx, chlorozolinate+Tx, clozylacon+Tx, copper containing compounds to give combintations such as copper oxychloride+Tx, copper oxyquinolate+Tx, copper sulfate+Tx, copper tallate+Tx and Bordeaux mixture+Tx, cyclufenamid+Tx, cymoxanil+Tx, cyproconazole+Tx, cyprodinil+Tx, debacarb+Tx, di-2-pyridyl disulfide 1,1′-dioxide+Tx, dichlofluanid+Tx, diclomezine+Tx, dicloran+Tx, diethofencarb+Tx, difenoconazole+Tx, difenzoquat+Tx, diflumetorim+Tx, O,O-di-iso-propyl-5-benzyl thiophosphate+Tx, dimefluazole+Tx, dimetconazole+Tx, dimethomorph+Tx, dimethirimol+Tx, diniconazole+Tx, dinocap+Tx, dithianon+Tx, dodecyl dimethyl ammonium chloride+Tx, dodemorph+Tx, dodine+Tx, doguadine+Tx, edifenphos+Tx, epoxiconazole+Tx, ethirimo+Tx 1, ethyl-(Z)—N-benzyl-N-([methyl(methyl-thioethylideneaminooxycarbonyl)amino]thio)-β-alaninate+Tx, etridiazole+Tx, famoxadone+Tx, fenamidone (RPA407213)+Tx, fenarimol+Tx, fenbuconazole+Tx, fenfuram+Tx, fenhexamid (KBR2738)+Tx, fenpiclonil+Tx, fenpropidin+Tx, fenpropimorph+Tx, fentin acetate+Tx, fentin hydroxide+Tx, ferbam+Tx, ferimzone+Tx, fluazinam+Tx, fludioxonil+Tx, flumetover+Tx, fluopyram+Tx, fluoxastrobin+Tx, fluoroimide+Tx, fluquinconazole+Tx, flusilazole+Tx, flutolanil+Tx, flutriafol+Tx, fluxapyroxad+Tx, folpet+Tx, fuberidazole+Tx, furalaxyl+Tx, furametpyr+Tx, guazatine, +Tx hexaconazole+Tx, hydroxyisoxazole+Tx, hymexazole+Tx, imazalil+Tx, imibenconazole+Tx, iminoctadine+Tx, iminoctadine triacetate+Tx, ipconazole+Tx, iprobenfos+Tx, iprodione+Tx, iprovalicarb (SZX0722)+Tx, isopropanyl butyl carbamate+Tx, isoprothiolane+Tx, isopyrazam+Tx, kasugamycin+Tx, kresoxim-methyl+Tx, LY186054+Tx, LY211795+Tx, LY248908+Tx, mancozeb+Tx, mandipropamid+Tx, maneb+Tx, mefenoxam+Tx, metalaxyl+Tx, mepanipyrim+Tx, mepronil+Tx, metalaxyl+Tx, metconazole+Tx, metiram+Tx, metiram-zinc+Tx, metominostrobin+Tx, myclobutanil+Tx, neoasozin+Tx, nickel dimethyldithiocarbamate+Tx, nitrothal-isopropyl+Tx, nuarimol+Tx, ofurace+Tx, organomercury compounds, +Tx oxadixyl+Tx, oxasulfuron+Tx, oxolinic acid+Tx, oxpoconazole+Tx, oxycarboxin+Tx, pefurazoate+Tx, penconazole+Tx, pencycuron+Tx, penflufen+Tx, penthiopyrad+Tx, phenazin oxide+Tx, phosetyl-Al+Tx, phosphorus acids+Tx, phthalide+Tx, picoxystrobin (ZA1963)+Tx, polyoxinD+Tx, polyram+Tx, probenazole+Tx, prochloraz+Tx, procymidone+Tx, propamocarb+Tx, propiconazole+Tx, propineb+Tx, propionic acid+Tx, prothioconazole+Tx, pyrazophos+Tx, pyrifenox+Tx, pyrimethanil+Tx, pyraclostrobin+Tx, pyroquilon+Tx, pyroxyfur+Tx, pyrroInitrin+Tx, quaternary ammonium compounds+Tx, quinomethionate+Tx, quinoxyfen+Tx, quintozene+Tx, sedaxane+Tx, sipconazole (F-155)+Tx, sodium pentachlorophenate+Tx, spiroxamine+Tx, streptomycin+Tx, sulfur+Tx, tebuconazole+Tx, tecloftalam+Tx, tecnazene+Tx, tetraconazole+Tx, thiabendazole+Tx, thifluzamid+Tx, 2-(thiocyanomethylthio)benzothiazole+Tx, thiophanate-methyl+Tx, thiram+Tx, timibenconazole+Tx, tolclofos-methyl+Tx, tolylfluanid+Tx, triadimefon+Tx, triadimenol+Tx, triazbutil+Tx, triazoxide+Tx, tricyclazole+Tx, tridemorph+Tx, trifloxystrobin (CGA279202)+Tx, triforine+Tx, triflumizole+Tx, triticonazole+Tx, validamycin A+Tx, vapam+Tx, vinclozolin+Tx, zineb+Tx and ziram+Tx, N-[9-(dichloromethylene)-1,2,3,4-tetrahydro-1,4-methanonaphthalen-5-yl]-3-(difluoromethyl)-1-methyl-1H-pyrazole-4-carboxamide [1072957-71-1]+Tx, 1-methyl-3-difluoromethyl-1H-pyrazole-4-carboxylic acid (2-dichloromethylene-3-ethyl-1-methyl-indan-4-yl)-amide+Tx, and 1-methyl-3-difluoromethyl-4H-pyrazole-4-carboxylic acid [2-(2,4-dichloro-phenyl)-2-methoxy-1-methyl-ethyl]-amide+Tx.

The active ingredients combinations described above comprising a compound selected of the invention, in particulary from Tables 1P to 90P and 1Q to 36Q and an active ingredient as described above are preferably combined in a mixing ratio of from 100:1 to 1:6000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are understood to include, on the one hand, ratios by weight and also, on other hand, molar ratios.

In addition, biological agents may be included in the composition of the invention e.g. Baciullus species such as Bacillus firmus+Tx, Bacillus cereus+Tx, Bacillus subtilis+Tx, and Pasteuria species such as Pasteuria penetrans+Tx and Pasteuria nishizawae+Tx. A suitable Bacillus firmus strain is strain CNCM I-1582 which is commercially available as BioNem™. A suitable Bacillus cereus strain is strain CNCM 1-1562. Of both Bacillus strains more details can be found in U.S. Pat. No. 6,406,690. Other biological organisms that may be included in the compositions of the invention are bacteria such as Streptomyces spp. such as S. avermitilis, and fungi such as Pochonia spp. such as P. chlamydosporia+Tx. Also of interest are Metarhizium spp. such as M. anisopliae+Tx; Pochonia spp. such as P. chlamydosporia+Tx.

The compounds of formula (I) may be mixed with soil, peat or other rooting media for the protection of plants against seed-borne, soil-borne or foliar fungal diseases.

Examples of suitable synergists for use in the compositions include piperonyl butoxide, sesamex, safroxan and dodecyl imidazole.

Suitable herbicides and plant-growth regulators for inclusion in the compositions will depend upon the intended target and the effect required.

An example of a rice selective herbicide which may be included is propanil. An example of a plant growth regulator for use in cotton is PIX™.

Some mixtures may comprise active ingredients which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

The compounds of the invention are also useful in the field of animal health, e.g. they may be used against parasitic invertebrate pests, more preferably against parasitic invertebrate pests in or on an animal. Examples of pests include nematodes, trematodes, cestodes, flies, mites, tricks, lice, fleas, true bugs and maggots. The animal may be a non-human animal, e.g. an animal associated with agriculture, e.g. a cow, a pig, a sheep, a goat, a horse, or a donkey, or a companion animal, e.g. a dog or a cat.

In a further aspect the invention provides a compound of the invention for use in a method of therapeutic treatment.

In a further aspect the invention relates to a method of controlling parasitic invertebrate pests in or on an animal comprising administering a pesticidally effective amount of a compound of the invention. The administration may be for example oral administration, parenteral administration or external administration, e.g. to the surface of the animal body. In a further aspect the invention relates to a compound of the invention for controlling parasitic invertebrate pests in or on an animal. In a further aspect the invention relates to use of a compound of the invention in the manufacture of a medicament for controlling parasitic invertebrate pests in or on an animal

In a further aspect, the invention relates to a method of controlling parasitic invertebrate pests comprising administering a pesticidally effective amount of a compound of the invention to the environment in which an animal resides.

In a further aspect the invention relates to a method of protecting an animal from a parasitic invertebrate pest comprising administering to the animal a pesticidally effective amount of a compound of the invention. In a further aspect the invention relates to a compound of the invention for use in protecting an animal from a parasitic invertebrate pest. In a further aspect the invention relates to use of a compound of the invention in the manufacture of a medicament for protecting an animal from a parasitic invertebrate pest.

In a further aspect the invention provides a method of treating an animal suffering from a parasitic invertebrate pest comprising administering to the animal a pesticidally effective amount of a compound of the invention. In a further aspect the invention relates to a compound of the invention for use in treating an animal suffering from a parasitic invertebrate pest. In a further aspect the invention relates to use of a compound of the invention in the manufacture of a medicament for treating an animal suffering from a parasitic invertebrate pest.

In a further aspect, the invention provides a pharmaceutical composition comprising a compound of the invention and a pharmaceutically suitable excipient.

The compounds of the invention may be used alone or in combination with one or more other biologically active ingredients.

In one aspect the invention provides a combination product comprising a pesticidally effective amount of a component A and a pesticidally effective amount of component B wherein component A is a compound of the invention and component B is a compound as described below.

The compounds of the invention may be used in combination with anthelmintic agents. Such anthelmintic agents include, compounds selected from the macrocyclic lactone class of compounds such as ivermectin, avermectin, abamectin, emamectin, eprinomectin, doramectin, selamectin, moxidectin, nemadectin and milbemycin derivatives as described in EP-357460, EP-444964 and EP-594291. Additional anthelmintic agents include semisynthetic and biosynthetic avermectin/milbemycin derivatives such as those described in U.S. Pat. No. 5,015,630, WO-9415944 and WO-9522552. Additional anthelmintic agents include the benzimidazoles such as albendazole, cambendazole, fenbendazole, flubendazole, mebendazole, oxfendazole, oxibendazole, parbendazole, and other members of the class. Additional anthelmintic agents include imidazothiazoles and tetrahydropyrimidines such as tetramisole, levamisole, pyrantel pamoate, oxantel or morantel. Additional anthelmintic agents include flukicides, such as triclabendazole and clorsulon and the cestocides, such as praziquantel and epsiprantel.

The compounds of the invention may be used in combination with derivatives and analogues of the paraherquamide/marcfortine class of anthelmintic agents, as well as the antiparasitic oxazolines such as those disclosed in U.S. Pat. No. 5,478,855, U.S. Pat. No. 4,639,771 and DE-19520936.

The compounds of the invention may be used in combination with derivatives and analogues of the general class of dioxomorpholine antiparasitic agents as described in WO-9615121 and also with anthelmintic active cyclic depsipeptides such as those described in WO-9611945, WO-9319053, WO-9325543, EP-626375, EP-382173, WO-9419334, EP-382173, and EP-503538.

The compounds of the invention may be used in combination with other ectoparasiticides; for example, fipronil; pyrethroids; organophosphates; insect growth regulators such as lufenuron; ecdysone agonists such as tebufenozide and the like; neonicotinoids such as imidacloprid and the like.

The compounds of the invention may be used in combination with terpene alkaloids, for example those described in International Patent Application Publication Numbers WO95/19363 or WO04/72086, particularly the compounds disclosed therein.

Other examples of such biologically active compounds that the compounds of the invention may be used in combination with include but are not restricted to the following:

Organophosphates: acephate, azamethiphos, azinphos-ethyl, azinphos-methyl, bromophos, bromophos-ethyl, cadusafos, chlorethoxyphos, chlorpyrifos, chlorfenvinphos, chlormephos, demeton, demeton-S-methyl, demeton-S-methyl sulphone, dialifos, diazinon, dichlorvos, dicrotophos, dimethoate, disulfoton, ethion, ethoprophos, etrimfos, famphur, fenamiphos, fenitrothion, fensulfothion, fenthion, flupyrazofos, fonofos, formothion, fosthiazate, heptenophos, isazophos, isothioate, isoxathion, malathion, methacriphos, methamidophos, methidathion, methyl-parathion, mevinphos, monocrotophos, naled, omethoate, oxydemeton-methyl, paraoxon, parathion, parathion-methyl, phenthoate, phosalone, phosfolan, phosphocarb, phosmet, phosphamidon, phorate, phoxim, pirimiphos, pirimiphos-methyl, profenofos, propaphos, proetamphos, prothiofos, pyraclofos, pyridapenthion, quinalphos, sulprophos, temephos, terbufos, tebupirimfos, tetrachlorvinphos, thimeton, triazophos, trichlorfon, vamidothion.

Carbamates: alanycarb, aldicarb, 2-sec-butylphenyl methylcarbamate, benfuracarb, carbaryl, carbofuran, carbosulfan, cloethocarb, ethiofencarb, fenoxycarb, fenthiocarb, furathiocarb, HCN-801, isoprocarb, indoxacarb, methiocarb, methomyl, 5-methyl-m-cumenylbutyryl(methyl)carbamate, oxamyl, pirimicarb, propoxur, thiodicarb, thiofanox, triazamate, UC-51717.

Pyrethroids: acrinathin, allethrin, alphametrin, 5-benzyl-3-furylmethyl(E)-(1R)-cis-2,2-dimethyl-3-(2-oxothiolan-3-ylidenemethyl)cyclopropanecarboxylate, bifenthrin, beta-cyfluthrin, cyfluthrin, a-cypermethrin, beta-cypermethrin, bioallethrin, bioallethrin((S)-cyclopentylisomer), bioresmethrin, bifenthrin, NCI-85193, cycloprothrin, cyhalothrin, cythithrin, cyphenothrin, deltamethrin, empenthrin, esfenvalerate, ethofenprox, fenfluthrin, fenpropathrin, fenvalerate, flucythrinate, flumethrin, fluvalinate (D isomer), imiprothrin, cyhalothrin, lambda-cyhalothrin, permethrin, phenothrin, prallethrin, pyrethrins (natural products), resmethrin, tetramethrin, transfluthrin, theta-cypermethrin, silafluofen, t-fluvalinate, tefluthrin, tralomethrin, Zeta-cypermethrin.

Arthropod growth regulators: a) chitin synthesis inhibitors: benzoylureas: chlorfluazuron, diflubenzuron, fluazuron, flucycloxuron, flufenoxuron, hexaflumuron, lufenuron, novaluron, teflubenzuron, triflumuron, buprofezin, diofenolan, hexythiazox, etoxazole, chlorfentazine; b) ecdysone antagonists: halofenozide, methoxyfenozide, tebufenozide; c) juvenoids: pyriproxyfen, methoprene (including S-methoprene), fenoxycarb; d) lipid biosynthesis inhibitors: spirodiclofen.

Other antiparasitics: acequinocyl, amitraz, AKD-1022, ANS-118, azadirachtin, Bacillus thuringiensis, bensultap, bifenazate, binapacryl, bromopropylate, BTG-504, BTG-505, camphechlor, cartap, chlorobenzilate, chlordimeform, chlorfenapyr, chromafenozide, clothianidine, cyromazine, diacloden, diafenthiuron, DBI-3204, dinactin, dihydroxymethyldihydroxypyrrolidine, dinobuton, dinocap, endosulfan, ethiprole, ethofenprox, fenazaquin, flumite, MTI-800, fenpyroximate, fluacrypyrim, flubenzimine, flubrocythrinate, flufenzine, flufenprox, fluproxyfen, halofenprox, hydramethylnon, IKI-220, kanemite, NC-196, neem guard, nidinorterfuran, nitenpyram, SD-35651, WL-108477, pirydaryl, propargite, protrifenbute, pymethrozine, pyridaben, Buprofezine pyrimidifen, NC-1111, R-195,RH-0345, RH-2485, RYI-210, S-1283, S-1833, SI-8601, silafluofen, silomadine, spinosad, tebufenpyrad, tetradifon, tetranactin, thiacloprid, thiocyclam, thiamethoxam, tolfenpyrad, triazamate, triethoxyspinosyn, trinactin, verbutin, vertalec, YI-5301.

Fungicides: acibenzolar, aldimorph, ampropylfos, andoprim, azaconazole, azoxystrobin, benalaxyl, benomyl, bialaphos, blasticidin-S, Bordeaux mixture, bromuconazole, bupirimate, carpropamid, captafol, captan, carbendazim, chlorfenazole, chloroneb, chloropicrin, chlorothalonil, chlozolinate, copper oxychloride, copper salts, cyflufenamid, cymoxanil, cyproconazole, cyprodinil, cyprofuram, RH-7281, diclocymet, diclobutrazole, diclomezine, dicloran, difenoconazole, RP-407213, dimethomorph, domoxystrobin, diniconazole, diniconazole-M, dodine, edifenphos, epoxiconazole, famoxadone, fenamidone, fenarimol, fenbuconazole, fencaramid, fenpiclonil, fenpropidin, fenpropimorph, fentin acetate, fluazinam, fludioxonil, flumetover, flumorf/flumorlin, fentin hydroxide, fluoxastrobin, fluquinconazole, flusilazole, flutolanil, flutriafol, folpet, fosetyl-aluminium, furalaxyl, furametapyr, hexaconazole, ipconazole, iprobenfos, iprodione, isoprothiolane, kasugamycin, krsoxim-methyl, mancozeb, maneb, mefenoxam, mepronil, metalaxyl, metconazole, metominostrobin/fenominostrobin, metrafenone, myclobutanil, neo-asozin, nicobifen, orysastrobin, oxadixyl, penconazole, pencycuron, probenazole, prochloraz, propamocarb, propioconazole, proquinazid, prothioconazole, pyrifenox, pyraclostrobin, pyrimethanil, pyroquilon, quinoxyfen, spiroxamine, sulfur, tebuconazole, tetrconazole, thiabendazole, thifluzamide, thiophanate-methyl, thiram, tiadinil, triadimefon, triadimenol, tricyclazole, trifloxystrobin, triticonazole, validamycin, vinclozin.

Biological agents: Bacillus thuringiensis ssp aizawai, kurstaki, Bacillus thuringiensis delta endotoxin, baculovirus, entomopathogenic bacteria, virus and fungi.

Bactericides: chlortetracycline, oxytetracycline, streptomycin.

Other biological agents: enrofloxacin, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, carprofen, metaflumizone, praziquarantel, triclabendazole.

When used in combination with other active ingredients, the compounds of the invention are preferably used in combination with the following (where “Tx” means a compound of formula (I), and in particular a compound selected from Tables 1P to 90P and 1Q to 36Q, which may result in a synergistic combination with the given active ingredient): imidacloprid+Tx, enrofloxacin+Tx, praziquantel+Tx, pyrantel embonate+Tx, febantel+Tx, penethamate+Tx, moloxicam+Tx, cefalexin+Tx, kanamycin+Tx, pimobendan+Tx, clenbuterol+Tx, fipronil+Tx, ivermectin+Tx, omeprazole+Tx, tiamulin+Tx, benazepril+Tx, milbemycin+Tx, cyromazine+Tx, thiamethoxam+Tx, pyriprole+Tx, deltamethrin+Tx, cefquinome+Tx, florfenicol+Tx, buserelin+Tx, cefovecin+Tx, tulathromycin+Tx, ceftiour+Tx, selamectin+Tx, carprofen+Tx, metaflumizone+Tx, moxidectin+Tx, methoprene (including S-methoprene)+Tx, clorsulon+Tx, pyrantel+Tx, amitraz+Tx, triclabendazole+Tx, avermectin+Tx, abamectin+Tx, emamectin+Tx, eprinomectin+Tx, doramectin+Tx, selamectin+Tx, nemadectin+Tx, albendazole+Tx, cambendazole+Tx, fenbendazole+Tx, flubendazole+Tx, mebendazole+Tx, oxfendazole+Tx, oxibendazole+Tx, parbendazole+Tx, tetramisole+Tx, levamisole+Tx, pyrantel pamoate+Tx, oxantel+Tx, morantel+Tx, triclabendazole+Tx, epsiprantel+Tx, fipronil+Tx, lufenuron+Tx, ecdysone+Tx or tebufenozide+Tx; more preferably, enrofloxacin+Tx, praziquantel+Tx, pyrantel embonate+Tx, febantel+Tx, penethamate+Tx, moloxicam+Tx, cefalexin+Tx, kanamycin+Tx, pimobendan+Tx, clenbuterol+Tx, omeprazole+Tx, tiamulin+Tx, benazepril+Tx, pyriprole+Tx, cefquinome+Tx, florfenicol+Tx, buserelin+Tx, cefovecin+Tx, tulathromycin+Tx, ceftiour+Tx, selamectin+Tx, carprofen+Tx, moxidectin+Tx, clorsulon+Tx, pyrantel+Tx, eprinomectin+Tx, doramectin+Tx, selamectin+Tx, nemadectin+Tx, albendazole+Tx, cambendazole+Tx, fenbendazole+Tx, flubendazole+Tx, mebendazole+Tx, oxfendazole+Tx, oxibendazole+Tx, parbendazole+Tx, tetramisole+Tx, levamisole+Tx, pyrantel pamoate+Tx, oxantel+Tx, morantel+Tx, triclabendazole+Tx, epsiprantel+Tx, lufenuron+Tx or ecdysone+Tx; even more preferably enrofloxacin+Tx, praziquantel+Tx, pyrantel embonate+Tx, febantel+Tx, penethamate+Tx, moloxicam+Tx, cefalexin+Tx, kanamycin+Tx, pimobendan+Tx, clenbuterol+Tx, omeprazole+Tx, tiamulin+Tx, benazepril+Tx, pyriprole+Tx, cefquinome+Tx, florfenicol+Tx, buserelin+Tx, cefovecin+Tx, tulathromycin+Tx, ceftiour+Tx, selamectin+Tx, carprofen+Tx, moxidectin+Tx, clorsulon+Tx or pyrantel+Tx.

Examples of ratios of compounds of formula Ito mixing partner include 100:1 to 1:6000, 50:1 to 1:50, 20:1 to 1:20, even more especially from 10:1 to 1:10, 5:1 to 1:5, 2:1 to 1:2, 4:1 to 2:1, 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are understood to include, on the one hand, ratios by weight and also, on other hand, molar ratios.

Of particular note is a combination where the additional active ingredient has a different site of action from the compound of formula I. In certain instances, a combination with at least one other parasitic invertebrate pest control active ingredient having a similar spectrum of control but a different site of action will be particularly advantageous for resistance management. Thus, a combination product of the invention may comprise a pesticidally effective amount of a compound of formula I and pesticidally effective amount of at least one additional parasitic invertebrate pest control active ingredient having a similar spectrum of control but a different site of action.

One skilled in the art recognizes that because in the environment and under physiological conditions salts of chemical compounds are in equilibrium with their corresponding non salt forms, salts share the biological utility of the non salt forms.

Thus a wide variety of salts of compounds of the invention (and active ingredients used in combination with the active ingredients of the invention) may be useful for control of invertebrate pests and animal parasites. Salts include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

The compounds of the invention also include N-oxides. Accordingly, the invention comprises combinations of compounds of the invention including N-oxides and salts thereof and an additional active ingredient including N-oxides and salts thereof.

The compositions for use in animal health may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The compounds of the invention can be applied without other adjuvants, but most often application will be of a formulation comprising one or more active ingredients with suitable carriers, diluents, and surfactants and possibly in combination with a food depending on the contemplated end use. One method of application involves spraying a water dispersion or refined oil solution of the combination products. Compositions with spray oils, spray oil concentrations, spreader stickers, adjuvants, other solvents, and synergists such as piperonyl butoxide often enhance compound efficacy. Such sprays can be applied from spray containers such as a can, a bottle or other container, either by means of a pump or by releasing it from a pressurized container, e.g., a pressurized aerosol spray can. Such spray compositions can take various forms, for example, sprays, mists, foams, fumes or fog. Such spray compositions thus can further comprise propellants, foaming agents, etc. as the case may be. Of note is a spray composition comprising a pesticidally effective amount of a compound of the invention and a carrier. One embodiment of such a spray composition comprises a pesticidally effective amount of a compound of the invention and a propellant. Representative propellants include, but are not limited to, methane, ethane, propane, butane, isobutane, butene, pentane, isopentane, neopentane, pentene, hydrofluorocarbons, chlorofluorocarbons, dimethyl ether, and mixtures of the foregoing. Of note is a spray composition (and a method utilizing such a spray composition dispensed from a spray container) used to control at least one parasitic invertebrate pest selected from the group consisting of mosquitoes, black flies, stable flies, deer flies, horse flies, wasps, yellow jackets, hornets, ticks, spiders, ants, gnats, and the like, including individually or in combinations.

The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. The compounds of the invention may be particularly suitable for combating external parasitic pests. The compounds of the invention may be suitable for systemic and/or non-systemic control of infestation or infection by parasites on animals.

The compounds of the invention may be suitable for combating parasitic invertebrate pests that infest animal subjects including those in the wild, livestock and agricultural working animals. Livestock is the term used to refer (singularly or plurally) to a domesticated animal intentionally reared in an agricultural setting to make produce such as food or fiber, or for its labor; examples of livestock include cattle, sheep, goats, horses, pigs, donkeys, camels, buffalo, rabbits, hens, turkeys, ducks and geese (e.g., raised for meat, milk, butter, eggs, fur, leather, feathers and/or wool), cultured fish, honeybees. By combating parasites, fatalities and performance reduction (in terms of meat, milk, wool, skins, eggs, etc.) are reduced, so that applying the compounds of the invention allows more economic and simple husbandry of animals.

By controlling these pests it is intended to reduce deaths and improve performance (in the case of meat, milk, wool, hides, eggs, honey and the like) and health of the host animal. Also, controlling parasites may help to prevent the transmittance of infectious agents, the term “controlling” referring to the veterinary field, meaning that the active compounds are effective in reducing the incidence of the respective parasite in an animal infected with such parasites to innocuous levels, e.g. the active compound is effective in killing the respective parasite, inhibiting its growth, or inhibiting its proliferation.

The compounds of the invention may be suitable for combating parasitic invertebrate pests that infest companion animals and pets (e.g., dogs, cats, pet birds and aquarium fish), research and experimental animals (e.g., hamsters, guinea pigs, rats and mice), as well as animals raised for/in zoos, wild habitats and/or circuses.

In an embodiment of this invention, the animal is preferably a vertebrate, and more preferably a mammal, avian or fish. In a particular embodiment, the animal subject is a mammal (including great apes, such as humans). Other mammalian subjects include primates (e.g., monkeys), bovine (e.g., cattle or dairy cows), porcine (e.g., hogs or pigs), ovine (e.g., goats or sheep), equine (e.g., horses), canine (e.g., dogs), feline (e.g., house cats), camels, deer, donkeys, buffalos, antelopes, rabbits, and rodents (e.g., guinea pigs, squirrels, rats, mice, gerbils, and hamsters). Avians include Anatidae (swans, ducks and geese), Columbidae (e.g., doves and pigeons), Phasianidae (e.g., partridges, grouse and turkeys), Thesienidae (e.g., domestic chickens), Psittacines (e.g., parakeets, macaws, and parrots), game birds, and ratites (e.g., ostriches).

Birds treated or protected by the compounds of the invention can be associated with either commercial or noncommercial aviculture. These include Anatidae, such as swans, geese, and ducks, Columbidae, such as doves and domestic pigeons, Phasianidae, such as partridge, grouse and turkeys, Thesienidae, such as domestic chickens, and Psittacines, such as parakeets, macaws and parrots raised for the pet or collector market, among others.

For purposes of the present invention, the term “fish” is understood to include without limitation, the Teleosti grouping of fish, i.e., teleosts. Both the Salmoniformes order (which includes the Salmonidae family) and the Perciformes order (which includes the Centrarchidae family) are contained within the Teleosti grouping. Examples of potential fish recipients include the Salmonidae, Serranidae, Sparidae, Cichlidae, and Centrarchidae, among others.

Other animals are also contemplated to benefit from the inventive methods, including marsupials (such as kangaroos), reptiles (such as farmed turtles), and other economically important domestic animals for which the inventive methods are safe and effective in treating or preventing parasite infection or infestation.

Examples of parasitic invertebrate pests controlled by administering a pesticidally effective amount of the compounds of the invention to an animal to be protected include ectoparasites (arthropods, acarines, etc.) and endoparasites (helminths, e.g., nematodes, trematodes, cestodes, acanthocephalans, etc. and protozoae, such as coccidia).

The disease or group of diseases described generally as helminthiasis is due to infection of an animal host with parasitic worms known as helminths. The term ‘helminths’ is meant to include nematodes, trematodes, cestodes and acanthocephalans. Helminthiasis is a prevalent and serious economic problem with domesticated animals such as swine, sheep, horses, cattle, goats, dogs, cats and poultry.

Among the helminths, the group of worms described as nematodes causes widespread and at times serious infection in various species of animals.

Nematodes that are contemplated to be treated by the compounds of the invention include, without limitation, the following genera: Acanthocheilonema, Aelurostrongylus, Ancylostoma, Angiostrongylus, Ascaridia, Ascaris, Brugia, Bunostomum, Capillaria, Chabertia, Cooperia, Crenosoma, Dictyocaulus, Dioctophyme, Dipetalonema, Diphyllobothrium, Dirofilaria, Dracunculus, Enterobius, Filaroides, Haemonchus, Heterakis, Lagochilascaris, Loa, Mansonella, Muellerius, Necator, Nematodirus, Oesophagostomum, Ostertagia, Oxyuris, Parafilaria, Parascaris, Physaloptera, Protostrongylus, Setaria, Spirocerca, Stephanofilaria, Strongyloides, Strongylus, Thelazia, Toxascaris, Toxocara, Trichinella, Trichonema, Trichostrongylus, Trichuris, Uncinaria and Wuchereria.

Of the above, the most common genera of nematodes infecting the animals referred to above are Haemonchus, Trichostrongylus, Ostertagia, Nematodirus, Cooperia, Ascaris, Bunostomum, Oesophagostomum, Chabertia, Trichuris, Strongylus, Trichonema, Dictyocaulus, Capillaria, Heterakis, Toxocara, Ascaridia, Oxyuris, Ancylostoma, Uncinaria, Toxascaris and Parascaris. Certain of these, such as Nematodirus, Cooperia and Oesophagostomum attack primarily the intestinal tract while others, such as Haemonchus and Ostertagia, are more prevalent in the stomach while others such as Dictyocaulus are found in the lungs. Still other parasites may be located in other tissues such as the heart and blood vessels, subcutaneous and lymphatic tissue and the like.

Trematodes that are contemplated to be treated by the invention and by the inventive methods include, without limitation, the following genera: Alaria, Fasciola, Nanophyetus, Opisthorchis, Paragonimus and Schistosoma.

Cestodes that are contemplated to be treated by the invention and by the inventive methods include, without limitation, the following genera: Diphyllobothrium, Diplydium, Spirometra and Taenia.

The most common genera of parasites of the gastrointestinal tract of humans are

Ancylostoma, Necator, Ascaris, Strongy hides, Trichinella, Capillaria, Trichuris and Enterobius. Other medically important genera of parasites which are found in the blood or other tissues and organs outside the gastrointestinal tract are the filarial worms such as Wuchereria, Brugia, Onchocerca and Loa, as well as Dracunculus and extra intestinal stages of the intestinal worms Strongyloides and Trichinella.

Numerous other helminth genera and species are known to the art, and are also contemplated to be treated by the compounds of the invention. These are enumerated in great detail in Textbook of Veterinary Clinical Parasitology, Volume 1, Helminths, E. J. L. Soulsby, F. A. Davis Co., Philadelphia, Pa.; Helminths, Arthropods and Protozoa, (6^{th} Edition of Monnig's Veterinary Helminthology and Entomology), E. J. L. Soulsby, Williams and Wilkins Co., Baltimore, Md.

The compounds of the invention may be effective against a number of animal ectoparasites (e.g., arthropod ectoparasites of mammals and birds in particular insects such as flies (stinging and licking), parasitic fly larvae, lice, hair lice, bird lice, fleas and the like; or acarids, such as ticks, for examples hard ticks or soft ticks, or mites, such as scab mites, harvest mites, bird mites and the like).

Insect and acarine pests include, e.g., biting insects such as flies and mosquitoes, mites, ticks, lice, fleas, true bugs, parasitic maggots, and the like.

Adult flies include, e.g., the horn fly or Haematobia irritans, the horse fly or Tabanus spp., the stable fly or Stomoxys calcitrans, the black fly or Simulium spp., the deer fly or Chrysops spp., the louse fly or Melophagus ovinus, and the tsetse fly or Glossina spp. Parasitic fly maggots include, e.g., the bot fly (Oestrus ovis and Cuterebra spp.), the blow fly or Phaenicia spp., the screwworm or Cochliomyia hominivorax, the cattle grub or Hypoderma spp., the fleeceworm and the Gastrophilus of horses. Mosquitoes include, for example, Culex spp., Anopheles spp. and Aedes spp.

Mites include Mesostigmalphatalpha spp. e.g., mesostigmatids such as the chicken mite, Dermalphanyssus galphallinalphae; itch or scab mites such as Sarcoptidae spp. for example, Salpharcoptes scalphabiei; mange mites such as Psoroptidae spp. including Chorioptes bovis and Psoroptes ovis; chiggers e.g., Trombiculidae spp. for example the North American chigger, Trombiculalpha alphalfreddugesi.

Ticks include, e.g., soft-bodied ticks including Argasidae spp. for example Argalphas spp. and Ornithodoros spp.; hard-bodied ticks including Ixodidae spp., for example Rhipicephalphalus sanguineus, Dermacentor variabilis, Dermacentor andersoni, Amblyomma americanum, Ixodes scapularis and other Rhipicephalus spp. (including the former Boophilus genera).

Lice include, e.g., sucking lice, e.g., Menopon spp.

and Bovicola spp.; biting lice, e.g., Haematopinus spp., Linognathus spp. and Solenopotes spp.

Fleas include, e.g., Ctenocephalides spp., such as dog flea (Ctenocephalides canis) and cat flea (Ctenocephalides felis); Xenopsylla spp. such as oriental rat flea (Xenopsylla cheopis); and Pulex spp. such as human flea (Pulex irritans).

True bugs include, e.g., Cimicidae or e.g., the common bed bug (Cimex lectularius); Triatominae spp. including triatomid bugs also known as kissing bugs; for example Rhodnius prolixus and Triatoma spp.

Generally, flies, fleas, lice, mosquitoes, gnats, mites, ticks and helminths cause tremendous losses to the livestock and companion animal sectors. Arthropod parasites also are a nuisance to humans and can vector disease-causing organisms in humans and animals.

Numerous other parasitic invertebrate pests are known to the art, and are also contemplated to be treated by the compounds of the invention. These are enumerated in great detail in Medical and Veterinary Entomology, D. S. Kettle, John Wiley AND Sons, New York and Toronto; Control of Arthropod Pests of Livestock: A Review of Technology, R. O. Drummand, J. E. George, and S. E. Kunz, CRC Press, Boca Raton, FIa.

The compounds of the invention may also be effective against ectoparasites, e.g. insects such as flies (stinging and licking), parasitic fly larvae, lice, hair lice, bird lice, fleas and the like; or acarids, such as ticks, for examples hard ticks or soft ticks, or mites, such as scab mites, harvest mites, bird mites and the like. These include e.g. flies such as Haematobia (Lyperosia) irritans (horn fly), Simulium spp. (blackfly), Glossina spp. (tsetse flies), Hydrotaea irritans (head fly), Musca autumnalis (face fly), Musca domestica (house fly), Morellia simplex (sweat fly), Tabanus spp. (horse fly), Hypoderma bovis, Hypoderma lineatum, Lucilia sericata, Lucilia cuprina (green blowfly), Calliphora spp. (blowfly), Protophormia spp., Oestrus ovis (nasal botfly), Culicoides spp. (midges), Hippobosca equine, Gastrophilus intestinalis, Gastrophilus haemorrhoidalis and Gastrophilus nasalis; lice such as Bovicola (Damalinia) bovis, Bovicola equi, Haematopinus asini, Felicola subrostratus, Heterodoxus spiniger, Lignonathus setosus and Trichodectes canis; keds such as Melophagus ovinus; and mites such as Psoroptes spp., Sarcoptes scabei, Chorioptes bovis, Demodex equi, Cheyletiella spp., Notoedres cati, Trombicula spp. and Otodectes cyanotis (ear mites).

Examples of species of animal health pesets include those from the order of the Anoplurida, for example Haematopinus spp., Linognathus spp., Pediculus spp., Phtirus spp., Solenopotes spp.; particular examples are: Linognathus setosus, Linognathus vituli, Linognathus ovillus, Linognathus oviformis, Linognathus pedalis, Linognathus stenopsis, Haematopinus asini macrocephalus, Haematopinus eurysternus, Haematopinus suis, Pediculus humanus capitis, Pediculus humanus corporis, Phylloera vastatrix, Phthirus pubis, Solenopotes capillatus; from the order of the Mallophagida and the suborders Amblycerina and Ischnocerina, for example Trimenopon spp., Menopon spp., Trinoton spp., Bovicola spp., Werneckiella spp., Lepikentron spp., Damalina spp., Trichodectes spp., Felicola spp.; particular examples are: Bovicola bovis, Bovicola ovis, Bovicola limbata, Damalina bovis, Trichodectes canis, Felicola subrostratus, Bovicola caprae, Lepikentron ovis, Werneckiella equi; from the order of the Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Odagmia spp., Wilhelmia spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp., Rhinoestrus spp., Tipula spp.; particular examples are: Aedes aegypti, Aedes albopictus, Aedes taeniorhynchus, Anopheles gambiae, Anopheles maculipennis, Calliphora erythrocephala, Chrysozona pluvialis, Culex quinquefasciatus, Culex pipiens, Culex tarsalis, Fannia canicularis, Sarcophaga carnaria, Stomoxys calcitrans, Tipula paludosa, Lucilia cuprina, Lucilia sericata, Simulium reptans, Phlebotomus papatasi, Phlebotomus longipalpis, Odagmia ornata, Wilhelmia equina, Boophthora erythrocephala, Tabanus bromius, Tabanus spodopterus, Tabanus atratus, Tabanus sudeticus, Hybomitra ciurea, Chrysops caecutiens, Chrysops relictus, Haematopota pluvialis, Haematopota italica, Musca autumnalis, Musca domestica, Haematobia irritans irritans, Haematobia irritans exigua, Haematobia stimulans, Hydrotaea irritans, Hydrotaea albipuncta, Chrysomya chloropyga, Chrysomya bezziana, Oestrus ovis, Hypoderma bovis, Hypoderma lineatum, Przhevalskiana silenus, Dermatobia hominis, Melophagus ovinus, Lipoptena capreoli, Lipoptena cervi, Hippobosca variegata, Hippobosca equina, Gasterophilus intestinalis, Gasterophilus haemorroidalis, Gasterophilus inermis, Gasterophilus nasalis, Gasterophilus nigricornis, Gasterophilus pecorum, Braula coeca; from the order of the Siphonapterida, for example Pulex spp., Ctenocephalides spp., Tunga spp., Xenopsylla spp., Ceratophyllus spp.; particular examples are: Ctenocephalides canis, Ctenocephalides felis, Pulex irritans, Tunga penetrans, Xenopsylla cheopis; from the order of the Heteropterida, for example Cimex spp., Triatoma spp., Rhodnius spp., Panstrongylus spp; from the order of the Blattarida, for example Blatta orientalis, Periplaneta americana, Blattela germanica, Supella spp. (e.g. Suppella longipalpa); from the subclass of the Acari (Acarina) and the orders of the Meta- and Mesostigmata, for example Argas spp., Ornithodorus spp., Otobius spp., Ixodes spp., Amblyomma spp., Rhipicephalus (Boophilus) spp Dermacentor spp., Haemophysalis spp., Hyalomma spp., Dermanyssus spp., Rhipicephalus spp. (the original genus of multi host ticks) Ornithonyssus spp., Pneumonyssus spp., Raillietia spp., Pneumonyssus spp., Sternostoma spp., Varroa spp., Acarapis spp.; particular examples are: Argas persicus, Argas reflexus, Ornithodorus moubata, Otobius megnini, Rhipicephalus (Boophilus) microplus, Rhipicephalus (Boophilus) decoloratus, Rhipicephalus (Boophilus) annulatus, Rhipicephalus (Boophilus) calceratus, Hyalomma anatolicum, Hyalomma aegypticum, Hyalomma marginatum, Hyalomma transiens, Rhipicephalus evertsi, Ixodes ricinus, Ixodes hexagonus, Ixodes canisuga, Ixodes pilosus, Ixodes rubicundus, Ixodes scapularis, Ixodes holocyclus, Haemaphysalis concinna, Haemaphysalis punctata, Haemaphysalis cinnabarina, Haemaphysalis otophila, Haemaphysalis leachi, Haemaphysalis longicorni, Dermacentor marginatus, Dermacentor reticulatus, Dermacentor pictus, Dermacentor albipictus, Dermacentor andersoni, Dermacentor variabilis, Hyalomma mauritanicum, Rhipicephalus sanguineus, Rhipicephalus bursa, Rhipicephalus appendiculatus, Rhipicephalus capensis, Rhipicephalus turanicus, Rhipicephalus zambeziensis, Amblyomma americanum, Amblyomma variegatum, Amblyomma maculatum, Amblyomma hebraeum, Amblyomma cajennense, Dermanyssus gallinae, Ornithonyssus bursa, Ornithonyssus sylviarum, Varroa jacobsoni; from the order of the Actinedida (Prostigmata) and Acaridida (Astigmata), for example Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.; particular examples are: Cheyletiella yasguri, Cheyletiella blakei, Demodex canis, Demodex bovis, Demodex ovis, Demodex caprae, Demodex equi, Demodex caballi, Demodex suis, Neotrombicula autumnalis, Neotrombicula desaleri, Neoschongastia xerothermobia, Trombicula akamushi, Otodectes cynotis, Notoedres cati, Sarcoptis canis, Sarcoptes bovis, Sarcoptes ovis, Sarcoptes rupicaprae (S. caprae), Sarcoptes equi, Sarcoptes suis, Psoroptes ovis, Psoroptes cuniculi, Psoroptes equi, Chorioptes bovis, Psoergates ovis, Pneumonyssoidic mange, Pneumonyssoides caninum, Acarapis woodi; Gasterophilus spp., Stomoxys spp., Trichodectes spp., Rhodnius spp., Ctenocephalides canis, Cimx lecturius, Ctenocephalides felis, Lucilia cuprina; examples of acari include Ornithodoros spp., Ixodes spp., Boophilus spp.

Treatments of the invention are by conventional means such as by enteral administration in the form of, for example, tablets, capsules, drinks, drenching preparations, granulates, pastes, boli, feed-through procedures, or suppositories; or by parenteral administration, such as, for example, by injection (including intramuscular, subcutaneous, intravenous, intraperitoneal) or implants; or by nasal administration; or by dermal application in the form of, for example, bathing or dipping, spraying, pouring-on and spotting-on, washing, dusting, and with the aid of active-compound-comprising shaped articles such as collars, ear tags, tail tags, limb bands, halters, marking devices and the like.

When compounds of the invention are applied in combination with an additional biologically active ingredient, they may be administered separately e.g. as separate compositions. In this case, the biologically active ingredients may be administered simultaneously or sequentially. Alternatively, the biologically active ingredients may be components of one composition.

The compounds of the invention may be administered in a controlled release form, for example in subcutaneous or orally adminstered slow release formulations.

Typically a parasiticidal composition according to the present invention comprises a compound of the invention, optionally in combination with an additional biologically active ingredient, or N-oxides or salts thereof, with one or more pharmaceutically or veterinarily acceptable carriers comprising excipients and auxiliaries selected with regard to the intended route of administration (e.g., oral or parenteral administration such as injection) and in accordance with standard practice. In addition, a suitable carrier is selected on the basis of compatibility with the one or more active ingredients in the composition, including such considerations as stability relative to pH and moisture content. Therefore of note are compounds of the invention for protecting an animal from an invertebrate parasitic pest comprising a parasitically effective amount of a compound of the invention, optionally in combination with an additional biologically active ingredient and at least one carrier.

For parenteral administration including intravenous, intramuscular and subcutaneous injection, the compounds of the invention can be formulated in suspension, solution or emulsion in oily or aqueous vehicles, and may contain adjuncts such as suspending, stabilizing and/or dispersing agents.

The compounds of the invention may also be formulated for bolus injection or continuous infusion. Pharmaceutical compositions for injection include aqueous solutions of water-soluble forms of active ingredients (e.g., a salt of an active compound), preferably in physiologically compatible buffers containing other excipients or auxiliaries as are known in the art of pharmaceutical formulation. Additionally, suspensions of the active compounds may be prepared in a lipophilic vehicle. Suitable lipophilic vehicles include fatty oils such as sesame oil, synthetic fatty acid esters such as ethyl oleate and triglycerides, or materials such as liposomes.

Aqueous injection suspensions may contain substances that increase the viscosity of the suspension, such as sodium carboxymethyl cellulose, sorbitol, or dextran. Formulations for injection may be presented in unit dosage form, e.g., in ampoules or in multi-dose containers. Alternatively, the active ingredient may be in powder form for constitution with a suitable vehicle, e.g., sterile, pyrogen-free water, before use.

In addition to the formulations described supra, the compounds of the invention may also be formulated as a depot preparation. Such long acting formulations may be administered by implantation (for example, subcutaneously or intramuscularly) or by intramuscular or subcutaneous injection.

The compounds of the invention may be formulated for this route of administration with suitable polymeric or hydrophobic materials (for instance, in an emulsion with a pharmacologically acceptable oil), with ion exchange resins, or as a sparingly soluble derivative such as, without limitation, a sparingly soluble salt.

For administration by inhalation, the compounds of the invention can be delivered in the form of an aerosol spray using a pressurized pack or a nebulizer and a suitable propellant, e.g., without limitation, dichlorodifluoromethane, trichlorofluoromethane, dichlorotetrafluoroethane or carbon dioxide. In the case of a pressurized aerosol, the dosage unit may be controlled by providing a valve to deliver a metered amount. Capsules and cartridges of, for example, gelatin for use in an inhaler or insufflator may be formulated containing a powder mix of the compound and a suitable powder base such as lactose or starch.

The compounds of the invention may have favourable pharmacokinetic and pharmacodynamic properties providing systemic availability from oral administration and ingestion. Therefore after ingestion by the animal to be protected, parasiticidally effective concentrations of a compound of the invention in the bloodstream may protect the treated animal from blood-sucking pests such as fleas, ticks and lice. Therefore of note is a composition for protecting an animal from an invertebrate parasite pest in a form for oral administration (i.e. comprising, in addition to a parasiticidally effective amount of a compound of the invention, one or more carriers selected from binders and fillers suitable for oral administration and feed concentrate carriers).

For oral administration in the form of solutions (the most readily available form for absorption), emulsions, suspensions, pastes, gels, capsules, tablets, boluses, powders, granules, rumen-retention and feed/water/lick blocks, the compounds of the invention can be formulated with binders/fillers known in the art to be suitable for oral administration compositions, such as sugars and sugar derivatives (e.g., lactose, sucrose, mannitol, sorbitol), starch (e.g., maize starch, wheat starch, rice starch, potato starch), cellulose and derivatives (e.g., methylcellulose, carboxymethylcellulose, ethylhydroxycellulose), protein derivatives (e.g., zein, gelatin), and synthetic polymers (e.g., polyvinyl alcohol, polyvinylpyrrolidone). If desired, lubricants (e.g., magnesium stearate), disintegrating agents (e.g., cross-linked polyvinylpyrrolidinone, agar, alginic acid) and dyes or pigments can be added. Pastes and gels often also contain adhesives (e.g., acacia, alginic acid, bentonite, cellulose, xanthan gum, colloidal magnesium aluminum silicate) to aid in keeping the composition in contact with the oral cavity and not being easily ejected.

In one embodiment a composition of the present invention is formulated into a chewable and/or edible product (e.g., a chewable treat or edible tablet). Such a product would ideally have a taste, texture and/or aroma favored by the animal to be protected so as to facilitate oral administration of the compounds of the invention.

If the parasiticidal compositions are in the form of feed concentrates, the carrier is typically selected from high-performance feed, feed cereals or protein concentrates.

Such feed concentrate-containing compositions can, in addition to the parasiticidal active ingredients, comprise additives promoting animal health or growth, improving quality of meat from animals for slaughter or otherwise useful to animal husbandry.

These additives can include, for example, vitamins, antibiotics, chemotherapeutics, bacteriostats, fungistats, coccidiostats and hormones.

The compound of the invention may also be formulated in rectal compositions such as suppositories or retention enemas, using, e.g., conventional suppository bases such as cocoa butter or other glycerides.

The formulations for the method of this invention may include an antioxidant, such asBHT (butylated hydroxytoluene). The antioxidant is generally present in amounts of at 0.1-5 percent (wt/vol). Some of the formulations require a solubilizer, such as oleic acid, to dissolve the active agent, particularly if spinosad is included. Common spreading agents used in these pour-on formulations include isopropyl myristate, isopropyl palmitate, caprylic/capric acid esters of saturated C₁₂-C₁₈ fatty alcohols, oleic acid, oleyl ester, ethyl oleate, triglycerides, silicone oils and dipropylene glycol methyl ether. The pour-on formulations for the method of this invention are prepared according to known techniques. Where the pour-on is a solution, the parasiticide/insecticide is mixed with the carrier or vehicle, using heat and stirring if required. Auxiliary or additional ingredients can be added to the mixture of active agent and carrier, or they can be mixed with the active agent prior to the addition of the carrier. Pour-on formulations in the form of emulsions or suspensions are similarly prepared using known techniques.

Other delivery systems for relatively hydrophobic pharmaceutical compounds may be employed. Liposomes and emulsions are well-known examples of delivery vehicles or carriers for hydrophobic drugs. In addition, organic solvents such as dimethylsulfoxide may be used, if needed.

The rate of application required for effective parasitic invertebrate pest control (e.g. “pesticidally effective amount”) will depend on such factors as the species of parasitic invertebrate pest to be controlled, the pest's life cycle, life stage, its size, location, time of year, host crop or animal, feeding behavior, mating behavior, ambient moisture, temperature, and the like. One skilled in the art can easily determine the pesticidally effective amount necessary for the desired level of parasitic invertebrate pest control.

In general for veterinary use, the compounds of the invention are administered in a pesticidally effective amount to an animal, particularly a homeothermic animal, to be protected from parasitic invertebrate pests.

A pesticidally effective amount is the amount of active ingredient needed to achieve an observable effect diminishing the occurrence or activity of the target parasitic invertebrate pest. One skilled in the art will appreciate that the pesticidally effective dose can vary for the various compounds and compositions useful for the method of the present invention, the desired pesticidal effect and duration, the target parasitic invertebrate pest species, the animal to be protected, the mode of application and the like, and the amount needed to achieve a particular result can be determined through simple experimentation.

For oral or parenteral administration to animals, a dose of the compositions of the present invention administered at suitable intervals typically ranges from about 0.01 mg/kg to about 100 mg/kg, and preferably from about 0.01 mg/kg to about 30 mg/kg of animal body weight.

Suitable intervals for the administration of the compositions of the present invention to animals range from about daily to about yearly. Of note are administration intervals ranging from about weekly to about once every 6 months. Of particular note are monthly administration intervals (i.e. administering the compounds to the animal once every month).

It has now been found, surprisingly, that the animal health active ingredient mixtures according to the invention not only delivers about the additive enhancement of the spectrum of action with respect to the pest to be controlled that was in principle to be expected but achieves a synergistic effect which can extend the range of action of the component A and of the component B in two ways. Firstly, the rates of application of the component A and of the component B are lowered whilst the action remains equally good. Secondly, the active ingredient mixture still achieves a high degree of pest control, sometimes even where the two individual components have become totally ineffective in such a low application rate range. This allows increased safety in use.

This synergistic effect applies in particular to mixtures where component A is a compound of formula I, in particular the compounds listed in Tables1P to 90P, and component B is imidacloprid, enrofloxacin, praziquantel, pyrantel embonate, febantel, penethamate, moloxicam, cefalexin, kanamycin, pimobendan, clenbuterol, fipronil, ivermectin, omeprazole, tiamulin, benazepril, milbemycin, cyromazine, thiamethoxam, pyriprole, deltamethrin, cefquinome, florfenicol, buserelin, cefovecin, tulathromycin, ceftiour, selamectin, carprofen, metaflumizone, moxidectin, methoprene (including S-methoprene), clorsulon, pyrantel, amitraz, triclabendazole, avermectin, abamectin, emamectin, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, fipronil, lufenuron, ecdysone or tebufenozide. More preferably, component B is enrofloxacin, praziquantel, pyrantel embonate, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, selamectin, carprofen, moxidectin, clorsulon, pyrantel, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, lufenuron or ecdysone. Even more preferably, component B is enrofloxacin, praziquantel, pyrantel embonate, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, selamectin, carprofen, moxidectin, clorsulon or pyrantel.

The following Examples illustrate, but do not limit, the invention. Documents referred to herein are incorporated by reference.

The following abbreviations were used in this section: s=singlet; bs=broad singlet; d=doublet; dd=double doublet; dt=double triplet; t=triplet, tt=triple triplet, q=quartet, sept=septet; m=multiplet; Me=methyl; Et=ethyl; Pr=propyl; Bu=butyl; M.p.=melting point; RT=retention time, [M+H]⁺=molecular mass of the molecular cation, [M−H]⁻=molecular mass of the molecular anion.

### EXAMPLE 1

### tert-butyl N-[(4R)-3-oxoisoxazolidin-4-yl]carbamate

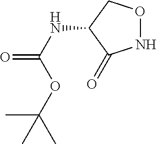

D-cycloserine (100 g) was dissolved in tetrahydrofuran (1000 ml) and water (1000 ml) then triethylamine (144 ml) was added. The stirred solution was cooled to 10° C. then a solution of di-tert-butylcarbonate (224 g) in tetrahydrofuran (1000 ml) was added dropwise over a period of 1 hour and the resulting reaction mixture was stirred overnight at room temperature. The solvent was removed in vacuo then the residue was acidified to pH 2-3 with a 2N hydrochloric acid solution. A precipitate was obtained, which was filtered to obtain a white solid. The filtrate was extracted with dichloromethane (6*200 ml). The combined organic layers were dried over sodium sulphate and the solvent evaporated in vacuo. The combined solids were triturated with diethyl ether then filtered and rinsed with cold diethyl ether and dried to afford the title product as a white solid (157 g). ¹H-NMR (CDCl₃, 400 MHz): 5.20 (m, 1H), 4.80 (m, 1H), 4.60 (m, 1H), 4.10 (m, 1H), 1.50 (s, 9H).

### EXAMPLE 2

### (R)-4-Amino-2-ethyl-isoxazolidin-3-one hydrochloride

### Step A: ((R)-2-ethyl-3-oxo-isoxazolidin-4-yl)-carbamic acid tert-butyl ester

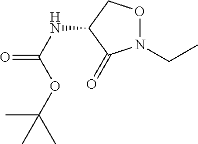 [SMILES: CCN1OC[C@@H](NC(=O)OC(C)(C)C)C1=O]

(3-Oxo-isoxazolidin-4-yl)-carbamic acid tert-butyl ester (50 g) was dissolved in dimethylformamide (750 ml) then potassium carbonate (69 g), potassium iodide (44 g) were added and the mixture stirred at room temperature for 30 min. The reaction mixture was cooled to 0° C. and a solution of bromoethane (30 g) in dimethylformamide (250 ml) was added dropwise over a period of 30 minutes. The reaction was stirred at room temperature for 2 hours. The solvent was removed in vacuo then the residue was partitioned between ethyl acetate and water. The organic layer was washed with water, brine and then dried over sodium sulphate. The solvent was removed in vacuo and the crude product was purified by column chromatography (eluent heptane/ethyl acetate) to afford ((R)-2-ethyl-3-oxo-isoxazolidin-4-yl)-carbamic acid tert-butyl ester as a white solid (43 g). ¹H-NMR (CDCl₃, 400 MHz): 5.10 (m, 1H), 4.75 (m, 1H), 4.55 (m, 1H), 3.95 (m, 1H), 3.60 (m, 2H), 1.50 (s, 9H), 1.20 (t, 3H).

### Step B: (R)-4-Amino-2-ethyl-isoxazolidin-3-one hydrochloride

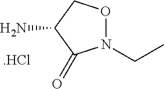

To a stirred solution of ((R)-2-ethyl-3-oxo-isoxazolidin-4-yl)-carbamic acid tert-butyl ester (50 g) in dichloromethane (665 ml) at 0° C. was added dropwise hydrochloric acid (4M solution in dioxan (217 ml) and the solution was stirred at room temperature overnight. The precipitate was collected by filtration, washed with diethyl ether and dried under vacuum to afford the title product as a white solid (26 g). ¹H-NMR (DMSO, 400 MHz): 9.05 (br s, 3H), 4.65 (m, 1H), 4.50 (m, 1H), 4.22 (m, 1H), 3.55 (m, 2H), 1.15 (t, 3H).

### EXAMPLE 3

### (R)-4-Amino-2-ethyl-isoxazolidin-3-one hydrochloride

### Step A: tert-butyl N-[(4R)-3-oxo-2-(2,2,2-trifluoroethyl)isoxazolidin-4-yl]carbamate

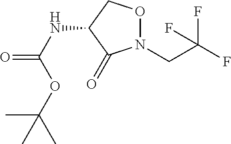 [SMILES: CC(C)(C)OC(=O)N[C@@H]1CON(CC(F)(F)F)C1=O]

(3-Oxo-isoxazolidin-4-yl)-carbamic acid tert-butyl ester (10 g) was dissolved in tetrahydrofuran (150 ml), the solution was cooled to 0° C., then triethylamine (21 ml) was added followed by 2,2,2-trifluoroethyl-trifluoromethanesulfonate (9.3 ml). The solution was stirred at room temperature overnight then the solvent evaporated in vacuo. The residue was extracted partitioned between ethyl acetate and water. The organic layer was washed with water, brine, then,dried over sodium sulphate. The solvent was removed in vacuo and the crude product was purified by chromatography (eluent dichloromethane/ethyl acetate) to afford the title product as a white solid (8.9 g). ¹H-NMR (CDCl₃, 400 MHz): 5.10 (m, 1H), 4.79 (m, 1H), 4.64 (m, 1H), 4.00-4.25 (m, 2H), 1.45 (s, 9H).

### Step B: (R)-4-Amino-2-(2,2,2-trifluoroethyl)-isoxazolidin-3-one hydrochloride

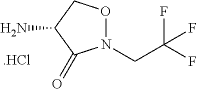 [SMILES: ".HCl" ; N[C@@H]1CON(CC(F)(F)F)C1=O]

To a stirred solution of tert-butyl N-[(4R)-3-oxo-2-(2,2,2-trifluoroethyl)isoxazolidin-4-yl]carbamate (50 g) in dichloromethane (530 ml) at 0° C. was added dropwise hydrochloric acid (4M solution in dioxan (176 ml) and the solution was stirred at room temperature overnight. The precipitate was collected by filtration, washed with diethyl ether and dried under vacuum to afford the title product as a white solid (37 g). ¹H-NMR (DMSO, 400 MHz): 9.05 (br s, 3H), 4.70 (t, 1H), 4.65 (t, 1H), 4.50 (m, 2H), 4.30 (t, 1H). ¹⁹F-NMR (DMSO, 400 MHz): −69.1.

### EXAMPLE 4

### tert-butyl 4-[5-[3-chloro-5-(trifluoromethyl)phenyl]-5-(trifluoromethyl)-4H-isoxazol-3-yl]-2-methyl-benzoate

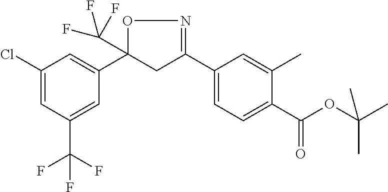 [SMILES: Cc1cc(C2=NOC(c3cc(Cl)cc(C(F)(F)F)c3)(C(F)(F)F)C2)ccc1C(=O)OC(C)(C)C]

To a solution of 1-chloro-3-(trifluoromethyl)-5-[1-(trifluoromethyl)vinyl]benzene (9 g) in toluene (150 ml) was added potassium carbonate (8.8 g) and triethylamine (4.6 mL). The reaction mixture was stirred at room temperature for 10 min then tert-butyl 4-[(Z)—C-chloro-N-hydroxy-carbonimidoyl]-2-methyl-benzoate (2.8 g) was added. After 20 minutes, more tert-butyl 4-[(Z)—C-chloro-N-hydroxy-carbonimidoyl]-2-methyl-benzoate (3 g) was added and a further amount of tert-butyl 4-[(Z)—C-chloro-N-hydroxy-carbonimidoyl]-2-methyl-benzoate (3 g) was added 30 minutes later. The suspension was stirred at room temperature overnight then it was diluted with water and extracted with dichloromethane. The combined organic layers were dried over magnesium sulphate, concentrated under reduced pressure and purified by column chromatography (eluent: dichloromethane/heptane 1:2) to give tert-butyl 4-[5-[3-chloro-5-(trifluoromethyl)phenyl]-5-(trifluoromethyl)-4H-isoxazol-3-yl]-2-methyl-benzoate (9.91 g) as a yellow oil. H¹ NMR (400 MHz, CDCl₃); δ=7.83-7.92 (m, 2H), 7.79 (s, 1H), 7.72 (s, 1H), 7.50-7.62 (m, 2H), 4.17 (d, 1H), 3.76 (d, 1H), 2.62 (s, 3H), 1.54-1.73 (m, 9H) ppm.

Similarly, tert-butyl 4-[5-(3-bromo-5-chloro-phenyl)-5-(trifluoromethyl)-4H-isoxazol-3-yl]-2-methyl-benzoate was obtained as a white solid. H¹ NMR (400 MHz, CDCl₃); δ=7.86 (d, 1H), 7.67 (s, 1H), 7.55-7.61 (m, 2H), 7.47-7.55 (m, 2H), 4.09 (d, 1H), 3.71 (d, 1H), 2.60 (s, 3H), 1.61 (s, 9H) ppm.

Similarly, tert-butyl 2-methyl-4-[5-(3,4,5-trichlorophenyl)-5-(trifluoromethyl)-4H-isoxazol-3-yl]benzoate was obtained as a colorless foam. H¹ NMR (400 MHz, CDCl₃); δ=7.86 (d, 1H), 7.66 (s, 2H), 7.45-7.56 (m, 2H), 4.10 (d, 1H), 3.70 (d, 1H), 2.60 (s, 3H), 1.50-1.70 (m, 9H) ppm.

Similarly, tert-butyl 4-[5-(3,5-dichloro-4-fluoro-phenyl)-5-(trifluoromethyl)-4H-isoxazol-3-yl]-2-methyl-benzoate was obtained. H¹ NMR (400 MHz, CDCl₃); δ=7.86 (d, 1H), 7.60 (d, 2H), 7.45-7.58 (m, 2H), 4.10 (d, 1H), 3.70 (d, 1H), 2.60 (s, 3H), 1.61 (s, 9H) ppm.

### EXAMPLE 5

### Preparation of 4-[5-[3-chloro-5-(trifluoromethyl)phenyl]-5-(trifluoromethyl)-4H-isoxazol-3-yl]-2-methyl-benzoic acid

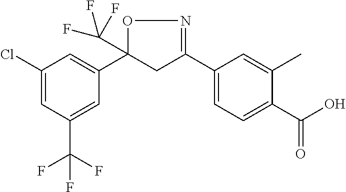 [SMILES: Cc1cc(C2=NOC(c3cc(Cl)cc(C(F)(F)F)c3)(C(F)(F)F)C2)ccc1C(=O)O]

To a solution of tert-butyl 4-[5-[3-chloro-5-(trifluoromethyl)phenyl]-5-(trifluoromethyl)-4H-isoxazol-3-yl]-2-methyl-benzoate (8.8 g) in dichloromethane (80 mL) was added trifluoroacetic acid (8 mL). The reaction mixture was stirred at room temperature for 18 hours then the solution was concentrated under vacuo. The crude residue was diluted with water and extracted with dichloromethane. The combined organic layers were dried over magnesium sulphate, concentrated under reduced pressure to give 4-[5-[3-chloro-5-(trifluoromethyl)phenyl]-5-(trifluoromethyl)-4H-isoxazol-3-yl]-2-methyl-benzoic acid (7.5 g) as a white foam. ¹H-NMR (CDCl₃, 400 MHz): δ=8.12 (d, 1H), 7.84 (s, 1H), 7.77 (s, 1H), 7.71 (s, 1H), 7.54-7.66 (m, 2H), 4.18 (d, 1H), 3.76 (d, 1H), 2.70 (s, 3H) ppm.

Similarly, 4-[5-(3-bromo-5-chloro-phenyl)-5-(trifluoromethyl)-4H-isoxazol-3-yl]-2-methyl-benzoic acid was obtained as a white foam. H¹ NMR (400 MHz, CDCl₃); δ=8.12 (d, 1H), 7.67 (s, 1H), 7.54-7.64 (m, 4H), 4.12 (d, 1H), 3.73 (d, 1H), 2.70 (s, 3H) ppm.

Similarly,2-methyl-4-[5-(3,4,5-trichlorophenyl)-5-(trifluoromethyl)-4H-isoxazol-3-yl]benzoic acid was obtained as a white foam. H¹ NMR (400 MHz, CDCl₃); δ=8.12 (d, 1H), 7.66 (s, 2H), 7.43-7.64 (m, 2H), 4.12 (d, 1H), 3.72 (d, 1H), 2.69 (s, 3H) ppm.

Similarly,4-[5-(3,5-dichloro-4-fluoro-phenyl)-5-(trifluoromethyl)-4H-isoxazol-3-yl]-2-methyl-benzoic acid was obtained as a white foam. H¹ NMR (400 MHz, CDCl₃); δ=8.12 (d, 1H), 7.51-7.65 (m, 4H), 4.12 (d, 1H), 3.72 (d, 1H), 2.69 (s, 3H) ppm.

### EXAMPLE 6

### Preparation of 4-[5-[3-chloro-5-(trifluoromethyl)phenyl]-5-(trifluoromethyl)-4H-isoxazol-3-yl]-N-[(4R)-2-ethyl-3-oxo-isoxazolidin-4-yl]-2-methyl-benzamide

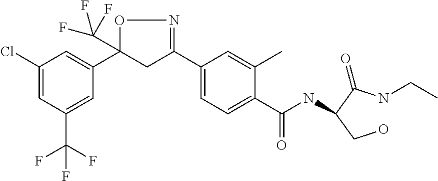 [SMILES: CCNC(=O)[C@@H](CO)NC(=O)c1ccc(C2=NOC(c3cc(Cl)cc(C(F)(F)F)c3)(C(F)(F)F)C2)cc1C]

To a suspension of 4-[5-[3-chloro-5-(trifluoromethyl)phenyl]-5-(trifluoromethyl)-4H-isoxazol-3-yl]-2-methyl-benzoic acid (600 mg) in dichloromethane (6 ml) was added oxalyl chloride (0.135 ml) and then one drop of dimethylformamide. The reaction mixture was stirred at room temperature for 16 hours, then oxalyl chloride (0.027 ml) was added again. The reaction mixture was stirred at room temperature for 2.5 hours, and the solvent was evaporated in vacuo. The acyl chloride thus obtained was dissolved in tetrahydrofuran (2 ml) and the resulting solution was added dropwise to a solution of triethylamine (0.552 ml) and the trifluoroacetate salt of (4R)-4-amino-2-ethyl-isoxazolidin-3-one (644 mg) in tetrahydrofuran (4 ml) at room temperature, under argon. The reaction was stirred for 3 hours at room temperature. Then the residue was diluted with water and extracted with ethyl acetate. The organic phase was washed with water, dried over anhydrous magnesium sulfate, filtered and concentrated in vacuo and purified by column chromatography (dichloromethane/ethyl acetate, 0 to 20%) to give a residue which was suspended in diethyl ether. The solid was filtered and dried, to give 4-[(5S)-5-[3-chloro-5-(trifluoromethyl)phenyl]-5-(trifluoromethyl)-4H-isoxazol-3-yl]-N-[(4R)-2-ethyl-3-oxo-isoxazolidin-4-yl]-2-methyl-benzamide (240 mg) as a white solid, as a major diastereoisomer. Chiral analysis: Column: Chiralpack IA, eluent Isocratic: Heptane/iPrOH/Diethylamine 70/30/0.1, Room temperature, flow: 1 mL/min, UV: 270 nm, rt=15.18 min (minor, 6.7%) and rt=16.83 (major, 93%)

The mother liquors were concentrated under vacuo to give the title compound (390 mg) as yellow foam and as an enriched mixture of the second diastereoisomer. Chiral analysis: Column: Chiralpack IA, eluent Isocratic: Heptane/iPrOH/Diethylamine 70/30/0.1, Room temperature, flow: 1 mL/min, UV: 270 nm, retention time rt=14.84 min (major, 81%) and rt=16.91 (minor, 19%). ¹H-NMR (CDCl₃, 400 MHz): δ=7.83 (s, 1H), 7.77 (s, 1H), 7.70 (s, 1H), 7.47-7.57 (m, 3H), 6.46 (d, 1H), 4.94-5.07 (m, 1H), 4.87 (dd, 1H), 4.09-4.22 (m, 1H), 4.05 (dd, 1H), 3.53-3.79 (m, 3H), 2.50 (s, 3H), 1.15-1.33 (m, 3H) ppm.

Similarly, 4-[5-(3-bromo-5-chloro-phenyl)-5-(trifluoromethyl)-4H-isoxazol-3-yl]-N-[(4R)-2-ethyl-3-oxo-isoxazolidin-4-yl]-2-methyl-benzamide could be obtained. After purification of the crude, the residue was suspended in diethyl ether and the two diastereoisomers could be separated. The solid was filtered and was analysed by chiral HPLC: Column: Chiralpack IA, eluent Isocratic: Heptane/iPrOH/Diethylamine 80/20/0.1, Room temperature, flow: 1 mL/min, UV: 270 nm, rt=23.78 min (48%) and rt=27.21 (52%). The mother liquors were concentrated under vacuo to give the title compound as an enriched mixture of one diastereoisomer: chiral HPLC: Column: Chiralpack IA, eluent Isocratic: Heptane/iPrOH/Diethylamine 80/20/0.1, Room temperature, flow: 1 mL/min, UV: 270 nm, rt=23.15 min (major, 97%) and rt=27.17 (minor, 2.6%).

¹H-NMR (CDCl₃, 400 MHz): δ=7.67 (s, 1H), 7.59 (t, 1H), 7.53-7.58 (m, 2H), 7.47-7.53 (m, 2H), 6.43 (d, 1H), 4.93-5.06 (m, 1H), 4.86 (dd, 1H), 3.95-4.13 (m, 2H), 3.56-3.80 (m, 3H), 2.50 (s, 3H), 1.27 (t, 3H)ppm.

Similarly, 4-[(5S)-5-(3-bromo-5-chloro-phenyl)-5-(trifluoromethyl)-4H-isoxazol-3-yl]-2-methyl-N-[(4R)-3-oxo-2-(2,2,2-trifluoroethyl)isoxazolidin-4-yl]benzamide could be obtained. After purification of the crude, the residue was suspended in diethyl ether and the two diastereoisomers could be separated: The solid was filtered and was analysed by chiral HPLC: Column: Chiralpack IB, eluent Isocratic: Heptane/iPrOH/Diethylamine 70/30/0.1, Room temperature, flow: 1 mL/min, UV: 270 nm, rt=5.67 min (major, 83%), rt=6.54 min (minor, 16%). The mother liquors were concentrated under vacuo to give the title compound as an enriched mixture of the second diastereoisomer: chiral HPLC: Column: Chiralpack IB, eluent Isocratic: Heptane/iPrOH/Diethylamine 70/30/0.1, Room temperature, flow: 1 mL/min, UV: 270 nm, rt=5.51 min (minor, 8%), rt=6.27 min (major, 92%).

¹H-NMR (CDCl₃, 400 MHz): δ=7.67 (s, 1H), 7.60 (t, 1H), 7.54-7.58 (m, 2H), 7.48-7.54 (m, 2H), 6.38 (d, 1H), 4.99-5.10 (m, 1H), 4.97 (dd, 1H), 4.04-4.32 (m, 4H), 3.71 (d, 1H), 2.50 (s, 3H) ppm.

Similarly, 4-[5-(3,5-dichloro-4-fluoro-phenyl)-5-(trifluoromethyl)-4H-isoxazol-3-yl]-N-(2-ethyl-3-oxo-isoxazolidin-4-yl)-2-methyl-benzamide could be obtained. After the completion of the reaction and extraction, the residue was suspended in diethyl ether and the two diastereoisomers could be separated: The solid was filtered and was analysed by chiral HPLC: Column: Chiralpack IB (4.6×250 mm), eluent Isocratic: Heptane/iPrOH/Diethylamine 70/30/0.1, flow: 1 mL/min, Room temperature, UV: 270 nm: rt=8.88 min (major, 89%), rt=15.98 min (minor, 6%). The mother liquors were concentrated under vacuo and purified by column chromatography to give the title compound as an enriched mixture of the second diastereoisomer. This compound was analysed by chiral HPLC (same method): rt=8.61 min (minor, 24%), rt=12.25 min (major, 75%).

¹H-NMR (CDCl₃, 400 MHz): δ=7.60 (d, 2H), 7.55 (s, 1H), 7.51 (s, 2H), 6.43 (d, 1H), 4.94-5.05 (m, 1H), 4.86 (dd, 1H), 3.99-4.13 (m, 2H), 3.59-3.78 (m, 3H), 2.50 (s, 3H), 1.21-1.35 (t, 3H) ppm

Similarly, 2-methyl-N-[3-oxo-2-(2,2,2-trifluoroethyl)isoxazolidin-4-yl]-4-[5-(3,4,5-trichlorophenyl)-5-(trifluoromethyl)-4H-isoxazol-3-yl]benzamide could be obtained. After purification of the crude, the residue was suspended in diethyl ether and the two diastereoisomers could be separated: The solid was filtered and was analysed by chiral HPLC: Chiral analysis: Column: Chiralpack IB (4.6×250 mm), Isocratic: Heptane/iPrOH/Diethylamine 70/30/0.1, flow:1 mL/min, Room temperature, UV: 270 nm, rt=8.90 min (major, 91%), rt=11.97 min (minor, 9%).

The mother liquors were concentrated under vacuo to give the title compound as an enriched mixture of the second diastereoisomer: Chiral analysis (same method), rt=8.66 min (minor, 17%), rt=11.02 min (major, 82%).

¹H-NMR (CDCl₃, 400 MHz): δ=7.65 (s, 2H), 7.55 (s, 1H), 7.47-7.54 (m, 2H), 6.40 (d, 1H), 4.99-5.11 (m, 1H), 4.97 (dd, 1H), 4.09-4.32 (m, 4H), 3.70 (d, 1H), 2.50 (s, 3H) ppm.

Similarly, 4-[5-(3,5-dichloro-4-fluoro-phenyl)-5-(trifluoromethyl)-4H-isoxazol-3-yl]-2-methyl-N-[3-oxo-2-(2,2,2-trifluoroethyl)isoxazolidin-4-yl]benzamide could be obtained. After purification of the crude, the residue was suspended in diethyl ether and the two diastereoisomers could be separated: The solid was filtered and was analysed by chiral HPLC: Chiral analysis: Column: Chiralpack IB (4.6×250 mm), Isocratic: Heptane/iPrOH/Diethylamine 70/30/0.1, flow:1 mL/min, Room temperature, UV: 270 nm, rt=8.31 min (major, 88%), rt=10.79 min (minor, 6%).

The mother liquors were concentrated under vacuo to give the title compound as an enriched mixture of the second diastereoisomer: Chiral analysis (same method), rt=8.28 min (minor, 18%), rt=10.75 min (major, 82%).

¹H-NMR (CDCl₃, 400 MHz): δ=7.60 (d, 2H), 7.55 (s, 1H), 7.48-7.53 (m, 2H), 6.40 (d, 1H), 5.00-5.09 (m, 1H), 4.87-5.00 (m, 1H), 4.09-4.34 (m, 4H), 3.70 (d, 1H), 2.50 (s, 3H) ppm.

TABLE A
R/S indicates a racemic mixture.

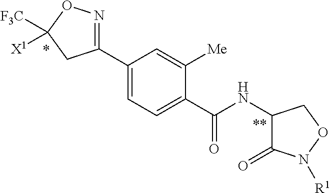

| | | | Stereochemistry | Stereochemistry |
|---|---|---|---|---|
| | X1 | R1 | at * | at ** |
| A01 | 3,5-dichlorophenyl | methyl | S | R/S |
| A02 | 3,4,5-trichlorophenyl | ethyl | R | R |
| A03 | 3,4,5-trichlorophenyl | ethyl | S | R |
| A04 | 3,5-dichloro-4-fluorophenyl | ethyl | S | R |
| A05 | 3,5-dichloro-4-fluorophenyl | ethyl | R | R |
| A06 | 3,5-dichloro-4-fluorophenyl | Ethyl | S | R/S |
| A07 | 3,5-dichlorophenyl | ethyl | S | R/S |
| A08 | 3,5-dichlorophenyl | ethyl | R/S | R/S |
| A09 | 3,5-dichlorophenyl | ethyl | S | S |
| A10 | 3-chloro-5-bromophenyl | ethyl | S | R |
| A11 | 3-chloro-5-bromophenyl | ethyl | R | R |
| A12 | 3-chloro-5-trifluoromethylphenyl | ethyl | S | R |
| A13 | 3-chloro-5-trifluoromethylphenyl | ethyl | R | R |
| A14 | 3,5-dichlorophenyl | 2,2-difluoroethyl | S | R/S |
| A15 | 3,5-dichlorophenyl | 2,2-difluoroethyl | S | S |
| A16 | 3,4,5-trichlorophenyl | 2,2,2-trifluoroethyl | S | R |
| A17 | 3,4,5-trichlorophenyl | 2,2,2-trifluoroethyl | R | R |
| A18 | 3,4,5-trichlorophenyl | 2,2,2-trifluoroethyl | S | R/S |
| A19 | 3,4,5-trichlorophenyl | 2,2,2-trifluoroethyl | S | R |
| A20 | 3,5-dichloro-4-fluorophenyl | 2,2,2-trifluoroethyl | S | R |
| A21 | 3,5-dichloro-4-fluorophenyl | 2,2,2-trifluoroethyl | R | R |
| A22 | 3,5-dichlorophenyl | 2,2,2-trifluoroethyl | S | R/S |
| A23 | 3,5-dichlorophenyl | 2,2,2-trifluoroethyl | R/S | R/S |
| A24 | 3,5-dichlorophenyl | 2,2,2-trifluoroethyl | S | S |
| A25 | 3-chloro-5-bromophenyl | 2,2,2-trifluoroethyl | S | R |
| A26 | 3-chloro-5-bromophenyl | 2,2,2-trifluoroethyl | R | R |

TABLE C

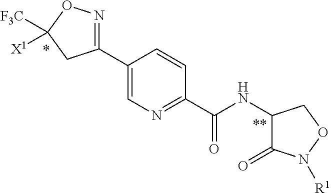

| | | | Stereochemistry | Stereochemistry |
|---|---|---|---|---|
| | X1 | R1 | at * | at ** |
| B1 | 3,5- | ethyl | R/S | R |
| | dichlorophenyl | | | |
| B2 | 3,5- | 2,2,2- | R/S | R |
| | dichlorophenyl | trifluoroethyl | | |

### Biological Examples

This Example illustrates the pesticidal/insecticidal properties of compounds of formula (I). Tests were performed as follows:

Spodoptera littoralis (Egyptian Cotton Leafworm):

Cotton leaf discs were placed on agar in a 24-well microtiter plate and sprayed with test solutions at an application rate of 200 ppm. After drying, the leaf discs were infested with 5 μl larvae. The samples were checked for mortality, feeding behavior, and growth regulation 3 days after treatment (DAT).

The following compounds gave at least 80% control of Spodoptera littoralis: A01, A02, A03, A04, A05, A06, A07, A08, A09, A10, A11, A12, A13, A15, A16, A17, A18, A19, A20, A21, A22, A23, A24, A25, A26, B1 and B2

Heliothis virescens (Tobacco Budworm):

Eggs (0-24 h old) were placed in 24-well microtiter plate on artificial diet and treated with test solutions at an application rate of 200 ppm (concentration in well 18 ppm) by pipetting. After an incubation period of 4 days, samples were checked for egg mortality, larval mortality, and growth regulation.

The following compounds gave at least 80% control of Heliothis virescens: A01, A02, A03, A04, A05, A06, A07, A08, A09, A10, A11, A12, A13, A15, A16, A17, A18, A19, A20, A21, A22, A23, A24, A25, A26, B1 and B2

Plutella xylostella (Diamond Back Moth):

24-well microtiter plate (MTP) with artificial diet was treated with test solutions at an application rate of 200 ppm (concentration in well 18 ppm) by pipetting. After drying, the MTP's were infested with L2 larvae (7-12 per well). After an incubation period of 6 days, samples were checked for larval mortality and growth regulation.

The following compounds gave at least 80% control of Plutella xylostella: A01, A02, A03, A04, A05, A06, A07, A08, A09, A10, A11, A12, A13, A15, A16, A17, A18, A19, A20, A21, A22, A23, A24, A25, A26, B1 and B2

Diabrotica balteata (Corn Root Worm):

A 24-well microtiter plate (MTP) with artificial diet was treated with test solutions at an application rate of 200 ppm (concentration in well 18 ppm) by pipetting. After drying, the MTP's were infested with L2 larvae (6-10 per well). After an incubation period of 5 days, samples were checked for larval mortality and growth regulation.

The following compounds gave at least 80% control of Diabrotica balteata:

A01, A02, A03, A04, A05, A06, A07, A08, A09, A10, A11, A12, A13, A15, A16, A17, A18, A19, A20, A21, A22, A23, A24, A25, A26, B1 and B2

### Thrips Tabaci (Onion Thrips):

Sunflower leaf discs were placed on agar in a 24-well microtiter plate and sprayed with test solutions at an application rate of 200 ppm. After drying, the leaf discs were infested with a thrips population of mixed ages. After an incubation period of 7 days, samples were checked for mortality.

The following compounds gave at least 80% control of Thrips tabaci A01, A02, A03, A04, A05, A06, A07, A08, A09, A10, A11, A12, A13, A15, A16, A17, A18, A19, A20, A21, A22, A23, A24, A25, A26 and B2

Tetranychus urticae (Two-Spotted Spider Mite):

Bean leaf discs on agar in 24-well microtiter plates were sprayed with test solutions at an application rate of 200 ppm. After drying, the leaf discs are infested with mite populations of mixed ages. 8 days later, discs are checked for egg mortality, larval mortality, and adult mortality.

The following compounds gave at least 80% control of Tetranychus urticae:

A01, A02, A03, A04, A05, A06, A07, A08, A09, A10, A11, A12, A13, A15, A16, A17, A18, A19, A20, A21, A22, A23, A24, A25, A26, B1 and B2

1. A compound of formula I 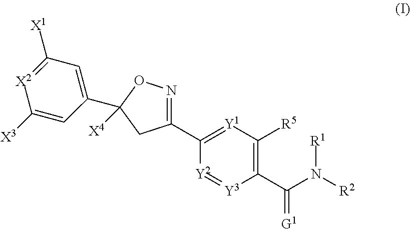
wherein
G¹ is oxygen;
R¹ is hydrogen;
R² is group P 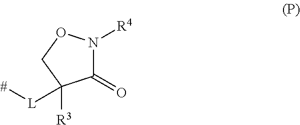
L is a bond, methylene or ethylene;
R³ is hydrogen;
R⁴ is independently hydrogen, cyano, cyano-C₁-C₈alkyl, C₁-C₈alkyl, C₁-C₈haloalkyl, C₃-C₈cycloalkyl, C₃-C₈cycloalkyl where one carbon atom is replaced by O, S, S(O) or SO₂, or C₃-C₈cycloalkyl-C₁-C₈alkyl, C₃-C₈cycloalkyl-C₁-C₈alkyl where one carbon atom in the cycloalkyl group is replaced by O, S, S(O) or SO₂, or C₃-C₈cycloalkyl-C₁-C₈haloalkyl, C₁-C₈hydroxyalkyl, C₁-C₈alkoxy-C₁-C₈alkyl, C₂-C₈alkenyl, C₂-C₈haloalkenyl, C₂-C₈alkynyl, C₂-C₈haloalkynyl, phenyl, phenyl substituted by one to three R⁶, phenyl-C₁-C₄alkyl, phenyl-C₁-C₄alkyl wherein the phenyl moiety is substituted by one to three R⁶, 5-6 membered heteroaryl-C₁-C₄alkyl or 5-6 membered heteroaryl-C₁-C₄alkyl wherein the heteroaryl moiety is substituted by one to three R⁶, or C₁-C₄alkyl-(C₁-C₄alkyl-O—N═)C—CH₂—;
each R⁶ is independently halogen, cyano, nitro, C₁-C₈alkyl, C₁-C₈haloalkyl, C₁-C₈alkoxy, or C₁-C₈haloalkoxy;
Y¹, Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₂alkyl, C₁-C₂haloalkyl, C₃-C₅cycloalkyl, C₁-C₂halocycloalkyl, C₁-C₂alkoxy, C₁-C₂haloalkoxy;
or Y¹ is CR⁷, and R⁵ and R⁷ together form a —CH═CH—CH═CH— bridge or a —N═CH—CH═CH— bridge;
X² is C—X⁶ or nitrogen;
X¹, X³ and X⁶ are independently hydrogen, halogen or trihalomethyl, wherein at least two of X¹, X³ and X⁶ are not hydrogen;
X⁴ is trifluoromethyl, difluoromethyl or chlorodifluoromethyl.
or a salt or N-oxide thereof.

2. A compound according to claim 1, wherein R⁴ is hydrogen, methyl, ethyl, 2,2,2-trifluoro-ethyl, 3,3,3-trifluoro-propyl, 2-methoxy-ethyl, 3,3,3-trifluoro-propyl, 2-methoxy-ethyl, 2-hydroxy-ethyl, cyclobutyl, phenyl-methyl, (pyrid-2-yl)-methyl, (pyrid-3-yl)-methyl, thietan-3-yl, 1-oxo-thietan-3-yl, 1,1-dioxo-thietan-3-yl, 3-methyl-thietan-3-yl-oxetan-3yl, tetrahydropyran-4-yl, cyclopropyl, 2-cyano-ethyl, 2,2-difluoro-ethyl, prop-2-ynyl, cyclopropylmethyl, cyclobutylmethyl, 3-cyano-propyl, 2-([1′,3′]dioxolan-2′-yl)-eth-1-yl, (2-chloro-pyrid-5-yl)-methyl, tetrahydro-pyran-2-ylmethyl, allyl, 3-methyl-but-2-enyl, butyl, but-2-ynyl, 2-methoxyimino-propy, (2,6-difluoro-phenyl)-methyl, (4-fluoro-phenyl)-methyl, 3-phenyl-propyl, 2,5-dimethyl-2H-[1,2,3],2,5-dimethyl-2H-[1,2,3]triazol-4-ylmethyl, cyclohexylmethyl, (tetrahydrofuran-2-yl)-methyl, 5-trifluoromethyl-furan-2-ylmethyl or isopropyl.

3. A compound according to claim 1, wherein R⁴ is methyl, ethyl, 2,2,2-trifluoro-ethyl, 3,3,3-trifluoro-propyl, 2-prop-2-ynyl, 2,2-difluoro-ethyl, cyclobutyl, 3-cyano-propyl, cyclopropylmethyl, or 2-methoxy-ethyl.

4. A compound according to claim 1, wherein
Y¹ is CH, Y² is CH, Y³ is CH, or
Y¹ is N, Y² is CH, Y³ is CH, or
Y¹ is N, Y² is N, Y³ is CH, or
Y¹ is CH, Y² is N, Y³ is CH, or
Y¹ is CH, Y² is CH, Y³ is N.

5. A compound according to claim 1, wherein R⁵ is hydrogen, chloro, bromo, fluoro, trifluoromethyl, methyl, ethyl, methoxy, nitro, trifluoromethoxy, cyano, or cyclopropyl.

6. A compound according to claim 1, wherein
X¹ is chloro, X² is CH, X³ is chloro, or
X¹ is chloro, X² is C—F, X³ is hydrogen, or
X¹ is fluoro, X² is C—Cl, X³ is hydrogen, or
X¹ is chloro, X² is C—Cl, X³ is hydrogen, or
X¹ is chloro, X² is C—Br, X³ is chloro, or
X¹ is chloro, X² is C—F, X³ is chloro, or
X¹ is chloro, X² is C—Cl, X³ is chloro, or
X¹ is chloro, X² is C—I, X³ is chloro, or
X¹ is fluoro, X² is C—F, X³ is fluoro, or
X¹ is chloro, X² is CH, X³ is bromo, or
X¹ is chloro, X² is CH, X³ is fluoro, or
X¹ is chloro, X² is CH, X³ is trifluoromethyl, or
X¹ is chloro, X² is C—Cl, X³ is trifluoromethyl, or
X¹ is trifluoromethyl, X² is CH, X³ is trifluoromethyl, or
X¹ is trifluoromethyl, X² is C—Cl, X³ is trifluoromethyl, or
X¹ is trifluoromethyl, X² is CH, X³ is hydrogen, or
X¹ is chloro, X² is N, X³ is chloro, or
X¹ is trifluoromethyl, X² is N, X³ is trifluoromethyl.

7. A compound according to claim 1, wherein X² is C—X⁶, Y¹, Y² and Y³ are C—H, R³ is hydrogen and each R⁴ is hydrogen.

8. A compound of formula X1 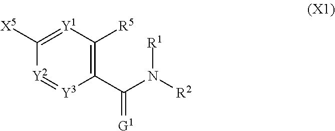
wherein G¹, R¹, R², R⁵, Y¹, Y², and Y³ are as defined for the compound of formula I in claim 1 and X⁵ is chloro, bromo, iodo, amino, CHO, CN, OH, C(═O)OH, C(═NOH)H, C(═NOH)Cl, C(═NOH)NH₂, C(═O)CH₃, C(═NOH)CH₃, C(═O)CH₂Cl, or C(═O)CH₂Br.

9. A compound of formula X2 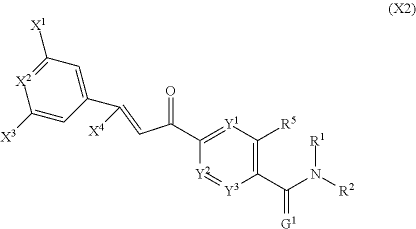
wherein G¹, R¹, R², R⁵, X¹, X², X³, X⁴, Y¹, Y², and Y³ are as defined for the compound of formula I in claim 1.

10. A method of controlling insects, acarines, nematodes or molluscs which comprises applying to a pest, to a locus of a pest, or to a plant susceptible to attack by a pest an insecticidally, acaricidally, nematicidally or molluscicidally effective amount of a compound of formula (I) as defined in claim 1.

11. An insecticidal, acaricidal, nematicidal or molluscicidal composition comprising an insecticidally, acaricidally, nematicidally or molluscicidally effective amount of a compound of formula (I) as defined in claim 1.

12. An insecticidal, acaricidal, nematicidal or molluscicidal composition according to claim 11 comprising at least one additional compound having biological activity.

13. A combination product comprising a pesticidally effective amount of a component A and a pesticidally effective amount of component B, wherein component A is a compound of formula (I) as defined in claim 1, and compound B is imidacloprid, enrofloxacin, praziquantel, pyrantel embonate, febantel, penethamate, moloxicam, cefalexin, kanamycin, pimobendan, clenbuterol, fipronil, ivermectin, omeprazole, tiamulin, benazepril, milbemycin, cyromazine, thiamethoxam, pyriprole, deltamethrin, cefquinome, florfenicol, buserelin, cefovecin, tulathromycin, ceftiour, selamectin, carprofen, metaflumizone, moxidectin, methoprene (including S-methoprene), clorsulon, pyrantel, amitraz, triclabendazole, avermectin, abamectin, emamectin, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, fipronil, lufenuron, ecdysone or tebufenozide, wherein the combination product is for use in a method of therapeutic treatment.

14. A combination product comprising a pesticidally effective amount of a component A and a pesticidally effective amount of component B, wherein component A is a compound of formula (I) as defined in claim 1, wherein component B is enrofloxacin, praziquantel, pyrantel embonate, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, selamectin, carprofen, moxidectin, clorsulon, pyrantel, eprinomectin, doramectin, selamectin, nemadectin, albendazole, cambendazole, fenbendazole, flubendazole, mebendazole, oxfendazole, oxibendazole, parbendazole, tetramisole, levamisole, pyrantel pamoate, oxantel, morantel, triclabendazole, epsiprantel, lufenuron or ecdysone.

15. A combination product according to claim 13, wherein component B is enrofloxacin, praziquantel, pyrantel embonate, febantel, penethamate, moloxicam, cefalexin, kanamycin, pimobendan, clenbuterol, omeprazole, tiamulin, benazepril, pyriprole, cefquinome, florfenicol, buserelin, cefovecin, tulathromycin, ceftiour, selamectin, carprofen, moxidectin, clorsulon or pyrantel.
